(19) United States
(12) Patent Application Publication
(10) Pub. No.: US 2004/0110777 A1
(43) Pub. Date: Jun. 10, 2004

(54) Quinazolinones and pyridinylpyrimidinones for controlling invertebrate pests

(76) Inventors: Gary David Annis, Landenberg, PA (US); Brian James Myers, Oxford, PA (US); Thomas Paul Selby, Wilmington, DE (US); Thomas Martin Stevenson, Newark, DE (US); William Thomas Zimmerman, Landenberg, PA (US)

Correspondence Address: Linda D Birch, E I du Pont de Nemours & Company, Legal Patents, Wilmington, DE, 19898, US

(21) Appl. No.: 10/433,368

(22) PCT Filed: Dec. 3, 2001
(86) PCT No.: PCT/US01/46629

(51) Int. Cl. A01N 43/90; A01N 43/54

(52) U.S. Cl. 514/264.1; 514/266.2; 514/266.3

(57) ABSTRACT

This invention provides methods for controlling invertebrate pests comprising contacting the pests or their environment with an arthropodicidally effective amount of a compound of Formula (I), its N-oxides or agriculturally suitable salts wherein B, J, K, R³ and R⁴ and n are as defined in the disclosure.This invention also pertains to certain compounds of Formula (I) and compositions for controlling invertebrate pests comprising a biologically effective amount of a compound of Formula I and at least one additional component selected from the group consisting of surfactants, solid diluents and liquid diluents.

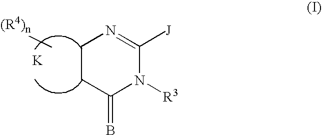

### BACKGROUND OF THE INVENTION

This invention relates to certain quinazolinones and pyridinylpyrimidinones, their N-oxides, agriculturally suitable salts and compositions, and a method of use for controlling invertebrate pests in both agronomic and nonagronomic environments.

The control of invertebrate pests is extremely important in achieving high crop efficiency. Damage by invertebrate pests to growing and stored agronomic crops can cause significant reduction in productivity and thereby result in increased costs to the consumer. The control of invertebrate pests in forestry, greenhouse crops, ornamentals, nursery crops, stored food and fiber products, livestock, household, and public and animal health is also important. Many products are commercially available for these purposes, but the need continues for new compounds that are more effective, less costly, less toxic, environmentally safer or have different modes of action.

WO 99/14202 discloses pyrimidin-4-one and pyrimidin-4-thiones of Formula i as fungicides

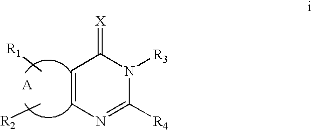

wherein, inter alia,

X is O or S;

A is fused phenyl or pyridyl;

R₁ and R₂ are selected from H, halogen or trimethylsilyl;

R₃ is C₁-C₈ alkyl, C₁-C₈ alkenyl or C₁-C₈ alkynyl, each optionally substituted; and

R₄ is optionally substituted phenyl.

### SUMMARY OF THE INVENTION

This invention pertains to a method for controlling an invertebrate pest comprising contacting the invertebrate pest or its environment with a biologically effective amount of a compound of Formula I, its N-oxide or an agriculturally suitable salt of the compound (e.g., as a composition described herein)

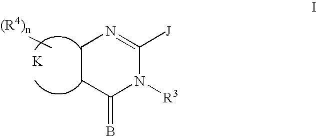

wherein

B is O or S;

J is a phenyl ring substituted with 1 to 4 R⁵, or a naphthyl ring system, a 5- or 6-membered heteroaromatic ring or an aromatic 8-, 9- or 10-membered fused heterobicyclic ring system wherein each ring or ring system is optionally substituted with 1 to 4 R⁵;

K is, together with the two contiguous linking carbon atoms, a fused phenyl or a fused pyridinyl ring selected from the group consisting of K-1, K-2, K-3, K-4 and K-5, each optionally substituted with 1 to 4 R⁴

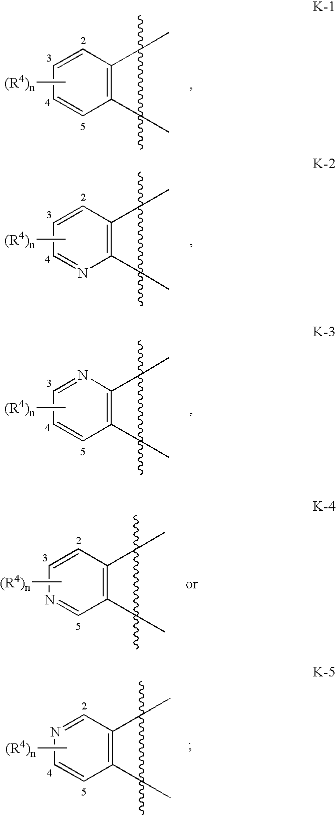

R³ is G; C₁-C₆ alkyl, C₂-C₆ alkenyl, C₂-C₆ alkynyl, C₃-C₆ cycloalkyl, each optionally substituted with one or more substituents selected from the group consisting of halogen, G, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₂-C₆ alkoxycarbonyl, C₂-C₆ alkylcarbonyl, C₃-C₆ trialkylsilyl, or a phenoxy ring optionally substituted with one to three substituents independently selected from R⁶; hydroxy; C₁-C₄ alkoxy; C₁-C₄ alkylamino; C₂-C₈ dialkylamino; C₃-C₆ cycloalkylamino; C₂-C₆ alkoxycarbonyl or C₂-C₆ alkylcarbonyl; G is a phenyl ring or 5- or 6-membered heteroaromatic ring, each ring optionally substituted with one to three substituents independently selected from R⁶; a 5- or 6-membered nonaromatic carbocyclic or heterocyclic ring, optionally including one or two ring members selected from the group consisting of C(═O), SO or S(O)₂ and optionally substituted with 1 to 4 substituents selected from R¹²;

each R⁴ is independently H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₁-C₄ alkoxyalkyl, C₁-C₄ hydroxyalkyl, C(O)R¹⁰, CO₂R¹⁰, C(O)NR¹⁰R¹¹, NR¹⁰R¹, N(R¹¹)COR¹⁰, N(R¹¹)CO₂R¹⁰ or C₃-C₆ trialkylsilyl; or

each R⁴ is independently a phenyl, benzyl, phenoxy or a 5- or 6-membered heteroaromatic ring, each ring optionally substituted with one to three substituents independently selected from R⁶;

each R⁵ is independently H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl, C₃-C₆ trialkylsilyl; or

each R⁵ is independently a phenyl, benzyl, benzoyl, phenoxy, 5- or 6-membered heteroaromatic ring or an aromatic 8-, 9- or 10-membered fused heterobicyclic ring system, each ring optionally substituted with one to three substituents independently selected from R⁶; or

(R⁵)₂ when attached to adjacent carbon atoms can be taken together as —OCF₂O—, —CF₂CF₂O—, or —OCF₂CF₂O—;

each R⁶ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl;

R¹⁰ is H or C₁-C₄ alkyl or C₁-C₄ haloalkyl;

R¹¹ is H or C₁-C₄ alkyl;

each R¹² is independently C₁-C₂ alkyl, halogen, CN, NO₂ and C₁-C₂ alkoxy; and n is 1 to 4.

This invention also relates to such a method wherein the invertebrate pest or its environment is contacted with a biologically effective amount of a compound of Formula I or a composition comprising a compound of Formula I and a biologically effective amount of at least one additional compound or agent for controlling invertebrate pests.

This invention also pertains to a compound of Formula Ia, its i-oxide or an agriculturally suitable salt of the compound

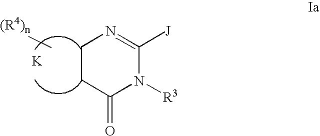

wherein

K is, together with the two contiguous linking carbon atoms, a fused phenyl or a fused pyridinyl ring selected from the group consisting of K-1, K-2, K-3, K-4 and K-5, each optionally substituted with 1 to 4 R⁴

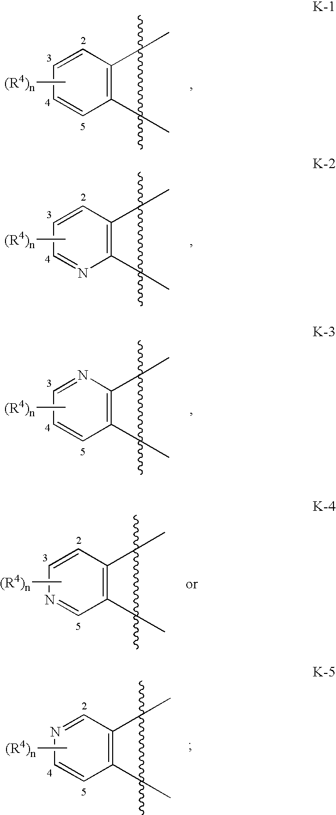

J substituted with 1 to 3 R⁵ is selected from the group consisting of J-6, J-7, J-8, J-9, J-10, J-11, J-12 and J-13

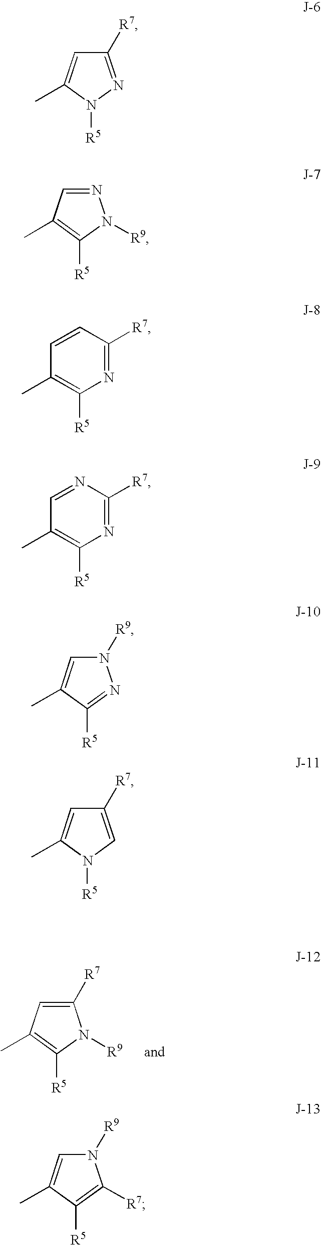

R³ is C₁-C₆ alkyl, C₂-C₆ alkenyl, C₂-C₆ alkynyl or C₃-C₆ cycloalkyl each optionally substituted with one or more substituents selected from the group consisting of halogen, CN, C₁-C₂ alkoxy, C₁-C₂ alkylthio, C₁-C₂ alkylsulfinyl and C₁-C₂ alkylsulfonyl;

one R⁴ group is attached to the K-ring at the 2-position or 5-position, and said R⁴ is C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, or C₁-C₄ haloalkylsulfonyl; and

an optional second R⁴ is H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₁-C₄ alkoxyalkyl, C₁-C₄ hydroxyalkyl, C(O)R¹⁰,CO₂R¹⁰,C(O)NR¹⁰R¹¹, NR¹⁰R¹¹, N(R¹¹)COR¹⁰, N(R¹¹)CO₂R¹⁰ or C₃-C₆ trialkylsilyl;

R⁵ is

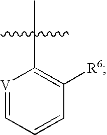

V is N, CH, CF, CCl, CBr or CI;

each R⁶ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl;

each R⁷ is independently H, C₁-C₆ alkyl, C₁-C₆ haloalkyl, halogen, CN, C₁-C₄ alkoxy, C₁-C₄ haloalkoxy or C₁-C₄ haloalkylthio;

R⁹ is H, C₂-C₆ alkyl, C₁-C₆ haloalkyl, C₃-C₆ alkenyl, C₃-C₆ haloalkenyl, C₃-C₆ alkynyl or C₃-C₆ haloalkynyl, provided that R⁷ and R⁹ are not both H;

R¹⁰ is H or C₁-C₄ alkyl or C₁-C₄ haloalkyl;

R¹¹ is H or C₁-C₄ alkyl; and

n is 0, 1 or 2.

This invention also pertains to a composition for controlling an invertebrate pest comprising a biologically effective amount of a compound of Formula Ia and at least one additional component selected from the group consisting of surfactants, solid diluents and liquid diluents. This invention also pertains to a composition comprising a biologically effective amount of a compound of Formula Ia and an effective amount of at least one additional biologically active compound or agent.

### DETAILS OF THE INVENTION

In the above recitations, the term “alkyl”, used either alone or in compound words such as “alkylthio” or “haloalkyl” includes straight-chain or branched alkyl, such as methyl, ethyl, in-propyl, i-propyl, or the different butyl, pentyl or hexyl isomers. “Alkenyl” includes straight-chain or branched alkenes such as 1-propenyl, 2-propenyl, and the different butenyl, pentenyl and hexenyl isomers. “Alkenyl” can also include polyenes such as 1,2-propadienyl and 2,4-hexadienyl. “Alkynyl” includes straight-chain or branched alkynes such as 1-propynyl, 2-propynyl and the different butynyl, pentynyl and hexynyl isomers. “Alkynyl” can also include moieties comprised of multiple triple bonds such as 2,5-hexadiynyl. “Alkoxy” includes, for example, methoxy, ethoxy, ii-propyloxy, isopropyloxy and the different butoxy, pentoxy and hexyloxy isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkylthio” includes branched or straight-chain alkylthio moieties such as methylthio, ethylthio, and the different propylthio, butylthio, pentylthio and hexylthio isomers. “Cycloalkyl” includes, for example, cyclopropyl, cyclobutyl, cyclopentyl and cyclohexyl.

The term “heteroaromatic ring” denotes fully aromatic rings in which at least one ring atom is not carbon and can contain 1 to 4 heteroatoms independently selected from the group consisting of nitrogen, oxygen and sulfur, provided that each heteroaromatic ring contains no more than 4 nitrogens, no more than 2 oxygens and no more than 2 sulfurs (where aromatic indicates that the Hückel rule is satisfied). The heteroaromatic ring can be attached through any available carbon or nitrogen by replacement of hydrogen on said carbon or nitrogen.

The term “halogen”, either alone or in compound words such as “haloalkyl”, includes fluorine, chlorine, bromine or iodine. Further, when used in compound words such as “haloalkyl”, said alkyl may be partially or fully substituted with halogen atoms which may be the same or different. Examples of “haloalkyl” include F₃C, ClCH₂, CF₃CH₂ and CF₃CCl₂. The terms “haloalkenyl”, “haloalkynyl”, “haloalkoxy”, and the like, are defined analogously to the term “haloalkyl”. Examples of “haloalkenyl” include (Cl)₂C═CHCH₂ and CF₃CH₂CH═CHCH₂. Examples of “haloalkynyl” include HC≡CCHCl, CF₃C≡C, CCl₃C≡C and FCH₂C≡CCH₂. Examples of “haloalkoxy” include CF₃O, CCl₃CH₂O, HCF₂CH₂CH₂O and CF₃CH₂O.

The total number of carbon atoms in a substituent group is indicated by the “Cᵢ-Cⱼ” prefix where i and j are numbers from 1 to 6. For example, C₁-C₃ alkylsulfonyl designates methylsulfonyl through propylsulfonyl; C₂ alkoxyalkyl designates CH₃OCH₂; C₃ alkoxyalkyl designates, for example, CH₃CH(OCH₃), CH₃OCH₂CH₂ or CH₃CH₂OCH₂; and C₄ alkoxyalkyl designates the various isomers of an alkyl group substituted with an alkoxy group containing a total of four carbon atoms, examples including CH₃CH₂CH₂OCH₂ and CH₃CH₂OCH₂CH₂. In the above recitations, when a compound of Formula 1 contains a heteroaromatic ring, all substituents are attached to this ring through any available carbon or nitrogen by replacement of a hydrogen on said carbon or nitrogen.

When a group contains a substituent which can be hydrogen, for example R³, then, when this substituent is taken as hydrogen, it is recognized that this is equivalent to said group being unsubstituted.

Compounds of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. Accordingly, the compounds of the invention may be present as a mixture of stereoisomers, individual stereoisomers, or as an optically active form.

The present invention comprises compounds selected from Formula I, N-oxides and agriculturally suitable salts thereof, compositions thereof and methods of their use for invertebrate pest control. One skilled in the art will appreciate that not all nitrogen containing heterocycles can form N-oxides since the nitrogen requires an available lone pair for oxidation to the oxide; one skilled in the art will recognize those nitrogen containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethydioxirane. These methods for the preparation of N-oxides have been extensively described and reviewed in the literature, see for example: T. L. Gilchrist in Comprehensive Organic Syntheses, vol. 7, pp 748-750, S. V. Ley, Ed., Pergamon Press; M. Tisler and B. Stanovnik in Comprehensive Heterocyclic Chemistry, vol. 3, pp 18S-19, A. J. Boulton and A. McKillop, Eds., Pergamon Press; M. R. Grimmett and B. R. T. Keene in Advances in Heteyocyclic Chemistry, vol. 43, pp 139-151, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

The salts of the compounds of the invention include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids.

Preferred methods for reasons of better activity, cost and/or ease of synthesis are:

Preferred 1. Methods wherein for the compounds of Formula I B is O and R³ is C₁-C₆ alkyl, C₂-C₆ alkenyl, C₂-C₆ alkynyl or C₃-C₆ cycloalkyl each optionally substituted with one or more substituents selected from the group consisting of halogen, CN, C₁-C₂ alkoxy, C₁-C₂ alkylthio, C₁-C₂ alkylsulfinyl and C₁-C₂ alkylsulfonyl.

Preferred 2. Methods of Preferred 1 wherein J is a phenyl group substituted with 1 to 4R⁵.

Preferred 3. Methods of Preferred 2 wherein

n is 1 to 2;

one R⁴ group is attached to the K-ring at the 2-position or 5-position, and said R⁴ is C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl or C₁-C₄ haloalkylsulfonyl; and

each R⁵ is independently H, halogen, C₁-C₄ alkyl, C₁-C₂ alkoxy, C₁-C₄ haloalkyl, CN, NO₂, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl or C₂-C₄ alkoxycarbonyl; or

each R⁵ is independently a phenyl or a 5- or 6-membered heteroaromatic ring, each ring optionally substituted with R⁶; or

(R⁵)₂ when attached to adjacent carbon atoms can be taken together as —OCF₂O—, —CF₂CF₂O— or —OCF₂CF₂O—.

Preferred 4. Methods of Preferred 3 wherein

R³ is C₁-C₄ alkyl optionally substituted with halogen, CN, OCH₃ or S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

each R⁵ is independently H, halogen, methyl, CF₃, OCF₃, OCHF₂, S(O)ₚCF₃, S(O)ₚCHF₂, OCH₂CF₃, OCF₂CHF₂, S(O)ₚCH₂CF₃ or S(O)ₚCF₂CHF₂; or a phenyl, pyrazole, imidazole, triazole, pyridine or pyrimidine ring, each ring optionally substituted with C₁-C₄ alkyl, C₁-C₄ haloalkyl, halogen or CN; and p2 is 0, 1 or2.

Preferred 5. Methods of Preferred 4 wherein R³ is i-propyl or t-butyl.

Preferred 6. Methods of Preferred 1 wherein J is a 5- or 6-membered heteroaromatic ring optionally substituted with 1 to 4 R⁵.

Preferred 7. Methods of Preferred 6 wherein

J is a 5- or 6-membered heteroaromatic ring selected from the group consisting of J-1, J-2, J-3, J-4 and J-5, each J optionally substituted with 1 to 3 R⁵

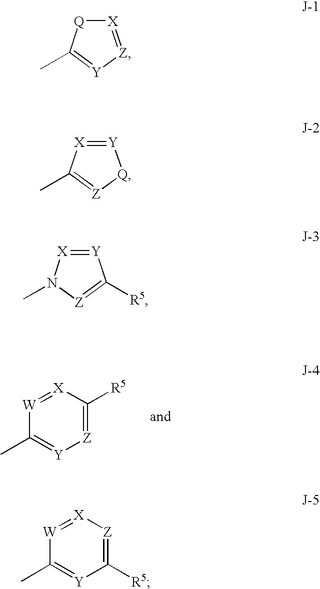

Q is O, S or NR⁵; and

W, X, Y and Z are independently N or CR⁵, provided that in J-4 and J-5 at least one of W, X, Y or Z is N.

Preferred 8. Methods of Preferred 7 wherein

n is 1 to 2;

one R⁴ group is attached to the K-ring at the 2-position or 5-position, and said R⁴ is C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, or C₁-C₄ haloalkylsulfonyl; and

each R⁵ is independently H, C₁-C₄ alkyl, C₁-C₄ haloalkyl, halogen, CN, NO₂, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl or C₂-C₄ alkoxycarbonyl; or a phenyl or a 5- or 6-membered heteroaromatic ring, each ring optionally substituted with R⁶.

Preferred 9. Methods of Preferred 8 wherein

J substituted with 1 to 3 R⁵ is selected from the group consisting of J-6, J-7, J-8, J-9, J-10, J-11, J-12 and J-13

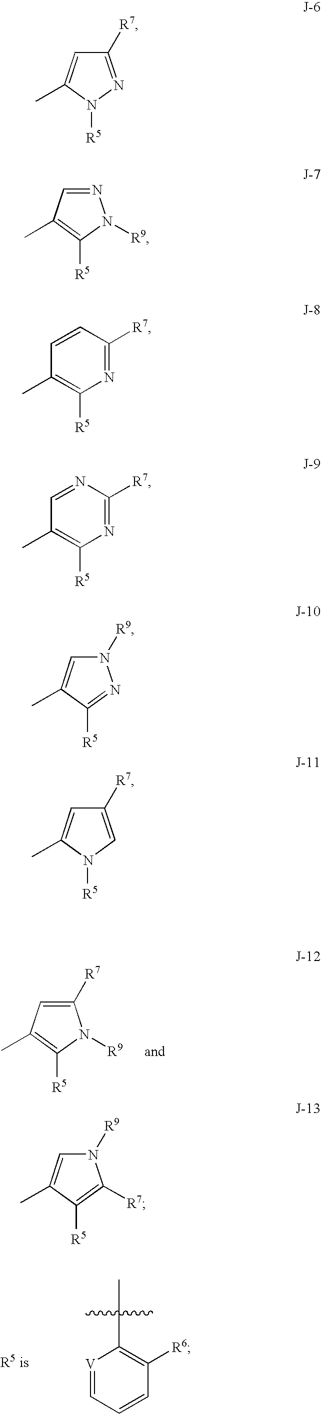

V is N, CH, CF, CCl, CBr or CI;

each R⁷ is independently H, C₁-C₆ alkyl, C₁-C₆ haloalkyl, halogen, CN, C₁-C₄ alkoxy, C₁-C₄ haloalkoxy or C₁-C₄ haloalkylthio;

R⁹ is H, C₂-C₆ alkyl, C₁-C₆ haloalkyl, C₃-C₆ alkenyl, C₃-C₆ haloalkenyl, C₃-C₆ alkynyl or C₃-C₆ haloalkynyl, provided that R⁷ and R⁹ are not both H; and

n is 0, 1 or 2.

Preferred 10. Methods of Preferred 9 wherein

J substituted with 1 to 3 R⁵ is J-6;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁷ is CH₃, CF₃, OCHF₂ or halogen; and

p is 0, 1 or 2.

Preferred 11. Methods of Preferred 10 wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁷ is halogen or CF₃.

Preferred 12. Methods of Preferred 9 wherein

J substituted with 1 to 3 R⁵ is J-7;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁹ is C₂-C₆ alkyl or C₁-C₆ haloalkyl; and

p is 0, 1 or 2.

Preferred 13. Methods of Preferred 12 wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁹ is CF₃, CHF₂, CBrF₂, CClF₂, CH₂CF₃, or CF₂CHF₂.

Preferred 14. Methods of Preferred 9 wherein

J substituted with 1 to 3 R⁵ is J-8;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN R⁶ is CH₃, CF₃ or halogen;

R⁷ is CH₃, CF₃ or halogen; and

p is 0, 1 or 2.

Preferred 15. Methods of Preferred 14 wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁷ is halogen or CF₃.

Preferred 16. Methods of Preferred 9 wherein

J substituted with 1 to 3 R⁵ is J-9;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁷ is CH₃, CF₃ or halogen; and

p is 0, 1 or 2.

Preferred 17. Methods of Preferred 18 wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁷ is CF₃.

Preferred 18. Methods of Preferred 9 wherein

J substituted with 1 to 3 R⁵ is J-10;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁹ is C₂-C₆ alkyl or C₁-C₆ haloalkyl; and

p is 0, 1 or 2.

Preferred 19. Methods of Preferred 18 wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁹ is CF₃, CHF₂, CBrF₂, CClF₂, CH₂CF₃, or CF₂CHF₂.

Preferred 20. Methods of Preferred 9 wherein

J substituted with 1 to 3 R⁵ is J-11;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁷ is CH₃, CF₃, OCHF₂ or halogen; and

p is 0, 1 or 2.

Preferred 21. Methods of Preferred 20 wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁷ is halogen or CF₃.

Preferred 22. Methods of Preferred 9 wherein

J substituted with 1 to 3 R⁵ is J-12;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁹ is C₂-C₆ alkyl or C₁-C₆ haloalkyl; and

p is 0, 1 or 2.

Preferred 23. Methods of Preferred 22 wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁹ is CF₃, CHF₂, CBrF₂, CClF₂, CH₂CF₃, or CF₂CHF₂.

Preferred 24. Methods of Preferred 9 wherein

J substituted with 1 to 3 R⁵ is J-13;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁹ is C₂-C₆ alkyl or C₁-C₆ haloalkyl; and

p is 0, 1 or 2.

Preferred 25. Methods of Preferred 24 wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁹ is CF₃, CHF₂, CBrF₂, CClF₂, CH₂CF₃, or CF₂CHF₂.

Most preferred is the method wherein the compound of Formula I is selected from the group consisting of:

8-methyl-3-(1-methylethyl)-2-[2-methyl-6-(trifluoromethyl)-3-pyridinyl]-4(3H)quinazolinone,

2-[3-bromo-1-(3-chloro-2-pyridinyl)-1H-pyrazol-5-yl]-6-chloro-3,8-dimethyl-4(3H)-quinazoline,

2-[3-bromo-1-(3-chloro-2-pyridinyl)-1H-pyrazol-5-yl]-6-chloro-3-ethyl-8-methyl-4(3H)-quinazoline,

2-[3-bromo-1-(3-chloro-2-pyridinyl)-1-H-pyrazol-5-yl]-6-chloro-8-methyl-3-(1-methylethyl)-4(3H)-quinazoline,

2-[3-bromo-1-(3-chloro-2-pyridinyl)-1H-pyrazol-5-yl]-6-chloro-3-(1,1-dimethylethyl)-8-methyl-4(3H)-quinazoline,

6-chloro-2-[3-chloro-1-(3-chloro-2-pyridinyl)-1H-pyrazol-5-yl]-3,8-dimethyl-4(3H)-quinazoline,

6-chloro-2-[3-chloro-1-(3-chloro-2-pyridinyl)-1H-pyrazol-5-yl]-3-ethyl-8-methyl-4(3H)-quinazoline,

6-chloro-2-[3-chloro-1-(3-chloro-2-pyridinyl)-1H-pyrazol-5-yl]-8-methyl-3-(1-methylethyl)-4(3H)-quinazoline,

6-chloro-2-[3-chloro-1-(3-chloro-2-pyridinyl)-1H-pyrazol-5-yl]-3-(1,1-dimethylethyl)-8-methyl-4(3H)-quinazoline,

6-chloro-2-[1-(3-chloro-2-pyridinyl)-3-(trifluoromethyl)-1H-pyrazol-5-yl]-3,8-dimethyl-4(3H)-quinazoline,

6-chloro-2-[1-(3-chloro-2-pyridinyl)-3-(trifluoromethyl)-1H-pyrazol-5-yl]-3-ethyl-8-methyl-4(3H)-quinazoline,

6-chloro-2-[1-(3-chloro-2-pyridinyl)-3(trifluoromethyl)-1H-pyrazol-5-yl]-8-methyl-3-(1-methylethyl)-4(3H)-quinazoline,

6-chloro-2-[1-(3-chloro-2-pyridinyl)-3-(trifluoromethyl)-1H-pyrazol-5-yl]-3-(1,1-dimethylethyl)-8-methyl-4(3H)-quinazoline,

2-[3-bromo-1-(3-chloro-2-pyridinyl)-1H-pyrazol-5-yl]-8-methyl-3-(1-methylethyl)-4(3H)-quinazoline,

2-[3-bromo-1-(3-chloro-2-pyridinyl)-1H-pyrazol-5-yl]-3-(1,1-dimethylethyl)-8-methyl-4(3H)-quinazoline,

2-[1-(3-chloro-2-pyridinyl)-3-(trifluoromethyl)-1H-pyrazol-5-yl]-8-methyl-3-(1-methylethyl)-4(3H)-quinazoline,

2-[1-(3-chloro-2-pyridinyl)-3-(trifluoromethyl)-1H-pyrazol-5-yl]-3(1,1-dimethylethyl)-8-methyl-4(3H)-quinazoline,

6,8-dichloro-2-[1-(3-chloro-2-pyridinyl)-3-(trifluoromethyl)-1H-pyrazol-5-yl]-3-methyl-4(3H)-quinazoline,

6,8-dichloro-2-[1-(3-chloro-2-pyridinyl)-3-(trifluoromethyl)-1H-pyrazol-5-yl]-3-ethyl-4(3H)-quinazoline,

6,8-dichloro-2-[1-(3-chloro-2-pyridinyl)-3-(trifluoromethyl)-1H-pyrazol-5-yl]-3-(1-methylethyl)-4(3H)-quinazoline,

2-[3-bromo-1-(3-chloro-2-pyridinyl)-1H-pyrazol-5-yl]-6,8-dichloro-3-methyl4(3H)-quinazoline,

2-[3-bromo-1-(3-chloro-2-pyridinyl)-1H-pyrazol-5-yl]-6,8-dichloro-3-ethyl-4(3H)-quinazoline,

2-[3-bromo-1-(3-chloro-2-pyridinyl)-1H-pyrazol-5-yl]-6,8-dichloro-3(1-methylethyl)-4(3H)-quinazoline,

6,8-dichloro-2-[3-chloro-1-(3-chloro-2-pyridinyl)-1H-pyrazol-5-yl]-3-methyl-4(3H)-quinazoline,

6,8-dichloro-2-[3-chloro-1-(3-chloro-2-pyridinyl)-1H-pyrazol-5-yl]-3-ethyl-4(3H)-quinazoline, and

6,8-dichloro-2-[3-chloro-1-(3-chloro-2-pyridinyl)-1H-pyrazol-5-yl]-3-(1-methylethyl)-4(3H)-quinazoline.

Preferred compounds for reasons of better activity, cost and/or ease of synthesis are:

Preferred A. Compounds of Formula Ia wherein

J substituted with 1 to 3 R⁵ is J-6;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁷ is CH₃, CF₃, OCHF₂ or halogen; and

p is 0, 1 or 2.

Preferred B. Compounds of Preferred A wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁷ is halogen or CF₃.

Preferred C. Compounds of Formula Ia wherein

J substituted with 1 to 3 R⁵ is J-7;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁹ is C₂-C₆ alkyl or C₁-C₆ haloalkyl; and

p is 0, 1 or 2.

Preferred D. Compounds of Preferred C wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁹ is CF₃, CHF₂, CBrF₂, CClF₂, CH₂CF₃, or CF₂CHF₂.

Preferred E. Compounds of Formula Ia wherein

J substituted with 1 to 3 R⁵ is J-8;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCH₂, CN or halogen;

a second R⁴ is H, F, Cl, Br, I or CF₃;

R⁶ is C₁-C₄ alkyl, C₁-C₄ haloalkyl, halogen or CN R⁶ is CH₃, CF₃ or halogen;

R⁷ is CH₃, CF₃ or halogen; and

p is 0, 1 or 2.

Preferred F. Methods of Preferred E wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁷ is halogen or CF₃.

Preferred G. Compounds of Formula Ia wherein

J substituted with 1 to 3 R⁵ is J-9;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F. Cl, Br, I or CF₃;

R⁶ is C₁-C₄ alkyl, C₁-C₄ haloalkyl, halogen or CN;

R⁷ is CH₃, CF₃ or halogen; and

p is 0, 1 or 2.

Preferred H. Compounds of Preferred G wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁷ is CF₃.

Preferred I. Compounds of Formula Ia wherein

J substituted with 1 to 3 R⁵ is J-10;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁹ is C₂-C₆ alkyl or C₁-C₆ haloalkyl; and

p is 0, 1 or 2.

Preferred J. Compounds of Preferred I wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁹ is CF₃, CHF₂, CBrF₂, CClF₂, CH₂CF₃, or CF₂CHF₂.

Preferred K. Compounds of Formula Ia wherein

J substituted with 1 to 3 R⁵ is J-11;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁷ is CH₃, CF₃, OCHF₂ or halogen; and

p is 0, 1 or 2.

Preferred L. Compounds of Preferred K wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁷ is halogen or CF₃.

Preferred M. Compounds of Formnula Ia wherein

J substituted with 1 to 3 R⁵ is J-12;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁹ is C₂-C₆ alkyl or C₁-C₆ haloalkyl; and

p is 0, 1 or 2.

Preferred N. Methods of Preferred M wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁹ is CF₃, CHF₂, CBrF₂, CClF₂, CH₂CF₃, or CF₂CHF₂.

Preferred O. Compounds of Formula Ia wherein

J substituted with 1 to 3 R⁵ is J-13;

R³ is C₁-C₄ alkyl optionally substituted with halogen, CN, OCH₃, S(O)ₚCH₃;

one R⁴ group is attached to the K-ring at the 2-position and said R⁴ is CH₃, CF₃, OCF₃, OCHF₂, S(O)ₚCF₃, S(O)ₚCHF₂, CN or halogen;

a second R⁴ is H, F, Cl, Br, I or CF₃;

R⁶ is C₁-C₄ alkyl, C₁-C₄ haloalkyl, halogen or CN;

R⁹ is C₂-C₆ alkyl or C₁-C₆ haloalkyl; and

p is 0, 1 or 2.

Preferred P. Methods of Preferred O wherein

R³ is C₁-C₄ alkyl;

one R⁴ group is attached to the K-ring at the 2-position and said R⁴ is CH₃, Cl or Br;

a second R⁴ is H, F, Cl, Br, I or CF₃;

R⁶ is Cl or Br; and

R⁹ is CF₃, CHF₂, CBrF₂, CClF₂, CH₂CF₃, or CF₂CHF₂.

Most preferred is the compound of Formula I selected from the group consisting of:

8-methyl-3-(1-methylethyl)-2-[2-methyl-6-(trifluoromethyl)-3-pyridinyl]-4(3H)-quinazolinone,

2-[3-bromo-1-(3-chloro-2-pyridinyl)-1H-pyrazol-5-yl]-6-chloro-3,8-dimethyl-4(3H)-quinazoline,

2-[3-bromo-1-(3-chloro-2-pyridinyl)-1H-pyrazol-5-yl]-6-chloro-3-ethyl-8-methyl-4(3H)-quinazoline,

2-[3-bromo-1-(3-chloro-2-pyridinyl)-1H-pyrazol-5-yl]-6-chloro-8-methyl-3-(1-methylethyl)-4(3H)-quinazoline,

2-[3-bromo-1-(3-chloro-2-pyridinyl)-1H-pyrazol-5-yl]-6-chloro-3-(1,1-dimethylethyl)-8-methyl-4(3H)-quinazoline,

6-chloro-2-[3-chloro-1-(3-chloro-2-pyridinyl)-1H-pyrazol-5-yl]-3,8-dimethyl-4(3H)-quinazoline,

6-chloro-2-[3-chloro-1-(3-chloro-2-pyridinyl)-1H-pyrazol-5-yl]-3-ethyl-8-methyl-4(3H)-quinazoline,

6-chloro-2-[3-chloro-1-(3-chloro-2-pyridinyl)-1H-pyrazol-5-yl]-8-methyl-3-(1-methylethyl)-4(3H)-quinazoline,

6-chloro-2-[3-chloro-1-(3-chloro-2-pyridinyl)-1H-pyrazol-5-yl]-3-(1,1-dimethylethyl)-8-methyl-4(3H)-quinazoline,

6-chloro-2-[1-(3-chloro-2-pyridinyl)-3-(trifluoromethyl)-1H-pyrazol-5-yl]-3,8dimethyl-4(3H)-quinazoline,

6-chloro-2-[1-(3-chloro-2-pyridinyl)-3-(trifluoromethyl)-1H-pyrazol-5-yl]-3-ethyl-8-methyl-4(3H)-quinazoline,

6-chloro-2-[1-(3-chloro-2-pyridinyl)-3-(trifluoromethyl)-1H-pyrazol-5-yl]-8-methyl-3-(1-methylethyl)-4(3H)-quinazoline

6-chloro-2-[1-(3-chloro-2-pyridinyl)-3-(trifluoromethyl)-1H-pyrazol-5-yl]-3-(1,1-dimethylethyl)-8-methyl-4(3H)-quinazoline,

2-[3-bromo-1-(3-chloro-2-pyridinyl)-1H-pyrazol-5-yl]-S-methyl-3-(1-methylethyl)-4(3H)-quinazoline,

2-[3-bromo-1-(3-chloro-2-pyridinyl)-1H-pyrazol-5-yl]-3-(1,1-dimethylethyl)-8-methyl-4(3H)-quinazoline,

2-[1-(3-chloro-2-pyridinyl)-3-(trifluoromethyl)-1H-pyrazol-5-yl]-8-methyl-3(1-methylethyl)-4(3H)-quinazoline,

2-[1-(3-chloro-2-pyridinyl)-3-(trifluoromethyl)-1H-pyrazol-5-yl]-3(1,1-dimethylethyl)-8-methyl-4(3H)-quinazoline,

6,8-dichloro-2-[1-(3-chloro-2-pyridinyl)-3-(trifluoromethyl)-1H-pyrazol-5-yl]-3-methyl-4(3H)-quinazoline,

6,8-dichloro-2-[1-(3-chloro-2-pyridinyl)-3-(trifluoromethyl)-1H-pyrazol-5-yl]-3-ethyl-4(3H)-quinazoline,

6,8-dichloro-2-[1-(3-chloro-2-pyridinyl)-3-(trifluoromethyl)-1H-pyrazol-5-yl]-3-(1-methylethyl)-4(3H)-quinazoline,

2-[3-bromo-1-(3-chloro-2-pyridinyl)-1H-pyrazol-5-yl]-6,8-dichloro-3-methyl-4(3H)-quinazoline,

2-[3-bromo-1-(3-chloro-2-pyridinyl)-1H-pyrazol-5-yl]-6,8-dichloro-3-ethyl-4(3H)-quinazoline,

2-[3-bromo-1-(3-chloro-2-pyridinyl)-1H-pyrazol-5-yl]-6,8-dichloro-3-(1-methylethyl)-4(3H)-quinazoline,

6,8-dichloro-2-[3-chloro-1-(3-chloro-2-pyridinyl)-1H-pyrazol-5-yl]-3-methyl-4(3H)-quinazoline,

6,8-dichloro-2-[3-chloro-1-(3-chloro-2-pyridinyl)-1H-pyrazol-5-yl]-3-ethyl-4(3H)-quinazoline, and

6,8-dichloro-2-[3-chloro-1-(3-chloro-2-pyridinyl)-1H-pyrazol-5-yl]-3-(1-methylethyl)-4(3H)-quinazoline.

This invention also pertains to a composition for controlling an invertebrate pest comprising a biologically effective amount of a compound of Formula Ia and at least one additional component selected from the group consisting of surfactants, solid diluents and liquid diluents. Preferred compositions are those comprising the above preferred compounds.

Of note is a method for controlling arthropods comprising contacting the arthropods or their environment with an arthropodicidally effective amount of a compound of Formula 1, its N-oxides or agriculturally suitable salts thereof

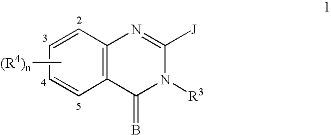

wherein

B is O or S;

J is a phenyl group substituted with 1 to 2 R⁵ and optionally substituted with 1 to 3 R⁶, or a 5- or 6-membered heteroaromatic ring optionally substituted with 1 to 4 R⁷;

n is 1 to 4;

R³ is C₁-C₆ alkyl, C₂-C₆ alkenyl, C₂-C₆ alkynyl, C₃-C₆ cycloalkyl, each optionally substituted with one or more substituents selected from the group consisting of halogen, CN, NO₂, hydroxy, C₁-C₄ alkoxy, C₁-C₄ alkylthio, C₁-C₄ alkylsulfinyl and C₁-C₄ alkylsulfonyl; C₁-C₄ alkoxy; C₁-C₄ alkylamino; C₂-C₈ dialkylamino; C₃-C₆ cycloalkylamino; C₂-C₆ alkoxycarbonyl or C₂-C₆ alkylcarbonyl; each R⁴ is independently H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl, C₃-C₆ trialkylsilyl; or

each R⁴ is independently phenyl, benzyl or phenoxy, each optionally substituted with C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl;

each R⁵ is independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl, C₃-C₆ trialkylsilyl; or

(R⁵)₂ when attached to adjacent carbon atoms can be taken together as —OCF₂O—, —CF₂CF₂O—, or —OCF₂CF₂O—;

each R⁶ is independently H, halogen, C₁-C₆ alkyl, C₂-C₆ alkenyl, C₂-C₆ alkynyl, C₃-C₆ cycloalkyl, C₁-C₄ alkoxy or C₂-C₄ alkoxy carbonyl; or

each R⁶ is independently a phenyl, benzyl, phenoxy or a 5- or 6-membered heteroaromatic ring, each ring optionally substituted with C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl;

each R⁷ is independently H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, Cₗ-C₄ haloalkylsulfonyl, C₁-C₄ alkoxycarbonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl, C₃-C₆ trialkylsilyl; or

each R⁷ is independently a phenyl, benzyl, benzoyl, phenoxy or a 5- or 6-membered heteroaromatic ring, each ring optionally substituted with C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl.

Of note are compounds of Formula 1 wherein

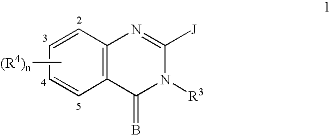

B is O;

J is a phenyl group substituted with 1 to 2 R⁵ and optionally substituted with 1 to 3 R⁶; or J is selected from the group consisting of pyridine, pyrimidine, pyrazole, thiophene and thiazole, each optionally substituted with 1 to 3 R⁷;

R³ is C₂-C₄ alkyl optionally substituted with halogen, CN, OCH₃, S(O)ₚCH₃;

each R⁴ is independently CH₃, CF₃, OCF₃, OCHF₂, S(O)ₚCF₃, S(O)ₚCHF₂ or halogen;

each R⁵ is independently CF₃, OCF₃, OCHF₂, S(O)ₚCF₃, S(O)ₚCHF₂, OCH₂CF₃, OCF₂CHF₂, S(O)ₚCH₂CF₃ or S(O)ₚCF₂CHF₂;

each R⁶ is independently halogen or methyl; or phenyl, pyrazole, imidazole, triazole, pyridine or pyrimidine, each ring optionally substituted with C₁-C₄ alkyl, C₁-C₄ haloalkyl, halogen or CN;

each R⁷ is independently H, halogen, CH₃, CF₃, OCHF₂, S(O)ₚCF₃, S(O)ₚCHF₂, OCH₂CF₃, OCF₂CHF₂, S(O)ₚCH₂CF₃, S(O)ₚCF₂CHF₂; or phenyl, pyrazole, imidazole, triazole, pyridine or pyrimidine, each ring optionally substituted with C₁-C₄ alkyl, C₁-C₄ haloalkyl, C₁-C₄ alkoxy, C₁-C₄ haloalkoxy, halogen, NO₂ or CN; and

p is 0, 1 or 2.

As noted above, J is a phenyl ring, a naphthyl ring system, a 5- or 6-membered heteroaromatic ring or an aromatic 8-, 9- or 10-membered fused heterobicyclic ring system wherein each ring or ring system is optionally substituted with 1 to 4 R⁵. The term “optionally substituted” in connection with these J groups refers to groups which are unsubstituted or have at least one non-hydrogen substituent that does not extinguish the biological activity possessed by the unsubstituted analog An example of phenyl optionally substituted with 1 to 4 R⁵ is the ring illustrated as U-1 in Exhibit 1, wherein Rv is R⁵ and r is an integer from 1 to 4. An example of a naphthyl group optionally substituted with 1 to 3 R⁵ is illustrated as U-85 in Exhibit 1, wherein R^{v} is R⁵ and r is an integer from 1 to 4. Examples of 5- or 6-membered heteroaromatic rings optionally substituted with 1 to 4 R⁵ include the rings U-2 through U-53 illustrated in Exhibit 1 wherein R^{v} is R⁵ and r is an integer from 1 to 4. Note that J-1 through J-5 below also denote 5- or 6-membered heteroaromatic rings. Note that U-2 through U-20 are examples of J-1, U-21 through U-35 and U-40 are examples of J-2, U-36 through U-39 are examples of J-3, U-41 through U-48 are examples of J-4 and U-49 through U-53 are examples of J-5. Examples of aromatic 8-, 9- or 10-membered fused heterobicyclic ring systems optionally substituted with 1 to 4 R⁵ include U-54 through U-84 illustrated in Exhibit 1 wherein R^{v} is R⁵ and r is an integer from 1 to 4.

Although R^{v} groups are shown in the structures U-1 through U-85, it is noted that they do not need to be present since they are optional substituents. Note that when R^{v} is H when attached to an atom, this is the same as if said atom is unsubstituted. The nitrogen atoms that require substitution to fill their valence are substituted with H or R^{v}. Note that some U groups can only be substituted with less than 4 R^{v} groups (e.g. U-14, U-15, U-18 through U-21 and U-32 through U-34 can only be substituted with one R^{v}). Note that when the attachment point between (R^{v})ᵣ and the U group is illustrated as floating, (R^{v})ᵣ can be attached to any available carbon atom of the U group. Note that when the attachment point on the U group is illustrated as floating, the U group can be attached to the remainder of Formula I through any available carbon of the U group by replacement of a hydrogen atom.

### Exhibit 1

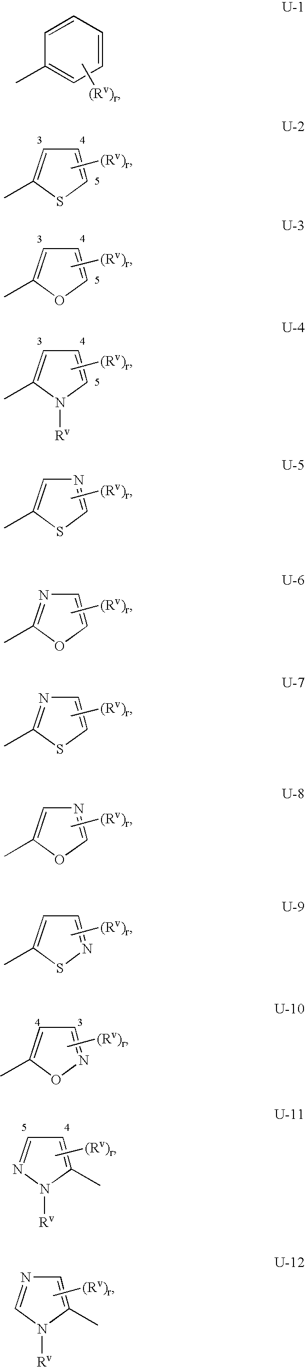

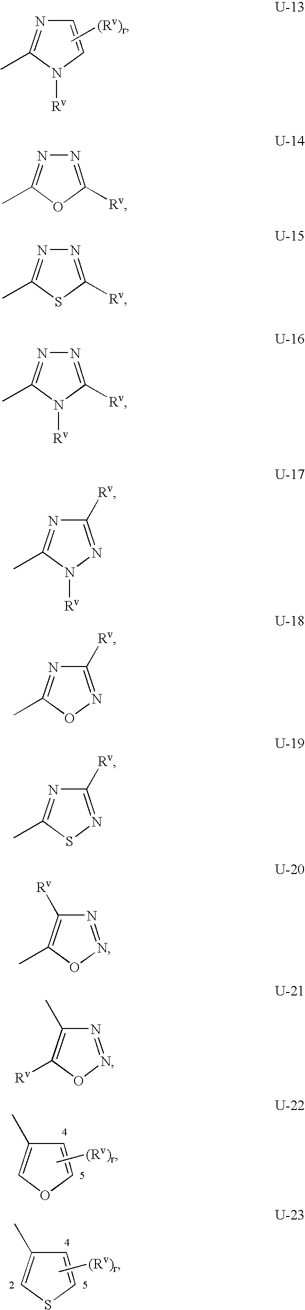

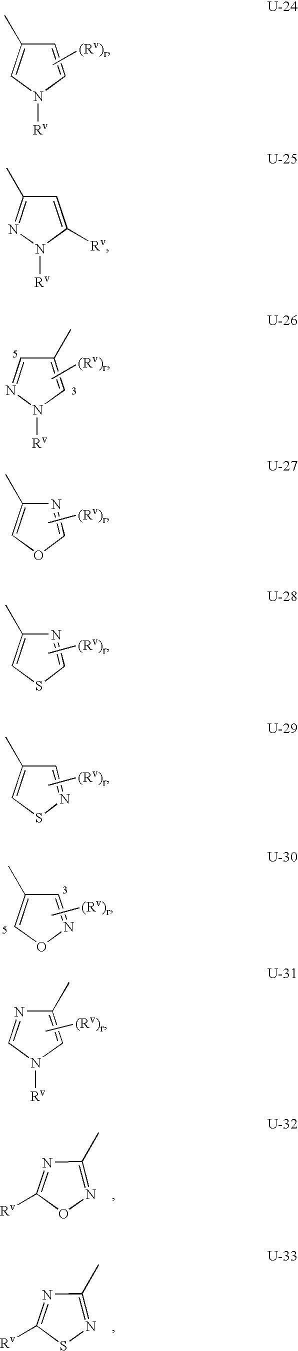

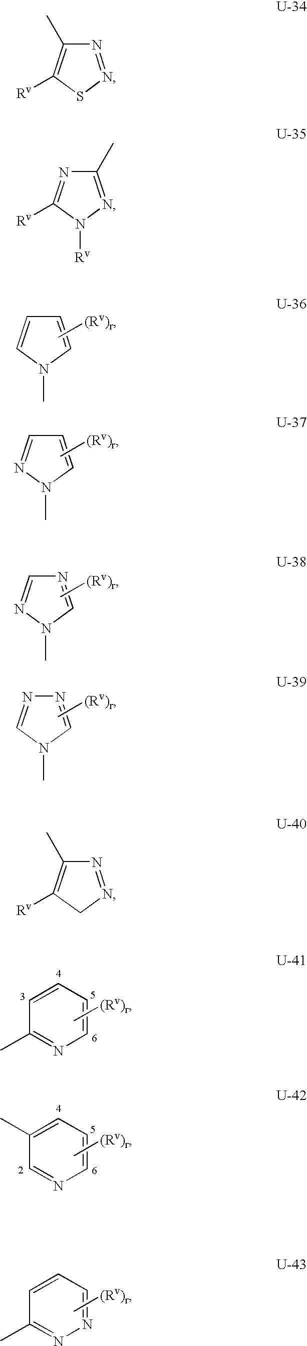

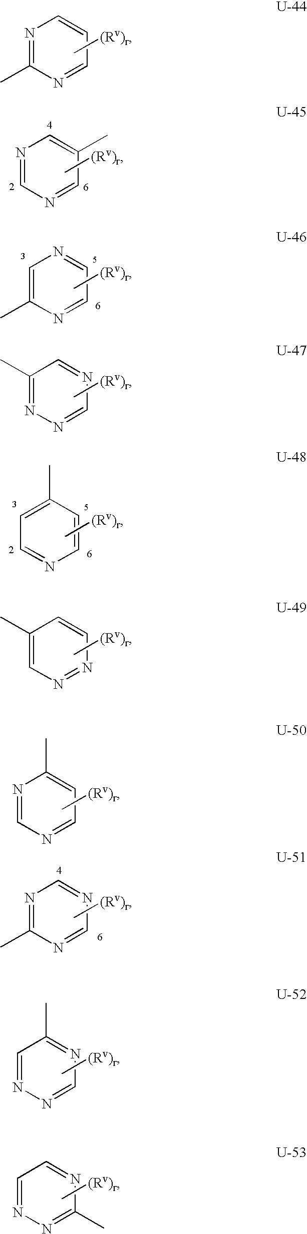

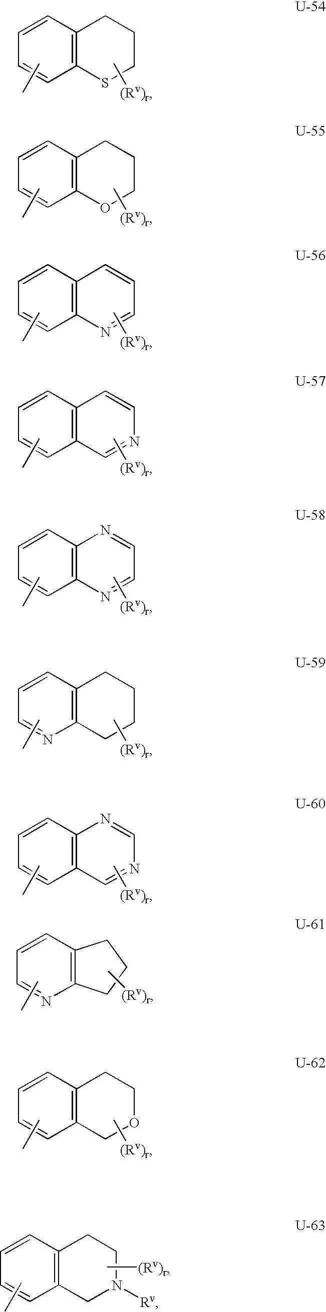

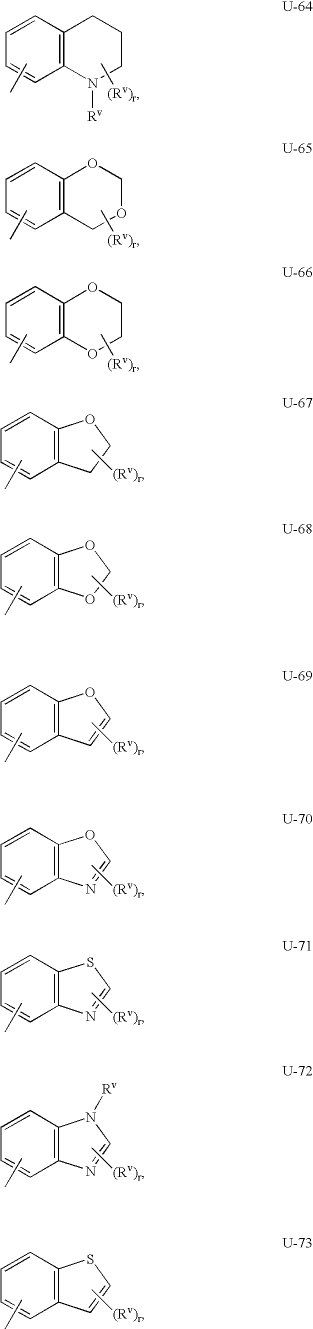

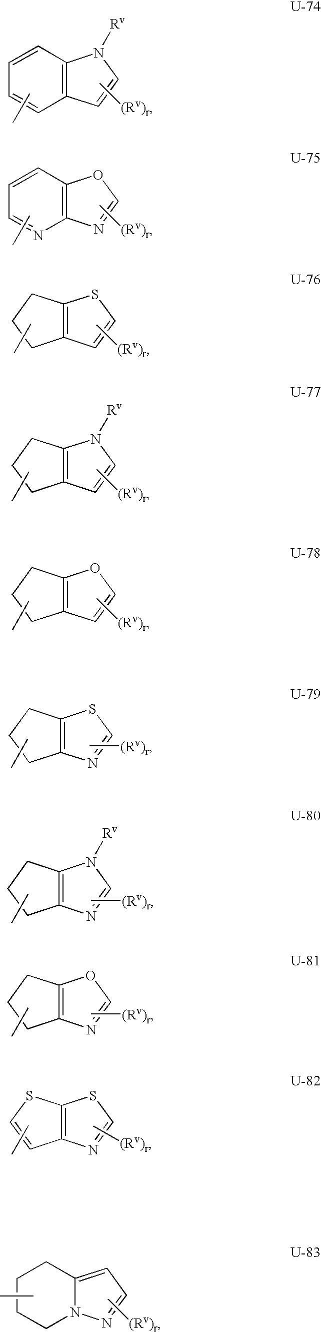

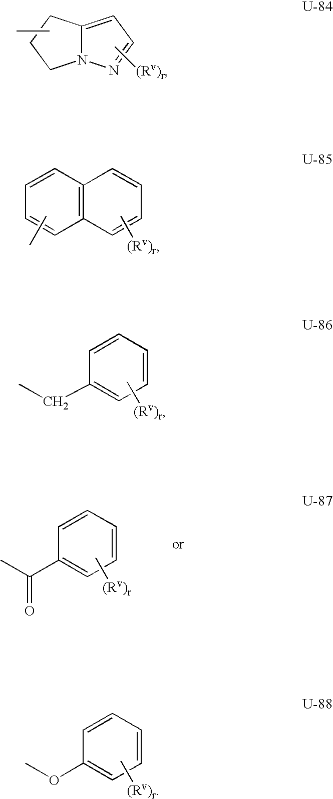

As noted above G can be a 5- or 6-membered nonaromatic carbocyclic or heterocyclic ring, optionally including one or two ring members selected from the group consisting of C(═O), SO or S(O)₂ and optionally substituted with 1 to 4 substituents selected from R¹². Examples of such G groups include those illustrated as G-1 through G-41 in Exhibit 2 wherein m is an integer from 1 to 4. The term “optionally substituted” in connection with these G groups refers to groups which are unsubstituted or have at least one non-hydrogen substituent that does not extinguish the biological activity possessed by the unsubstituted analog. Although (R¹²)ₘ are illustrated in the examples, they need not be present since they are optional substituents. Note that when the attachment point on these G groups is illustrated as floating, the G group can be attached to the remainder of Formula I through any available carbon or nitrogen of the G group by replacement of a hydrogen atom. The optional substituents can be attached to any available carbon or nitrogen by replacing a hydrogen atom. Note that when G comprises a ring selected from G-24 through G-29 and G-32 through G-35, A is selected from O, S, NH or NR¹². Note that when G is G-3, G-5, G-7, G-9, G-16 through G-18, G-23, and G-24 through G-29, and G-32 through G-35 (when A is NR¹²), the nitrogen atoms that require substitution to fill their valence are substituted with H or R¹².

### Exhibit 2

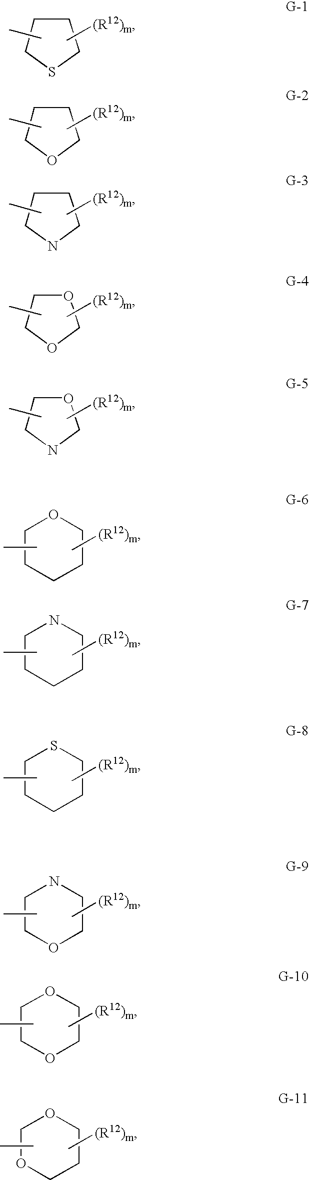

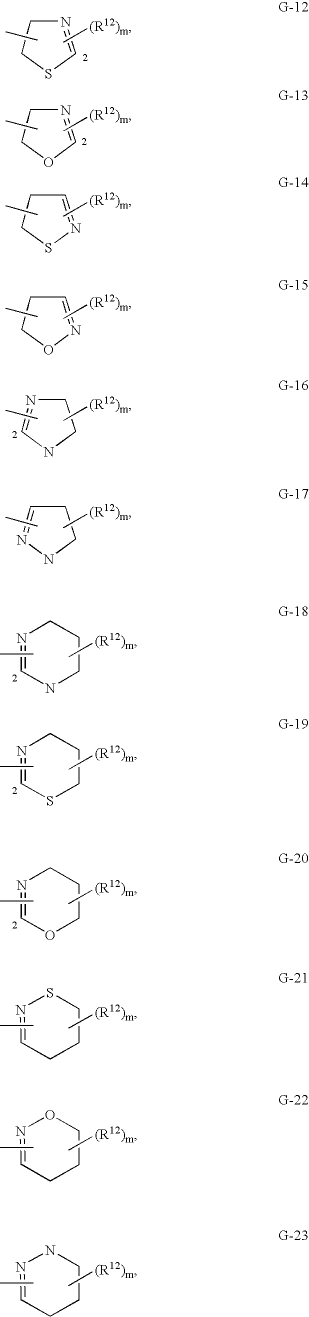

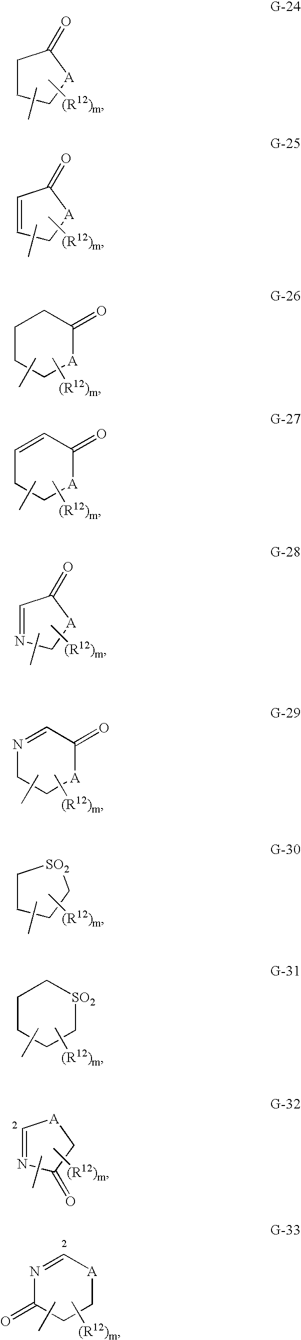

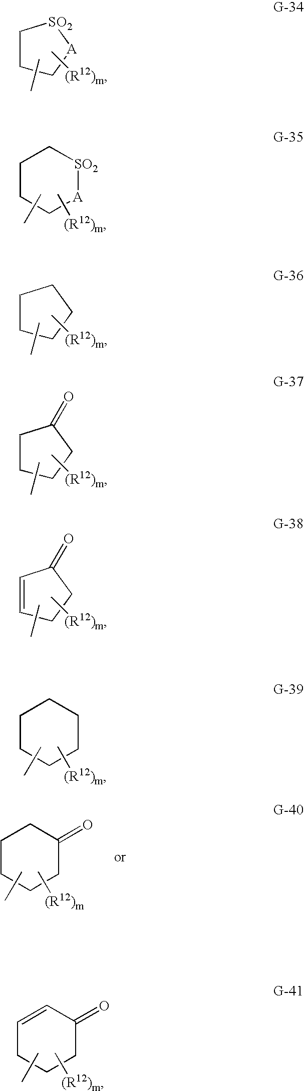

As noted above, R³ can be (among others) C₁-C₆ alkyl, C₂-C₆ alkenyl, C₂-C₆ alkynyl, C₃-C₆ cycloalkyl, each optionally substituted with one or more substituents selected from (among others) a phenyl, phenoxy or 5- or 6-membered heteroaromatic ring, each ring optionally substituted with one to three substituents independently selected from R⁶. The term “optionally substituted” in connection with these groups refers to groups which are unsubstituted or have at least one non-hydrogen substituent that does not extinguish the biological activity possessed by the unsubstituted analog. Examples of such substituents include the rings illustrated as U-1 through U-53 and U-88 illustrated in Exhibit 1, except that such rings are optionally substituted with 1 to 3 substituents independently selected from R⁶ rather than (R^{v})ᵣ. Note that R⁶ substituents do not need to be present since they are optional substituents.

As noted above, each R⁴ is independently (among others) a phenyl, benzyl, phenoxy or a 5- or 6-membered heteroaromatic ring, each ring optionally substituted with one to three substituents independently selected from R⁶. The term “optionally substituted” in connection with these R⁴ groups refers to groups which are unsubstituted or have at least one non-hydrogen substituent that does not extinguish the biological activity possessed by the unsubstituted analog. Examples of such R⁴ groups include the rings illustrated as U-1 through U-53, U-86 and U-88 illustrated in Exhibit 1, except that such rings are optionally substituted with 1 to 3 substituents independently selected from R⁶ rather than (R^{v})ᵣ. Note that R⁶ substituents do not need to be present since they are optional substituents.

As noted above, each R⁵ is independently (among others) a phenyl, benzyl, benzoyl, phenoxy, 5- or 6-membered heteroaromatic ring or an aromatic 8-, 9- or 10-membered fused heterobicyclic ring system, each ring optionally substituted with one to three substituents independently selected from R⁶. Examples of such R⁵ groups include the rings illustrated as U-1 through U-88 illustrated in Exhibit 1, except that such rings are optionally substituted with 1 to 3 substituents independently selected from R⁶ rather than (R^{v})ᵣ. Note that R⁶ substituents do not need to be present since they are optional substituents. Note that in J-6 through J-13, R⁷ and R⁹ are subsets of R⁵.

As noted above K is, together with the two contiguous linking carbon atoms, a fused phenyl or a fused pyridinyl ring optionally substituted with 1 to 4 R⁴. The term “optionally substituted” in connection with these K groups refers to groups which are unsubstituted or have at least one non-hydrogen substituent that does not extinguish the biological activity possessed by the unsubstituted analog. Examples of such K groups include the rings illustrated as K-1 through K-5 in Exhibit 3. Note that K2 through K-5 can be optionally substituted with one to three 3 R⁴ groups. In the exemplified K groups, the upper right bond is attached through the available linking carbon atom to the nitrogen atom of the N═C—J portion of Formula I and the lower right bond is attached through the available linking carbon atom to the carbon atom of the C(═B)NR³ portion of Formula I. The wavy line indicates that the K-ring is attached to the remainder of Formula I as illustrated below.

### Exhibit 3

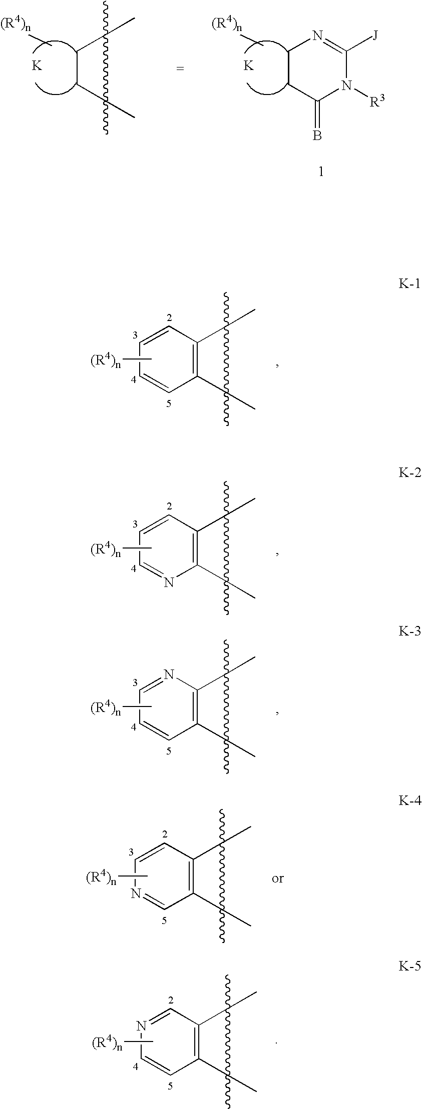

Preferred K-rings are K-1, K-2 and K-5. Most preferred is K-1.

The compounds of Formula I can be prepared by one or more of the following methods and variations as described in Schemes 1-13. The definitions of B, J, K, R³, R⁴, R⁵ and n in the compounds of Formulae I and 2-24 below are as defined above in the Summary of the Invention. Of note are compounds wherein K is K-1.

Compounds of Formula Ib (Formula I wherein B is O) can be prepared by procedures outlined in Schemes 1-13. A typical procedure is detailed in Scheme 1 and involves dehydration of an o-amido amide of Formula 2 with sodium hydride and ethyl chloroformate in a suitable solvent (See e.g. Example 1). Other methods for preparing compounds of Formula I include treating a compound of Formula 2 with acetic anhydride and sodium acetate, heating at greater than 70° C. neat or optionally in an appropriate solvent such as tetrahydrofuran, and treating 2 with a suitable acid scavenger and trimethylsilyl chloride in a suitable solvent. Further useful methods include heating o-amido amides of Formula 2 adsorbed on surface-active materials such as zeolites or clay, generally in the range of 50-150° C. A specific example of this type is described in Example 2 and involves heating the anthranilic amide on Montmorillonite clay. Compounds of Formula Ic (Formula I wherein B is S) can be prepared by conventional methods for conversion of amides to thioamides such as by treatment with phosphorus pentasulfide or Lawesson's reagent. (See (Bull. Soc. Chim. Belg.), 1978, 87, 229; and (Tetrahedron Lett.), 1983, 24, 3815 for general procedures).

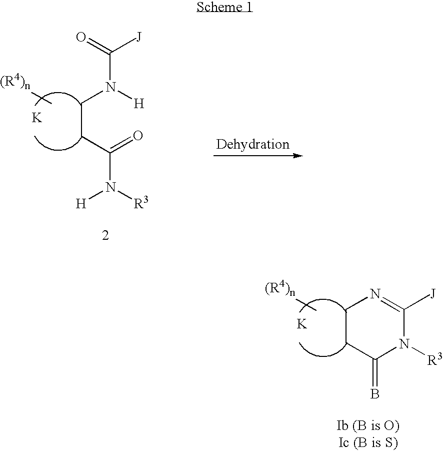

Compounds of Formula 2 can be prepared by procedures outlined in Scheme 2. A typical procedure involves coupling of an o-amino amide of Formula 3 with an acid chloride of Formula 4 in the presence of an acid scavenger to provide the compound of Formula 2. Typical acid scavengers include amine bases such as triethylamine, diisopropylethylamine and pyridine; other scavengers include hydroxides such as sodium and potassium hydroxide and carbonates such as sodium carbonate and potassium carbonate. In certain instances it is useful to use polymer-supported acid scavengers such as polymer-bound diisopropylethylamine and polymer-bound dimethylaminopyridine.

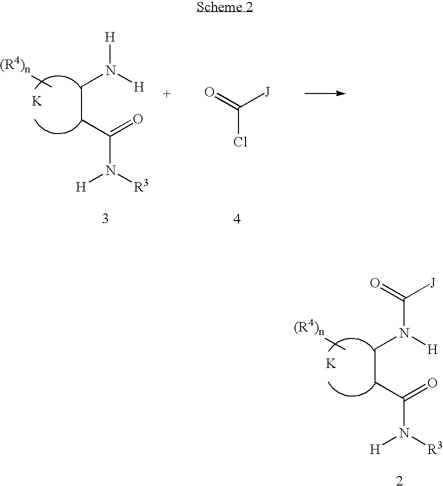

An alternate procedure for the preparation of compounds of Formula 2 involves coupling of an o-amino amide of Formula 3 with an acid of Formula 5 in the presence of a dehydrating agent such as dicyclohexylcarbodiimide (DCC). Polymer supported reagents can be useful here, such as polymer-bound cyclohexylcarbodiimide. Synthetic procedures of Schemes 2 and 3 are only representative examples of useful methods for the preparation of Formula 2 compounds as the synthetic literature is extensive for this type of reaction.

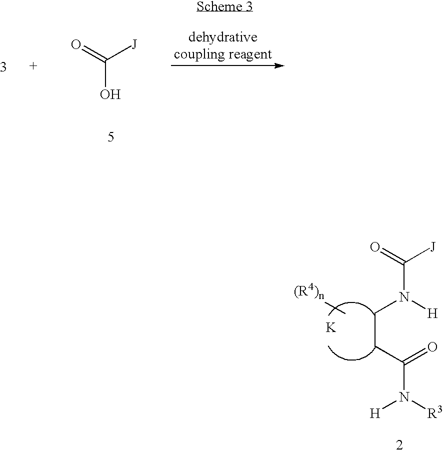

One skilled in the art will also realize that acid chlorides of Formula 4 may be prepared from acids of Formula 5 by numerous well-known methods.

Formula 3 o-Amino amides are typically available from the corresponding o-nitro amides of Formula 6 via catalytic hydrogenation of the nitro group. Typical procedures involve reduction with hydrogen in the presence of a metal catalyst such as palladium on carbon or platinum oxide and in hydroxylic solvents such as ethanol and isopropanol. These procedures are well documented in the chemical literature.

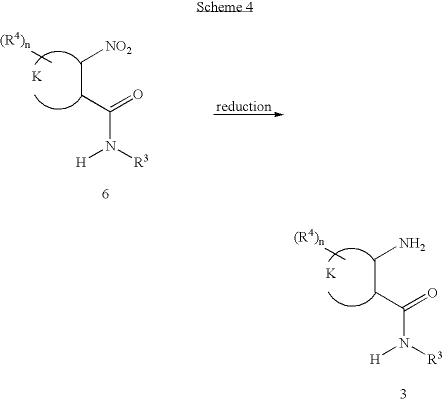

The intermediate amides of Formula 6 are readily prepared from commercially available o-nitro acids of Formula 7. Typical methods for amide formation can be applied here. These include direct dehydrative coupling of acids of Formula 7 with amines of Formula 8 using for example DCC, and conversion of the acids to an activated form such as the acid chlorides or anhydrides and subsequent coupling with amines to form amides of Formula 6. Ethylchloroformate is an especially useful reagent for this type of reaction.

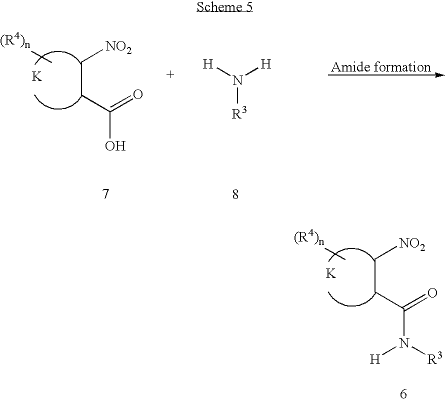

Intermediate o-amino amides of Formula 3 may also be prepared from anhydrides of Formula 9 (Scheme 6). Typical procedures involve combination of equimolar amounts of the amine 8 with the anhydride of Formula 9 in polar aprotic solvents such as pyridine and dimethylformamide at temperatures ranging from room temperature to 100° C.

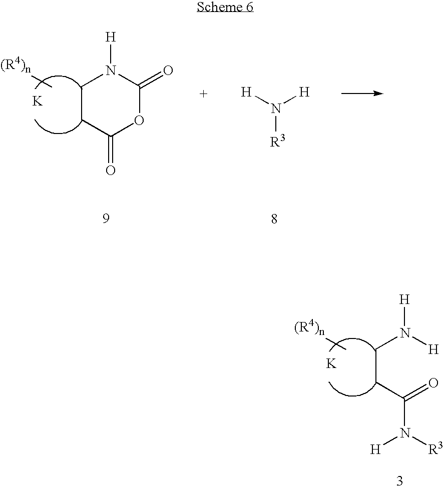

An alternate procedure for the preparation of compounds of Formula 2 involves reaction of an amine 8 with a compound of Formula 10. Typical procedures involve combination of the amine with the compound of Formula 10 in solvents such as tetrahydrofuran or pyridine at temperatures ranging from room temperature to the reflux temperature of the solvent. Benzoxazinones (compounds of Formula 10 wherein K is K-1) are well documented in the chemical literature and are available via known methods that involve the coupling of either an anthranilic acid or an isatoic anhydride with an acid chloride.

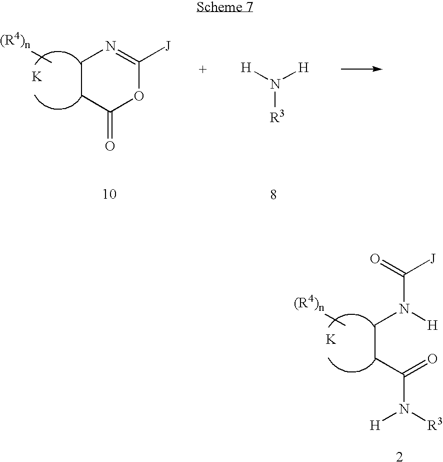

Compounds of Formula I may also be prepared by modification of known procedures (J. Med. Chem. 1985, 28, 568). Usually this involves condensation of an aryl aldehyde of Formula 11 with a compound of Formula 3 in an alcoholic solvent and with a catalytic amount of base to produce intermediate 12, which is then further oxidized to the Formula I compound by known methods. This reaction is shown in Scheme 8.

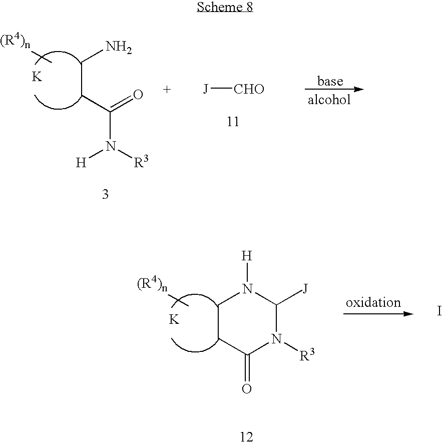

An alternate procedure for the preparation of specific quinazolinones of Formula I (Formula Id) is depicted in Scheme 9. This procedure may be specifically suitable for pyrazole-substituted quinazolinones which may prove difficult to prepare by alternate procedures. The cross coupling reaction of quinazolines of Formula 13 (wherein X is a leaving group such as halogen, triflate or fluorosulfonate) with pyrazoles of Formula 14 (where Met is Sn, Zn, B(OH)₂, Mg, Li or Cu and additional counterions as necessary) in the presence of a palladium or nickel catalyst produces compounds of Formula Id. Quinazolines of Formula 13 wherein X is halogen are known in the art (PCT patent application publication WO98/26664 and references cited therein). Preferred catalysts for the synthesis of compounds of Formula Id include but are not limited to Pd(PPh₃)₄, PdCl₂(PPh₃)₂, PdCl₂(diphenylphosphinoferrocene), NiCl₂(PPh₃)₂, and Tetrakis(tri-2-furylphosphino)palladium. The exact conditions for each reaction depend upon the catalyst used and the metal attached to the pyrazole. The additional presence of an external base (such as an alkali carbonate, tertiary amine or alkali fluoride) is necessary for reactions involving pyrazoles of Formula 14 where Met is B(OH)₂. Similar procedures also can be used for other K-rings and J-groups.

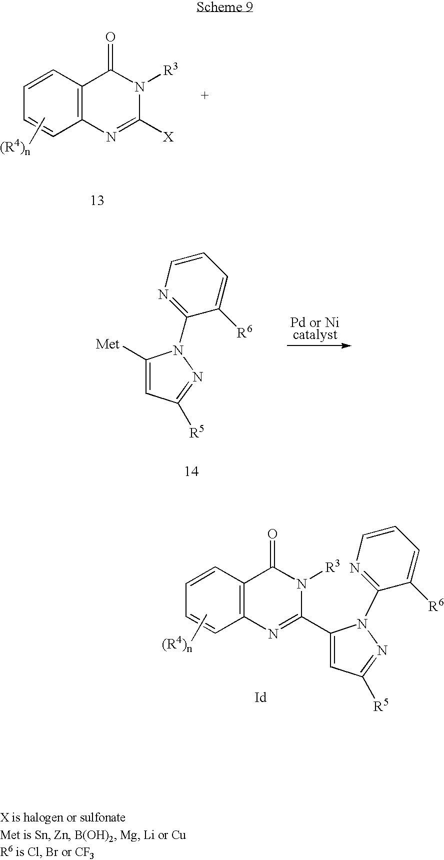

Pyrazoles of Formula 14 can be made by lithiation of the pyrazole 17 followed by transmetallation with the appropriate metal as described in Scheme 10. Pyridylpyrazoles 17 are prepared by the reaction of pyrazoles 15 with a 2,3-dihalopyridine of Formula 16 to afford the 1-pyridylpyrazole 17 with good specificity for the desired regiochemistry. Metallation of 17 with lithium diisopropylamide (LDA) followed by transmetallation with the appropriate metal affords the metal pyrazole of Formula 14. For conditions and catalysts used in transmetallation and cross coupling reactions see Metal-catalyzed Cross-coupling Reactions. Diederich, Francois; Stang, Peter J.; Editors. 1998, p. 517, (Wiley-VCH, Weinheim, Germany) and references cited therein.

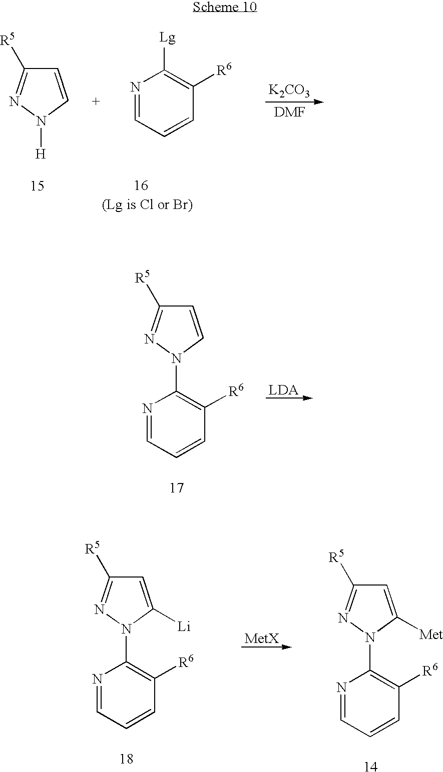

The starting pyrazoles 15 are known compounds. Pyrazole 15 wherein R⁵ is CF₃ is commercially available. Pyrazoles 15 wherein R⁵ is Cl or Br can be prepared by literature procedures (Chem. Ber. 1966, 99(10), 3350-7). A useful alternative method for the preparation of 15 wherein R⁵ is Cl or Br is depicted in Scheme 11. Metallation of the sulfamoyl pyrazole 19 with n-butyllithium followed by direct halogenation of the anion with either hexachloroethane (for R⁵ being Cl) or 1,2-dibromotetrachloroethane (for R⁵ being Br) affords the halogenated derivatives 20. Removal of the sulfamoyl group with trifluoroacetic acid (TFA) at room temperature proceeds cleanly and in good yield to afford the pyrazoles 15 wherein R⁵ is Cl or Br respectively. One skilled in the art will recognize that Formula 15c is a tautomer of Formula 15b.

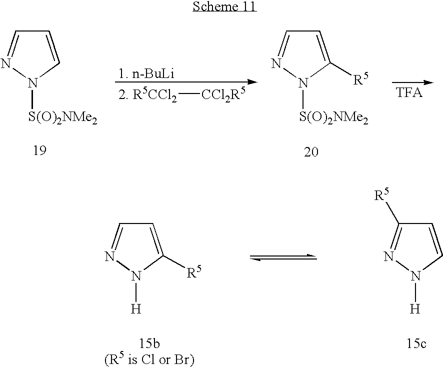

An alternate procedure for the preparation of quinazolinones of Formula Id involves prolonged heating of a benzoxazinone of Formula 21 with an amine of Formula 22 as shown in Scheme 12. Reactions times as long as 1-7 days may be required. An example of this type is detailed in Example 3. Similar procedures also can be used for other K-rings and J-groups.

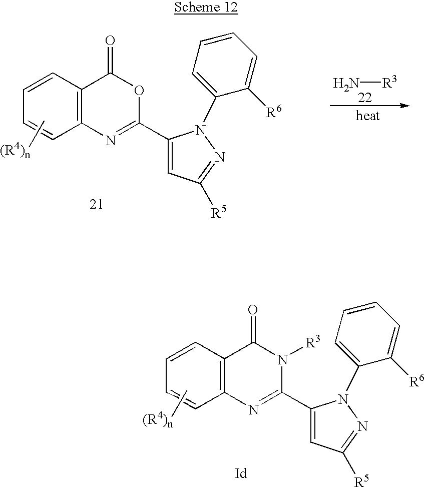

The benzoxazinones of Formula 21 are available by the method of Scheme 13. Coupling of a pyrazole acid of Formula 23 with an anthranilic acid of Formula 24 via sequential addition of methanesulfonyl chloride and triethylamine affords the benzoxazinone of Formula 21. The intermediate acid of Formula 23 is available from the lithiated pyrazole by quenching with carbon dioxide. Similar procedures also can be used for other K-rings and J-groups.

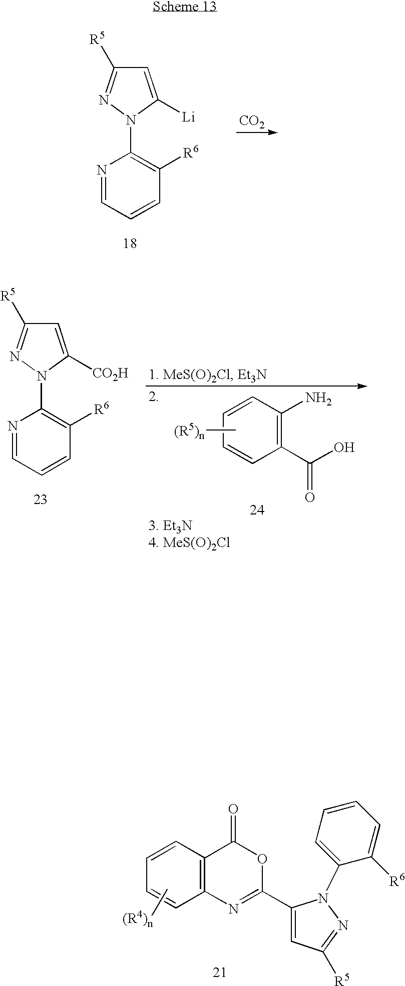

It is recognized that some reagents and reaction conditions described above for preparing compounds of Formula I may not be compatible with certain functionalities present in the intermediates. In these instances, the incorporation of protection/deprotection sequences or functional group interconversions into the synthesis will aid in obtaining the desired products. The use and choice of the protecting groups will be apparent to one skilled in chemical synthesis (see, for example, Greene, T. W.; Wuts, P. G. M. Protective Groups in Organic Synthesis, 2nd ed.; Wiley: New York, 1991). One skilled in the art will recognize that, in some cases, after the introduction of a given reagent as it is depicted in any individual scheme, it may be necessary to perform additional routine synthetic steps not described in detail to complete the synthesis of compounds of Formula I. One skilled in the art will also recognize that it may be necessary to perform a combination of the steps illustrated in the above schemes in an order other than that implied by the particular sequence presented to prepare the compounds of Formula I.

One skilled in the art will also recognize that compounds of Formula I and the intermediates described herein can be subjected to various electrophilic, nucleophilic, radical, organometallic, oxidation, and reduction reactions to add substituents or modify existing substituents.

Without further elaboration, it is believed that one skilled in the art using the preceding description can utilize the present invention to its fullest extent. The following Examples are, therefore, to be construed as merely illustrative, and not limiting of the disclosure in any way whatsoever. Percentages are by weight except for chromatographic solvent mixtures or where otherwise indicated. Parts and percentages for chromatographic solvent mixtures are by volume unless otherwise indicated. ¹H NMR spectra are reported in ppm downfield from tetramethylsilane; s is singlet, d is doublet, t is triplet, q is quartet, m is multiplet, dd is doublet of doublets, dt is doublet of triplets, br s is broad singlet.

### EXAMPLE 1

### Preparation of 8-methyl-3-(1-methylethyl)-2-[2-methyl-4-(trifluoromethyl)-phenyl]-4(3H)-quinazolinone

Step A: Preparation of 3-methyl-N-(1-methylethyl)-2-nitrobenzamide

A solution of 3-methyl-2-nitrobenzoic acid (2.00 g, 11.0 mmol) and triethylamine (1.22 g, 12.1 mmol) in 25 mL of methylene chloride was cooled to 10° C. Ethyl chloroformate was carefully added and a solid precipitate formed. After stirring for 30 minutes isopropylamine (0.94 g, 16.0 mmol) was added and a homogeneous solution resulted. The reaction was stirred for an additional hour, poured into water and extracted with ethyl acetate. The organic extracts were washed with water, dried over magnesium sulfate and evaporated under reduced pressure to afford 1.96 g of the desired intermediate as a white solid melting at 126-128° C.

¹H NMR (CDCl₃) δ 1.24 (d,6H), 2.38 (s,3H), 4.22 (m,1H), 5.80 (br s,1H), 7.4 (m,3H).

Step B: Preparation of 2-amino-3-methyl-N-(1-methylethyl)benzamide

The 2-nitrobenzamide of Step A (1.70 g, 7.6 mmol) was hydrogenated over 5% Pd/C in 40 mL of ethanol at 3.45×10⁵ Pa. When the uptake of hydrogen ceased the reaction was filtered through celite and the celite was washed with ether. The filtrate was evaporated under reduced pressure to afford 1.41 g of the title compound as a solid melting at 149-151° C.

¹H NMR (CDCl₃) δ 1.24 (dd,6H), 2.16 (s,3H), 4.25 (m,1H), 5.54 (br s,2H), 5.85 (br s,1H), 6.59 (t,1H), 7.13 (d,1H), 7.17 (d,1H).

Step C: Preparation of S,S-dimethyl-N-[4-(trifluoromethyl)phenyl]sulfilimine

A solution of N-chlorosuccinimide (12.43 g, 93.1 mmol) in ˜170 mL of dichloromethane was added to a mixture of 4-(trifluoromethyl) aniline (15 g, 93.1 mmol) and dimethyl sulphide (6.35 g, 102 mmol) in 230 mL of dichloromethane at −5 to 0° C. After the addition was complete, the mixture was stirred at 0-5° C. for 1 hour, and N-chlorosuccinimide (0.02 g, 4.64 mmol) was added. After a further 30 minutes, the mixture was washed with 500 mL of 1N sodium hydroxide.

The organic phase was dried and evaporated to give the product as a solid 19.72 g melting at 101-103° C. (after crystallization from ethyl acetate/hexanes).

IR(Nujol®) 1603, 1562, 1532, 1502, 1428, 1402, 1335, 1300, 1270, 1185, 1150, 1103, 1067, 1000, 972, 940, 906, 837, 817 cm⁻¹.

¹H NMR (CDCl₃) δ 7.35 (d,2H), 6.84 (d,2H), 2.67 (s,3H).

Step D: 2-[(methylthio)methyl]-4-(trifluoromethyl)benzenamine

Sodium methoxide in methanol (1.95 g, 9.02 mmol, 25%) was added to S,S-dimethyl-N-[4-(trifluoromethyl)phenyl]sulfilimine from Step C (2 g, 9.04 mmol) in 15 mL of toluene. The mixture was warmed to ˜80° C. for ˜1 h. The mixture was allowed to cool to 25° C. and was poured into 100 mL of water. The mixture was extracted with 2×100 mL of ethyl acetate and the combined extracts were dried and evaporated to give the product 1.8 g as a solid melting at 65.5-67.5° C. (after crystallization from hexanes).

IR (Nujol®) 3419, 3333, 1629, 1584, 1512, 1440, 1334, 1302, 1235, 1193, 1139, 1098, 1078, 979, 904, 832 cm⁻¹.

¹H NMR (CDCl₃) δ 7.35 (dd,1H), 7.26 (s,1H), 6.72 (d,1H) 4.39 (br s,2H), 3.69 (s,2H), 1.99 (s,3H).

Step E: Preparation of 2-methyl-4-(trifluoromethyl)benzenamine

Activated Raney nickel (500 g wet paste, ˜50μ) was added portionwise to a solution of 2-[(methylthio)methyl]-4-(trifluoromethyl)benzenamine (55.3 g, 0.25 mole) in 1 L of ethanol over 30 minutes at 25-30° C. The heterogeneous mixture was stirred vigorously for 30 minutes after the addition. The stirring was stopped, and the solids were allowed to settle over one hour. The liquid was decanted from the solids and poured through filter paper. The filtrate was evaporated under reduced pressure, and the residue was taken up in dichloromethane. The organic phase was separated from a small volume of water, dried over magnesium sulfate and evaporated under reduced pressure to afford 37.6 g of the title compound as an amber oil.

¹H NMR (CDCl₃) δ 7.28 (m,2H), 6.68 (d,1H), 3.87 (br s,2H), 2.19 (s,3H).

Step F: Preparation of 2-methyl-4-(trifluoromethyl)benzonitrile

Concentrated hydrochloric acid (16 mL) was added dropwise at a moderate rate to a heterogeneous mixture of 2-methyl-4-(trifluoromethyl)benzenamine (14 g, 80 mmol) and 120 mL of water while stirring vigorously. A thick suspension resulted which was stirred for 20 minutes, diluted with 280 mL of water and cooled to 5° C. A solution of sodium nitrite (5.5 g, 80 mmol) in 25 mL of water was added slowly to the reaction suspension. After stirring for 30 minutes at 5° C. a solution resulted which was stirred cold for 30 more minutes and then neutralized with potassium carbonate. This diazonium salt solution was then added portionwise via cannula to a stirred, 95° C. mixture of potassium cyanide (22 g, 0.34 mole), copper sulfate pentahydrate (20 g, 80 mmol) and 140 mL of water. After the addition the mixture was stirred for 30 minutes at 95° C. and then allowed to cool to room temperature. Ether was added and the heterogeneous mixture was filtered through celite. The solids were washed with ether, and the filtrate was partitioned. The aqueous phase was extracted with ether, and the combined organic extracts were dried over magnesium sulfate and concentrated under reduced pressure to afford 13.1 g of the title compound as a brown oil.

¹H NMR (CDCl₃) δ 7.74 (d,1H), 7.60 (s,1H), 7.55 (d,1H), 2.64 (s,3H).

Step G: Preparation of 2-methyl-4-trifluoromethyl benzoic acid

Potassium hydroxide (15.7 g, 0.28 mole) and 15 mL of water were added as a solution to a stirred, heterogeneous mixture of 2-methyl-4-(trifluoromethyl)benzonitrile (13 g, 70 mmol) and 135 mL of ethylene glycol. The reaction mixture was heated at 120-130° C. for 20 hours and allowed to cool to room temperature. The dark solution was poured into 800 mL of water and filtered through celite. The filtrate was washed with ether and then the aqueous was acidified with concentrated hydrochloric acid. This aqueous phase was extracted three times with ethyl acetate, the organic extracts were combined, dried over magnesium sulfate and evaporated under reduced pressure to afford the title compound as a tan solid.

¹H NMR (CDCl₃) δ 7.98 (d,1H), 7.70 (s,1H), 7.65 (d,1H), 2.60 (s,3H).

Step H: Preparation of 2-methyl-4-(trifluoromethoxy)benzoyl chloride

Thionyl chloride (0.42 g, 3.5 mmol) was added to a solution of the benzoic acid from Step G (0.50 g, 2.4 mmol) in 10 mL of toluene at room temperature. The reaction was refluxed for three hours then cooled to room temperature. The solvent was evaporated under reduced pressure and excess thionyl chloride was removed by azeotroping with toluene. The benzoyl chloride obtained was used directly in Step I.

Step I: Preparation of 2-methyl-N-[2-methyl-6-[[(1-methylethyl)amino]-carbonyl]phenyl]-4-(trifluoromethyl)benzamide

The benzoyl chloride of Step H (0.29 g, 1.3 mmol) was added to a mixture of the aniline from Step B (0.36 g, 1.9 mmol) and diisopropylethylamine (0.26 g, 2.0 mmol) in 10 mL of chloroform at room temperature. The reaction was allowed to stir overnight. The solid precipitate was filtered and dried to afford 0.38 g of the title compound, as a solid melting at 247-248° C.

¹H NMR (CDCl₃) δ 1.24 (d,6H), 2.41 (s,3H), 2.58 (s,3H), 4.20 (m,1H), 5.94 (br d,1H), 7.2-7.3 (m,2H), 7.40 (d,1H), 7.52 (s,1H), 7.53 (d,1H), 7.70 (d,1H), 9.36 (br s,1H).

Step J: Preparation of 8-methyl-3-(1-methylethyl)-2-[2-methyl-4-(trifluoromethyl)phenyl]-4(3H)-quinazolinone

A slurry of the benzamide of Step I (0.25 g, 0.6 mmol) in N,N-dimethylformamide (4 mL) was added cautiously to a slurry of NaH (0.03 g, 0.7 mmol, 60%) in N,N-dimethylformamide (2 mL). Gas evolution was seen and the mixture became a light yellow solution. After stirring for approximately 5 min, methylchloroformate (0.11 g, 1.2 mmol) was added and a solid precipitate formed. The reaction was stirred for 30 min, then poured into water (50 mL) and extracted with ethyl acetate (2×50 mL). The combined extracts were washed with water (2×50 mL) then dried and evaporated to give 0.16 g of the title compound, a compound of the invention, as a solid melting at 100-103° C.

¹H NMR (CDCl₃) δ 1.25 (d,6H), 2.52 (s,3H), 2.81 (s,3H), 4.28 (m,1H), 7.26 (t,1H), 7.43 (d,1H), 7.57-7.61 (br s,2H), 7.98 (d,1H), 8.07 (d,1H).

### EXAMPLE 2

### Preparation of 6-chloro-2-[1-(3-chloro-2-pyridinyl)-3-(trifluoromethyl)-1H-pyrazol-5-yl]-3,8-dimethyl-4(3H)-quinazoline

Step A: Preparation of 2-amino-3-methyl-5-chlorobenzoic acid

To a solution of 2-amino-3-methylbenzoic acid (Aldrich, 15.0 g, 99.2 mmol) in N,N-dimethylformamide (50 mL) was added N-chlorosuccinimide (13.3 g, 99.2 mmol) and the reaction mixture was heated to 100° C. for 30 minutes. The heat was removed, the reaction was cooled to room temperature and let stand overnight. The reaction mixture was then slowly poured into ice-water (250 mL) to precipitate a white solid. The solid was filtered and washed four times with water and then taken up in ethyl acetate (900 mL). The ethyl acetate solution was dried over magnesium sulfate, evaporated under reduced pressure and the residual solid was washed with ether to afford the desired intermediate as a white solid (13.9 g).

¹H NMR (DMSO-d₆) δ 2.11 (s, 3H), 7.22 (s, 1H), 7.55 (s, 1H).

Step B: Preparation of 3-chloro-2-[3-(trifluoromethyl)-1H-pyrazol-1-yl]pyridine

To a mixture of 2,3-dichloropyridine (99.0 g, 0.67 mol) and 3-trifluoromethyl pyrazole (83 g, 0.61 mol) in dry N,N-dimethylformamide (300 mL) was added potassium carbonate (166.0 g, 1.2 mol) and the reaction was then heated to 110-125° C. over 48 hours. The reaction was cooled to 100° C. and filtered through Celite® diatomaceous filter aid to remove solids. N,N-Dimethylformamide and excess dichloropyridine were removed by distillation at atmospheric pressure. Distillation of the product at reduced pressure (b.p. 139-141° C., 7 mm) afforded the desired intermediate as a clear yellow oil (113.4 g).

¹H NMR (CDCl₃) δ 6.78 (s, 1H), 7.36 (t, 1H), 7.93 (d, 1H), 8.15 (s, 1H), 8.45 (d, 1H).

Step C: Preparation of 1-(3-chloro-2-pyridinyl)-3-(trifluoromethyl)-1H-pyrazole-5carboxylic acid

To a solution of the pyrazole product from Step B (105.0 g, 425 mmol) in dry tetrahydrofuran (700 mL) at −75° C. was added via cannula a −30° C. solution of lithium diisopropylamide (425 mmol) in dry tetrahydrofuran (300 mL). The deep red solution was stirred for 15 minutes, after which time carbon dioxide was bubbled through at −63° C. until the solution became pale yellow and the exothermicity ceased. The reaction was stirred for an additional 20 minutes and then quenched with water (20 mL). The solvent was removed under reduced pressure, and the reaction mixture partitioned between ether and 0.5 N aqueous sodium hydroxide solution. The aqueous extracts were washed with ether (3×), filtered through Celite® diatomaceous filter aid to remove residual solids, and then acidified to a pH of approximately 4, at which point an orange oil formed. The aqueous mixture was stirred vigorously and additional acid was added to lower the pH to 2.5-3. The orange oil congealed into a granular solid, which was filtered, washed successively with water and 1N hydrochloric acid, and dried under vacuum at 50° C. to afford the title product as an off-white solid (130 g). (Product from another run following similar procedure melted at 175-176° C.)

¹H NMR (DMSO-d₆) δ 7.61 (s, 1H), 7.76 (dd, 1H), 8.31 (d, 1H), 8.60 (d, 1H).

Step D: Preparation of 6-chloro-2-[1-(3-chloro-2-pyridinyl)-3-(trifluoromethyl)-1H-pyrazol-5-yl]-8-methyl-4H-3,1-benzoxazin-4-one

To a solution of methanesulfonyl chloride (2.2 mL, 28.3 mmol) in acetonitrile (75 mL) was added dropwise a mixture of the carboxylic acid product from Step C (7.5 g, 27.0 mmol) and triethylamine (3.75 mL, 27.0 mmol) in acetonitrile (75 mL) at 5° C. The reaction temperature was then maintained at 0° C. throughout successive addition of reagents. After stirring for 20 minutes, 2-amino-3-methyl-5-chlorobenzoic acid from Step A (5.1 g, 27.0 mmol) was added and stirring was continued for an additional 5 minutes. A solution of triethylamine (7.5 mL, 54.0 mmol) in acetonitrile (15 mL) was then added dropwise, and the reaction mixture was stirred 45 minutes, followed by the addition of methanesulfonyl chloride (2.2 mL, 28.3 mmol). The reaction mixture was then warmed to room temperature and stirred overnight. Approximately 75 mL of water was then added to precipitate 5.8 g of a yellow solid. An additional 1 g of product was isolated by extraction from the filtrate to provide a total of 6.8 g of the title compound as a yellow solid.

¹H NMR (CDCl₃) δ 1.83 (s, 3H), 7.50 (s, 1H), 7.53 (m, 2H), 7.99 (m, 2H), 8.58 (d, 1H).

Step E: Preparation of N-[4-chloro-2-methyl-6-[(methylamino)carbonyl]phenyl]-1-(3-chloro-2-pyridinyl)-3-(trifluoromethyl)-1H-pyrazole-5-carboxamide

To a solution of the benzoxazinone product of Step D (6.6 g, 15 mmol) in tetrahydrofuran (50 mL) was added methylamine (2.0 M solution in THF, 38 mL, 77.38 mmol), and the reaction mixture was heated to 60° C., stirred for 1 hour and then cooled to room temperature. The tetrahydrofuran solvent was evaporated under reduced pressure, and the residual solid was purified by chromatography on silica gel to afford the title compound, as a white solid melting at 225-226° C.

1H NMR (CDCl₃) δ 2.17 (s,3H), 2.95 (m,3H), 6.2 (m,1H), 7.2 (m,2H), 7.4 (m,2H), 7.85 (md,1H), 8.45 (md,l H), 10.2 (br s, 1H).

Step F: Preparation of 6-chloro-2-[1-(3-chloro-2-pyridinyl)-3-(trifluoromethyl)-1H-pyrazol-5-yl]-3,8-dimethyl-4(3H)-quinazoline

A solution of the title compound from Step E (50 mg, 0.11 mmol) in dichloromethane (20 mL) was mixed with 2 g of montmorillonite K10 clay (Aldrich, preactivated by heating under vacuum) and evaporated to dryness in vacuo. The dry residue was heated using a steam bath (ca. 90-95° C.) for a total of 24 hours. The solids were then extracted twice by mixing with dichloromethane and ethyl acetate (1:1) and filtering. The combined filtrates were evaporated to leave a film. This material was chromatographed on silica gel using 5% ethyl acetate in dichloromethane as the eluant. Pure fractions were combined, evaporated and the residue crystallized from dichloromethane/hexanes to afford 15 mg of the title compound, a compound of the invention, as a white solid.

IR(KBr) 1674, 1598, 1462, 1241, 1194, 1169, 1140cm⁻¹. ¹H NMR (CDCl₃) δ 2.10 (s,3H), 3.78 (s,3H), 7.06 (s, 1H), 7.37 (dd,1H), 7.42 (d,1H), 7.87 (dd,1H).

### EXAMPLE 3

### Preparation of 8-chloro-2-[1-(3-chloro-2-pyridinyl)-3-(trifluoromethyl)-1H-pyrazol-5-yl]-3methyl-4(3H)-quinazolinone

Step A: Preparation of 8-chloro-2-[1-(3-chloro-2-pyridinyl)-3-(trifluoromethyl)-1H-pyrazol-5-yl]-4H-3,1-benzoxazin-4-one

Application of the procedure of Example 2, Step D with 2.91 g of the carboxylic acid of Example 2, Step C and 1.71 g of 2-amino-3-chlorobenzoic acid affords 2.5 g of the title benzoxazinone.

¹H NMR (CDCl₃) δ 7.46 (t,1H), 7.50 (m,1H), 7.52 (s,1H), 7.76 (d,1H), 8.00 (d,1H), 8.11 (d,1H), 8.58 (d, 1H).

Step B: Preparation of 8-chloro-2-[1-(3-chloro-2-pyridinyl)-3-(trifluoromethyl)-1H-pyrazol-5-yl]-3-methyl-4(3H-quinazolinone

A solution of the title compound of Step A (300 mg) in 2 mL of tetrahydrofuran was treated with methylamine (2.0 M solution in THF, 10 mL), sealed in a capped bottle and stirred for four days at room temperature. The solvent was removed under reduced pressure and the solid residue was washed with ether. The ether soluble material was purified by chromatography on silica gel using hexanes/ethyl acetate (1:1) as eluant. The title compound, a compound of the invention, was isolated as a solid, m.p. 155-157° C.

¹H NMR (CDCl₃) δ 3.8 (s,3H), 7.1 (s,1H), 7.4 (m,2H), 7.7 (d,1H), 7.9 (d,1H), 8.15 (d,1H), 8.35 (m,1H).

By the procedures described herein together with methods known in the art, the following compounds of Tables 1 to 33 can be prepared. The following abbreviations are used in the Tables: t is tertiary, s is secondary, n is normal, i is iso, c is cyclo, Me is methyl, Et is ethyl, Pr is propyl, i-Pr is isopropyl, t-Bu is tert butyl, Ph is phenyl, OMe is methoxy, OEt is ethoxy, SMe is methylthio, SEt is ethylthio, CN is cyano, NO₂ is nitro, TMS is trimethylsilyl, S(O)Me is methylsulfinyl, and S(O)₂Me is methylsulfonyl.

TABLE 1

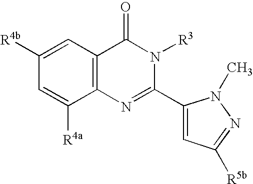

| R^{5b} is Cl | | | R^{5b} is CF₃ | | | R^{5b} is OCF₃ | | | R^{5b} is CF(CF₃)₂ | | |
|---|---|---|---|---|---|---|---|---|---|---|---|
| R³ | R^{4a} | R^{4b} | R³ | R^{4a} | 4^{4b} | R³ | R^{4a} | R^{4b} | R³ | R^{4a} | R^{4b} |
| i-Pr | Me | H | i-Pr | Me | H | i-Pr | Me | H | i-Pr | Me | H |
| i-Pr | Cl | H | i-Pr | Cl | H | i-Pr | Cl | H | i-Pr | Cl | H |
| i-Pr | Me | Cl | i-Pr | Me | Cl | i-Pr | Me | Cl | i-Pr | Me | Cl |
| i-Pr | Cl | Cl | i-Pr | Cl | Cl | i-Pr | Cl | Cl | i-Pr | Cl | Cl |
| i-Pr | Me | Br | i-Pr | Me | Br | i-Pr | Me | Br | i-Pr | Me | Br |
| i-Pr | Cl | Br | i-Pr | Cl | Br | i-Pr | Cl | Br | i-Pr | Cl | Br |
| t-Bu | Me | H | t-Bu | Me | H | t-Bu | Me | H | t-Bu | Me | H |
| t-Bu | Cl | H | t-Bu | Cl | H | t-Bu | Cl | H | t-Bu | Cl | H |
| t-Bu | Me | Cl | t-Bu | Me | Cl | t-Bu | Me | Cl | t-Bu | Me | Cl |
| t-Bu | Cl | Cl | t-Bu | Cl | Cl | t-Bu | Cl | Cl | t-Bu | Cl | Cl |
| t-Bu | Me | Br | t-Bu | Me | Br | t-Bu | Me | Br | t-Bu | Me | Br |
| t-Bu | Cl | Br | i-Bu | Cl | Br | t-Bu | Cl | Br | t-Bu | Cl | Br |
| Et | Me | H | Et | Me | H | Et | Me | H | Et | Me | H |
| Et | Cl | H | Et | Cl | H | Et | Cl | H | Et | Cl | H |
| Et | Me | Cl | Et | Me | Cl | Et | Me | Cl | Et | Me | Cl |
| Et | Cl | Cl | Et | Cl | Cl | Et | Cl | Cl | Et | Cl | Cl |
| Et | Me | Br | Et | Me | Br | Et | Me | Br | Et | Me | Br |
| Et | Cl | Br | Et | Cl | Br | Et | Cl | Br | Et | Cl | Br |
| Me | Me | H | Me | Me | H | Me | Me | H | Me | Me | H |
| Me | Cl | H | Me | Cl | H | Me | Cl | H | Me | Cl | H |
| Me | Me | Cl | Me | Me | Cl | Me | Me | Cl | Me | Me | Cl |
| Me | Cl | Cl | Me | Cl | Cl | Me | Cl | Cl | Me | Cl | Cl |
| Me | Me | Br | Me | Me | Br | Me | Me | Br | Me | Me | Br |
| Me | Cl | Br | Me | Cl | Br | Me | Cl | Br | Me | Cl | Br |

TABLE 2

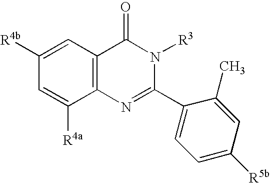

| R^{5b} is Cl | | | R^{5b} is CF₃ | | | R^{5b} is OCF₃ | | | R^{5b} is CF(CF₃)₂ | | |
|---|---|---|---|---|---|---|---|---|---|---|---|
| R³ | R^{4a} | R^{4b} | R³ | R^{4a} | R^{4b} | R³ | R^{4a} | R^{4b} | R³ | R^{4a} | R^{4b} |
| i-Pr | Me | H | i-Pr | Me | H | i-Pr | Me | H | i-Pr | Me | H |
| i-Pr | Cl | H | i-Pr | Cl | H | i-Pr | Cl | H | i-Pr | Cl | H |
| i-Pr | Me | Cl | i-Pr | Me | Cl | i-Pr | Me | Cl | i-Pr | Me | Cl |
| i-Pr | Cl | Cl | i-Pr | Cl | Cl | i-Pr | Cl | Cl | i-Pr | Cl | Cl |
| i-Pr | Me | Br | i-Pr | Me | Br | i-Pr | Me | Br | i-Pr | Me | Br |
| i-Pr | Cl | Br | i-Pr | Cl | Br | i-Pr | Cl | Br | i-Pr | Cl | Br |
| t-Bu | Me | H | t-Bu | Me | H | t-Bu | Me | H | t-Bu | Me | H |
| t-Bu | Cl | H | t-Bu | Cl | H | t-Bu | Cl | H | t-Bu | Cl | H |
| t-Bu | Me | Cl | t-Bu | Me | Cl | t-Bu | Me | Cl | t-Bu | Me | Cl |
| t-Bu | Cl | Cl | t-Bu | Cl | Cl | t-Bu | Cl | Cl | t-Bu | Cl | Cl |
| t-Bu | Me | Br | t-Bu | Me | Br | t-Bu | Me | Br | t-Bu | Me | Br |
| t-Bu | Cl | Br | t-Bu | Cl | Br | t-Bu | Cl | Br | t-Bu | Cl | Br |
| Et | Me | H | Et | Me | H | Et | Me | H | Et | Me | H |
| Et | Cl | H | Et | Cl | H | Et | Cl | H | Et | Cl | H |
| Et | Me | Cl | Et | Me | Cl | Et | Me | Cl | Et | Me | Cl |
| Et | Cl | Cl | Et | Cl | Cl | Et | Cl | Cl | Et | Cl | Cl |
| Et | Me | Br | Et | Me | Br | Et | Me | Br | Et | Me | Br |
| Et | Cl | Br | Et | Cl | Br | Et | Cl | Br | Et | Cl | Br |
| Me | Me | H | Me | Me | H | Me | Me | H | Me | Me | H |
| Me | Cl | H | Me | Cl | H | Me | Cl | H | Me | Cl | H |
| Me | Me | Cl | Me | Me | Cl | Me | Me | Cl | Me | Me | Cl |
| Me | Cl | Cl | Me | Cl | Cl | Me | Cl | Cl | Me | Cl | Cl |
| Me | Me | Br | Me | Me | Br | Me | Me | Br | Me | Me | Br |
| Me | Cl | Br | Me | Cl | Br | Me | Cl | Br | Me | Cl | Br |

TABLE 3

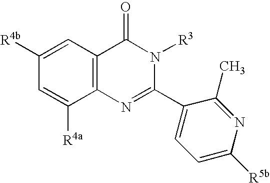

| R^{5b} is Cl | | | R^{5b} is CF₃ | | | R^{5b} is OCF₃ | | | R^{5b} is CF(CF₃)₂ | | |
|---|---|---|---|---|---|---|---|---|---|---|---|
| R³ | R^{4a} | R^{4b} | R³ | R^{4a} | R^{4b} | R³ | R^{4a} | R^{4b} | R³ | R^{4a} | R^{4b} |
| i-Pr | Me | H | i-Pr | Me | H | i-Pr | Me | H | i-Pr | Me | H |
| i-Pr | Cl | H | i-Pr | Cl | H | i-Pr | Cl | H | i-Pr | Cl | H |
| i-Pr | Me | Cl | i-Pr | Me | Cl | i-Pr | Me | Cl | i-Pr | Me | Cl |
| i-Pr | Cl | Cl | i-Pr | Cl | Cl | i-Pr | Cl | Cl | i-Pr | Cl | Cl |
| i-Pr | Me | Br | i-Pr | Me | Br | i-Pr | Me | Br | i-Pr | Me | Br |
| i-Pr | Cl | Br | i-Pr | Cl | Br | i-Pr | Cl | Br | i-Pr | Cl | Br |
| t-Bu | Me | H | t-Bu | Me | H | t-Bu | Me | H | t-Bu | Me | H |
| t-Bu | Cl | H | t-Bu | Cl | H | t-Bu | Cl | H | t-Bu | Cl | H |
| t-Bu | Me | Cl | t-Bu | Me | Cl | t-Bu | Me | Cl | t-Bu | Me | Cl |
| t-Bu | Cl | Cl | t-Bu | Cl | Cl | t-Bu | Cl | Cl | t-Bu | Cl | Cl |
| t-Bu | Me | Br | t-Bu | Me | Br | t-Bu | Me | Br | t-Bu | Me | Br |
| t-Bu | Cl | Br | t-Bu | Cl | Br | t-Bu | Cl | Br | t-Bu | Cl | Br |
| Et | Me | H | Et | Me | H | Et | Me | H | Et | Me | H |
| Et | Cl | H | Et | Cl | H | Et | Cl | H | Et | Cl | H |
| Et | Me | Cl | Et | Me | Cl | Et | Me | Cl | Et | Me | Cl |
| Et | Cl | Cl | Et | Cl | Cl | Et | Cl | Cl | Et | Cl | Cl |
| Et | Me | Br | Et | Me | Br | Et | Me | Br | Et | Me | Br |
| Et | Cl | Br | Et | Cl | Br | Et | Cl | Br | Et | Cl | Br |
| Me | Me | H | Me | Me | H | Me | Me | H | Me | Me | H |
| Me | Cl | H | Me | Cl | H | Me | Cl | H | Me | Cl | H |
| Me | Me | Cl | Me | Me | Cl | Me | Me | Cl | Me | Me | Cl |
| Me | Cl | Cl | Me | Cl | Cl | Me | Cl | Cl | Me | Cl | Cl |
| Me | Me | Br | Me | Me | Br | Me | Me | Br | Me | Me | Br |
| Me | Cl | Br | Me | Cl | Br | Me | Cl | Br | Me | Cl | Br |

TABLE 4

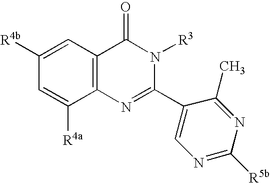

| R^{5b} is Cl | | | R^{5b} is CF₃ | | | R^{5b} is OCF₃ | | | R^{5b} is CF(CF₃)₂ | | |
|---|---|---|---|---|---|---|---|---|---|---|---|
| R³ | R^{4a} | R^{4b} | R³ | R^{4a} | R^{4b} | R³ | R^{4a} | R^{4b} | R³ | R^{4a} | R^{4b} |
| i-Pr | Me | H | i-Pr | Me | H | i-Pr | Me | H | i-Pr | Me | H |
| i-Pr | Cl | H | i-Pr | Cl | H | i-Pr | Cl | H | i-Pr | Cl | H |
| i-Pr | Me | Cl | i-Pr | Me | Cl | i-Pr | Me | Cl | i-Pr | Me | Cl |
| i-Pr | CI | Cl | i-Pr | Cl | Cl | i-Pr | Cl | Cl | i-Pr | Cl | Cl |
| i-Pr | Me | Br | i-Pr | Me | Br | i-Pr | Me | Br | i-Pr | Me | Br |
| i-Pr | Cl | Br | i-Pr | Cl | Br | i-Pr | Cl | Br | i-Pr | Cl | Br |
| t-Bu | Me | H | t-Bu | Me | H | t-Bu | Me | H | t-Bu | Me | H |
| t-Bu | Cl | H | t-Bu | Cl | H | t-Bu | Cl | H | t-Bu | Cl | H |
| t-Bu | Me | Cl | t-Bu | Me | Cl | t-Bu | Me | Cl | t-Bu | Me | Cl |
| t-Bu | Cl | Cl | t-Bu | Cl | Cl | t-Bu | Cl | Cl | t-Bu | Cl | Cl |
| t-Bu | Me | Br | t-Bu | Me | Br | t-Bu | Me | Br | t-Bu | Me | Br |
| t-Bu | Cl | Br | t-Bu | Cl | Br | t-Bu | Cl | Br | t-Bu | Cl | Br |
| Et | Me | H | Et | Me | H | Et | Me | H | Et | Me | H |
| Et | Cl | H | Et | Cl | H | Et | Cl | H | Et | Cl | H |
| Et | Me | Cl | Et | Me | Cl | Et | Me | Cl | Et | Me | Cl |
| Et | Cl | Cl | Et | Cl | Cl | Et | Cl | Cl | Et | Cl | Cl |
| Et | Me | Br | Et | Me | Br | Et | Me | Br | Et | Me | Br |
| Et | Cl | Br | Et | Cl | Br | Et | Cl | Br | Et | Cl | Br |
| Me | Me | H | Me | Me | H | Me | Me | H | Me | Me | H |
| Me | Cl | H | Me | Cl | H | Me | Cl | H | Me | Cl | H |
| Me | Me | Cl | Me | Me | Cl | Me | Me | Cl | Me | Me | Cl |
| Me | Cl | Cl | Me | Cl | Cl | Me | Cl | Cl | Me | Cl | Cl |
| Me | Me | Br | Me | Me | Br | Me | Me | Br | Me | Me | Br |
| Me | Cl | Br | Me | Cl | Br | Me | Cl | Br | Me | Cl | Br |

TABLE 5

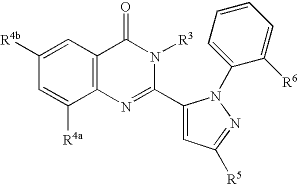

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | H | Cl | Br | Me | Cl | Br | Cl | Br |
| Et | CH₃ | H | CF₃ | Cl | Et | Cl | H | Cl | Br | Et | Cl | Br | Cl | Br |
| i-Pr | CH₃ | H | CF₃ | Cl | i-Pr | Cl | H | Cl | Br | i-Pr | Cl | Br | Cl | Br |
| t-Bu | CH₃ | H | CF₃ | Cl | t-Bu | Cl | H | Cl | Br | t-Bu | Cl | Br | Cl | Br |
| Me | CH₃ | H | CF₃ | Br | Me | Cl | H | Br | Cl | Me | Cl | Br | Br | Cl |
| Et | CH₃ | H | CF₃ | Br | Et | Cl | H | Br | Cl | Et | Cl | Br | Br | Cl |
| i-Pr | CH₃ | H | CF₃ | Br | i-Pr | Cl | H | Br | Cl | i-Pr | Cl | Br | Br | Cl |
| t-Bu | CH₃ | H | CF₃ | Br | t-Bu | Cl | H | Br | Cl | t-Bu | Cl | Br | Br | Cl |
| Me | CH₃ | H | Cl | Cl | Me | Cl | H | Br | Br | Me | Cl | Br | Br | Br |
| Et | CH₃ | H | Cl | Cl | Et | Cl | H | Br | Br | Et | Cl | Br | Br | Br |
| i-Pr | CH₃ | H | Cl | Cl | i-Pr | Cl | H | Br | Br | i-Pr | Cl | Br | Br | Br |
| t-Bu | CH₃ | H | Cl | Cl | t-Bu | Cl | H | Br | Br | t-Bu | Cl | Br | Br | Br |
| Me | CH₃ | H | Cl | Br | Me | Cl | H | CF₃ | Cl | Me | Cl | I | CF₃ | Cl |
| Et | CH₃ | H | Cl | Br | Et | Cl | H | CF₃ | Cl | Et | Cl | I | CF₃ | Cl |
| i-Pr | CH₃ | H | Cl | Br | i-Pr | Cl | H | CF₃ | Cl | i-Pr | Cl | I | CF₃ | Cl |
| t-Bu | CH₃ | H | Cl | Br | t-Bu | Cl | H | CF₃ | Cl | t-Bu | Cl | I | CF₃ | Cl |
| Me | CH₃ | H | Br | Cl | Me | Cl | H | CF₃ | Br | Me | Cl | I | CF₃ | Br |
| Et | CH₃ | H | Br | Cl | Et | Cl | H | CF₃ | Br | Et | Cl | I | CF₃ | Br |
| i-Pr | CH₃ | H | Br | Cl | i-Pr | Cl | H | CF₃ | Br | i-Pr | Cl | I | CF₃ | Br |
| t-Bu | CH₃ | H | Br | Cl | i-Bu | Cl | H | CF₃ | Br | t-Bu | Cl | I | CF₃ | Br |
| Me | CH₃ | H | Br | Br | Me | Cl | H | Cl | Cl | Me | Cl | I | Cl | Cl |
| Et | CH₃ | H | Br | Br | Et | Cl | H | Cl | Cl | Et | Cl | I | Cl | Cl |
| i-Pr | CH₃ | H | Br | Br | i-Pr | Cl | H | Cl | Cl | i-Pr | Cl | I | Cl | Cl |
| t-Bu | CH₃ | H | Br | Br | i-Pr | Cl | H | Cl | Cl | t-Bu | Cl | I | Cl | Cl |
| Me | CH₃ | F | CF₃ | Cl | Me | CH₃ | Cl | CF₃ | Cl | Me | Cl | I | Cl | Br |
| Et | CH₃ | F | CF₃ | Cl | Et | CH₃ | Cl | CF₃ | Cl | Et | Cl | I | Cl | Br |
| i-Pr | CH₃ | F | CF₃ | Cl | i-Pr | CH₃ | Cl | CF₃ | Cl | i-Pr | Cl | I | Cl | Br |
| t-Bu | CH₃ | F | CF₃ | Cl | t-Bu | CH₃ | Cl | CF₃ | Cl | i-Bu | Cl | I | Cl | Br |
| Me | CH₃ | F | CF₃ | Br | Me | CH₃ | Cl | CF₃ | Br | Me | Cl | I | Br | Cl |
| Et | CH₃ | F | CF₃ | Br | Et | CH₃ | Cl | CF₃ | Br | Et | Cl | I | Br | Cl |
| i-Pr | CH₃ | F | CF₃ | Br | i-Pr | CH₃ | Cl | CF₃ | Br | i-Pr | Cl | I | Br | Cl |
| t-Bu | CH₃ | F | CF₃ | Br | t-Bu | CH₃ | Cl | CF₃ | Br | t-Bu | Cl | I | Br | Cl |
| Me | CH₃ | F | Cl | Cl | Me | CH₃ | Cl | Cl | Cl | Me | Cl | I | Br | Br |
| Et | CH₃ | F | Cl | Cl | Et | CH₃ | Cl | Cl | Cl | Et | Cl | I | Br | Br |
| i-Pr | CH₃ | F | Cl | Cl | i-Pr | CH₃ | Cl | Cl | Cl | i-Pr | Cl | I | Br | Br |
| t-Bu | CH₃ | F | Cl | Cl | t-Bu | CH₃ | Cl | Cl | Cl | i-Bu | Cl | I | Br | Br |
| Me | CH₃ | F | Cl | Br | Me | CH₃ | Cl | Cl | Br | Me | Cl | CF₃ | CF₃ | Cl |
| Et | CH₃ | F | Cl | Br | Et | CH₃ | Cl | Cl | Br | Et | Cl | CF₃ | CF₃ | Cl |
| i-Pr | CH₃ | F | Cl | Br | i-Pr | CH₃ | Cl | Cl | Br | i-Pr | Cl | CF₃ | CF₃ | Cl |
| t-Bu | CH₃ | F | Cl | Br | t-Bu | CH₃ | Cl | Cl | Br | t-Bu | Cl | CF₃ | CF₃ | Cl |
| Me | CH₃ | F | Br | Cl | Me | CH₃ | Cl | Br | Cl | Me | Cl | CF₃ | CF₃ | Br |
| Et | CH₃ | F | Br | Cl | Et | CH₃ | Cl | Br | Cl | Et | Cl | CF₃ | CF₃ | Br |
| i-Pr | CH₃ | F | Br | Cl | i-Pr | CH₃ | Cl | Br | Cl | i-Pr | Cl | CF₃ | CF₃ | Br |
| t-Bu | CH₃ | F | Br | Cl | i-Bu | CH₃ | Cl | Br | Cl | t-Bu | Cl | CF₃ | CF₃ | Br |
| Me | CH₃ | F | Br | Br | Me | CH₃ | Cl | Br | Br | Me | Cl | CF₃ | Cl | Cl |
| Et | CH₃ | F | Br | Br | Et | CH₃ | Cl | Br | Br | Et | Cl | CF₃ | Cl | Cl |
| i-Pr | CH₃ | F | Br | Br | i-Pr | CH₃ | Cl | Br | Br | i-Pr | Cl | CF₃ | Cl | Cl |
| t-Bu | CH₃ | F | Br | Br | i-Bu | CH₃ | Cl | Br | Br | t-Bu | Cl | CF₃ | Cl | Cl |
| Me | CH₃ | Br | CF₃ | Cl | Me | Cl | F | CF₃ | Cl | Me | Cl | CF₃ | Cl | Br |
| Et | CH₃ | Br | CF₃ | Cl | Et | Cl | F | CF₃ | Cl | Et | Cl | CF₃ | Cl | Br |
| i-Pr | CH₃ | Br | CF₃ | Cl | i-Pr | Cl | F | CF₃ | Cl | i-Pr | Cl | CF₃ | Cl | Br |
| i-Bu | CH₃ | Br | CF₃ | Cl | t-Bu | Cl | F | CF₃ | Cl | i-Bu | Cl | CF₃ | Cl | Br |
| Me | CH₃ | Br | CF₃ | Br | Me | Cl | F | CF₃ | Br | Me | Cl | CF₃ | Br | Cl |
| Et | CH₃ | Br | CF₃ | Br | Et | Cl | F | CF₃ | Br | Et | Cl | CF₃ | Br | Cl |
| i-Pr | CH₃ | Br | CF₃ | Br | i-Pr | Cl | F | CF₃ | Br | i-Pr | Cl | CF₃ | Br | Cl |
| t-Bu | CH₃ | Br | CF₃ | Br | t-Bu | Cl | F | CF₃ | Br | t-Bu | Cl | CF₃ | Br | Cl |
| Me | CH₃ | Br | Cl | Cl | Me | Cl | F | Cl | Cl | Me | Cl | CF₃ | Br | Br |
| Et | CH₃ | Br | Cl | Cl | Et | Cl | F | Cl | Cl | Et | Cl | CF₃ | Br | Br |
| i-Pr | CH₃ | Br | Cl | Cl | i-Pr | Cl | F | Cl | Cl | i-Pr | Cl | CF₃ | Br | Br |
| t-Bu | CH₃ | Br | Cl | Cl | t-Bu | Cl | F | Cl | Cl | t-Bu | Cl | CF₃ | Br | Br |
| Me | CH₃ | Br | Cl | Br | Me | Cl | F | Cl | Br | n-Pr | Cl | Cl | Cl | Cl |
| Et | CH₃ | Br | Cl | Br | Et | Cl | F | Cl | Br | n-Bu | Cl | Cl | Cl | Cl |
| i-Pr | CH₃ | Br | Cl | Br | i-Pr | Cl | F | Cl | Br | s-Bu | Cl | Cl | Cl | Cl |
| t-Bu | CH₃ | Br | Cl | Br | t-Bu | Cl | F | Cl | Br | i-Bu | Cl | Cl | Cl | Cl |
| Me | CH₃ | Br | Br | Cl | Me | Cl | F | Br | Cl | Me | Br | F | CF₃ | Cl |
| Et | CH₃ | Br | Br | Cl | Et | Cl | F | Br | Cl | Et | Br | F | CF₃ | Cl |
| i-Pr | CH₃ | Br | Br | Cl | i-Pr | Cl | F | Br | Cl | i-Pr | Br | F | CF₃ | Cl |
| t-Bu | CH₃ | Br | Br | Cl | t-Bu | Cl | F | Br | Cl | t-Bu | Br | F | CF₃ | Cl |
| Me | CH₃ | Br | Br | Br | Me | Cl | F | Br | Br | Me | Br | F | CF₃ | Br |
| Et | CH₃ | Br | Br | Br | Et | Cl | F | Br | Br | Et | Br | F | CF₃ | Br |
| i-Pr | CH₃ | Br | Br | Br | i-Pr | Cl | F | Br | Br | i-Pr | Br | F | CF₃ | Br |
| t-Bu | CH₃ | Br | Br | Br | t-Bu | Cl | F | Br | Br | t-Bu | Br | F | CF₃ | Br |
| Me | CH₃ | I | CF₃ | Cl | Me | Cl | Cl | CF₃ | Cl | Me | Br | F | Cl | Cl |
| Et | CH₃ | I | CF₃ | Cl | Et | Cl | Cl | CF₃ | Cl | Et | Br | F | Cl | Cl |
| i-Pr | CH₃ | I | CF₃ | Cl | i-Pr | Cl | Cl | CF₃ | Cl | i-Pr | Br | F | Cl | Cl |
| i-Bu | CH₃ | I | CF₃ | Cl | t-Bu | Cl | Cl | CF₃ | Cl | t-Bu | Br | F | Cl | Cl |
| Me | CH₃ | I | CF₃ | Br | Me | Cl | Cl | CF₃ | Br | Me | Br | F | Cl | Br |
| Et | CH₃ | I | CF₃ | Br | Et | Cl | Cl | CF₃ | Br | Et | Br | F | Cl | Br |
| i-Pr | CH₃ | I | CF₃ | Br | i-Pr | Cl | Cl | CF₃ | Br | i-Pr | Br | F | Cl | Br |
| t-Bu | CH₃ | I | CF₃ | Br | t-Bu | Cl | Cl | CF₃ | Br | t-Bu | Br | F | Cl | Br |
| Me | CH₃ | I | Cl | Cl | Me | Cl | Cl | Cl | Cl | Me | Br | F | Br | Cl |
| Et | CH₃ | I | Cl | Cl | Et | Cl | Cl | Cl | Cl | Et | Br | F | Br | Cl |
| i-Pr | CH₃ | I | Cl | Cl | i-Pr | Cl | Cl | Cl | Cl | i-Pr | Br | F | Br | Cl |
| t-Bu | CH₃ | I | Cl | Cl | t-Bu | Cl | Cl | Cl | Cl | t-Bu | Br | F | Br | Cl |
| Me | CH₃ | I | Cl | Br | Me | Cl | Cl | Cl | Br | Me | Br | F | Br | Br |
| Et | CH₃ | I | Cl | Br | Et | Cl | Cl | Cl | Br | Et | Br | F | Br | Br |
| i-Pr | CH₃ | I | Cl | Br | i-Pr | Cl | Cl | Cl | Br | i-Pr | Br | F | Br | Br |
| t-Bu | CH₃ | I | Cl | Br | t-Bu | Cl | Cl | Cl | Br | t-Bu | Br | F | Br | Br |
| Me | CH₃ | I | Br | Cl | Me | Br | CF₃ | CF₃ | Cl | Me | Br | Cl | CF₃ | Cl |
| Et | CH₃ | I | Br | Cl | Et | Br | CF₃ | CF₃ | Cl | Et | Br | Cl | CF₃ | Cl |
| i-Pr | CH₃ | I | Br | Cl | i-Pr | Br | CF₃ | CF₃ | Cl | i-Pr | Br | Cl | CF₃ | Cl |
| t-Bu | CH₃ | I | Br | Cl | t-Bu | Br | CF₃ | CF₃ | Cl | t-Bu | Br | Cl | CF₃ | Cl |
| Me | CH₃ | I | Br | Br | Me | Br | CF₃ | CF₃ | Br | Me | Br | Cl | CF₃ | Br |
| Et | CH₃ | I | Br | Br | Et | Br | CF₃ | CF₃ | Br | Et | Br | Cl | CF₃ | Br |
| i-Pr | CH₃ | I | Br | Br | i-Pr | Br | CF₃ | CF₃ | Br | i-Pr | Br | Cl | CF₃ | Br |
| t-Bu | CH₃ | I | Br | Br | t-Bu | Br | CF₃ | CF₃ | Br | t-Bu | Br | Cl | CF₃ | Br |
| Me | CH₃ | CF₃ | CF₃ | Cl | Me | Br | CF₃ | Cl | Cl | Me | Br | Cl | Cl | Cl |
| Et | CH₃ | CF₃ | CF₃ | Cl | Et | Br | CF₃ | Cl | Cl | Et | Br | Cl | Cl | Cl |
| i-Pr | CH₃ | CF₃ | CF₃ | Cl | i-Pr | Br | CF₃ | Cl | Cl | i-Pr | Br | Cl | Cl | Cl |
| t-Bu | CH₃ | CF₃ | CF₃ | Cl | t-Bu | Br | CF₃ | Cl | Cl | t-Bu | Br | Cl | Cl | Cl |
| Me | CH₃ | CF₃ | CF₃ | Br | Me | Br | CF₃ | Cl | Br | Me | Br | Cl | Cl | Br |
| Et | CH₃ | CF₃ | CF₃ | Br | Et | Br | CF₃ | Cl | Br | Et | Br | Cl | Cl | Br |
| i-Pr | CH₃ | CF₃ | CF₃ | Br | i-Pr | Br | CF₃ | Cl | Br | i-Pr | Br | Cl | Cl | Br |
| t-Bu | CH₃ | CF₃ | CF₃ | Br | t-Bu | Br | CF₃ | Cl | Br | t-Bu | Br | Cl | Cl | Br |
| Me | CH₃ | CF₃ | Cl | Cl | Me | Br | CF₃ | Br | Cl | Me | Br | Cl | Br | Cl |
| Et | CH₃ | CF₃ | Cl | Cl | Et | Br | CF₃ | Br | Cl | Et | Br | Cl | Br | Cl |
| i-Pr | CH₃ | CF₃ | Cl | Cl | i-Pr | Br | CF₃ | Br | Cl | i-Pr | Br | Cl | Br | Cl |
| t-Bu | CH₃ | CF₃ | Cl | Cl | t-Bu | Br | CF₃ | Br | Cl | t-Bu | Br | Cl | Br | Cl |
| Me | CH₃ | CF₃ | Cl | Br | Me | Br | CF₃ | Br | Br | Me | Br | Cl | Br | Br |
| Et | CH₃ | CF₃ | Cl | Br | Et | Br | CF₃ | Br | Br | Et | Br | Cl | Br | Br |
| i-Pr | CH₃ | CF₃ | Cl | Br | i-Pr | Br | CF₃ | Br | Br | i-Pr | Br | Cl | Br | Br |
| t-Bu | CH₃ | CF₃ | Cl | Br | t-Bu | Br | CF₃ | Br | Br | t-Bu | Br | Cl | Br | Br |
| Me | CH₃ | CF₃ | Br | Cl | Me | Br | I | CF₃ | Cl | Me | Br | Br | CF₃ | Cl |
| Et | CH₃ | CF₃ | Br | Cl | Et | Br | I | CF₃ | Cl | Et | Br | Br | CF₃ | Cl |
| i-Pr | CH₃ | CF₃ | Br | Cl | i-Pr | Br | I | CF₃ | Cl | i-Pr | Br | Br | CF₃ | Cl |
| t-Bu | CH₃ | CF₃ | Br | Cl | t-Bu | Br | I | CF₃ | Cl | t-Bu | Br | Br | CF₃ | Cl |
| Me | CH₃ | CF₃ | Br | Br | Me | Br | I | CF₃ | Br | Me | Br | Br | CF₃ | Br |
| Et | CH₃ | CF₃ | Br | Br | Et | Br | I | CF₃ | Br | Et | Br | Br | CF₃ | Br |
| i-Pr | CH₃ | CF₃ | Br | Br | i-Pr | Br | I | CF₃ | Br | i-Pr | Br | Br | CF₃ | Br |
| t-Bu | CH₃ | CF₃ | Br | Br | t-Bu | Br | I | CF₃ | Br | t-Bu | Br | Br | CF₃ | Br |
| n-Pr | CH₃ | Cl | Cl | Cl | Me | Br | I | Cl | Cl | Me | Br | Br | Cl | Cl |
| n-Bu | CH₃ | Cl | Cl | Cl | Et | Br | I | Cl | Cl | Et | Br | Br | Cl | Cl |
| s-Bu | CH₃ | Cl | Cl | Cl | i-Pr | Br | I | Cl | Cl | i-Pr | Br | Br | Cl | Cl |
| i-Bu | CH₃ | Cl | Cl | Cl | t-Bu | Br | I | Cl | Cl | t-Bu | Br | Br | Cl | Cl |
| Me | Cl | Cl | Br | Cl | Me | Br | I | Cl | Br | Me | Br | Br | Cl | Br |
| Et | Cl | Cl | Br | Cl | Et | Br | I | Cl | Br | Et | Br | Br | Cl | Br |
| i-Pr | Cl | Cl | Br | Cl | i-Pr | Br | I | Cl | Br | i-Pr | Br | Br | Cl | Br |
| t-Bu | Cl | Cl | Br | Cl | t-Bu | Br | I | Cl | Br | t-Bu | Br | Br | Cl | Br |
| Me | Cl | Cl | Br | Br | Me | Br | I | Br | Cl | Me | Br | Br | Br | Cl |
| Et | Cl | Cl | Br | Br | Et | Br | I | Br | Cl | Et | Br | Br | Br | Cl |
| i-Pr | Cl | Cl | Br | Br | i-Pr | Br | I | Br | Cl | i-Pr | Br | Br | Br | Cl |
| t-Bu | Cl | Cl | Br | Br | t-Bu | Br | I | Br | Cl | t-Bu | Br | Br | Br | Cl |
| Me | Cl | Br | CF₃ | Cl | Me | Br | I | Br | Br | Me | Br | Br | Br | Br |
| Et | Cl | Br | CF₃ | Cl | Et | Br | I | Br | Br | Et | Br | Br | Br | Br |
| i-Pr | Cl | Br | CF₃ | Cl | i-Pr | Br | I | Br | Br | i-Pr | Br | Br | Br | Br |
| t-Bu | Cl | Br | CF₃ | Cl | t-Bu | Br | I | Br | Br | t-Bu | Br | Br | Br | Br |
| Me | Cl | Br | CF₃ | Br | Me | Cl | Br | Cl | Cl | t-Bu | Cl | Br | CF₃ | Br |
| Et | Cl | Br | CF₃ | Br | Et | Cl | Br | Cl | Cl | t-Bu | Cl | Br | Cl | Cl |
| i-Pr | Cl | Br | CF₃ | Br | i-Pr | Cl | Br | Cl | Cl | | | | | |

TABLE 6

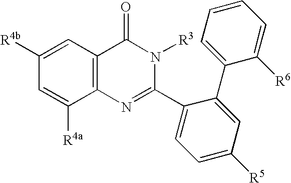

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | H | Cl | Br | Me | Cl | Br | Cl | Br |
| Et | CH₃ | H | CF₃ | Cl | Et | Cl | H | Cl | Br | Et | Cl | Br | Cl | Br |
| i-Pr | CH₃ | H | CF₃ | Cl | i-Pr | Cl | H | Cl | Br | i-Pr | Cl | Br | Cl | Br |
| t-Bu | CH₃ | H | CF₃ | Cl | t-Bu | Cl | H | Cl | Br | t-Bu | Cl | Br | Cl | Br |
| Me | CH₃ | H | CF₃ | Br | Me | Cl | H | Br | Cl | Me | Cl | Br | Br | Cl |
| Et | CH₃ | H | CF₃ | Br | Et | Cl | H | Br | Cl | Et | Cl | Br | Br | Cl |
| i-Pr | CH₃ | H | CF₃ | Br | i-Pr | Cl | H | Br | Cl | i-Pr | Cl | Br | Br | Cl |
| t-Bu | CH₃ | H | CF₃ | Br | t-Bu | Cl | H | Br | Cl | t-Bu | Cl | Br | Br | Cl |
| Me | CH₃ | H | Cl | Cl | Me | Cl | H | Br | Br | Me | Cl | Br | Br | Br |
| Et | CH₃ | H | Cl | Cl | Et | Cl | H | Br | Br | Et | Cl | Br | Br | Br |
| i-Pr | CH₃ | H | Cl | Cl | i-Pr | Cl | H | Br | Br | i-Pr | Cl | Br | Br | Br |
| t-Bu | CH₃ | H | Cl | Cl | t-Bu | Cl | H | Br | Br | t-Bu | Cl | Br | Br | Br |
| Me | CH₃ | H | Cl | Br | Me | Cl | H | CF₃ | Cl | Me | Cl | I | CF₃ | Cl |
| Et | CH₃ | H | Cl | Br | Et | Cl | H | CF₃ | Cl | Et | Cl | I | CF₃ | Cl |
| i-Pr | CH₃ | H | Cl | Br | i-Pr | Cl | H | CF₃ | Cl | i-Pr | Cl | I | CF₃ | Cl |
| t-Bu | CH₃ | H | Cl | Br | t-Bu | Cl | H | CF₃ | Cl | t-Bu | Cl | I | CF₃ | Cl |
| Me | CH₃ | H | Br | Cl | Me | Cl | H | CF₃ | Br | Me | Cl | I | CF₃ | Br |
| Et | CH₃ | H | Br | Cl | Et | Cl | H | CF₃ | Br | Et | Cl | I | CF₃ | Br |
| i-Pr | CH₃ | H | Br | Cl | i-Pr | Cl | H | CF₃ | Br | i-Pr | Cl | I | CF₃ | Br |
| i-Bu | CH₃ | H | Br | Cl | t-Bu | Cl | H | CF₃ | Br | t-Bu | Cl | I | CF₃ | Br |
| Me | CH₃ | H | Br | Br | Me | Cl | H | Cl | Cl | Me | Cl | I | Cl | Cl |
| Et | CH₃ | H | Br | Br | Et | Cl | H | Cl | Cl | Et | Cl | I | Cl | Cl |
| i-Pr | CH₃ | H | Br | Br | i-Pr | Cl | H | Cl | Cl | i-Pr | Cl | I | Cl | Cl |
| t-Bu | CH₃ | H | Br | Br | i-Pr | Cl | H | Cl | Cl | t-Bu | Cl | I | Cl | Cl |
| Me | CH₃ | F | CF₃ | Cl | Me | CH₃ | Cl | CF₃ | Cl | Me | Cl | I | Cl | Br |
| Et | CH₃ | F | CF₃ | Cl | Et | CH₃ | Cl | CF₃ | Cl | Et | Cl | I | Cl | Br |
| i-Pr | CH₃ | F | CF₃ | Cl | i-Pr | CH₃ | Cl | CF₃ | Cl | i-Pr | Cl | I | Cl | Br |
| t-Bu | CH₃ | F | CF₃ | Cl | t-Bu | CH₃ | Cl | CF₃ | Cl | t-Bu | Cl | I | Cl | Br |
| Me | CH₃ | F | CF₃ | Br | Me | CH₃ | Cl | CF₃ | Br | Me | Cl | I | Br | Cl |
| Et | CH₃ | F | CF₃ | Br | Et | CH₃ | Cl | CF₃ | Br | Et | Cl | I | Br | Cl |
| i-Pr | CH₃ | F | CF₃ | Br | i-Pr | CH₃ | Cl | CF₃ | Br | i-Pr | Cl | I | Br | Cl |
| t-Bu | CH₃ | F | CF₃ | Br | t-Bu | CH₃ | Cl | CF₃ | Br | t-Bu | Cl | I | Br | Cl |
| Me | CH₃ | F | Cl | Cl | Me | CH₃ | Cl | Cl | Cl | Me | Cl | I | Br | Br |
| Et | CH₃ | F | Cl | Cl | Et | CH₃ | Cl | Cl | Cl | Et | Cl | I | Br | Br |
| i-Pr | CH₃ | F | Cl | Cl | i-Pr | CH₃ | Cl | Cl | Cl | i-Pr | Cl | I | Br | Br |
| t-Bu | CH₃ | F | Cl | Cl | t-Bu | CH₃ | Cl | Cl | Cl | t-Bu | Cl | I | Br | Br |
| Me | CH₃ | F | Cl | Br | Me | CH₃ | Cl | Cl | Br | Me | Cl | CF₃ | CF₃ | Cl |
| Et | CH₃ | F | Cl | Br | Et | CH₃ | Cl | Cl | Br | Et | Cl | CF₃ | CF₃ | Cl |
| i-Pr | CH₃ | F | Cl | Br | i-Pr | CH₃ | Cl | Cl | Br | i-Pr | Cl | CF₃ | CF₃ | Cl |
| t-Bu | CH₃ | F | Cl | Br | t-Bu | CH₃ | Cl | Cl | Br | t-Bu | Cl | CF₃ | CF₃ | Cl |
| Me | CH₃ | F | Br | Cl | Me | CH₃ | Cl | Br | Cl | Me | Cl | CF₃ | CF₃ | Br |
| Et | CH₃ | F | Br | Cl | Et | CH₃ | Cl | Br | Cl | Et | Cl | CF₃ | CF₃ | Br |
| i-Pr | CH₃ | F | Br | Cl | i-Pr | CH₃ | Cl | Br | Cl | i-Pr | Cl | CF₃ | CF₃ | Br |
| t-Bu | CH₃ | F | Br | Cl | t-Bu | Cl₃ | Cl | Br | Cl | t-Bu | Cl | CF₃ | CF₃ | Br |
| Me | CH₃ | F | Br | Br | Me | CH₃ | Cl | Br | Br | Me | Cl | CF₃ | Cl | Cl |
| Et | CH₃ | F | Br | Br | Et | CH₃ | Cl | Br | Br | Et | Cl | CF₃ | Cl | Cl |
| i-Pr | CH₃ | F | Br | Br | i-Pr | CH₃ | Cl | Br | Br | i-Pr | Cl | CF₃ | Cl | Cl |
| t-Bu | CH₃ | F | Br | Br | i-Bu | CH₃ | Cl | Br | Br | t-Bu | Cl | CF₃ | Cl | Cl |
| Me | CH₃ | Br | CF₃ | Cl | Me | Cl | F | CF₃ | Cl | Me | Cl | CF₃ | Cl | Br |
| Et | CH₃ | Br | CF₃ | Cl | Et | Cl | F | CF₃ | Cl | Et | Cl | CF₃ | Cl | Br |
| i-Pr | CH₃ | Br | CF₃ | Cl | i-Pr | Cl | F | CF₃ | Cl | i-Pr | Cl | CF₃ | Cl | Br |
| t-Bu | CH₃ | Br | CF₃ | Cl | t-Bu | Cl | F | CF₃ | Cl | t-Bu | Cl | CF₃ | Cl | Br |
| Me | CH₃ | Br | CF₃ | Br | Me | Cl | F | CF₃ | Br | Me | Cl | CF₃ | Br | Cl |
| Et | CH₃ | Br | CF₃ | Br | Et | Cl | F | CF₃ | Br | Et | Cl | CF₃ | Br | Cl |
| i-Pr | CH₃ | Br | CF₃ | Br | i-Pr | Cl | F | CF₃ | Br | i-Pr | Cl | CF₃ | Br | Cl |
| t-Bu | CH₃ | Br | CF₃ | Br | t-Bu | Cl | F | CF₃ | Br | t-Bu | Cl | CF₃ | Br | Cl |
| Me | CH₃ | Br | Cl | Cl | Me | Cl | F | Cl | Cl | Me | Cl | CF₃ | Br | Br |
| Et | CH₃ | Br | Cl | Cl | Et | Cl | F | Cl | Cl | Et | Cl | CF₃ | Br | Br |
| i-Pr | CH₃ | Br | Cl | Cl | i-Pr | Cl | F | Cl | Cl | i-Pr | Cl | CF₃ | Br | Br |
| i-Bu | CH₃ | Br | Cl | Cl | t-Bu | Cl | F | Cl | Cl | t-Bu | Cl | CF₃ | Br | Br |
| Me | CH₃ | Br | Cl | Br | Me | Cl | F | Cl | Br | n-Pr | Cl | Cl | Cl | Cl |
| Et | CH₃ | Br | Cl | Br | Et | Cl | F | Cl | Br | n-Bu | Cl | Cl | Cl | Cl |
| i-Pr | CH₃ | Br | Cl | Br | i-Pr | Cl | F | Cl | Br | s-Bu | Cl | Cl | Cl | Cl |
| t-Bu | CH₃ | Br | Cl | Br | t-Bu | Cl | F | Cl | Br | i-Bu | Cl | Cl | Cl | Cl |
| Me | CH₃ | Br | Br | Cl | Me | Cl | F | Br | Cl | Me | Br | F | CF₃ | Cl |
| Et | CH₃ | Br | Br | Cl | Et | Cl | F | Br | Cl | Et | Br | F | CF₃ | Cl |
| i-Pr | CH₃ | Br | Br | Cl | i-Pr | Cl | F | Br | Cl | i-Pr | Br | F | CF₃ | Cl |
| t-Bu | CH₃ | Br | Br | Cl | t-Bu | Cl | F | Br | Cl | t-Bu | Br | F | CF₃ | Cl |
| Me | CH₃ | Br | Br | Br | Me | Cl | F | Br | Br | Me | Br | F | CF₃ | Br |
| Et | CH₃ | Br | Br | Br | Et | Cl | F | Br | Br | Et | Br | F | CF₃ | Br |
| i-Pr | CH₃ | Br | Br | Br | i-Pr | Cl | F | Br | Br | i-Pr | Br | F | CF₃ | Br |
| t-Bu | CH₃ | Br | Br | Br | t-Bu | Cl | F | Br | Br | t-Bu | Br | F | CF₃ | Br |
| Me | CH₃ | I | CF₃ | Cl | Me | Cl | Cl | CF₃ | Cl | Me | Br | F | Cl | Cl |
| Et | CH₃ | I | CF₃ | Cl | Et | Cl | Cl | CF₃ | Cl | Et | Br | F | Cl | Cl |
| i-Pr | CH₃ | I | CF₃ | Cl | i-Pr | Cl | Cl | CF₃ | Cl | i-Pr | Br | F | Cl | Cl |
| t-Bu | CH₃ | I | CF₃ | Cl | t-Bu | Cl | Cl | CF₃ | Cl | t-Bu | Br | F | Cl | Cl |
| Me | CH₃ | I | CF₃ | Br | Me | Cl | Cl | CF₃ | Br | Me | Br | F | Cl | Br |
| Et | CH₃ | I | CF₃ | Br | Et | Cl | Cl | CF₃ | Br | Et | Br | F | Cl | Br |
| i-Pr | CH₃ | I | CF₃ | Br | i-Pr | Cl | Cl | CF₃ | Br | i-Pr | Br | F | Cl | Br |
| t-Bu | CH₃ | I | CF₃ | Br | t-Bu | Cl | Cl | CF₃ | Br | t-Bu | Br | F | Cl | Br |
| Me | CH₃ | I | Cl | Cl | Me | Cl | Cl | Cl | Cl | Me | Br | F | Br | Cl |
| Et | CH₃ | I | Cl | Cl | Et | Cl | Cl | Cl | Cl | Et | Br | F | Br | Cl |
| i-Pr | CH₃ | I | Cl | Cl | i-Pr | Cl | Cl | Cl | Cl | i-Pr | Br | F | Br | Cl |
| t-Bu | CH₃ | I | Cl | Cl | t-Bu | Cl | Cl | Cl | Cl | i-Bu | Br | F | Br | Cl |
| Me | CH₃ | I | Cl | Br | Me | Cl | Cl | Cl | Br | Me | Br | F | Br | Br |
| Et | CH₃ | I | Cl | Br | Et | Cl | Cl | Cl | Br | Et | Br | F | Br | Br |
| i-Pr | CH₃ | I | Cl | Br | i-Pr | Cl | Cl | Cl | Br | i-Pr | Br | F | Br | Br |
| t-Bu | CH₃ | I | Cl | Br | t-Bu | Cl | Cl | Cl | Br | t-Bu | Br | F | Br | Br |
| Me | CH₃ | I | Br | Cl | Me | Br | CF₃ | CF₃ | Cl | Me | Br | Cl | CF₃ | Cl |
| Et | CH₃ | I | Br | Cl | Et | Br | CF₃ | CF₃ | Cl | Et | Br | Cl | CF₃ | Cl |
| i-Pr | CH₃ | I | Br | Cl | i-Pr | Br | CF₃ | CF₃ | Cl | i-Pr | Br | Cl | CF₃ | Cl |
| t-Bu | CH₃ | I | Br | Cl | t-Bu | Br | CF₃ | CF₃ | Cl | t-Bu | Br | Cl | CF₃ | Cl |
| Me | CH₃ | I | Br | Br | Me | Br | CF₃ | CF₃ | Br | Me | Br | Cl | CF₃ | Br |
| Et | CH₃ | I | Br | Br | Et | Br | CF₃ | CF₃ | Br | Et | Br | Cl | CF₃ | Br |
| i-Pr | CH₃ | I | Br | Br | i-Pr | Br | CF₃ | CF₃ | Br | i-Pr | Br | Cl | CF₃ | Br |
| t-Bu | CH₃ | I | Br | Br | t-Bu | Br | CF₃ | CF₃ | Br | t-Bu | Br | Cl | CF₃ | Br |
| Me | CH₃ | CF₃ | CF₃ | Cl | Me | Br | CF₃ | Cl | Cl | Me | Br | Cl | Cl | Cl |
| Et | CH₃ | CF₃ | CF₃ | Cl | Et | Br | CF₃ | Cl | Cl | Et | Br | Cl | Cl | Cl |
| i-Pr | CH₃ | CF₃ | CF₃ | Cl | i-Pr | Br | CF₃ | Cl | Cl | i-Pr | Br | Cl | Cl | Cl |
| t-Bu | CH₃ | CF₃ | CF₃ | Cl | t-Bu | Br | CF₃ | Cl | Cl | t-Bu | Br | Cl | Cl | Cl |
| Me | CH₃ | CF₃ | CF₃ | Br | Me | Br | CF₃ | Cl | Br | Me | Br | Cl | Cl | Br |
| Et | CH₃ | CF₃ | CF₃ | Br | Et | Br | CF₃ | Cl | Br | Et | Br | Cl | Cl | Br |
| i-Pr | CH₃ | CF₃ | CF₃ | Br | i-Pr | Br | CF₃ | Cl | Br | i-Pr | Br | Cl | Cl | Br |
| t-Bu | CH₃ | CF₃ | CF₃ | Br | t-Bu | Br | CF₃ | Cl | Br | t-Bu | Br | Cl | Cl | Br |
| Me | CH₃ | CF₃ | Cl | Cl | Me | Br | CF₃ | Br | Cl | Me | Br | Cl | Br | Cl |
| Et | CH₃ | CF₃ | Cl | Cl | Et | Br | CF₃ | Br | Cl | Et | Br | Cl | Br | Cl |
| i-Pr | CH₃ | CF₃ | Cl | Cl | i-Pr | Br | CF₃ | Br | Cl | i-Pr | Br | Cl | Br | Cl |
| t-Bu | CH₃ | CF₃ | Cl | Cl | i-Bu | Br | CF₃ | Br | Cl | t-Bu | Br | Cl | Br | Cl |
| Me | CH₃ | CF₃ | Cl | Br | Me | Br | CF₃ | Br | Br | Me | Br | Cl | Br | Br |
| Et | CH₃ | CF₃ | Cl | Br | Et | Br | CF₃ | Br | Br | Et | Br | Cl | Br | Br |
| i-Pr | CH₃ | CF₃ | Cl | Br | i-Pr | Br | CF₃ | Br | Br | i-Pr | Br | Cl | Br | Br |
| t-Bu | CH₃ | CF₃ | Cl | Br | i-Bu | Br | CF₃ | Br | Br | t-Bu | Br | Cl | Br | Br |
| Me | CH₃ | CF₃ | Br | Cl | Me | Br | I | CF₃ | Cl | Me | Br | Br | CF₃ | Cl |
| Et | CH₃ | CF₃ | Br | Cl | Et | Br | I | CF₃ | Cl | Et | Br | Br | CF₃ | Cl |
| i-Pr | CH₃ | CF₃ | Br | Cl | i-Pr | Br | I | CF₃ | Cl | i-Pr | Br | Br | CF₃ | Cl |
| t-Bu | CH₃ | CF₃ | Br | Cl | t-Bu | Br | I | CF₃ | Cl | t-Bu | Br | Br | CF₃ | Cl |
| Me | CH₃ | CF₃ | Br | Br | Me | Br | I | CF₃ | Br | Me | Br | Br | CF₃ | Br |
| Et | CH₃ | CF₃ | Br | Br | Et | Br | I | CF₃ | Br | Et | Br | Br | CF₃ | Br |
| i-Pr | CH₃ | CF₃ | Br | Br | i-Pr | Br | I | CF₃ | Br | i-Pr | Br | Br | CF₃ | Br |
| t-Bu | CH₃ | CF₃ | Br | Br | t-Bu | Br | I | CF₃ | Br | t-Bu | Br | Br | CF₃ | Br |
| n-Pr | CH₃ | Cl | Cl | Cl | Me | Br | I | Cl | Cl | Me | Br | Br | Cl | Cl |
| n-Bu | CH₃ | Cl | Cl | Cl | Et | Br | I | Cl | Cl | Et | Br | Br | Cl | Cl |
| s-Bu | CH₃ | Cl | Cl | Cl | i-Pr | Br | I | Cl | Cl | i-Pr | Br | Br | Cl | Cl |
| i-Bu | CH₃ | Cl | Cl | Cl | t-Bu | Br | I | Cl | Cl | t-Bu | Br | Br | Cl | Cl |
| Me | Cl | Cl | Br | Cl | Me | Br | I | Cl | Br | Me | Br | Br | Cl | Br |
| Et | Cl | Cl | Br | Cl | Et | Br | I | Cl | Br | Et | Br | Br | Cl | Br |
| i-Pr | Cl | Cl | Br | Cl | i-Pr | Br | I | Cl | Br | i-Pr | Br | Br | Cl | Br |
| t-Bu | Cl | Cl | Br | Cl | t-Bu | Br | I | Cl | Br | t-Bu | Br | Br | Cl | Br |
| Me | Cl | Cl | Br | Br | Me | Br | I | Br | Cl | Me | Br | Br | Br | Cl |
| Et | Cl | Cl | Br | Br | Et | Br | I | Br | Cl | Et | Br | Br | Br | Cl |
| i-Pr | Cl | Cl | Br | Br | i-Pr | Br | I | Br | Cl | i-Pr | Br | Br | Br | Cl |
| t-Bu | Cl | Cl | Br | Br | t-Bu | Br | I | Br | Cl | t-Bu | Br | Br | Br | Cl |
| Me | Cl | Br | CF₃ | Cl | Me | Br | I | Br | Br | Me | Br | Br | Br | Br |
| Et | Cl | Br | CF₃ | Cl | Et | Br | I | Br | Br | Et | Br | Br | Br | Br |
| i-Pr | Cl | Br | CF₃ | Cl | i-Pr | Br | I | Br | Br | i-Pr | Br | Br | Br | Br |
| t-Bu | Cl | Br | CF₃ | Cl | t-Bu | Br | I | Br | Br | t-Bu | Br | Br | Br | Br |
| Me | Cl | Br | CF₃ | Br | Me | Cl | Br | Cl | Cl | t-Bu | Cl | Br | CF₃ | Br |
| Et | Cl | Br | CF₃ | Br | Et | Cl | Br | Cl | Cl | t-Bu | Cl | Br | Cl | Cl |
| i-Pr | Cl | Br | CF₃ | Br | i-Pr | Cl | Br | Cl | Cl | | | | | |

TABLE 7

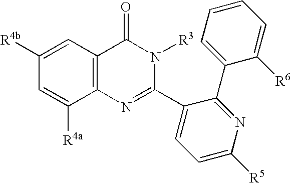

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | H | Cl | Br | Me | Cl | Br | Cl | Br |
| Et | CH₃ | H | CF₃ | Cl | Et | Cl | H | Cl | Br | Et | Cl | Br | Cl | Br |
| i-Pr | CH₃ | H | CF₃ | Cl | i-Pr | Cl | H | Cl | Br | i-Pr | Cl | Br | Cl | Br |
| t-Bu | CH₃ | H | CF₃ | Cl | t-Bu | Cl | H | Cl | Br | t-Bu | Cl | Br | Cl | Br |
| Me | CH₃ | H | CF₃ | Br | Me | Cl | H | Br | Cl | Me | Cl | Br | Br | Cl |
| Et | CH₃ | H | CF₃ | Br | Et | Cl | H | Br | Cl | Et | Cl | Br | Br | Cl |
| i-Pr | CH₃ | H | CF₃ | Br | i-Pr | Cl | H | Br | Cl | i-Pr | Cl | Br | Br | Cl |
| t-Bu | CH₃ | H | CF₃ | Br | t-Bu | Cl | H | Br | Cl | t-Bu | Cl | Br | Br | Cl |
| Me | CH₃ | H | Cl | Cl | Me | Cl | H | Br | Br | Me | Cl | Br | Br | Br |
| Et | CH₃ | H | Cl | Cl | Et | Cl | H | Br | Br | Et | Cl | Br | Br | Br |
| i-Pr | CH₃ | H | Cl | Cl | i-Pr | Cl | H | Br | Br | i-Pr | Cl | Br | Br | Br |
| t-Bu | CH₃ | H | Cl | Cl | t-Bu | Cl | H | Br | Br | t-Bu | Cl | Br | Br | Br |
| Me | CH₃ | H | Cl | Br | Me | Cl | H | CF₃ | Cl | Me | Cl | I | CF₃ | Cl |
| Et | CH₃ | H | Cl | Br | Et | Cl | H | CF₃ | Cl | Et | Cl | I | CF₃ | Cl |
| i-Pr | CH₃ | H | Cl | Br | i-Pr | Cl | H | CF₃ | Cl | i-Pr | Cl | I | CF₃ | Cl |
| t-Bu | CH₃ | H | Cl | Br | t-Bu | Cl | H | CF₃ | Cl | t-Bu | Cl | I | CF₃ | Cl |
| Me | CH₃ | H | Br | Cl | Me | Cl | H | CF₃ | Br | Me | Cl | I | CF₃ | Br |
| Et | CH₃ | H | Br | Cl | Et | Cl | H | CF₃ | Br | Et | Cl | I | CF₃ | Br |
| i-Pr | CH₃ | H | Br | Cl | i-Pr | Cl | H | CF₃ | Br | i-Pr | Cl | I | CF₃ | Br |
| t-Bu | CH₃ | H | Br | Cl | t-Bu | Cl | H | CF₃ | Br | t-Bu | Cl | I | CF₃ | Br |
| Me | CH₃ | H | Br | Br | Me | Cl | H | Cl | Cl | Me | Cl | I | Cl | Cl |
| Et | CH₃ | H | Br | Br | Et | Cl | H | Cl | Cl | Et | Cl | I | Cl | Cl |
| i-Pr | CH₃ | H | Br | Br | i-Pr | Cl | H | Cl | Cl | i-Pr | Cl | I | Cl | Cl |
| t-Bu | CH₃ | H | Br | Br | i-Pr | Cl | H | Cl | Cl | t-Bu | Cl | I | Cl | Cl |
| Me | CH₃ | F | CF₃ | Cl | Me | CH₃ | Cl | CF₃ | Cl | Me | Cl | I | Cl | Br |
| Et | CH₃ | F | CF₃ | Cl | Et | CH₃ | Cl | CF₃ | Cl | Et | Cl | I | Cl | Br |
| i-Pr | CH₃ | F | CF₃ | Cl | i-Pr | CH₃ | Cl | CF₃ | Cl | i-Pr | Cl | I | Cl | Br |
| t-Bu | CH₃ | F | CF₃ | Cl | t-Bu | CH₃ | Cl | CF₃ | Cl | t-Bu | Cl | I | Cl | Br |
| Me | CH₃ | F | CF₃ | Br | Me | CH₃ | Cl | CF₃ | Br | Me | Cl | I | Br | Cl |
| Et | CH₃ | F | CF₃ | Br | Et | CH₃ | Cl | CF₃ | Br | Et | Cl | I | Br | Cl |
| i-Pr | CH₃ | F | CF₃ | Br | i-Pr | CH₃ | Cl | CF₃ | Br | i-Pr | Cl | I | Br | Cl |
| t-Bu | CH₃ | F | CF₃ | Br | t-Bu | CH₃ | Cl | CF₃ | Br | t-Bu | Cl | I | Br | Cl |
| Me | CH₃ | F | Cl | Cl | Me | CH₃ | Cl | Cl | Cl | Me | Cl | I | Br | Br |
| Et | CH₃ | F | Cl | Cl | Et | CH₃ | Cl | Cl | Cl | Et | Cl | I | Br | Br |
| i-Pr | CH₃ | F | Cl | Cl | i-Pr | CH₃ | Cl | Cl | Cl | i-Pr | Cl | I | Br | Br |
| t-Bu | CH₃ | F | Cl | Cl | t-Bu | CH₃ | Cl | Cl | Cl | t-Bu | Cl | I | Br | Br |
| Me | CH₃ | F | Cl | Br | Me | CH₃ | Cl | Cl | Br | Me | Cl | CF₃ | CF₃ | Cl |
| Et | CH₃ | F | Cl | Br | Et | CH₃ | Cl | Cl | Br | Et | Cl | CF₃ | CF₃ | Cl |
| i-Pr | CH₃ | F | Cl | Br | i-Pr | CH₃ | Cl | Cl | Br | i-Pr | Cl | CF₃ | CF₃ | Cl |
| t-Bu | CH₃ | F | Cl | Br | t-Bu | CH₃ | Cl | Cl | Br | t-Bu | Cl | CF₃ | CF₃ | Cl |
| Me | CH₃ | F | Br | Cl | Me | CH₃ | Cl | Br | Cl | Me | Cl | CF₃ | CF₃ | Br |
| Et | CH₃ | F | Br | Cl | Et | CH₃ | Cl | Br | Cl | Et | Cl | CF₃ | CF₃ | Br |
| i-Pr | CH₃ | F | Br | Cl | i-Pr | CH₃ | Cl | Br | Cl | i-Pr | Cl | CF₃ | CF₃ | Br |
| t-Bu | CH₃ | F | Br | Cl | t-Bu | CH₃ | Cl | Br | Cl | t-Bu | Cl | CF₃ | CF₃ | Br |
| Me | CH₃ | F | Br | Br | Me | CH₃ | Cl | Br | Br | Me | Cl | CF₃ | Cl | Cl |
| Et | CH₃ | F | Br | Br | Et | CH₃ | Cl | Br | Br | Et | Cl | CF₃ | Cl | Cl |
| i-Pr | CH₃ | F | Br | Br | i-Pr | CH₃ | Cl | Br | Br | i-Pr | Cl | CF₃ | Cl | Cl |
| t-Bu | CH₃ | F | Br | Br | t-Bu | CH₃ | Cl | Br | Br | t-Bu | Cl | CF₃ | Cl | Cl |
| Me | CH₃ | Br | CF₃ | Cl | Me | Cl | F | CF₃ | Cl | Me | Cl | CF₃ | Cl | Br |
| Et | CH₃ | Br | CF₃ | Cl | Et | Cl | F | CF₃ | Cl | Et | Cl | CF₃ | Cl | Br |
| i-Pr | CH₃ | Br | CF₃ | Cl | i-Pr | Cl | F | CF₃ | Cl | i-Pr | Cl | CF₃ | Cl | Br |
| t-Bu | CH₃ | Br | CF₃ | Cl | t-Bu | Cl | F | CF₃ | Cl | t-Bu | Cl | CF₃ | Cl | Br |
| Me | CH₃ | Br | CF₃ | Br | Me | Cl | F | CF₃ | Br | Me | Cl | CF₃ | Br | Cl |
| Et | CH₃ | Br | CF₃ | Br | Et | Cl | F | CF₃ | Br | Et | Cl | CF₃ | Br | Cl |
| i-Pr | CH₃ | Br | CF₃ | Br | i-Pr | Cl | F | CF₃ | Br | i-Pr | Cl | CF₃ | Br | Cl |
| t-Bu | CH₃ | Br | CF₃ | Br | t-Bu | Cl | F | CF₃ | Br | t-Bu | Cl | CF₃ | Br | Cl |
| Me | CH₃ | Br | Cl | Cl | Me | Cl | F | Cl | Cl | Me | Cl | CF₃ | Br | Br |
| Et | CH₃ | Br | Cl | Cl | Et | Cl | F | Cl | Cl | Et | Cl | CF₃ | Br | Br |
| i-Pr | CH₃ | Br | Cl | Cl | i-Pr | Cl | F | Cl | Cl | i-Pr | Cl | CF₃ | Br | Br |
| t-Bu | CH₃ | Br | Cl | Cl | t-Bu | Cl | F | Cl | Cl | t-Bu | Cl | CF₃ | Br | Br |
| Me | CH₃ | Br | Cl | Br | Me | Cl | F | Cl | Br | n-Pr | Cl | Cl | Cl | Cl |
| Et | CH₃ | Br | Cl | Br | Et | Cl | F | Cl | Br | n-Bu | Cl | Cl | Cl | Cl |
| i-Pr | CH₃ | Br | Cl | Br | i-Pr | Cl | F | Cl | Br | s-Bu | Cl | Cl | Cl | Cl |
| t-Bu | CH₃ | Br | Cl | Br | t-Bu | Cl | F | Cl | Br | t-Bu | Cl | Cl | Cl | Cl |
| Me | CH₃ | Br | Br | Cl | Me | Cl | F | Br | Cl | Me | Br | F | CF₃ | Cl |
| Et | CH₃ | Br | Br | Cl | Et | Cl | F | Br | Cl | Et | Br | F | CF₃ | Cl |
| i-Pr | CH₃ | Br | Br | Cl | i-Pr | Cl | F | Br | Cl | i-Pr | Br | F | CF₃ | Cl |
| t-Bu | CH₃ | Br | Br | Cl | t-Bu | Cl | F | Br | Cl | t-Bu | Br | F | CF₃ | Cl |
| Me | CH₃ | Br | Br | Br | Me | Cl | F | Br | Br | Me | Br | F | CF₃ | Br |
| Et | CH₃ | Br | Br | Br | Et | Cl | F | Br | Br | Et | Br | F | CF₃ | Br |
| i-Pr | CH₃ | Br | Br | Br | i-Pr | Cl | F | Br | Br | i-Pr | Br | F | CF₃ | Br |
| t-Bu | CH₃ | Br | Br | Br | t-Bu | Cl | F | Br | Br | t-Bu | Br | F | CF₃ | Br |
| Me | CH₃ | I | CF₃ | Cl | Me | Cl | Cl | CF₃ | Cl | Me | Br | F | Cl | Cl |
| Et | CH₃ | I | CF₃ | Cl | Et | Cl | Cl | CF₃ | Cl | Et | Br | F | Cl | Cl |
| i-Pr | CH₃ | I | CF₃ | Cl | i-Pr | Cl | Cl | CF₃ | Cl | i-Pr | Br | F | Cl | Cl |
| t-Bu | CH₃ | I | CF₃ | Cl | t-Bu | Cl | Cl | CF₃ | Cl | t-Bu | Br | F | Cl | Cl |
| Me | CH₃ | I | CF₃ | Br | Me | Cl | Cl | CF₃ | Br | Me | Br | F | Cl | Br |
| Et | CH₃ | I | CF₃ | Br | Et | Cl | Cl | CF₃ | Br | Et | Br | F | Cl | Br |
| i-Pr | CH₃ | I | CF₃ | Br | i-Pr | Cl | Cl | CF₃ | Br | i-Pr | Br | F | Cl | Br |
| t-Bu | CH₃ | I | CF₃ | Br | t-Bu | Cl | Cl | CF₃ | Br | t-Bu | Br | F | Cl | Br |
| Me | CH₃ | I | Cl | Cl | Me | Cl | Cl | Cl | Cl | Me | Br | F | Br | Cl |
| Et | CH₃ | I | Cl | Cl | Et | Cl | Cl | Cl | Cl | Et | Br | F | Br | Cl |
| i-Pr | CH₃ | I | Cl | Cl | i-Pr | Cl | Cl | Cl | Cl | i-Pr | Br | F | Br | Cl |
| t-Bu | CH₃ | I | Cl | Cl | t-Bu | Cl | Cl | Cl | Cl | t-Bu | Br | F | Br | Cl |
| Me | CH₃ | I | Cl | Br | Me | Cl | Cl | Cl | Br | Me | Br | F | Br | Br |
| Et | CH₃ | I | Cl | Br | Et | Cl | Cl | Cl | Br | Et | Br | F | Br | Br |
| i-Pr | CH₃ | I | Cl | Br | i-Pr | Cl | Cl | Cl | Br | i-Pr | Br | F | Br | Br |
| t-Bu | CH₃ | I | Cl | Br | t-Bu | Cl | Cl | Cl | Br | t-Bu | Br | F | Br | Br |
| Me | CH₃ | I | Br | Cl | Me | Br | CF₃ | CF₃ | Cl | Me | Br | Cl | CF₃ | Cl |
| Et | CH₃ | I | Br | Cl | Et | Br | CF₃ | CF₃ | Cl | Et | Br | Cl | CF₃ | Cl |
| i-Pr | CH₃ | I | Br | Cl | i-Pr | Br | CF₃ | CF₃ | Cl | i-Pr | Br | Cl | CF₃ | Cl |
| t-Bu | CH₃ | I | Br | Cl | t-Bu | Br | CF₃ | CF₃ | Cl | t-Bu | Br | Cl | CF₃ | Cl |
| Me | CH₃ | I | Br | Br | Me | Br | CF₃ | CF₃ | Br | Me | Br | Cl | CF₃ | Br |
| Et | CH₃ | I | Br | Br | Et | Br | CF₃ | CF₃ | Br | Et | Br | Cl | CF₃ | Br |
| i-Pr | CH₃ | I | Br | Br | i-Pr | Br | CF₃ | CF₃ | Br | i-Pr | Br | Cl | CF₃ | Br |
| t-Bu | CH₃ | I | Br | Br | t-Bu | Br | CF₃ | CF₃ | Br | t-Bu | Br | Cl | CF₃ | Br |
| Me | CH₃ | CF₃ | CF₃ | Cl | Me | Br | CF₃ | Cl | Cl | Me | Br | Cl | Cl | Cl |
| Et | CH₃ | CF₃ | CF₃ | Cl | Et | Br | CF₃ | Cl | Cl | Et | Br | Cl | Cl | Cl |
| i-Pr | CH₃ | CF₃ | CF₃ | Cl | i-Pr | Br | CF₃ | Cl | Cl | i-Pr | Br | Cl | Cl | Cl |
| t-Bu | CH₃ | CF₃ | CF₃ | Cl | t-Bu | Br | CF₃ | Cl | Cl | t-Bu | Br | Cl | Cl | Cl |
| Me | CH₃ | CF₃ | CF₃ | Br | Me | Br | CF₃ | Cl | Br | Me | Br | Cl | Cl | Br |
| Et | CH₃ | CF₃ | CF₃ | Br | Et | Br | CF₃ | Cl | Br | Et | Br | Cl | Cl | Br |
| i-Pr | CH₃ | CF₃ | CF₃ | Br | i-Pr | Br | CF₃ | Cl | Br | i-Pr | Br | Cl | Cl | Br |
| t-Bu | CH₃ | CF₃ | CF₃ | Br | t-Bu | Br | CF₃ | Cl | Br | t-Bu | Br | Cl | Cl | Br |
| Me | CH₃ | CF₃ | Cl | Cl | Me | Br | CF₃ | Br | Cl | Me | Br | Cl | Br | Cl |
| Et | CH₃ | CF₃ | Cl | Cl | Et | Br | CF₃ | Br | Cl | Et | Br | Cl | Br | Cl |
| i-Pr | CH₃ | CF₃ | Cl | Cl | i-Pr | Br | CF₃ | Br | Cl | i-Pr | Br | Cl | Br | Cl |
| t-Bu | CH₃ | CF₃ | Cl | Cl | t-Bu | Br | CF₃ | Br | Cl | t-Bu | Br | Cl | Br | Cl |
| Me | CH₃ | CF₃ | Cl | Br | Me | Br | CF₃ | Br | Br | Me | Br | Cl | Br | Br |
| Et | CH₃ | CF₃ | Cl | Br | Et | Br | CF₃ | Br | Br | Et | Br | Cl | Br | Br |
| i-Pr | CH₃ | CF₃ | Cl | Br | i-Pr | Br | CF₃ | Br | Br | i-Pr | Br | Cl | Br | Br |
| t-Bu | CH₃ | CF₃ | Cl | Br | t-Bu | Br | CF₃ | Br | Br | t-Bu | Br | Cl | Br | Br |
| Me | CH₃ | CF₃ | Br | Cl | Me | Br | I | CF₃ | Cl | Me | Br | Br | CF₃ | Cl |
| Et | CH₃ | CF₃ | Br | Cl | Et | Br | I | CF₃ | Cl | Et | Br | Br | CF₃ | Cl |
| i-Pr | CH₃ | CF₃ | Br | Cl | i-Pr | Br | I | CF₃ | Cl | i-Pr | Br | Br | CF₃ | Cl |
| t-Bu | CH₃ | CF₃ | Br | Cl | t-Bu | Br | I | CF₃ | Cl | t-Bu | Br | Br | CF₃ | Cl |
| Me | CH₃ | CF₃ | Br | Br | Me | Br | I | CF₃ | Br | Me | Br | Br | CF₃ | Br |
| Et | CH₃ | CF₃ | Br | Br | Et | Br | I | CF₃ | Br | Et | Br | Br | CF₃ | Br |
| i-Pr | CH₃ | CF₃ | Br | Br | i-Pr | Br | I | CF₃ | Br | i-Pr | Br | Br | CF₃ | Br |
| t-Bu | CH₃ | CF₃ | Br | Br | t-Bu | Br | I | CF₃ | Br | t-Bu | Br | Br | CF₃ | Br |
| i-Pr | CH₃ | Cl | Cl | Cl | Me | Br | I | Cl | Cl | Me | Br | Br | Cl | Cl |
| t-Bu | CH₃ | Cl | Cl | Cl | Et | Br | I | Cl | Cl | Et | Br | Br | Cl | Cl |
| s-Bu | CH₃ | Cl | Cl | Cl | i-Pr | Br | I | Cl | Cl | i-Pr | Br | Br | Cl | Cl |
| t-Bu | CH₃ | Cl | Cl | Cl | t-Bu | Br | I | Cl | Cl | t-Bu | Br | Br | Cl | Cl |
| Me | Cl | Cl | Br | Cl | Me | Br | I | Cl | Br | Me | Br | Br | Cl | Br |
| Et | Cl | Cl | Br | Cl | Et | Br | I | Cl | Br | Et | Br | Br | Cl | Br |
| i-Pr | Cl | Cl | Br | Cl | i-Pr | Br | I | Cl | Br | i-Pr | Br | Br | Cl | Br |
| t-Bu | Cl | Cl | Br | Cl | t-Bu | Br | I | Cl | Br | t-Bu | Br | Br | Cl | Br |
| Me | Cl | Cl | Br | Br | Me | Br | I | Br | Cl | Me | Br | Br | Br | Cl |
| Et | Cl | Cl | Br | Br | Et | Br | I | Br | Cl | Et | Br | Br | Br | Cl |
| i-Pr | Cl | Cl | Br | Br | i-Pr | Br | I | Br | Cl | i-Pr | Br | Br | Br | Cl |
| t-Bu | Cl | Cl | Br | Br | t-Bu | Br | I | Br | Cl | t-Bu | Br | Br | Br | Cl |
| Me | Cl | Br | CF₃ | Cl | Me | Br | I | Br | Br | Me | Br | Br | Br | Br |
| Et | Cl | Br | CF₃ | Cl | Et | Br | I | Br | Br | Et | Br | Br | Br | Br |
| i-Pr | Cl | Br | CF₃ | Cl | i-Pr | Br | I | Br | Br | i-Pr | Br | Br | Br | Br |
| t-Bu | Cl | Br | CF₃ | Cl | t-Bu | Br | I | Br | Br | t-Bu | Br | Br | Br | Br |
| Me | Cl | Br | CF₃ | Br | Me | Cl | Br | Cl | Cl | t-Bu | Cl | Br | CF₃ | Br |
| Et | Cl | Br | CF₃ | Br | Et | Cl | Br | Cl | Cl | t-Bu | Cl | Br | Cl | Cl |
| i-Pr | Cl | Br | CF₃ | Br | i-Pr | Cl | Br | Cl | Cl | | | | | |

TABLE 8

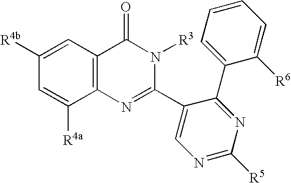

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | H | Cl | Br | Me | Cl | Br | Cl | Br |
| Et | CH₃ | H | CF₃ | Cl | Et | Cl | H | Cl | Br | Et | Cl | Br | Cl | Br |
| i-Pr | CH₃ | H | CF₃ | Cl | i-Pr | Cl | H | Cl | Br | i-Pr | Cl | Br | Cl | Br |
| t-Bu | CH₃ | H | CF₃ | Cl | t-Bu | Cl | H | Cl | Br | t-Bu | Cl | Br | Cl | Br |
| Me | CH₃ | H | CF₃ | Br | Me | Cl | H | Br | Cl | Me | Cl | Br | Br | Cl |
| Et | CH₃ | H | CF₃ | Br | Et | Cl | H | Br | Cl | Et | Cl | Br | Br | Cl |
| i-Pr | CH₃ | H | CF₃ | Br | i-Pr | Cl | H | Br | Cl | i-Pr | Cl | Br | Br | Cl |
| t-Bu | CH₃ | H | CF₃ | Br | t-Bu | Cl | H | Br | Cl | t-Bu | Cl | Br | Br | Cl |
| Me | CH₃ | H | Cl | Cl | Me | Cl | H | Br | Br | Me | Cl | Br | Br | Br |
| Et | CH₃ | H | Cl | Cl | Et | Cl | H | Br | Br | Et | Cl | Br | Br | Br |
| i-Pr | CH₃ | H | Cl | Cl | i-Pr | Cl | H | Br | Br | i-Pr | Cl | Br | Br | Br |
| t-Bu | CH₃ | H | Cl | Cl | t-Bu | Cl | H | Br | Br | t-Bu | Cl | Br | Br | Br |
| Me | CH₃ | H | Cl | Br | Me | Cl | H | CF₃ | Cl | Me | Cl | I | CF₃ | Cl |
| Et | CH₃ | H | Cl | Br | Et | Cl | H | CF₃ | Cl | Et | Cl | I | CF₃ | Cl |
| i-Pr | CH₃ | H | Cl | Br | i-Pr | Cl | H | CF₃ | Cl | i-Pr | Cl | I | CF₃ | Cl |
| t-Bu | CH₃ | H | Cl | Br | t-Bu | Cl | H | CF₃ | Cl | t-Bu | Cl | I | CF₃ | Cl |
| Me | CH₃ | H | Br | Cl | Me | Cl | H | CF₃ | Br | Me | Cl | I | CF₃ | Br |
| Et | CH₃ | H | Br | Cl | Et | Cl | H | CF₃ | Br | Et | Cl | I | CF₃ | Br |
| i-Pr | CH₃ | H | Br | Cl | i-Pr | Cl | H | CF₃ | Br | i-Pr | Cl | I | CF₃ | Br |
| t-Bu | CH₃ | H | Br | Cl | t-Bu | Cl | H | CF₃ | Br | t-Bu | Cl | I | CF₃ | Br |
| Me | CH₃ | H | Br | Br | Me | Cl | H | Cl | Cl | Me | Cl | I | Cl | Cl |
| Et | CH₃ | H | Br | Br | Et | Cl | H | Cl | Cl | Et | Cl | I | Cl | Cl |
| i-Pr | CH₃ | H | Br | Br | i-Pr | Cl | H | Cl | Cl | i-Pr | Cl | I | Cl | Cl |
| t-Bu | CH₃ | H | Br | Br | i-Pr | Cl | H | Cl | Cl | t-Bu | Cl | I | Cl | Cl |
| Me | CH₃ | F | CF₃ | Cl | Me | CH₃ | Cl | CF₃ | Cl | Me | Cl | I | Cl | Br |
| Et | CH₃ | F | CF₃ | Cl | Et | CH₃ | Cl | CF₃ | Cl | Et | Cl | I | Cl | Br |
| i-Pr | CH₃ | F | CF₃ | Cl | i-Pr | CH₃ | Cl | CF₃ | Cl | i-Pr | Cl | I | Cl | Br |
| t-Bu | CH₃ | F | CF₃ | Cl | t-Bu | CH₃ | Cl | CF₃ | Cl | t-Bu | Cl | I | Cl | Br |
| Me | CH₃ | F | CF₃ | Br | Me | CH₃ | Cl | CF₃ | Br | Me | Cl | I | Br | Cl |
| Et | CH₃ | F | CF₃ | Br | Et | CH₃ | Cl | CF₃ | Br | Et | Cl | I | Br | Cl |
| i-Pr | CH₃ | F | CF₃ | Br | i-Pr | CH₃ | Cl | CF₃ | Br | i-Pr | Cl | I | Br | Cl |
| t-Bu | CH₃ | F | CF₃ | Br | t-Bu | CH₃ | Cl | CF₃ | Br | t-Bu | Cl | I | Br | Cl |
| Me | CH₃ | F | Cl | Cl | Me | CH₃ | Cl | Cl | Cl | Me | Cl | I | Br | Br |
| Et | CH₃ | F | Cl | Cl | Et | CH₃ | Cl | Cl | Cl | Et | Cl | I | Br | Br |
| i-Pr | CH₃ | F | Cl | Cl | i-Pr | CH₃ | Cl | Cl | Cl | i-Pr | Cl | I | Br | Br |
| t-Bu | CH₃ | F | Cl | Cl | t-Bu | CH₃ | Cl | Cl | Cl | t-Bu | Cl | I | Br | Br |
| Me | CH₃ | F | Cl | Br | Me | CH₃ | Cl | Cl | Br | Me | Cl | CF₃ | CF₃ | Cl |
| Et | CH₃ | F | Cl | Br | Et | CH₃ | Cl | Cl | Br | Et | Cl | CF₃ | CF₃ | Cl |
| i-Pr | CH₃ | F | Cl | Br | i-Pr | CH₃ | Cl | Cl | Br | i-Pr | Cl | CF₃ | CF₃ | Cl |
| t-Bu | CH₃ | F | Cl | Br | t-Bu | CH₃ | Cl | Cl | Br | t-Bu | Cl | CF₃ | CF₃ | Cl |
| Me | CH₃ | F | Br | Cl | Me | CH₃ | Cl | Br | Cl | Me | Cl | CF₃ | CF₃ | Br |
| Et | CH₃ | F | Br | Cl | Et | CH₃ | Cl | Br | Cl | Et | Cl | CF₃ | CF₃ | Br |
| i-Pr | CH₃ | F | Br | Cl | i-Pr | CH₃ | Cl | Br | Cl | i-Pr | Cl | CF₃ | CF₃ | Br |
| t-Bu | CH₃ | F | Br | Cl | t-Bu | CH₃ | Cl | Br | Cl | t-Bu | Cl | CF₃ | CF₃ | Br |
| Me | CH₃ | F | Br | Br | Me | CH₃ | Cl | Br | Br | Me | Cl | CF₃ | Cl | Cl |
| Et | CH₃ | F | Br | Br | Et | CH₃ | Cl | Br | Br | Et | Cl | CF₃ | Cl | Cl |
| i-Pr | CH₃ | F | Br | Br | i-Pr | CH₃ | Cl | Br | Br | i-Pr | Cl | CF₃ | Cl | Cl |
| t-Bu | CH₃ | F | Br | Br | t-Bu | CH₃ | Cl | Br | Br | t-Bu | Cl | CF₃ | Cl | Cl |
| Me | CH₃ | Br | CF₃ | Cl | Me | Cl | F | CF₃ | Cl | Me | Cl | CF₃ | Cl | Br |
| Et | CH₃ | Br | CF₃ | Cl | Et | Cl | F | CF₃ | Cl | Et | Cl | CF₃ | Cl | Br |
| i-Pr | CH₃ | Br | CF₃ | Cl | i-Pr | Cl | F | CF₃ | Cl | i-Pr | Cl | CF₃ | Cl | Br |
| t-Bu | CH₃ | Br | CF₃ | Cl | t-Bu | Cl | F | CF₃ | Cl | t-Bu | Cl | CF₃ | Cl | Br |
| Me | CH₃ | Br | CF₃ | Br | Me | Cl | F | CF₃ | Br | Me | Cl | CF₃ | Br | Cl |
| Et | CH₃ | Br | CF₃ | Br | Et | Cl | F | CF₃ | Br | Et | Cl | CF₃ | Br | Cl |
| i-Pr | CH₃ | Br | CF₃ | Br | i-Pr | Cl | F | CF₃ | Br | i-Pr | Cl | CF₃ | Br | Cl |
| t-Bu | CH₃ | Br | CF₃ | Br | t-Bu | Cl | F | CF₃ | Br | t-Bu | Cl | CF₃ | Br | Cl |
| Me | CH₃ | Br | Cl | Cl | Me | Cl | F | Cl | Cl | Me | Cl | CF₃ | Br | Br |
| Et | CH₃ | Br | Cl | Cl | Et | Cl | F | Cl | Cl | Et | Cl | CF₃ | Br | Br |
| i-Pr | CH₃ | Br | Cl | Cl | i-Pr | Cl | F | Cl | Cl | i-Pr | Cl | CF₃ | Br | Br |
| t-Bu | CH₃ | Br | Cl | Cl | t-Bu | Cl | F | Cl | Cl | t-Bu | Cl | CF₃ | Br | Br |
| Me | CH₃ | Br | Cl | Br | Me | Cl | F | Cl | Br | n-Pr | Cl | Cl | Cl | Cl |
| Et | CH₃ | Br | Cl | Br | Et | Cl | F | Cl | Br | n-Bu | Cl | Cl | Cl | Cl |
| i-Pr | CH₃ | Br | Cl | Br | i-Pr | Cl | F | Cl | Br | s-Bu | Cl | Cl | Cl | Cl |
| t-Bu | CH₃ | Br | Cl | Br | t-Bu | Cl | F | Cl | Br | i-Bu | Cl | Cl | Cl | Cl |
| Me | CH₃ | Br | Br | Cl | Me | Cl | F | Br | Cl | Me | Br | F | CF₃ | Cl |
| Et | CH₃ | Br | Br | Cl | Et | Cl | F | Br | Cl | Et | Br | F | CF₃ | Cl |
| i-Pr | CH₃ | Br | Br | Cl | i-Pr | Cl | F | Br | Cl | i-Pr | Br | F | CF₃ | Cl |
| t-Bu | CH₃ | Br | Br | Cl | t-Bu | Cl | F | Br | Cl | t-Bu | Br | F | CF₃ | Cl |
| Me | CH₃ | Br | Br | Br | Me | Cl | F | Br | Br | Me | Br | F | CF₃ | Br |
| Et | CH₃ | Br | Br | Br | Et | Cl | F | Br | Br | Et | Br | F | CF₃ | Br |
| i-Pr | CH₃ | Br | Br | Br | i-Pr | Cl | F | Br | Br | i-Pr | Br | F | CF₃ | Br |
| t-Bu | CH₃ | Br | Br | Br | t-Bu | Cl | F | Br | Br | t-Bu | Br | F | CF₃ | Br |
| Me | CH₃ | I | CF₃ | Cl | Me | Cl | Cl | CF₃ | Cl | Me | Br | F | Cl | Cl |
| Et | CH₃ | I | CF₃ | Cl | Et | Cl | Cl | CF₃ | Cl | Et | Br | F | Cl | Cl |
| i-Pr | CH₃ | I | CF₃ | Cl | i-Pr | Cl | Cl | CF₃ | Cl | i-Pr | Br | F | Cl | Cl |
| t-Bu | CH₃ | I | CF₃ | Cl | t-Bu | Cl | Cl | CF₃ | Cl | t-Bu | Br | F | Cl | Cl |
| Me | CH₃ | I | CF₃ | Br | Me | Cl | Cl | CF₃ | Br | Me | Br | F | Cl | Br |
| Et | CH₃ | I | CF₃ | Br | Et | Cl | Cl | CF₃ | Br | Et | Br | F | Cl | Br |
| i-Pr | CH₃ | I | CF₃ | Br | i-Pr | Cl | Cl | CF₃ | Br | i-Pr | Br | F | Cl | Br |
| t-Bu | CH₃ | I | CF₃ | Br | t-Bu | Cl | Cl | CF₃ | Br | t-Bu | Br | F | Cl | Br |
| Me | CH₃ | I | Cl | Cl | Me | Cl | Cl | Cl | Cl | Me | Br | F | Br | Cl |
| Et | CH₃ | I | Cl | Cl | Et | Cl | Cl | Cl | Cl | Et | Br | F | Br | Cl |
| i-Pr | CH₃ | I | Cl | Cl | i-Pr | Cl | Cl | Cl | Cl | i-Pr | Br | F | Br | Cl |
| t-Bu | CH₃ | I | Cl | Cl | t-Bu | Cl | Cl | Cl | Cl | t-Bu | Br | F | Br | Cl |
| Me | CH₃ | I | Cl | Br | Me | Cl | Cl | Cl | Br | Me | Br | F | Br | Br |
| Et | CH₃ | I | Cl | Br | Et | Cl | Cl | Cl | Br | Et | Br | F | Br | Br |
| i-Pr | CH₃ | I | Cl | Br | i-Pr | Cl | Cl | Cl | Br | i-Pr | Br | F | Br | Br |
| t-Bu | CH₃ | I | Cl | Br | t-Bu | Cl | Cl | Cl | Br | t-Bu | Br | F | Br | Br |
| Me | CH₃ | I | Br | Cl | Me | Br | CF₃ | CF₃ | Cl | Me | Br | Cl | CF₃ | Cl |
| Et | CH₃ | I | Br | Cl | Et | Br | CF₃ | CF₃ | Cl | Et | Br | Cl | CF₃ | Cl |
| i-Pr | CH₃ | I | Br | Cl | i-Pr | Br | CF₃ | CF₃ | Cl | i-Pr | Br | Cl | CF₃ | Cl |
| t-Bu | CH₃ | I | Br | Cl | t-Bu | Br | CF₃ | CF₃ | Cl | t-Bu | Br | Cl | CF₃ | Cl |
| Me | CH₃ | I | Br | Br | Me | Br | CF₃ | CF₃ | Br | Me | Br | Cl | CF₃ | Br |
| Et | CH₃ | I | Br | Br | Et | Br | CF₃ | CF₃ | Br | Et | Br | Cl | CF₃ | Br |
| i-Pr | CH₃ | I | Br | Br | i-Pr | Br | CF₃ | CF₃ | Br | i-Pr | Br | Cl | CF₃ | Br |
| t-Bu | CH₃ | I | Br | Br | t-Bu | Br | CF₃ | CF₃ | Br | t-Bu | Br | Cl | CF₃ | Br |
| Me | CH₃ | CF₃ | CF₃ | Cl | Me | Br | CF₃ | Cl | Cl | Me | Br | Cl | Cl | Cl |
| Et | CH₃ | CF₃ | CF₃ | Cl | Et | Br | CF₃ | Cl | Cl | Et | Br | Cl | Cl | Cl |
| i-Pr | CH₃ | CF₃ | CF₃ | Cl | i-Pr | Br | CF₃ | Cl | Cl | i-Pr | Br | Cl | Cl | Cl |
| t-Bu | CH₃ | CF₃ | CF₃ | Cl | t-Bu | Br | CF₃ | Cl | Cl | t-Bu | Br | Cl | Cl | Cl |
| Me | CH₃ | CF₃ | CF₃ | Br | Me | Br | CF₃ | Cl | Br | Me | Br | Cl | Cl | Br |
| Et | CH₃ | CF₃ | CF₃ | Br | Et | Br | CF₃ | Cl | Br | Et | Br | Cl | Cl | Br |
| i-Pr | CH₃ | CF₃ | CF₃ | Br | i-Pr | Br | CF₃ | Cl | Br | i-Pr | Br | Cl | Cl | Br |
| t-Bu | CH₃ | CF₃ | CF₃ | Br | t-Bu | Br | CF₃ | Cl | Br | t-Bu | Br | Cl | Cl | Br |
| Me | CH₃ | CF₃ | Cl | Cl | Me | Br | CF₃ | Br | Cl | Me | Br | Cl | Br | Cl |
| Et | CH₃ | CF₃ | Cl | Cl | Et | Br | CF₃ | Br | Cl | Et | Br | Cl | Br | Cl |
| i-Pr | CH₃ | CF₃ | Cl | Cl | i-Pr | Br | CF₃ | Br | Cl | i-Pr | Br | Cl | Br | Cl |
| t-Bu | CH₃ | CF₃ | Cl | Cl | t-Bu | Br | CF₃ | Br | Cl | t-Bu | Br | Cl | Br | Cl |
| Me | CH₃ | CF₃ | Cl | Br | Me | Br | CF₃ | Br | Br | Me | Br | Cl | Br | Br |
| Et | CH₃ | CF₃ | Cl | Br | Et | Br | CF₃ | Br | Br | Et | Br | Cl | Br | Br |
| i-Pr | CH₃ | CF₃ | Cl | Br | i-Pr | Br | CF₃ | Br | Br | i-Pr | Br | Cl | Br | Br |
| t-Bu | CH₃ | CF₃ | Cl | Br | t-Bu | Br | CF₃ | Br | Br | t-Bu | Br | Cl | Br | Br |
| Me | CH₃ | CF₃ | Br | Cl | Me | Br | I | CF₃ | Cl | Me | Br | Br | CF₃ | Cl |
| Et | CH₃ | CF₃ | Br | Cl | Et | Br | I | CF₃ | Cl | Et | Br | Br | CF₃ | Cl |
| i-Pr | CH₃ | CF₃ | Br | Cl | i-Pr | Br | I | CF₃ | Cl | i-Pr | Br | Br | CF₃ | Cl |
| t-Bu | CH₃ | CF₃ | Br | Cl | t-Bu | Br | I | CF₃ | Cl | t-Bu | Br | Br | CF₃ | Cl |
| Me | CH₃ | CF₃ | Br | Br | Me | Br | I | CF₃ | Br | Me | Br | Br | CF₃ | Br |
| Et | CH₃ | CF₃ | Br | Br | Et | Br | I | CF₃ | Br | Et | Br | Br | CF₃ | Br |
| i-Pr | CH₃ | CF₃ | Br | Br | i-Pr | Br | I | CF₃ | Br | i-Pr | Br | Br | CF₃ | Br |
| t-Bu | CH₃ | CF₃ | Br | Br | t-Bu | Br | I | CF₃ | Br | t-Bu | Br | Br | CF₃ | Br |
| n-Pr | CH₃ | Cl | Cl | Cl | Me | Br | I | Cl | Cl | Me | Br | Br | Cl | Cl |
| n-Bu | CH₃ | Cl | Cl | Cl | Et | Br | I | Cl | Cl | Et | Br | Br | Cl | Cl |
| s-Bu | CH₃ | Cl | Cl | Cl | i-Pr | Br | I | Cl | Cl | i-Pr | Br | Br | Cl | Cl |
| i-Bu | CH₃ | Cl | Cl | Cl | t-Bu | Br | I | Cl | Cl | t-Bu | Br | Br | Cl | Cl |
| Me | Cl | Cl | Br | Cl | Me | Br | I | Cl | Br | Me | Br | Br | Cl | Br |
| Et | Cl | Cl | Br | Cl | Et | Br | I | Cl | Br | Et | Br | Br | Cl | Br |
| i-Pr | Cl | Cl | Br | Cl | i-Pr | Br | I | Cl | Br | i-Pr | Br | Br | Cl | Br |
| t-Bu | Cl | Cl | Br | Cl | t-Bu | Br | I | Cl | Br | t-Bu | Br | Br | Cl | Br |
| Me | Cl | Cl | Br | Br | Me | Br | I | Br | Cl | Me | Br | Br | Br | Cl |
| Et | Cl | Cl | Br | Br | Et | Br | I | Br | Cl | Et | Br | Br | Br | Cl |
| i-Pr | Cl | Cl | Br | Br | i-Pr | Br | I | Br | Cl | i-Pr | Br | Br | Br | Cl |
| t-Bu | Cl | Cl | Br | Br | t-Bu | Br | I | Br | Cl | t-Bu | Br | Br | Br | Cl |
| Me | Cl | Br | CF₃ | Cl | Me | Br | I | Br | Br | Me | Br | Br | Br | Br |
| Et | Cl | Br | CF₃ | Cl | Et | Br | I | Br | Br | Et | Br | Br | Br | Br |
| i-Pr | Cl | Br | CF₃ | Cl | i-Pr | Br | I | Br | Br | i-Pr | Br | Br | Br | Br |
| t-Bu | Cl | Br | CF₃ | Cl | t-Bu | Br | I | Br | Br | t-Bu | Br | Br | Br | Br |
| Me | Cl | Br | CF₃ | Br | Me | Cl | Br | Cl | Cl | t-Bu | Cl | Br | CF₃ | Br |
| Et | Cl | Br | CF₃ | Br | Et | Cl | Br | Cl | Cl | t-Bu | Cl | Br | Cl | Cl |
| i-Pr | Cl | Br | CF₃ | Br | i-Pr | Cl | Br | Cl | Cl | | | | | |

TABLE 9

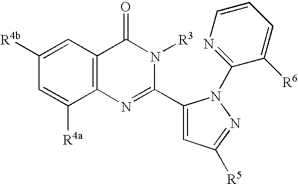

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | F | CF₃ | Cl | Me | Cl | H | Cl | Br |
| Et | CH₃ | H | CF₃ | Cl | Et | Cl | F | CF₃ | Cl | Et | Cl | H | Cl | Br |
| i-Pr | CH₃ | H | CF₃ | Cl | i-Pr | Cl | F | CF₃ | Cl | i-Pr | Cl | H | Cl | Br |
| t-Bu | CH₃ | H | CF₃ | Cl | t-Bu | Cl | F | CF₃ | Cl | t-Bu | Cl | H | Cl | Br |
| Me | CH₃ | H | CF₃ | Br | Me | Cl | F | CF₃ | Br | Me | Cl | H | Br | Cl |
| Et | CH₃ | H | CF₃ | Br | Et | Cl | F | CF₃ | Br | Et | Cl | H | Br | Cl |
| i-Pr | CH₃ | H | CF₃ | Br | i-Pr | Cl | F | CF₃ | Br | i-Pr | Cl | H | Br | Cl |
| t-Bu | CH₃ | H | CF₃ | Br | t-Bu | Cl | F | CF₃ | Br | t-Bu | Cl | H | Br | Cl |
| Me | CH₃ | H | Cl | Cl | Me | Cl | F | Cl | Cl | Me | Cl | H | Br | Br |
| Et | CH₃ | H | Cl | Cl | Et | Cl | F | Cl | Cl | Et | Cl | H | Br | Br |
| i-Pr | CH₃ | H | Cl | Cl | i-Pr | Cl | F | Cl | Cl | i-Pr | Cl | H | Br | Br |
| t-Bu | CH₃ | H | Cl | Cl | t-Bu | Cl | F | Cl | Cl | t-Bu | Cl | H | Br | Br |
| Me | CH₃ | H | Cl | Br | Me | Cl | F | Cl | Br | Me | Cl | H | CF₃ | Cl |
| Et | CH₃ | H | Cl | Br | Et | Cl | F | Cl | Br | Et | Cl | H | CF₃ | Cl |
| i-Pr | CH₃ | H | Cl | Br | i-Pr | Cl | F | Cl | Br | i-Pr | Cl | H | CF₃ | Cl |
| t-Bu | CH₃ | H | Cl | Br | t-Bu | Cl | F | Cl | Br | t-Bu | Cl | H | CF₃ | Cl |
| Me | CH₃ | H | Br | Cl | Me | Cl | F | Br | Cl | Me | Cl | H | CF₃ | Br |
| Et | CH₃ | H | Br | Cl | Et | Cl | F | Br | Cl | Et | Cl | H | CF₃ | Br |
| i-Pr | CH₃ | H | Br | Cl | i-Pr | Cl | F | Br | Cl | i-Pr | Cl | H | CF₃ | Br |
| t-Bu | CH₃ | H | Br | Cl | t-Bu | Cl | F | Br | Cl | t-Bu | Cl | H | CF₃ | Br |
| Me | CH₃ | H | Br | Br | Me | Cl | F | Br | Br | Me | Cl | H | Cl | Cl |
| Et | CH₃ | H | Br | Br | Et | Cl | F | Br | Br | Et | Cl | H | Cl | Cl |
| i-Pr | CH₃ | H | Br | Br | i-Pr | Cl | F | Br | Br | i-Pr | Cl | H | Cl | Cl |
| t-Bu | CH₃ | H | Br | Br | t-Bu | Cl | F | Br | Br | i-Pr | Cl | H | Cl | Cl |
| Me | CH₃ | F | CF₃ | Cl | Me | Cl | Cl | CF₃ | Cl | Me | Cl | Br | Cl | Br |
| Et | CH₃ | F | CF₃ | Cl | Et | Cl | Cl | CF₃ | Cl | Et | Cl | Br | Cl | Br |
| i-Pr | CH₃ | F | CF₃ | Cl | i-Pr | Cl | Cl | CF₃ | Cl | i-Pr | Cl | Br | Cl | Br |
| t-Bu | CH₃ | F | CF₃ | Cl | t-Bu | Cl | Cl | CF₃ | Cl | t-Bu | Cl | Br | Cl | Br |
| Me | CH₃ | F | CF₃ | Br | Me | Cl | Cl | CF₃ | Br | Me | Cl | Br | Br | Cl |
| Et | CH₃ | F | CF₃ | Br | Et | Cl | Cl | CF₃ | Br | Et | Cl | Br | Br | Cl |
| i-Pr | CH₃ | F | CF₃ | Br | i-Pr | Cl | Cl | CF₃ | Br | i-Pr | Cl | Br | Br | Cl |
| t-Bu | CH₃ | F | CF₃ | Br | t-Bu | Cl | Cl | CF₃ | Br | t-Bu | Cl | Br | Br | Cl |
| Me | CH₃ | F | Cl | Cl | Me | Cl | Cl | Cl | Cl | Me | Cl | Br | Br | Br |
| Et | CH₃ | F | Cl | Cl | Et | Cl | Cl | Cl | Cl | Et | Cl | Br | Br | Br |
| i-Pr | CH₃ | F | Cl | Cl | i-Pr | Cl | Cl | Cl | Cl | i-Pr | Cl | Br | Br | Br |
| t-Bu | CH₃ | F | Cl | Cl | t-Bu | Cl | Cl | Cl | Cl | t-Bu | Cl | Br | Br | Br |
| Me | CH₃ | F | Cl | Br | Me | Cl | Cl | Cl | Br | Me | Cl | I | CF₃ | Cl |
| Et | CH₃ | F | Cl | Br | Et | Cl | Cl | Cl | Br | Et | Cl | I | CF₃ | Cl |
| i-Pr | CH₃ | F | Cl | Br | i-Pr | Cl | Cl | Cl | Br | i-Pr | Cl | I | CF₃ | Cl |
| i-Bu | CH₃ | F | Cl | Br | t-Bu | Cl | Cl | Cl | Br | t-Bu | Cl | I | CF₃ | Cl |
| Me | CH₃ | F | Br | Cl | Me | Cl | Cl | Br | Cl | Me | Cl | I | CF₃ | Br |
| Et | CH₃ | F | Br | Cl | Et | Cl | Cl | Br | Cl | Et | Cl | I | CF₃ | Br |
| i-Pr | CH₃ | F | Br | Cl | i-Pr | Cl | Cl | Br | Cl | i-Pr | Cl | I | CF₃ | Br |
| t-Bu | CH₃ | F | Br | Cl | t-Bu | Cl | Cl | Br | Cl | t-Bu | Cl | I | CF₃ | Br |
| Me | CH₃ | F | Br | Br | Me | Cl | Cl | Br | Br | Me | Cl | I | Cl | Cl |
| Et | CH₃ | F | Br | Br | Et | Cl | Cl | Br | Br | Et | Cl | I | Cl | Cl |
| i-Pr | CH₃ | F | Br | Br | i-Pr | Cl | Cl | Br | Br | i-Pr | Cl | I | Cl | Cl |
| t-Bu | CH₃ | F | Br | Br | t-Bu | Cl | Cl | Br | Br | t-Bu | Cl | I | Cl | Cl |
| Me | CH₃ | Cl | CF₃ | Cl | Me | Cl | Br | CF₃ | Cl | Me | Cl | I | Cl | Br |
| Et | CH₃ | Cl | CF₃ | Cl | Et | Cl | Br | CF₃ | Cl | Et | Cl | I | Cl | Br |
| i-Pr | CH₃ | Cl | CF₃ | Cl | i-Pr | Cl | Br | CF₃ | Cl | i-Pr | Cl | I | Cl | Br |
| t-Bu | CH₃ | Cl | CF₃ | Cl | t-Bu | Cl | Br | CF₃ | Cl | t-Bu | Cl | I | Cl | Br |
| Me | CH₃ | Cl | CF₃ | Br | Me | Cl | Br | CF₃ | Br | Me | Cl | I | Br | Cl |
| Et | CH₃ | Cl | CF₃ | Br | Et | Cl | Br | CF₃ | Br | Et | Cl | I | Br | Cl |
| i-Pr | CH₃ | Cl | CF₃ | Br | i-Pr | Cl | Br | CF₃ | Br | i-Pr | Cl | I | Br | Cl |
| t-Bu | CH₃ | Cl | CF₃ | Br | t-Bu | Cl | Br | CF₃ | Br | t-Bu | Cl | I | Br | Cl |
| Me | CH₃ | Cl | Cl | Cl | Me | Cl | Br | Cl | Cl | Me | Cl | I | Br | Br |
| Et | CH₃ | Cl | Cl | Cl | Et | Cl | Br | Cl | Cl | Et | Cl | I | Br | Br |
| i-Pr | CH₃ | Cl | Cl | Cl | i-Pr | Cl | Br | Cl | Cl | i-Pr | Cl | I | Br | Br |
| t-Bu | CH₃ | Cl | Cl | Cl | t-Bu | Cl | Br | Cl | Cl | t-Bu | Cl | I | Br | Br |
| Me | CH₃ | Cl | Cl | Br | Me | Br | Br | Br | Cl | Me | Cl | CF₃ | CF₃ | Cl |
| Et | CH₃ | Cl | Cl | Br | Et | Br | Br | Br | Cl | Et | Cl | CF₃ | CF₃ | Cl |
| i-Pr | CH₃ | Cl | Cl | Br | i-Pr | Br | Br | Br | Cl | i-Pr | Cl | CF₃ | CF₃ | Cl |
| t-Bu | CH₃ | Cl | Cl | Br | t-Bu | Br | Br | Br | Cl | t-Bu | Cl | CF₃ | CF₃ | Cl |
| Me | CH₃ | Cl | Br | Cl | Me | Br | Br | Br | Br | Me | Cl | CF₃ | CF₃ | Br |
| Et | CH₃ | Cl | Br | Cl | Et | Br | Br | Br | Br | Et | Cl | CF₃ | CF₃ | Br |
| i-Pr | CH₃ | Cl | Br | Cl | i-Pr | Br | Br | Br | Br | i-Pr | Cl | CF₃ | CF₃ | Br |
| t-Bu | CH₃ | Cl | Br | Cl | t-Bu | Br | Br | Br | Br | t-Bu | Cl | CF₃ | CF₃ | Br |
| Me | CH₃ | Cl | Br | Br | Me | Br | I | CF₃ | Cl | Me | Cl | CF₃ | Cl | Cl |
| Et | CH₃ | Cl | Br | Br | Et | Br | I | CF₃ | Cl | Et | Cl | CF₃ | Cl | Cl |
| i-Pr | CH₃ | Cl | Br | Br | i-Pr | Br | I | CF₃ | Cl | i-Pr | Cl | CF₃ | Cl | Cl |
| t-Bu | CH₃ | Cl | Br | Br | t-Bu | Br | I | CF₃ | Cl | t-Bu | Cl | CF₃ | Cl | Cl |
| Me | CH₃ | Br | CF₃ | Cl | Me | Br | I | CF₃ | Br | Me | Cl | CF₃ | Cl | Br |
| Et | CH₃ | Br | CF₃ | Cl | Et | Br | I | CF₃ | Br | Et | Cl | CF₃ | Cl | Br |
| i-Pr | CH₃ | Br | CF₃ | Cl | i-Pr | Br | I | CF₃ | Br | i-Pr | Cl | CF₃ | Cl | Br |
| t-Bu | CH₃ | Br | CF₃ | Cl | t-Bu | Br | I | CF₃ | Br | t-Bu | Cl | CF₃ | Cl | Br |
| Me | CH₃ | Br | CF₃ | Br | Me | Br | I | Cl | Cl | Me | Cl | CF₃ | Br | Cl |
| Et | CH₃ | Br | CF₃ | Br | Et | Br | I | Cl | Cl | Et | Cl | CF₃ | Br | Cl |
| i-Pr | CH₃ | Br | CF₃ | Br | i-Pr | Br | I | Cl | Cl | i-Pr | Cl | CF₃ | Br | Cl |
| t-Bu | CH₃ | Br | CF₃ | Br | t-Bu | Br | I | Cl | Cl | t-Bu | Cl | CF₃ | Br | Cl |
| Me | CH₃ | Br | Cl | Cl | Me | Br | I | Cl | Br | Me | Cl | CF₃ | Br | Br |
| Et | CH₃ | Br | Cl | Cl | Et | Br | I | Cl | Br | Et | Cl | CF₃ | Br | Br |
| i-Pr | CH₃ | Br | Cl | Cl | i-Pr | Br | I | Cl | Br | i-Pr | Cl | CF₃ | Br | Br |
| t-Bu | CH₃ | Br | Cl | Cl | t-Bu | Br | I | Cl | Br | t-Bu | Cl | CF₃ | Br | Br |
| Me | CH₃ | Br | Cl | Br | Me | Br | I | Br | Cl | n-Pr | Cl | Cl | Cl | Cl |
| Et | CH₃ | Br | Cl | Br | Et | Br | I | Br | Cl | n-Bu | Cl | Cl | Cl | Cl |
| i-Pr | CH₃ | Br | Cl | Br | i-Pr | Br | I | Br | Cl | s-Bu | Cl | Cl | Cl | Cl |
| t-Bu | CH₃ | Br | Cl | Br | t-Bu | Br | I | Br | Cl | i-Bu | Cl | Cl | Cl | Cl |
| Me | CH₃ | Br | Br | Cl | Me | Br | I | Br | Br | Me | Br | F | CF₃ | Cl |
| Et | CH₃ | Br | Br | Cl | Et | Br | I | Br | Br | Et | Br | F | CF₃ | Cl |
| i-Pr | CH₃ | Br | Br | Cl | i-Pr | Br | I | Br | Br | i-Pr | Br | F | CF₃ | Cl |
| t-Bu | CH₃ | Br | Br | Cl | t-Bu | Br | I | Br | Br | t-Bu | Br | F | CF₃ | Cl |
| Me | CH₃ | Br | Br | Br | Me | Br | CF₃ | CF₃ | Cl | Me | Br | F | CF₃ | Br |
| Et | CH₃ | Br | Br | Br | Et | Br | CF₃ | CF₃ | Cl | Et | Br | F | CF₃ | Br |
| i-Pr | CH₃ | Br | Br | Br | i-Pr | Br | CF₃ | CF₃ | Cl | i-Pr | Br | F | CF₃ | Br |
| t-Bu | CH₃ | Br | Br | Br | t-Bu | Br | CF₃ | CF₃ | Cl | t-Bu | Br | F | CF₃ | Br |
| Me | CH₃ | I | CF₃ | Cl | Me | Br | CF₃ | CF₃ | Br | Me | Br | F | Cl | Cl |
| Et | CH₃ | I | CF₃ | Cl | Et | Br | CF₃ | CF₃ | Br | Et | Br | F | Cl | Cl |
| i-Pr | CH₃ | I | CF₃ | Cl | i-Pr | Br | CF₃ | CF₃ | Br | i-Pr | Br | F | Cl | Cl |
| t-Bu | CH₃ | I | CF₃ | Cl | t-Bu | Br | CF₃ | CF₃ | Br | t-Bu | Br | F | Cl | Cl |
| Me | CH₃ | I | CF₃ | Br | Me | Br | CF₃ | Cl | Cl | Me | Br | F | Cl | Br |
| Et | CH₃ | I | CF₃ | Br | Et | Br | CF₃ | Cl | Cl | Et | Br | F | Cl | Br |
| i-Pr | CH₃ | I | CF₃ | Br | i-Pr | Br | CF₃ | Cl | Cl | i-Pr | Br | F | Cl | Br |
| t-Bu | CH₃ | I | CF₃ | Br | t-Bu | Br | CF₃ | Cl | Cl | t-Bu | Br | F | Cl | Br |
| Me | CH₃ | I | Cl | Cl | Me | Br | CF₃ | Cl | Br | Me | Br | F | Br | Cl |
| Et | CH₃ | I | Cl | Cl | Et | Br | CF₃ | Cl | Br | Et | Br | F | Br | Cl |
| i-Pr | CH₃ | I | Cl | Cl | i-Pr | Br | CF₃ | Cl | Br | i-Pr | Br | F | Br | Cl |
| t-Bu | CH₃ | I | Cl | Cl | t-Bu | Br | CF₃ | Cl | Br | t-Bu | Br | F | Br | Cl |
| Me | CH₃ | I | Cl | Br | Me | Br | CF₃ | Br | Cl | Me | Br | F | Br | Br |
| Et | CH₃ | I | Cl | Br | Et | Br | CF₃ | Br | Cl | Et | Br | F | Br | Br |
| i-Pr | CH₃ | I | Cl | Br | i-Pr | Br | CF₃ | Br | Cl | i-Pr | Br | F | Br | Br |
| t-Bu | CH₃ | I | Cl | Br | t-Bu | Br | CF₃ | Br | Cl | t-Bu | Br | F | Br | Br |
| Me | CH₃ | I | Br | Cl | Me | Br | CF₃ | Br | Br | Me | Br | Cl | CF₃ | Cl |
| Et | CH₃ | I | Br | Cl | Et | Br | CF₃ | Br | Br | Et | Br | Cl | CF₃ | Cl |
| i-Pr | CH₃ | I | Br | Cl | i-Pr | Br | CF₃ | Br | Br | i-Pr | Br | Cl | CF₃ | Cl |
| t-Bu | CH₃ | I | Br | Cl | t-Bu | Br | CF₃ | Br | Br | t-Bu | Br | Cl | CF₃ | Cl |
| Me | CH₃ | I | Br | Br | Me | Br | Br | CF₃ | Cl | Me | Br | Cl | CF₃ | Br |
| Et | CH₃ | I | Br | Br | Et | Br | Br | CF₃ | Cl | Et | Br | Cl | CF₃ | Br |
| i-Pr | CH₃ | I | Br | Br | i-Pr | Br | Br | CF₃ | Cl | i-Pr | Br | Cl | CF₃ | Br |
| t-Bu | CH₃ | I | Br | Br | t-Bu | Br | Br | CF₃ | Cl | t-Bu | Br | Cl | CF₃ | Br |
| Me | CH₃ | CF₃ | CF₃ | Cl | Me | Br | Br | CF₃ | Br | Me | Br | Cl | Cl | Cl |
| Et | CH₃ | CF₃ | CF₃ | Cl | Et | Br | Br | CF₃ | Br | Et | Br | Cl | Cl | Cl |
| i-Pr | CH₃ | CF₃ | CF₃ | Cl | i-Pr | Br | Br | CF₃ | Br | i-Pr | Br | Cl | Cl | Cl |
| t-Bu | CH₃ | CF₃ | CF₃ | Cl | t-Bu | Br | Br | CF₃ | Br | t-Bu | Br | Cl | Cl | Cl |
| Me | CH₃ | CF₃ | CF₃ | Br | Me | Br | Br | Cl | Cl | Me | Br | Cl | Cl | Br |
| Et | CH₃ | CF₃ | CF₃ | Br | Et | Br | Br | Cl | Cl | Et | Br | Cl | Cl | Br |
| i-Pr | CH₃ | CF₃ | CF₃ | Br | i-Pr | Br | Br | Cl | Cl | i-Pr | Br | Cl | Cl | Br |
| t-Bu | CH₃ | CF₃ | CF₃ | Br | t-Bu | Br | Br | Cl | Cl | t-Bu | Br | Cl | Cl | Br |
| Me | CH₃ | CF₃ | Cl | Cl | Me | Br | Br | Cl | Br | Me | Br | Cl | Br | Cl |
| Et | CH₃ | CF₃ | Cl | Cl | Et | Br | Br | Cl | Br | Et | Br | Cl | Br | Cl |
| i-Pr | CH₃ | CF₃ | Cl | Cl | i-Pr | Br | Br | Cl | Br | i-Pr | Br | Cl | Br | Cl |
| t-Bu | CH₃ | CF₃ | Cl | Cl | t-Bu | Br | Br | Cl | Br | i-Bu | Br | Cl | Br | Cl |
| Me | CH₃ | CF₃ | Cl | Br | Me | CH₃ | CF₃ | Br | Cl | Me | Br | Cl | Br | Br |
| Et | CH₃ | CF₃ | Cl | Br | Et | CH₃ | CF₃ | Br | Cl | Et | Br | Cl | Br | Br |
| i-Pr | CH₃ | CF₃ | Cl | Br | i-Pr | CH₃ | CF₃ | Br | Cl | i-Pr | Br | Cl | Br | Br |
| t-Bu | CH₃ | CF₃ | Cl | Br | t-Bu | CH₃ | CF₃ | Br | Cl | t-Bu | Br | Cl | Br | Br |
| Me | CH₃ | CF₃ | Br | Br | n-Pr | CH₃ | Cl | Cl | Cl | t-Bu | CH₃ | CF₃ | Br | Br |
| Et | CH₃ | CF₃ | Br | Br | n-Bu | CH₃ | Cl | Cl | Cl | i-Bu | CH₃ | Cl | Cl | Cl |
| i-Pr | CH₃ | CF₃ | Br | Br | s-Bu | CH₃ | Cl | Cl | Cl | | | | | |

TABLE 10

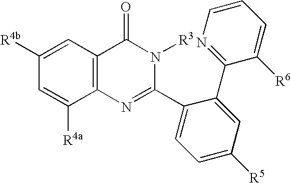

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | F | CF₃ | Cl | Me | Cl | H | Cl | Br |
| Et | CH₃ | H | CF₃ | Cl | Et | Cl | F | CF₃ | Cl | Et | Cl | H | Cl | Br |
| i-Pr | CH₃ | H | CF₃ | Cl | i-Pr | Cl | F | CF₃ | Cl | i-Pr | Cl | H | Cl | Br |
| t-Bu | CH₃ | H | CF₃ | Cl | t-Bu | Cl | F | CF₃ | Cl | t-Bu | Cl | H | Cl | Br |
| Me | CH₃ | H | CF₃ | Br | Me | Cl | F | CF₃ | Br | Me | Cl | H | Br | Cl |
| Et | CH₃ | H | CF₃ | Br | Et | Cl | F | CF₃ | Br | Et | Cl | H | Br | Cl |
| i-Pr | CH₃ | H | CF₃ | Br | i-Pr | Cl | F | CF₃ | Br | i-Pr | Cl | H | Br | Cl |
| t-Bu | CH₃ | H | CF₃ | Br | t-Bu | Cl | F | CF₃ | Br | t-Bu | Cl | H | Br | Cl |
| Me | CH₃ | H | Cl | Cl | Me | Cl | F | Cl | Cl | Me | Cl | H | Br | Br |
| Et | CH₃ | H | Cl | Cl | Et | Cl | F | Cl | Cl | Et | Cl | H | Br | Br |
| i-Pr | CH₃ | H | Cl | Cl | i-Pr | Cl | F | Cl | Cl | i-Pr | Cl | H | Br | Br |
| t-Bu | CH₃ | H | Cl | Cl | t-Bu | Cl | F | Cl | Cl | t-Bu | Cl | H | Br | Br |
| Me | CH₃ | H | Cl | Br | Me | Cl | F | Cl | Br | Me | Cl | H | CF₃ | Cl |
| Et | CH₃ | H | Cl | Br | Et | Cl | F | Cl | Br | Et | Cl | H | CF₃ | Cl |
| i-Pr | CH₃ | H | Cl | Br | i-Pr | Cl | F | Cl | Br | i-Pr | Cl | H | CF₃ | Cl |
| t-Bu | CH₃ | H | Cl | Br | t-Bu | Cl | F | Cl | Br | t-Bu | Cl | H | CF₃ | Cl |
| Me | CH₃ | H | Br | Cl | Me | Cl | F | Br | Cl | Me | Cl | H | CF₃ | Br |
| Et | CH₃ | H | Br | Cl | Et | Cl | F | Br | Cl | Et | Cl | H | CF₃ | Br |
| i-Pr | CH₃ | H | Br | Cl | i-Pr | Cl | F | Br | Cl | i-Pr | Cl | H | CF₃ | Br |
| t-Bu | CH₃ | H | Br | Cl | t-Bu | Cl | F | Br | Cl | t-Bu | Cl | H | CF₃ | Br |
| Me | CH₃ | H | Br | Br | Me | Cl | F | Br | Br | Me | Cl | H | Cl | Cl |
| Et | CH₃ | H | Br | Br | Et | Cl | F | Br | Br | Et | Cl | H | Cl | Cl |
| i-Pr | CH₃ | H | Br | Br | i-Pr | Cl | F | Br | Br | i-Pr | Cl | H | Cl | Cl |
| t-Bu | CH₃ | H | Br | Br | t-Bu | Cl | F | Br | Br | i-Pr | Cl | H | Cl | Cl |
| Me | CH₃ | F | CF₃ | Cl | Me | Cl | Cl | CF₃ | Cl | Me | Cl | Br | Cl | Br |
| Et | CH₃ | F | CF₃ | Cl | Et | Cl | Cl | CF₃ | Cl | Et | Cl | Br | Cl | Br |
| i-Pr | CH₃ | F | CF₃ | Cl | i-Pr | Cl | Cl | CF₃ | Cl | i-Pr | Cl | Br | Cl | Br |
| t-Bu | CH₃ | F | CF₃ | Cl | t-Bu | Cl | Cl | CF₃ | Cl | t-Bu | Cl | Br | Cl | Br |
| Me | CH₃ | F | CF₃ | Br | Me | Cl | Cl | CF₃ | Br | Me | Cl | Br | Br | Cl |
| Et | CH₃ | F | CF₃ | Br | Et | Cl | Cl | CF₃ | Br | Et | Cl | Br | Br | Cl |
| i-Pr | CH₃ | F | CF₃ | Br | i-Pr | Cl | Cl | CF₃ | Br | i-Pr | Cl | Br | Br | Cl |
| t-Bu | CH₃ | F | CF₃ | Br | t-Bu | Cl | Cl | CF₃ | Br | t-Bu | Cl | Br | Br | Cl |
| Me | CH₃ | F | Cl | Cl | Me | Cl | Cl | Cl | Cl | Me | Cl | Br | Br | Br |
| Et | CH₃ | F | Cl | Cl | Et | Cl | Cl | Cl | Cl | Et | Cl | Br | Br | Br |
| i-Pr | CH₃ | F | Cl | Cl | i-Pr | Cl | Cl | Cl | Cl | i-Pr | Cl | Br | Br | Br |
| t-Bu | CH₃ | F | Cl | Cl | t-Bu | Cl | Cl | Cl | Cl | t-Bu | Cl | Br | Br | Br |
| Me | CH₃ | F | Cl | Br | Me | Cl | Cl | Cl | Br | Me | Cl | I | CF₃ | Cl |
| Et | CH₃ | F | Cl | Br | Et | Cl | Cl | Cl | Br | Et | Cl | I | CF₃ | Cl |
| i-Pr | CH₃ | F | Cl | Br | i-Pr | Cl | Cl | Cl | Br | i-Pr | Cl | I | CF₃ | Cl |
| t-Bu | CH₃ | F | Cl | Br | t-Bu | Cl | Cl | Cl | Br | t-Bu | Cl | I | CF₃ | Cl |
| Me | CH₃ | F | Br | Cl | Me | Cl | Cl | Br | Cl | Me | Cl | I | CF₃ | Br |
| Et | CH₃ | F | Br | Cl | Et | Cl | Cl | Br | Cl | Et | Cl | I | CF₃ | Br |
| i-Pr | CH₃ | F | Br | Cl | i-Pr | Cl | Cl | Br | Cl | i-Pr | Cl | I | CF₃ | Br |
| t-Bu | CH₃ | F | Br | Cl | t-Bu | Cl | Cl | Br | Cl | t-Bu | Cl | I | CF₃ | Br |
| Me | CH₃ | F | Br | Br | Me | Cl | Cl | Br | Br | Me | Cl | I | Cl | C1 |
| Et | CH₃ | F | Br | Br | Et | Cl | Cl | Br | Br | Et | Cl | I | Cl | Cl |
| i-Pr | CH₃ | F | Br | Br | i-Pr | Cl | Cl | Br | Br | i-Pr | Cl | I | Cl | Cl |
| t-Bu | CH₃ | F | Br | Br | t-Bu | Cl | Cl | Br | Br | t-Bu | Cl | I | Cl | Cl |
| Me | CH₃ | Cl | CF₃ | Cl | Me | Cl | Br | CF₃ | Cl | Me | Cl | I | Cl | Br |
| Et | CH₃ | Cl | CF₃ | Cl | Et | Cl | Br | CF₃ | Cl | Et | Cl | I | Cl | Br |
| i-Pr | CH₃ | Cl | CF₃ | Cl | i-Pr | Cl | Br | CF₃ | Cl | i-Pr | Cl | I | Cl | Br |
| t-Bu | CH₃ | Cl | CF₃ | Cl | t-Bu | Cl | Br | CF₃ | Cl | t-Bu | Cl | I | Cl | Br |
| Me | CH₃ | Cl | CF₃ | Br | Me | Cl | Br | CF₃ | Br | Me | Cl | I | Br | Cl |
| Et | CH₃ | Cl | CF₃ | Br | Et | Cl | Br | CF₃ | Br | Et | Cl | I | Br | Cl |
| i-Pr | CH₃ | Cl | CF₃ | Br | i-Pr | Cl | Br | CF₃ | Br | i-Pr | Cl | I | Br | Cl |
| t-Bu | CH₃ | Cl | CF₃ | Br | t-Bu | Cl | Br | CF₃ | Br | t-Bu | Cl | I | Br | Cl |
| Me | CH₃ | Cl | Cl | Cl | Me | Cl | Br | Cl | Cl | Me | Cl | I | Br | Br |
| Et | CH₃ | Cl | Cl | Cl | Et | Cl | Br | Cl | Cl | Et | Cl | I | Br | Br |
| i-Pr | CH₃ | Cl | Cl | Cl | i-Pr | Cl | Br | Cl | Cl | i-Pr | Cl | I | Br | Br |
| t-Bu | CH₃ | Cl | Cl | Cl | t-Bu | Cl | Br | Cl | Cl | t-Bu | Cl | I | Br | Br |
| Me | CH₃ | Cl | Cl | Br | Me | Br | Br | Br | Cl | Me | Cl | CF₃ | CF₃ | Cl |
| Et | CH₃ | Cl | Cl | Br | Et | Br | Br | Br | Cl | Et | Cl | CF₃ | CF₃ | Cl |
| i-Pr | CH₃ | Cl | Cl | Br | i-Pr | Br | Br | Br | Cl | i-Pr | Cl | CF₃ | CF₃ | Cl |
| t-Bu | CH₃ | Cl | Cl | Br | t-Bu | Br | Br | Br | Cl | t-Bu | Cl | CF₃ | CF₃ | Cl |
| Me | CH₃ | Cl | Br | Cl | Me | Br | Br | Br | Br | Me | Cl | CF₃ | CF₃ | Br |
| Et | CH₃ | Cl | Br | Cl | Et | Br | Br | Br | Br | Et | Cl | CF₃ | CF₃ | Br |
| i-Pr | CH₃ | Cl | Br | Cl | i-Pr | Br | Br | Br | Br | i-Pr | Cl | CF₃ | CF₃ | Br |
| t-Bu | CH₃ | Cl | Br | Cl | t-Bu | Br | Br | Br | Br | t-Bu | Cl | CF₃ | CF₃ | Br |
| Me | CH₃ | Cl | Br | Br | Me | Br | I | CF₃ | Cl | Me | Cl | CF₃ | Cl | Cl |
| Et | CH₃ | Cl | Br | Br | Et | Br | I | CF₃ | Cl | Et | Cl | CF₃ | Cl | Cl |
| i-Pr | CH₃ | Cl | Br | Br | i-Pr | Br | I | CF₃ | Cl | i-Pr | Cl | CF₃ | Cl | Cl |
| t-Bu | CH₃ | Cl | Br | Br | t-Bu | Br | I | CF₃ | Cl | t-Bu | Cl | CF₃ | Cl | Cl |
| Me | CH₃ | Br | CF₃ | Cl | Me | Br | I | CF₃ | Br | Me | Cl | CF₃ | Cl | Br |
| Et | CH₃ | Br | CF₃ | Cl | Et | Br | I | CF₃ | Br | Et | Cl | CF₃ | Cl | Br |
| i-Pr | CH₃ | Br | CF₃ | Cl | i-Pr | Br | I | CF₃ | Br | i-Pr | Cl | CF₃ | Cl | Br |
| t-Bu | CH₃ | Br | CF₃ | Cl | t-Bu | Br | I | CF₃ | Br | t-Bu | Cl | CF₃ | Cl | Br |
| Me | CH₃ | Br | CF₃ | Br | Me | Br | I | Cl | Cl | Me | Cl | CF₃ | Br | Cl |
| Et | CH₃ | Br | CF₃ | Br | Et | Br | I | Cl | Cl | Et | Cl | CF₃ | Br | Cl |
| i-Pr | CH₃ | Br | CF₃ | Br | i-Pr | Br | I | Cl | Cl | i-Pr | Cl | CF₃ | Br | Cl |
| t-Bu | CH₃ | Br | CF₃ | Br | t-Bu | Br | I | Cl | Cl | t-Bu | Cl | CF₃ | Br | Cl |
| Me | CH₃ | Br | Cl | Cl | Me | Br | I | Cl | Br | Me | Cl | CF₃ | Br | Br |
| Et | CH₃ | Br | Cl | Cl | Et | Br | I | Cl | Br | Et | Cl | CF₃ | Br | Br |
| i-Pr | CH₃ | Br | Cl | Cl | i-Pr | Br | I | Cl | Br | i-Pr | Cl | CF₃ | Br | Br |
| t-Bu | CH₃ | Br | Cl | Cl | t-Bu | Br | I | Cl | Br | t-Bu | Cl | CF₃ | Br | Br |
| Me | CH₃ | Br | Cl | Br | Me | Br | I | Br | Cl | n-Pr | Cl | Cl | Cl | Cl |
| Et | CH₃ | Br | Cl | Br | Et | Br | I | Br | Cl | n-Bu | Cl | Cl | Cl | Cl |
| i-Pr | CH₃ | Br | Cl | Br | i-Pr | Br | I | Br | Cl | s-Bu | Cl | Cl | Cl | Cl |
| t-Bu | CH₃ | Br | Cl | Br | t-Bu | Br | I | Br | Cl | t-Bu | Cl | Cl | Cl | Cl |
| Me | CH₃ | Br | Br | Cl | Me | Br | I | Br | Br | Me | Br | F | CF₃ | Cl |
| Et | CH₃ | Br | Br | Cl | Et | Br | I | Br | Br | Et | Br | F | CF₃ | Cl |
| i-Pr | CH₃ | Br | Br | Cl | i-Pr | Br | I | Br | Br | i-Pr | Br | F | CF₃ | Cl |
| t-Bu | CH₃ | Br | Br | Cl | t-Bu | Br | I | Br | Br | t-Bu | Br | F | CF₃ | Cl |
| Me | CH₃ | Br | Br | Br | Me | Br | CF₃ | CF₃ | Cl | Me | Br | F | CF₃ | Br |
| Et | CH₃ | Br | Br | Br | Et | Br | CF₃ | CF₃ | Cl | Et | Br | F | CF₃ | Br |
| i-Pr | CH₃ | Br | Br | Br | i-Pr | Br | CF₃ | CF₃ | Cl | i-Pr | Br | F | CF₃ | Br |
| t-Bu | CH₃ | Br | Br | Br | t-Bu | Br | CF₃ | CF₃ | Cl | t-Bu | Br | F | CF₃ | Br |
| Me | CH₃ | I | CF₃ | Cl | Me | Br | CF₃ | CF₃ | Br | Me | Br | F | Cl | Cl |
| Et | CH₃ | I | CF₃ | Cl | Et | Br | CF₃ | CF₃ | Br | Et | Br | F | Cl | Cl |
| i-Pr | CH₃ | I | CF₃ | Cl | i-Pr | Br | CF₃ | CF₃ | Br | i-Pr | Br | F | Cl | Cl |
| t-Bu | CH₃ | I | CF₃ | Cl | t-Bu | Br | CF₃ | CF₃ | Br | t-Bu | Br | F | Cl | Cl |
| Me | CH₃ | I | CF₃ | Br | Me | Br | CF₃ | Cl | Cl | Me | Br | F | Cl | Br |
| Et | CH₃ | I | CF₃ | Br | Et | Br | CF₃ | Cl | Cl | Et | Br | F | Cl | Br |
| i-Pr | CH₃ | I | CF₃ | Br | i-Pr | Br | CF₃ | Cl | Cl | i-Pr | Br | F | Cl | Br |
| t-Bu | CH₃ | I | CF₃ | Br | t-Bu | Br | CF₃ | Cl | Cl | t-Bu | Br | F | Cl | Br |
| Me | CH₃ | I | Cl | Cl | Me | Br | CF₃ | Cl | Br | Me | Br | F | Br | Cl |
| Et | CH₃ | I | Cl | Cl | Et | Br | CF₃ | Cl | Br | Et | Br | F | Br | Cl |
| i-Pr | CH₃ | I | Cl | Cl | i-Pr | Br | CF₃ | Cl | Br | i-Pr | Br | F | Br | Cl |
| t-Bu | CH₃ | I | Cl | Cl | t-Bu | Br | CF₃ | Cl | Br | t-Bu | Br | F | Br | Cl |
| Me | CH₃ | I | Cl | Br | Me | Br | CF₃ | Br | Cl | Me | Br | F | Br | Br |
| Et | CH₃ | I | Cl | Br | Et | Br | CF₃ | Br | Cl | Et | Br | F | Br | Br |
| i-Pr | CH₃ | I | Cl | Br | i-Pr | Br | CF₃ | Br | Cl | i-Pr | Br | F | Br | Br |
| t-Bu | CH₃ | I | Cl | Br | t-Bu | Br | CF₃ | Br | Cl | t-Bu | Br | F | Br | Br |
| Me | CH₃ | I | Br | Cl | Me | Br | CF₃ | Br | Br | Me | Br | Cl | CF₃ | Cl |
| Et | CH₃ | I | Br | Cl | Et | Br | CF₃ | Br | Br | Et | Br | Cl | CF₃ | Cl |
| i-Pr | CH₃ | I | Br | Cl | i-Pr | Br | CF₃ | Br | Br | i-Pr | Br | Cl | CF₃ | Cl |
| t-Bu | CH₃ | I | Br | Cl | t-Bu | Br | CF₃ | Br | Br | t-Bu | Br | Cl | CF₃ | Cl |
| Me | CH₃ | I | Br | Br | Me | Br | Br | CF₃ | Cl | Me | Br | Cl | CF₃ | Br |
| Et | CH₃ | I | Br | Br | Et | Br | Br | CF₃ | Cl | Et | Br | Cl | CF₃ | Br |
| i-Pr | CH₃ | I | Br | Br | i-Pr | Br | Br | CF₃ | Cl | i-Pr | Br | Cl | CF₃ | Br |
| t-Bu | CH₃ | I | Br | Br | t-Bu | Br | Br | CF₃ | Cl | t-Bu | Br | Cl | CF₃ | Br |
| Me | CH₃ | CF₃ | CF₃ | Cl | Me | Br | Br | CF₃ | Br | Me | Br | Cl | Cl | Cl |
| Et | CH₃ | CF₃ | CF₃ | Cl | Et | Br | Br | CF₃ | Br | Et | Br | Cl | Cl | Cl |
| i-Pr | CH₃ | CF₃ | CF₃ | Cl | i-Pr | Br | Br | CF₃ | Br | i-Pr | Br | Cl | Cl | Cl |
| t-Bu | CH₃ | CF₃ | CF₃ | Cl | t-Bu | Br | Br | CF₃ | Br | t-Bu | Br | Cl | Cl | Cl |
| Me | CH₃ | CF₃ | CF₃ | Br | Me | Br | Br | Cl | Cl | Me | Br | Cl | Cl | Br |
| Et | CH₃ | CF₃ | CF₃ | Br | Et | Br | Br | Cl | Cl | Et | Br | Cl | Cl | Br |
| i-Pr | CH₃ | CF₃ | CF₃ | Br | i-Pr | Br | Br | Cl | Cl | i-Pr | Br | Cl | Cl | Br |
| t-Bu | CH₃ | CF₃ | CF₃ | Br | t-Bu | Br | Br | Cl | Cl | t-Bu | Br | Cl | Cl | Br |
| Me | CH₃ | CF₃ | Cl | Cl | Me | Br | Br | Cl | Br | Me | Br | Cl | Br | Cl |
| Et | CH₃ | CF₃ | Cl | Cl | Et | Br | Br | Cl | Br | Et | Br | Cl | Br | Cl |
| i-Pr | CH₃ | CF₃ | Cl | Cl | i-Pr | Br | Br | Cl | Br | i-Pr | Br | Cl | Br | Cl |
| t-Bu | CH₃ | CF₃ | Cl | Cl | t-Bu | Br | Br | Cl | Br | t-Bu | Br | Cl | Br | Cl |
| Me | CH₃ | CF₃ | Cl | Br | Me | CH₃ | CF₃ | Br | Cl | Me | Br | Cl | Br | Br |
| Et | CH₃ | CF₃ | Cl | Br | Et | CH₃ | CF₃ | Br | Cl | Et | Br | Cl | Br | Br |
| i-Pr | CH₃ | CF₃ | Cl | Br | i-Pr | CH₃ | CF₃ | Br | Cl | i-Pr | Br | Cl | Br | Br |
| t-Bu | CH₃ | CF₃ | Cl | Br | t-Bu | CH₃ | CF₃ | Br | Cl | t-Bu | Br | Cl | Br | Br |
| Me | CH₃ | CF₃ | Br | Br | n-Pr | CH₃ | Cl | Cl | Cl | t-Bu | CH₃ | CF₃ | Br | Br |
| Et | CH₃ | CF₃ | Br | Br | n-Bu | CH₃ | Cl | Cl | Cl | t-Bu | CH₃ | Cl | Cl | Cl |
| i-Pr | CH₃ | CF₃ | Br | Br | s-Bu | CH₃ | Cl | Cl | Cl | | | | | |

TABLE 11

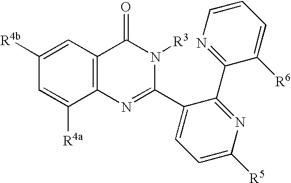

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | F | CF₃ | Cl | Me | Cl | H | Cl | Br |
| Et | CH₃ | H | CF₃ | Cl | Et | Cl | F | CF₃ | Cl | Et | Cl | H | Cl | Br |
| i-Pr | CH₃ | H | CF₃ | Cl | i-Pr | Cl | F | CF₃ | Cl | i-Pr | Cl | H | Cl | Br |
| t-Bu | CH₃ | H | CF₃ | Cl | t-Bu | Cl | F | CF₃ | Cl | t-Bu | Cl | H | Cl | Br |
| Me | CH₃ | H | CF₃ | Br | Me | Cl | F | CF₃ | Br | Me | Cl | H | Br | Cl |
| Et | CH₃ | H | CF₃ | Br | Et | Cl | F | CF₃ | Br | Et | Cl | H | Br | Cl |
| i-Pr | CH₃ | H | CF₃ | Br | i-Pr | Cl | F | CF₃ | Br | i-Pr | Cl | H | Br | Cl |
| t-Bu | CH₃ | H | CF₃ | Br | t-Bu | Cl | F | CF₃ | Br | t-Bu | Cl | H | Br | Cl |
| Me | CH₃ | H | Cl | Cl | Me | Cl | F | Cl | Cl | Me | Cl | H | Br | Br |
| Et | CH₃ | H | Cl | Cl | Et | Cl | F | Cl | Cl | Et | Cl | H | Br | Br |
| i-Pr | CH₃ | H | Cl | Cl | i-Pr | Cl | F | Cl | Cl | i-Pr | Cl | H | Br | Br |
| t-Bu | CH₃ | H | Cl | Cl | t-Bu | Cl | F | Cl | Cl | t-Bu | Cl | H | Br | Br |
| Me | CH₃ | H | Cl | Br | Me | Cl | F | Cl | Br | Me | Cl | H | CF₃ | Cl |
| Et | CH₃ | H | Cl | Br | Et | Cl | F | Cl | Br | Et | Cl | H | CF₃ | Cl |
| i-Pr | CH₃ | H | Cl | Br | i-Pr | Cl | F | Cl | Br | i-Pr | Cl | H | CF₃ | Cl |
| t-Bu | CH₃ | H | Cl | Br | t-Bu | Cl | F | Cl | Br | t-Bu | Cl | H | CF₃ | Cl |
| Me | CH₃ | H | Br | Cl | Me | Cl | F | Br | Cl | Me | Cl | H | CF₃ | Br |
| Et | CH₃ | H | Br | Cl | Et | Cl | F | Br | Cl | Et | Cl | H | CF₃ | Br |
| i-Pr | CH₃ | H | Br | Cl | i-Pr | Cl | F | Br | Cl | i-Pr | Cl | H | CF₃ | Br |
| t-Bu | CH₃ | H | Br | Cl | t-Bu | Cl | F | Br | Cl | t-Bu | Cl | H | CF₃ | Br |
| Me | CH₃ | H | Br | Br | Me | Cl | F | Br | Br | Me | Cl | H | Cl | Cl |
| Et | CH₃ | H | Br | Br | Et | Cl | F | Br | Br | Et | Cl | H | Cl | Cl |
| i-Pr | CH₃ | H | Br | Br | i-Pr | Cl | F | Br | Br | i-Pr | Cl | H | Cl | Cl |
| t-Bu | CH₃ | H | Br | Br | t-Bu | Cl | F | Br | Br | i-Pr | Cl | H | Cl | Cl |
| Me | CH₃ | F | CF₃ | Cl | Me | Cl | Cl | CF₃ | Cl | Me | Cl | Br | Cl | Br |
| Et | CH₃ | F | CF₃ | Cl | Et | Cl | Cl | CF₃ | Cl | Et | Cl | Br | Cl | Br |
| i-Pr | CH₃ | F | CF₃ | Cl | i-Pr | Cl | Cl | CF₃ | Cl | i-Pr | Cl | Br | Cl | Br |
| t-Bu | CH₃ | F | CF₃ | Cl | t-Bu | Cl | Cl | CF₃ | Cl | t-Bu | Cl | Br | Cl | Br |
| Me | CH₃ | F | CF₃ | Br | Me | Cl | Cl | CF₃ | Br | Me | Cl | Br | Br | Cl |
| Et | CH₃ | F | CF₃ | Br | Et | Cl | Cl | CF₃ | Br | Et | Cl | Br | Br | Cl |
| i-Pr | CH₃ | F | CF₃ | Br | i-Pr | Cl | Cl | CF₃ | Br | i-Pr | Cl | Br | Br | Cl |
| t-Bu | CH₃ | F | CF₃ | Br | t-Bu | Cl | Cl | CF₃ | Br | t-Bu | Cl | Br | Br | Cl |
| Me | CH₃ | F | Cl | Cl | Me | Cl | Cl | Cl | Cl | Me | Cl | Br | Br | Br |
| Et | CH₃ | F | Cl | Cl | Et | Cl | Cl | Cl | Cl | Et | Cl | Br | Br | Br |
| i-Pr | CH₃ | F | Cl | Cl | i-Pr | Cl | Cl | Cl | Cl | i-Pr | Cl | Br | Br | Br |
| t-Bu | CH₃ | F | Cl | Cl | t-Bu | Cl | Cl | Cl | Cl | t-Bu | Cl | Br | Br | Br |
| Me | CH₃ | F | Cl | Br | Me | Cl | Cl | Cl | Br | Me | Cl | I | CF₃ | Cl |
| Et | CH₃ | F | Cl | Br | Et | Cl | Cl | Cl | Br | Et | Cl | I | CF₃ | Cl |
| i-Pr | CH₃ | F | Cl | Br | i-Pr | Cl | Cl | Cl | Br | i-Pr | Cl | I | CF₃ | Cl |
| t-Bu | CH₃ | F | Cl | Br | t-Bu | Cl | Cl | Cl | Br | t-Bu | Cl | I | CF₃ | Cl |
| Me | CH₃ | F | Br | Cl | Me | Cl | Cl | Br | Cl | Me | Cl | I | CF₃ | Br |
| Et | CH₃ | F | Br | Cl | Et | Cl | Cl | Br | Cl | Et | Cl | I | CF₃ | Br |
| i-Pr | CH₃ | F | Br | Cl | i-Pr | Cl | Cl | Br | Cl | i-Pr | Cl | I | CF₃ | Br |
| t-Bu | CH₃ | F | Br | Cl | t-Bu | Cl | Cl | Br | Cl | t-Bu | Cl | I | CF₃ | Br |
| Me | CH₃ | F | Br | Br | Me | Cl | Cl | Br | Br | Me | Cl | I | Cl | Cl |
| Et | CH₃ | F | Br | Br | Et | Cl | Cl | Br | Br | Et | Cl | I | Cl | Cl |
| i-Pr | CH₃ | F | Br | Br | i-Pr | Cl | Cl | Br | Br | i-Pr | Cl | I | Cl | Cl |
| t-Bu | CH₃ | F | Br | Br | t-Bu | Cl | Cl | Br | Br | t-Bu | Cl | I | Cl | Cl |
| Me | CH₃ | Cl | CF₃ | Cl | Me | Cl | Br | CF₃ | Cl | Me | Cl | I | Cl | Br |
| Et | CH₃ | Cl | CF₃ | Cl | Et | Cl | Br | CF₃ | Cl | Et | Cl | I | Cl | Br |
| i-Pr | CH₃ | Cl | CF₃ | Cl | i-Pr | Cl | Br | CF₃ | Cl | i-Pr | Cl | I | Cl | Br |
| t-Bu | CH₃ | Cl | CF₃ | Cl | t-Bu | Cl | Br | CF₃ | Cl | t-Bu | Cl | I | Cl | Br |
| Me | CH₃ | Cl | CF₃ | Br | Me | Cl | Br | CF₃ | Br | Me | Cl | I | Br | Cl |
| Et | CH₃ | Cl | CF₃ | Br | Et | Cl | Br | CF₃ | Br | Et | Cl | I | Br | Cl |
| i-Pr | CH₃ | Cl | CF₃ | Br | i-Pr | Cl | Br | CF₃ | Br | i-Pr | Cl | I | Br | Cl |
| t-Bu | CH₃ | Cl | CF₃ | Br | t-Bu | Cl | Br | CF₃ | Br | t-Bu | Cl | I | Br | Cl |
| Me | CH₃ | Cl | Cl | Cl | Me | Cl | Br | Cl | Cl | Me | Cl | I | Br | Br |
| Et | CH₃ | Cl | Cl | Cl | Et | Cl | Br | Cl | Cl | Et | Cl | I | Br | Br |
| i-Pr | CH₃ | Cl | Cl | Cl | i-Pr | Cl | Br | Cl | Cl | i-Pr | Cl | I | Br | Br |
| t-Bu | CH₃ | Cl | Cl | Cl | t-Bu | Cl | Br | Cl | Cl | t-Bu | Cl | I | Br | Br |
| Me | CH₃ | Cl | Cl | Br | Me | Br | Br | Br | Cl | Me | Cl | CF₃ | CF₃ | Cl |
| Et | CH₃ | Cl | Cl | Br | Et | Br | Br | Br | Cl | Et | Cl | CF₃ | CF₃ | Cl |
| i-Pr | CH₃ | Cl | Cl | Br | i-Pr | Br | Br | Br | Cl | i-Pr | Cl | CF₃ | CF₃ | Cl |
| t-Bu | CH₃ | Cl | Cl | Br | t-Bu | Br | Br | Br | Cl | t-Bu | Cl | CF₃ | CF₃ | Cl |
| Me | CH₃ | Cl | Br | Cl | Me | Br | Br | Br | Br | Me | Cl | CF₃ | CF₃ | Br |
| Et | CH₃ | Cl | Br | Cl | Et | Br | Br | Br | Br | Et | Cl | CF₃ | CF₃ | Br |
| i-Pr | CH₃ | Cl | Br | Cl | i-Pr | Br | Br | Br | Br | i-Pr | Cl | CF₃ | CF₃ | Br |
| t-Bu | CH₃ | Cl | Br | Cl | t-Bu | Br | Br | Br | Br | t-Bu | Cl | CF₃ | CF₃ | Br |
| Me | CH₃ | Cl | Br | Br | Me | Br | I | CF₃ | Cl | Me | Cl | CF₃ | Cl | Cl |
| Et | CH₃ | Cl | Br | Br | Et | Br | I | CF₃ | Cl | Et | Cl | CF₃ | Cl | Cl |
| i-Pr | CH₃ | Cl | Br | Br | i-Pr | Br | I | CF₃ | Cl | i-Pr | Cl | CF₃ | Cl | Cl |
| t-Bu | CH₃ | Cl | Br | Br | t-Bu | Br | I | CF₃ | Cl | t-Bu | Cl | CF₃ | Cl | Cl |
| Me | CH₃ | Br | CF₃ | Cl | Me | Br | I | CF₃ | Br | Me | Cl | CF₃ | Cl | Br |
| Et | CH₃ | Br | CF₃ | Cl | Et | Br | I | CF₃ | Br | Et | Cl | CF₃ | Cl | Br |
| i-Pr | CH₃ | Br | CF₃ | Cl | i-Pr | Br | I | CF₃ | Br | i-Pr | Cl | CF₃ | Cl | Br |
| t-Bu | CH₃ | Br | CF₃ | Cl | t-Bu | Br | I | CF₃ | Br | t-Bu | Cl | CF₃ | Cl | Br |
| Me | CH₃ | Br | CF₃ | Br | Me | Br | I | Cl | Cl | Me | Cl | CF₃ | Br | Cl |
| Et | CH₃ | Br | CF₃ | Br | Et | Br | I | Cl | Cl | Et | Cl | CF₃ | Br | Cl |
| i-Pr | CH₃ | Br | CF₃ | Br | i-Pr | Br | I | Cl | Cl | i-Pr | Cl | CF₃ | Br | Cl |
| t-Bu | CH₃ | Br | CF₃ | Br | t-Bu | Br | I | Cl | Cl | t-Bu | Cl | CF₃ | Br | Cl |
| Me | CH₃ | Br | Cl | Cl | Me | Br | I | Cl | Br | Me | Cl | CF₃ | Br | Br |
| Et | CH₃ | Br | Cl | Cl | Et | Br | I | Cl | Br | Et | Cl | CF₃ | Br | Br |
| i-Pr | CH₃ | Br | Cl | Cl | i-Pr | Br | I | Cl | Br | i-Pr | Cl | CF₃ | Br | Br |
| t-Bu | CH₃ | Br | Cl | Cl | t-Bu | Br | I | Cl | Br | t-Bu | Cl | CF₃ | Br | Br |
| Me | CH₃ | Br | Cl | Br | Me | Br | I | Br | Cl | n-Pr | Cl | Cl | Cl | Cl |
| Et | CH₃ | Br | Cl | Br | Et | Br | I | Br | Cl | n-Bu | Cl | Cl | Cl | Cl |
| i-Pr | CH₃ | Br | Cl | Br | i-Pr | Br | I | Br | Cl | s-Bu | Cl | Cl | Cl | Cl |
| t-Bu | CH₃ | Br | Cl | Br | t-Bu | Br | I | Br | Cl | t-Bu | Cl | Cl | Cl | Cl |
| Me | CH₃ | Br | Br | Cl | Me | Br | I | Br | Br | Me | Br | F | CF₃ | Cl |
| Et | CH₃ | Br | Br | Cl | Et | Br | I | Br | Br | Et | Br | F | CF₃ | Cl |
| i-Pr | CH₃ | Br | Br | Cl | i-Pr | Br | I | Br | Br | i-Pr | Br | F | CF₃ | Cl |
| t-Bu | CH₃ | Br | Br | Cl | t-Bu | Br | I | Br | Br | t-Bu | Br | F | CF₃ | Cl |
| Me | CH₃ | Br | Br | Br | Me | Br | CF₃ | CF₃ | Cl | Me | Br | F | CF₃ | Br |
| Et | CH₃ | Br | Br | Br | Et | Br | CF₃ | CF₃ | Cl | Et | Br | F | CF₃ | Br |
| i-Pr | CH₃ | Br | Br | Br | i-Pr | Br | CF₃ | CF₃ | Cl | i-Pr | Br | F | CF₃ | Br |
| t-Bu | CH₃ | Br | Br | Br | t-Bu | Br | CF₃ | CF₃ | Cl | t-Bu | Br | F | CF₃ | Br |
| Me | CH₃ | I | CF₃ | Cl | Me | Br | CF₃ | CF₃ | Br | Me | Br | F | Cl | Cl |
| Et | CH₃ | I | CF₃ | Cl | Et | Br | CF₃ | CF₃ | Br | Et | Br | F | Cl | Cl |
| i-Pr | CH₃ | I | CF₃ | Cl | i-Pr | Br | CF₃ | CF₃ | Br | i-Pr | Br | F | Cl | Cl |
| t-Bu | CH₃ | I | CF₃ | Cl | t-Bu | Br | CF₃ | CF₃ | Br | t-Bu | Br | F | Cl | Cl |
| Me | CH₃ | I | CF₃ | Br | Me | Br | CF₃ | Cl | Cl | Me | Br | F | Cl | Br |
| Et | CH₃ | I | CF₃ | Br | Et | Br | CF₃ | Cl | Cl | Et | Br | F | Cl | Br |
| i-Pr | CH₃ | I | CF₃ | Br | i-Pr | Br | CF₃ | Cl | Cl | i-Pr | Br | F | Cl | Br |
| t-Bu | CH₃ | I | CF₃ | Br | t-Bu | Br | CF₃ | Cl | Cl | t-Bu | Br | F | Cl | Br |
| Me | CH₃ | I | Cl | Cl | Me | Br | CF₃ | Cl | Br | Me | Br | F | Br | Cl |
| Et | CH₃ | I | Cl | Cl | Et | Br | CF₃ | Cl | Br | Et | Br | F | Br | Cl |
| i-Pr | CH₃ | I | Cl | Cl | i-Pr | Br | CF₃ | Cl | Br | i-Pr | Br | F | Br | Cl |
| t-Bu | CH₃ | I | Cl | Cl | t-Bu | Br | CF₃ | Cl | Br | t-Bu | Br | F | Br | Cl |
| Me | CH₃ | I | Cl | Br | Me | Br | CF₃ | Br | Cl | Me | Br | F | Br | Br |
| Et | CH₃ | I | Cl | Br | Et | Br | CF₃ | Br | Cl | Et | Br | F | Br | Br |
| i-Pr | CH₃ | I | Cl | Br | i-Pr | Br | CF₃ | Br | Cl | i-Pr | Br | F | Br | Br |
| t-Bu | CH₃ | I | Cl | Br | t-Bu | Br | CF₃ | Br | Cl | t-Bu | Br | F | Br | Br |
| Me | CH₃ | I | Br | Cl | Me | Br | CF₃ | Br | Br | Me | Br | Cl | CF₃ | Cl |
| Et | CH₃ | I | Br | Cl | Et | Br | CF₃ | Br | Br | Et | Br | Cl | CF₃ | Cl |
| i-Pr | CH₃ | I | Br | Cl | i-Pr | Br | CF₃ | Br | Br | i-Pr | Br | Cl | CF₃ | Cl |
| t-Bu | CH₃ | I | Br | Cl | t-Bu | Br | CF₃ | Br | Br | t-Bu | Br | Cl | CF₃ | Cl |
| Me | CH₃ | I | Br | Br | Me | Br | Br | CF₃ | Cl | Me | Br | Cl | CF₃ | Br |
| Et | CH₃ | I | Br | Br | Et | Br | Br | CF₃ | Cl | Et | Br | Cl | CF₃ | Br |
| i-Pr | CH₃ | I | Br | Br | i-Pr | Br | Br | CF₃ | Cl | i-Pr | Br | Cl | CF₃ | Br |
| t-Bu | CH₃ | I | Br | Br | t-Bu | Br | Br | CF₃ | Cl | t-Bu | Br | Cl | CF₃ | Br |
| Me | CH₃ | CF₃ | CF₃ | Cl | Me | Br | Br | CF₃ | Br | Me | Br | Cl | Cl | Cl |
| Et | CF₃ | CF₃ | CF₃ | Cl | Et | Br | Br | CF₃ | Br | Et | Br | Cl | Cl | Cl |
| i-Pr | CH₃ | CF₃ | CF₃ | Cl | i-Pr | Br | Br | CF₃ | Br | i-Pr | Br | Cl | Cl | Cl |
| t-Bu | CF₃ | CF₃ | CF₃ | Cl | t-Bu | Br | Br | CF₃ | Br | t-Bu | Br | Cl | Cl | Cl |
| Me | CH₃ | CF₃ | CF₃ | Br | Me | Br | Br | Cl | Cl | Me | Br | Cl | Cl | Br |
| Et | CH₃ | CF₃ | CF₃ | Br | Et | Br | Br | Cl | Cl | Et | Br | Cl | Cl | Br |
| i-Pr | CH₃ | CF₃ | CF₃ | Br | i-Pr | Br | Br | Cl | Cl | i-Pr | Br | Cl | Cl | Br |
| t-Bu | CH₃ | CF₃ | CF₃ | Br | t-Bu | Br | Br | Cl | Cl | t-Bu | Br | Cl | Cl | Br |
| Me | CH₃ | CF₃ | Cl | Cl | Me | Br | Br | Cl | Br | Me | Br | Cl | Br | Cl |
| Et | CH₃ | CF₃ | Cl | Cl | Et | Br | Br | Cl | Br | Et | Br | Cl | Br | Cl |
| i-Pr | CH₃ | CF₃ | Cl | Cl | i-Pr | Br | Br | Cl | Br | i-Pr | Br | Cl | Br | Cl |
| t-Bu | CH₃ | CF₃ | Cl | Cl | t-Bu | Br | Br | Cl | Br | t-Bu | Br | Cl | Br | Cl |
| Me | CH₃ | CF₃ | Cl | Br | Me | CH₃ | CF₃ | Br | Cl | Me | Br | Cl | Br | Br |
| Et | CH₃ | CF₃ | Cl | Br | Et | CH₃ | CF₃ | Br | Cl | Et | Br | Cl | Br | Br |
| i-Pr | CH₃ | CF₃ | Cl | Br | i-Pr | CH₃ | CF₃ | Br | Cl | i-Pr | Br | Cl | Br | Br |
| t-Bu | CH₃ | CF₃ | Cl | Br | t-Bu | CH₃ | CF₃ | Br | Cl | t-Bu | Br | Cl | Br | Br |
| Me | CH₃ | CF₃ | Br | Br | n-Pr | CH₃ | Cl | Cl | Cl | t-Bu | CH₃ | CF₃ | Br | Br |
| Et | CH₃ | CF₃ | Br | Br | n-Bu | CH₃ | Cl | Cl | Cl | i-Bu | CH₃ | Cl | Cl | Cl |
| i-Pr | CH₃ | CF₃ | Br | Br | s-Bu | CH₃ | Cl | Cl | Cl | | | | | |

TABLE 12

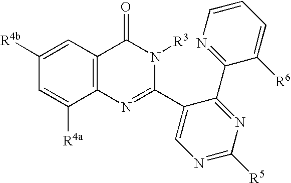

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | F | CF₃ | Cl | Me | Cl | H | Cl | Br |
| Et | CH₃ | H | CF₃ | Cl | Et | Cl | F | CF₃ | Cl | Et | Cl | H | Cl | Br |
| i-Pr | CH₃ | H | CF₃ | Cl | i-Pr | Cl | F | CF₃ | Cl | i-Pr | Cl | H | Cl | Br |
| t-Bu | CH₃ | H | CF₃ | Cl | t-Bu | Cl | F | CF₃ | Cl | t-Bu | Cl | H | Cl | Br |
| Me | CH₃ | H | CF₃ | Br | Me | Cl | F | CF₃ | Br | Me | Cl | H | Br | Cl |
| Et | CH₃ | H | CF₃ | Br | Et | Cl | F | CF₃ | Br | Et | Cl | H | Br | Cl |
| i-Pr | CH₃ | H | CF₃ | Br | i-Pr | Cl | F | CF₃ | Br | i-Pr | Cl | H | Br | Cl |
| t-Bu | CH₃ | H | CF₃ | Br | t-Bu | Cl | F | CF₃ | Br | t-Bu | Cl | H | Br | Cl |
| Me | CH₃ | H | Cl | Cl | Me | Cl | F | Cl | Cl | Me | Cl | H | Br | Br |
| Et | CH₃ | H | Cl | Cl | Et | Cl | F | Cl | Cl | Et | Cl | H | Br | Br |
| i-Pr | CH₃ | H | Cl | Cl | i-Pr | Cl | F | Cl | Cl | i-Pr | Cl | H | Br | Br |
| t-Bu | CH₃ | H | Cl | Cl | t-Bu | Cl | F | Cl | Cl | t-Bu | Cl | H | Br | Br |
| Me | CH₃ | H | Cl | Br | Me | Cl | F | Cl | Br | Me | Cl | H | CF₃ | Cl |
| Et | CH₃ | H | Cl | Br | Et | Cl | F | Cl | Br | Et | Cl | H | CF₃ | Cl |
| i-Pr | CH₃ | H | Cl | Br | i-Pr | Cl | F | Cl | Br | i-Pr | Cl | H | CF₃ | Cl |
| t-Bu | CH₃ | H | Cl | Br | t-Bu | Cl | F | Cl | Br | t-Bu | Cl | H | CF₃ | Cl |
| Me | CH₃ | H | Br | Cl | Me | Cl | F | Br | Cl | Me | Cl | H | CF₃ | Br |
| Et | CH₃ | H | Br | Cl | Et | Cl | F | Br | Cl | Et | Cl | H | CF₃ | Br |
| i-Pr | CH₃ | H | Br | Cl | i-Pr | Cl | F | Br | Cl | i-Pr | Cl | H | CF₃ | Br |
| t-Bu | CH₃ | H | Br | Cl | t-Bu | Cl | F | Br | Cl | t-Bu | Cl | H | CF₃ | Br |
| Me | CH₃ | H | Br | Br | Me | Cl | F | Br | Br | Me | Cl | H | Cl | Cl |
| Et | CH₃ | H | Br | Br | Et | Cl | F | Br | Br | Et | Cl | H | Cl | Cl |
| i-Pr | CH₃ | H | Br | Br | i-Pr | Cl | F | Br | Br | i-Pr | Cl | H | Cl | Cl |
| t-Bu | CH₃ | H | Br | Br | t-Bu | Cl | F | Br | Br | i-Pr | Cl | H | Cl | Cl |
| Me | CH₃ | F | CF₃ | Cl | Me | Cl | Cl | CF₃ | Cl | Me | Cl | Br | Cl | Br |
| Et | CH₃ | F | CF₃ | Cl | Et | Cl | Cl | CF₃ | Cl | Et | Cl | Br | Cl | Br |
| i-Pr | CH₃ | F | CF₃ | Cl | i-Pr | Cl | Cl | CF₃ | Cl | i-Pr | Cl | Br | Cl | Br |
| t-Bu | CH₃ | F | CF₃ | Cl | t-Bu | Cl | Cl | CF₃ | Cl | t-Bu | Cl | Br | Cl | Br |
| Me | CH₃ | F | CF₃ | Br | Me | Cl | Cl | CF₃ | Br | Me | Cl | Br | Br | Cl |
| Et | CH₃ | F | CF₃ | Br | Et | Cl | Cl | CF₃ | Br | Et | Cl | Br | Br | Cl |
| i-Pr | CH₃ | F | CF₃ | Br | i-Pr | Cl | Cl | CF₃ | Br | i-Pr | Cl | Br | Br | Cl |
| t-Bu | CH₃ | F | CF₃ | Br | t-Bu | Cl | Cl | CF₃ | Br | t-Bu | Cl | Br | Br | Cl |
| Me | CH₃ | F | Cl | Cl | Me | Cl | Cl | Cl | Cl | Me | Cl | Br | Br | Br |
| Et | CH₃ | F | Cl | Cl | Et | Cl | Cl | Cl | Cl | Et | Cl | Br | Br | Br |
| i-Pr | CH₃ | F | Cl | Cl | i-Pr | Cl | Cl | Cl | Cl | i-Pr | Cl | Br | Br | Br |
| t-Bu | CH₃ | F | Cl | Cl | t-Bu | Cl | Cl | Cl | Cl | t-Bu | Cl | Br | Br | Br |
| Me | CH₃ | F | Cl | Br | Me | Cl | Cl | Cl | Br | Me | Cl | I | CF₃ | Cl |
| Et | CH₃ | F | Cl | Br | Et | Cl | Cl | Cl | Br | Et | Cl | I | CF₃ | Cl |
| i-Pr | CH₃ | F | Cl | Br | i-Pr | Cl | Cl | Cl | Br | i-Pr | Cl | I | CF₃ | Cl |
| t-Bu | CH₃ | F | Cl | Br | t-Bu | Cl | Cl | Cl | Br | t-Bu | Cl | I | CF₃ | Cl |
| Me | CH₃ | F | Br | Cl | Me | Cl | Cl | Br | Cl | Me | Cl | I | CF₃ | Br |
| Et | CH₃ | F | Br | Cl | Et | Cl | Cl | Br | Cl | Et | Cl | I | CF₃ | Br |
| i-Pr | CH₃ | F | Br | Cl | i-Pr | Cl | Cl | Br | Cl | i-Pr | Cl | I | CF₃ | Br |
| t-Bu | CH₃ | F | Br | Cl | t-Bu | Cl | Cl | Br | Cl | t-Bu | Cl | I | CF₃ | Br |
| Me | CH₃ | F | Br | Br | Me | Cl | Cl | Br | Br | Me | Cl | I | Cl | Cl |
| Et | CH₃ | F | Br | Br | Et | Cl | Cl | Br | Br | Et | Cl | I | Cl | Cl |
| i-Pr | CH₃ | F | Br | Br | i-Pr | Cl | Cl | Br | Br | i-Pr | Cl | I | Cl | Cl |
| t-Bu | CH₃ | F | Br | Br | t-Bu | Cl | Cl | Br | Br | t-Bu | Cl | I | Cl | Cl |
| Me | CH₃ | Cl | CF₃ | Cl | Me | Cl | Br | CF₃ | Cl | Me | Cl | I | Cl | Br |
| Et | CH₃ | Cl | CF₃ | Cl | Et | Cl | Br | CF₃ | Cl | Et | Cl | I | Cl | Br |
| i-Pr | CH₃ | Cl | CF₃ | Cl | i-Pr | Cl | Br | CF₃ | Cl | i-Pr | Cl | I | Cl | Br |
| t-Bu | CH₃ | Cl | CF₃ | Cl | t-Bu | Cl | Br | CF₃ | Cl | t-Bu | Cl | I | Cl | Br |
| Me | CH₃ | Cl | CF₃ | Br | Me | Cl | Br | CF₃ | Br | Me | Cl | I | Br | Cl |
| Et | CH₃ | Cl | CF₃ | Br | Et | Cl | Br | CF₃ | Br | Et | Cl | I | Br | Cl |
| i-Pr | CH₃ | Cl | CF₃ | Br | i-Pr | Cl | Br | CF₃ | Br | i-Pr | Cl | I | Br | Cl |
| t-Bu | CH₃ | Cl | CF₃ | Br | t-Bu | Cl | Br | CF₃ | Br | t-Bu | Cl | I | Br | Cl |
| Me | CH₃ | Cl | Cl | Cl | Me | Cl | Br | Cl | Cl | Me | Cl | I | Br | Br |
| Et | CH₃ | Cl | Cl | Cl | Et | Cl | Br | Cl | Cl | Et | Cl | I | Br | Br |
| i-Pr | CH₃ | Cl | Cl | Cl | i-Pr | Cl | Br | Cl | Cl | i-Pr | Cl | I | Br | Br |
| t-Bu | CH₃ | Cl | Cl | Cl | t-Bu | Cl | Br | Cl | Cl | t-Bu | Cl | I | Br | Br |
| Me | CH₃ | Cl | Cl | Br | Me | Br | Br | Br | Cl | Me | Cl | CF₃ | CF₃ | Cl |
| Et | CH₃ | Cl | Cl | Br | Et | Br | Br | Br | Cl | Et | Cl | CF₃ | CF₃ | Cl |
| i-Pr | CH₃ | Cl | Cl | Br | i-Pr | Br | Br | Br | Cl | i-Pr | Cl | CF₃ | CF₃ | Cl |
| t-Bu | CH₃ | Cl | Cl | Br | t-Bu | Br | Br | Br | Cl | t-Bu | Cl | CF₃ | CF₃ | Cl |
| Me | CH₃ | Cl | Br | Cl | Me | Br | Br | Br | Br | Me | Cl | CF₃ | CF₃ | Br |
| Et | CH₃ | Cl | Br | Cl | Et | Br | Br | Br | Br | Et | Cl | CF₃ | CF₃ | Br |
| i-Pr | CH₃ | Cl | Br | Cl | i-Pr | Br | Br | Br | Br | i-Pr | Cl | CF₃ | CF₃ | Br |
| t-Bu | CH₃ | Cl | Br | Cl | t-Bu | Br | Br | Br | Br | t-Bu | Cl | CF₃ | CF₃ | Br |
| Me | CH₃ | Cl | Br | Br | Me | Br | I | CF₃ | Cl | Me | Cl | CF₃ | Cl | Cl |
| Et | CH₃ | Cl | Br | Br | Et | Br | I | CF₃ | Cl | Et | Cl | CF₃ | Cl | Cl |
| i-Pr | CH₃ | Cl | Br | Br | i-Pr | Br | I | CF₃ | Cl | i-Pr | Cl | CF₃ | Cl | Cl |
| t-Bu | CH₃ | Cl | Br | Br | t-Bu | Br | I | CF₃ | Cl | t-Bu | Cl | CF₃ | Cl | Cl |
| Me | CH₃ | Br | CF₃ | Cl | Me | Br | I | CF₃ | Br | Me | Cl | CF₃ | Cl | Br |
| Et | CH₃ | Br | CF₃ | Cl | Et | Br | I | CF₃ | Br | Et | Cl | CF₃ | Cl | Br |
| i-Pr | CH₃ | Br | CF₃ | Cl | i-Pr | Br | I | CF₃ | Br | i-Pr | Cl | CF₃ | Cl | Br |
| t-Bu | CH₃ | Br | CF₃ | Cl | t-Bu | Br | I | CF₃ | Br | t-Bu | Cl | CF₃ | Cl | Br |
| Me | CH₃ | Br | CF₃ | Br | Me | Br | I | Cl | Cl | Me | Cl | CF₃ | Br | Cl |
| Et | CH₃ | Br | CF₃ | Br | Et | Br | I | Cl | Cl | Et | Cl | CF₃ | Br | Cl |
| i-Pr | CH₃ | Br | CF₃ | Br | i-Pr | Br | I | Cl | Cl | i-Pr | Cl | CF₃ | Br | Cl |
| t-Bu | CH₃ | Br | CF₃ | Br | t-Bu | Br | I | Cl | Cl | t-Bu | Cl | CF₃ | Br | Cl |
| Me | CH₃ | Br | Cl | Cl | Me | Br | I | Cl | Br | Me | Cl | CF₃ | Br | Br |
| Et | CH₃ | Br | Cl | Cl | Et | Br | I | Cl | Br | Et | Cl | CF₃ | Br | Br |
| i-Pr | CH₃ | Br | Cl | Cl | i-Pr | Br | I | Cl | Br | i-Pr | Cl | CF₃ | Br | Br |
| t-Bu | CH₃ | Br | Cl | Cl | t-Bu | Br | I | Cl | Br | t-Bu | Cl | CF₃ | Br | Br |
| Me | CH₃ | Br | Cl | Br | Me | Br | I | Br | Cl | n-Pr | Cl | Cl | Cl | Cl |
| Et | CH₃ | Br | Cl | Br | Et | Br | I | Br | Cl | n-Bu | Cl | Cl | Cl | Cl |
| i-Pr | CH₃ | Br | Cl | Br | i-Pr | Br | I | Br | Cl | s-Bu | Cl | Cl | Cl | Cl |
| t-Bu | CH₃ | Br | Cl | Br | t-Bu | Br | I | Br | Cl | t-Bu | Cl | Cl | Cl | Cl |
| Me | CH₃ | Br | Br | Cl | Me | Br | I | Br | Br | Me | Br | F | CF₃ | Cl |
| Et | CH₃ | Br | Br | Cl | Et | Br | I | Br | Br | Et | Br | F | CF₃ | Cl |
| i-Pr | CH₃ | Br | Br | Cl | i-Pr | Br | I | Br | Br | i-Pr | Br | F | CF₃ | Cl |
| t-Bu | CH₃ | Br | Br | Cl | t-Bu | Br | I | Br | Br | t-Bu | Br | F | CF₃ | Cl |
| Me | CH₃ | Br | Br | Br | Me | Br | CF₃ | CF₃ | Cl | Me | Br | F | CF₃ | Br |
| Et | CH₃ | Br | Br | Br | Et | Br | CF₃ | CF₃ | Cl | Et | Br | F | CF₃ | Br |
| i-Pr | CH₃ | Br | Br | Br | i-Pr | Br | CF₃ | CF₃ | Cl | i-Pr | Br | F | CF₃ | Br |
| t-Bu | CH₃ | Br | Br | Br | t-Bu | Br | CF₃ | CF₃ | Cl | t-Bu | Br | F | CF₃ | Br |
| Me | CH₃ | I | CF₃ | Cl | Me | Br | CF₃ | CF₃ | Br | Me | Br | F | Cl | Cl |
| Et | CH₃ | I | CF₃ | Cl | Et | Br | CF₃ | CF₃ | Br | Et | Br | F | Cl | Cl |
| i-Pr | CH₃ | I | CF₃ | Cl | i-Pr | Br | CF₃ | CF₃ | Br | i-Pr | Br | F | Cl | Cl |
| t-Bu | CH₃ | I | CF₃ | Cl | t-Bu | Br | CF₃ | CF₃ | Br | t-Bu | Br | F | Cl | Cl |
| Me | CH₃ | I | CF₃ | Br | Me | Br | CF₃ | Cl | Cl | Me | Br | F | Cl | Br |
| Et | CH₃ | I | CF₃ | Br | Et | Br | CF₃ | Cl | Cl | Et | Br | F | Cl | Br |
| i-Pr | CH₃ | I | CF₃ | Br | i-Pr | Br | CF₃ | Cl | Cl | i-Pr | Br | F | Cl | Br |
| t-Bu | CH₃ | I | CF₃ | Br | t-Bu | Br | CF₃ | Cl | Cl | t-Bu | Br | F | Cl | Br |
| Me | CH₃ | I | Cl | Cl | Me | Br | CF₃ | Cl | Br | Me | Br | F | Br | Cl |
| Et | CH₃ | I | Cl | Cl | Et | Br | CF₃ | Cl | Br | Et | Br | F | Br | Cl |
| i-Pr | CH₃ | I | Cl | Cl | i-Pr | Br | CF₃ | Cl | Br | i-Pr | Br | F | Br | Cl |
| t-Bu | CH₃ | I | Cl | Cl | t-Bu | Br | CF₃ | Cl | Br | t-Bu | Br | F | Br | Cl |
| Me | CH₃ | I | Cl | Br | Me | Br | CF₃ | Br | Cl | Me | Br | F | Br | Br |
| Et | CH₃ | I | Cl | Br | Et | Br | CF₃ | Br | Cl | Et | Br | F | Br | Br |
| i-Pr | CH₃ | I | Cl | Br | i-Pr | Br | CF₃ | Br | Cl | i-Pr | Br | F | Br | Br |
| t-Bu | CH₃ | I | Cl | Br | t-Bu | Br | CF₃ | Br | Cl | t-Bu | Br | F | Br | Br |
| Me | CH₃ | I | Br | Cl | Me | Br | CF₃ | Br | Br | Me | Br | Cl | CF₃ | Cl |
| Et | CH₃ | I | Br | Cl | Et | Br | CF₃ | Br | Br | Et | Br | Cl | CF₃ | Cl |
| i-Pr | CH₃ | I | Br | Cl | i-Pr | Br | CF₃ | Br | Br | i-Pr | Br | Cl | CF₃ | Cl |
| t-Bu | CH₃ | I | Br | Cl | t-Bu | Br | CF₃ | Br | Br | t-Bu | Br | Cl | CF₃ | Cl |
| Me | CH₃ | I | Br | Br | Me | Br | Br | CF₃ | Cl | Me | Br | Cl | CF₃ | Br |
| Et | CH₃ | I | Br | Br | Et | Br | Br | CF₃ | Cl | Et | Br | Cl | CF₃ | Br |
| i-Pr | CH₃ | I | Br | Br | i-Pr | Br | Br | CF₃ | Cl | i-Pr | Br | Cl | CF₃ | Br |
| t-Bu | CH₃ | I | Br | Br | t-Bu | Br | Br | CF₃ | Cl | t-Bu | Br | Cl | CF₃ | Br |
| Me | CH₃ | CF₃ | CF₃ | Cl | Me | Br | Br | CF₃ | Br | Me | Br | Cl | Cl | Cl |
| Et | CH₃ | CF₃ | CF₃ | Cl | Et | Br | Br | CF₃ | Br | Et | Br | Cl | Cl | Cl |
| i-Pr | CH₃ | CF₃ | CF₃ | Cl | i-Pr | Br | Br | CF₃ | Br | i-Pr | Br | Cl | Cl | Cl |
| t-Bu | CH₃ | CF₃ | CF₃ | Cl | t-Bu | Br | Br | CF₃ | Br | t-Bu | Br | Cl | Cl | Cl |
| Me | CH₃ | CF₃ | CF₃ | Br | Me | Br | Br | Cl | Cl | Me | Br | Cl | Cl | Br |
| Et | CH₃ | CF₃ | CF₃ | Br | Et | Br | Br | Cl | Cl | Et | Br | Cl | Cl | Br |
| i-Pr | CH₃ | CF₃ | CF₃ | Br | i-Pr | Br | Br | Cl | Cl | i-Pr | Br | Cl | Cl | Br |
| t-Bu | CH₃ | CF₃ | CF₃ | Br | t-Bu | Br | Br | Cl | Cl | t-Bu | Br | Cl | Cl | Br |
| Me | CH₃ | CF₃ | Cl | Cl | Me | Br | Br | Cl | Br | Me | Br | Cl | Br | Cl |
| Et | CH₃ | CF₃ | Cl | Cl | Et | Br | Br | Cl | Br | Et | Br | Cl | Br | Cl |
| i-Pr | CH₃ | CF₃ | Cl | Cl | i-Pr | Br | Br | Cl | Br | i-Pr | Br | Cl | Br | Cl |
| t-Bu | CH₃ | CF₃ | Cl | Cl | t-Bu | Br | Br | Cl | Br | t-Bu | Br | Cl | Br | Cl |
| Me | CH₃ | CF₃ | Cl | Br | Me | CH₃ | CF₃ | Br | Cl | Me | Br | Cl | Br | Br |
| Et | CH₃ | CF₃ | Cl | Br | Et | CH₃ | CF₃ | Br | Cl | Et | Br | Cl | Br | Br |
| i-Pr | CH₃ | CF₃ | Cl | Br | i-Pr | CH₃ | CF₃ | Br | Cl | i-Pr | Br | Cl | Br | Br |
| t-Bu | CH₃ | CF₃ | Cl | Br | t-Bu | CH₃ | CF₃ | Br | Cl | t-Bu | Br | Cl | Br | Br |
| Me | CH₃ | CF₃ | Br | Br | n-Pr | CH₃ | Cl | Cl | Cl | t-Bu | CH₃ | CF₃ | Br | Br |
| Et | CH₃ | CF₃ | Br | Br | n-Bu | CH₃ | Cl | Cl | Cl | t-Bu | CH₃ | Cl | Cl | Cl |
| i-Pr | CH₃ | CF₃ | Br | Br | s-Bu | CH₃ | Cl | Cl | Cl | | | | | |

TABLE 13

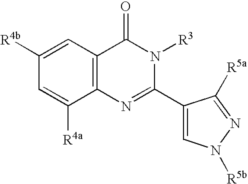

| R^{5b} is CHF₂ | | | | R^{5b} is CH₂CF₃ | | | | R^{5b} is CF₂CHF₂ | | | |
|---|---|---|---|---|---|---|---|---|---|---|---|
| R³ | R^{4a} | R^{4b} | R^{5a} | R³ | R^{4a} | R^{4b} | R^{5a} | R³ | R^{4a} | R^{4b} | R^{5a} |
| i-Pr | Me | H | Me | i-Pr | Me | H | Me | i-Pr | Me | H | Me |
| i-Pr | Cl | H | Me | i-Pr | Cl | H | Me | i-Pr | Cl | H | Me |
| i-Pr | Me | Cl | Me | i-Pr | Me | Cl | Me | i-Pr | Me | Cl | Me |
| i-Pr | Cl | Cl | Me | i-Pr | Cl | Cl | Me | i-Pr | Cl | Cl | Me |
| i-Pr | Me | Br | Me | i-Pr | Me | Br | Me | i-Pr | Me | Br | Me |
| i-Pr | Cl | Br | Me | i-Pr | Cl | Br | Me | i-Pr | Cl | Br | Me |
| t-Bu | Me | H | Me | t-Bu | Me | H | Me | t-Bu | Me | H | Me |
| t-Bu | Cl | H | Me | t-Bu | Cl | H | Me | t-Bu | Cl | H | Me |
| t-Bu | Me | Cl | Me | t-Bu | Me | Cl | Me | t-Bu | Me | Cl | Me |
| t-Bu | Cl | Cl | Me | t-Bu | Cl | Cl | Me | t-Bu | Cl | Cl | Me |
| t-Bu | Me | Br | Me | t-Bu | Me | Br | Me | t-Bu | Me | Br | Me |
| t-Bu | Cl | Br | Me | t-Bu | Cl | Br | Me | t-Bu | Cl | Br | Me |
| Et | Me | H | Me | Et | Me | H | Me | Et | Me | H | Me |
| Et | Cl | H | Me | Et | Cl | H | Me | Et | Cl | H | Me |
| Et | Me | Cl | Me | Et | Me | Cl | Me | Et | Me | Cl | Me |
| Et | Cl | Cl | Me | Et | Cl | Cl | Me | Et | Cl | Cl | Me |
| Et | Me | Br | Me | Et | Me | Br | Me | Et | Me | Br | Me |
| Et | Cl | Br | Me | Et | Cl | Br | Me | Et | Cl | Br | Me |
| Me | Me | H | Me | Me | Me | H | Me | Me | Me | H | Me |
| Me | Cl | H | Me | Me | Cl | H | Me | Me | Cl | H | Me |
| Me | Me | Cl | Me | Me | Me | Cl | Me | Me | Me | Cl | Me |
| Me | Cl | Cl | Me | Me | Cl | Cl | Me | Me | Cl | Cl | Me |
| Me | Me | Br | Me | Me | Me | Br | Me | Me | Me | Br | Me |
| Me | Cl | Br | Me | Me | Cl | Br | Me | Me | Cl | Br | Me |

TABLE 14

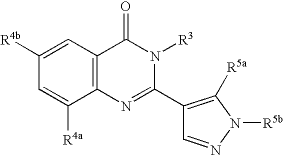

| R^{5b} is CHF₂ | | | | R^{5b} is CH₂CF₃ | | | | R^{5b} is CF₂CHF₂ | | | |
|---|---|---|---|---|---|---|---|---|---|---|---|
| R³ | R^{4a} | R^{4b} | R^{5a} | R³ | R^{4a} | R^{4b} | R^{5a} | R³ | R^{4a} | R^{4b} | R^{5a} |
| i-Pr | Me | H | Me | i-Pr | Me | H | Me | i-Pr | Me | H | Me |
| i-Pr | Cl | H | Me | i-Pr | Cl | H | Me | i-Pr | Cl | H | Me |
| i-Pr | Me | Cl | Me | i-Pr | Me | Cl | Me | i-Pr | Me | Cl | Me |
| i-Pr | Cl | Cl | Me | i-Pr | Cl | Cl | Me | i-Pr | Cl | Cl | Me |
| i-Pr | Me | Br | Me | i-Pr | Me | Br | Me | i-Pr | Me | Br | Me |
| i-Pr | Cl | Br | Me | i-Pr | Cl | Br | Me | i-Pr | Cl | Br | Me |
| t-Bu | Me | H | Me | t-Bu | Me | H | Me | t-Bu | Me | H | Me |
| t-Bu | Cl | H | Me | t-Bu | Cl | H | Me | t-Bu | Cl | H | Me |
| t-Bu | Me | Cl | Me | t-Bu | Me | Cl | Me | t-Bu | Me | Cl | Me |
| t-Bu | Cl | Cl | Me | t-Bu | Cl | Cl | Me | t-Bu | Cl | Cl | Me |
| t-Bu | Me | Br | Me | t-Bu | Me | Br | Me | t-Bu | Me | Br | Me |
| t-Bu | Cl | Br | Me | t-Bu | Cl | Br | Me | t-Bu | Cl | Br | Me |
| Et | Me | H | Me | Et | Me | H | Me | Et | Me | H | Me |
| Et | Cl | H | Me | Et | Cl | H | Me | Et | Cl | H | Me |
| Et | Me | Cl | Me | Et | Me | Cl | Me | Et | Me | Cl | Me |
| Et | Cl | Cl | Me | Et | Cl | Cl | Me | Et | Cl | Cl | Me |
| Et | Me | Br | Me | Et | Me | Br | Me | Et | Me | Br | Me |
| Et | Cl | Br | Me | Et | Cl | Br | Me | Et | Cl | Br | Me |
| Me | Me | H | Me | Me | Me | H | Me | Me | Me | H | Me |
| Me | Cl | H | Me | Me | Cl | H | Me | Me | Cl | H | Me |
| Me | Me | Cl | Me | Me | Me | Cl | Me | Me | Me | Cl | Me |
| Me | Cl | Cl | Me | Me | Cl | Cl | Me | Me | Cl | Cl | Me |
| Me | Me | Br | Me | Me | Me | Br | Me | Me | Me | Br | Me |
| Me | Cl | Br | Me | Me | Cl | Br | Me | Me | Cl | Br | Me |

TABLE 15

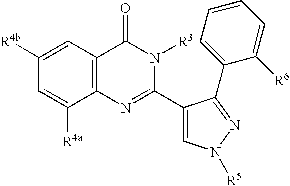

| R⁵ is CHF₂ | | | | R⁵ is CH₂CF₃ | | | | R⁵ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | H | Cl |
| Et | CH₃ | H | Cl | Et | CH₃ | H | Cl | Et | CH₃ | H | Cl |
| i-Pr | CH₃ | H | Cl | i-Pr | CH₃ | H | Cl | i-Pr | CH₃ | H | Cl |
| t-Bu | CH₃ | H | Cl | t-Bu | CH₃ | H | Cl | t-Bu | CH₃ | H | Cl |
| Me | CH₃ | H | Br | Me | CH₃ | H | Br | Me | CH₃ | H | Br |
| Et | CH₃ | H | Br | Et | CH₃ | H | Br | Et | CH₃ | H | Br |
| i-Pr | CH₃ | H | Br | i-Pr | CH₃ | H | Br | i-Pr | CH₃ | H | Br |
| t-Bu | CH₃ | H | Br | t-Bu | CH₃ | H | Br | t-Bu | CH₃ | H | Br |
| Me | CH₃ | F | Cl | Me | CH₃ | F | Cl | Me | CH₃ | F | Cl |
| Et | CH₃ | F | Cl | Et | CH₃ | F | Cl | Et | CH₃ | F | Cl |
| i-Pr | CH₃ | F | Cl | i-Pr | CH₃ | F | Cl | i-Pr | CH₃ | F | Cl |
| t-Bu | CH₃ | F | Cl | t-Bu | CH₃ | F | Cl | t-Bu | CH₃ | F | Cl |
| Me | CH₃ | F | Br | Me | CH₃ | F | Br | Me | CH₃ | F | Br |
| Et | CH₃ | F | Br | Et | CH₃ | F | Br | Et | CH₃ | F | Br |
| i-Pr | CH₃ | F | Br | i-Pr | CH₃ | F | Br | i-Pr | CH₃ | F | Br |
| t-Bu | CH₃ | F | Br | t-Bu | CH₃ | F | Br | t-Bu | CH₃ | F | Br |
| Me | CH₃ | Cl | Cl | Me | CH₃ | Cl | Cl | Me | CH₃ | Cl | Cl |
| Et | CH₃ | Cl | Cl | Et | CH₃ | Cl | Cl | Et | CH₃ | Cl | Cl |
| i-Pr | CH₃ | Cl | Cl | i-Pr | CH₃ | Cl | Cl | i-Pr | CH₃ | Cl | Cl |
| t-Bu | CH₃ | Cl | Cl | t-Bu | CH₃ | Cl | Cl | t-Bu | CH₃ | Cl | Cl |
| Me | CH₃ | Cl | Br | Me | CH₃ | Cl | Br | Me | CH₃ | Cl | Br |
| Et | CH₃ | Cl | Br | Et | CH₃ | Cl | Br | Et | CH₃ | Cl | Br |
| i-Pr | CH₃ | Cl | Br | i-Pr | CH₃ | Cl | Br | i-Pr | CH₃ | Cl | Br |
| t-Bu | CH₃ | Cl | Br | t-Bu | CH₃ | Cl | Br | t-Bu | CH₃ | Cl | Br |
| Me | CH₃ | Br | Cl | Me | CH₃ | Br | Cl | Me | CH₃ | Br | Cl |
| Et | CH₃ | Br | Cl | Et | CH₃ | Br | Cl | Et | CH₃ | Br | Cl |
| i-Pr | CH₃ | Br | Cl | i-Pr | CH₃ | Br | Cl | i-Pr | CH₃ | Br | Cl |
| t-Bu | CH₃ | Br | Cl | t-Bu | CH₃ | Br | Cl | t-Bu | CH₃ | Br | Cl |
| Me | CH₃ | Br | Br | Me | CH₃ | Br | Br | Me | CH₃ | Br | Br |
| Et | CH₃ | Br | Br | Et | CH₃ | Br | Br | Et | CH₃ | Br | Br |
| i-Pr | CH₃ | Br | Br | i-Pr | CH₃ | Br | Br | i-Pr | CH₃ | Br | Br |
| t-Bu | CH₃ | Br | Br | t-Bu | CH₃ | Br | Br | t-Bu | CH₃ | Br | Br |
| Me | CH₃ | I | Cl | Me | CH₃ | I | Cl | Me | CH₃ | I | Cl |
| Et | CH₃ | I | Cl | Et | CH₃ | I | Cl | Et | CH₃ | I | Cl |
| i-Pr | CH₃ | I | Cl | i-Pr | CH₃ | I | Cl | i-Pr | CH₃ | I | Cl |
| t-Bu | CH₃ | I | Cl | t-Bu | CH₃ | I | Cl | t-Bu | CH₃ | I | Cl |
| Me | CH₃ | I | Br | Me | CH₃ | I | Br | Me | CH₃ | I | Br |
| Et | CH₃ | I | Br | Et | CH₃ | I | Br | Et | CH₃ | I | Br |
| i-Pr | CH₃ | I | Br | i-Pr | CH₃ | I | Br | i-Pr | CH₃ | I | Br |
| t-Bu | CH₃ | I | Br | t-Bu | CH₃ | I | Br | t-Bu | CH₃ | I | Br |
| Me | CH₃ | CF₃ | Cl | Me | CH₃ | CF₃ | Cl | Me | CH₃ | CF₃ | Cl |
| Et | CH₃ | CF₃ | Cl | Et | CH₃ | CF₃ | Cl | Et | CH₃ | CF₃ | Cl |
| i-Pr | CH₃ | CF₃ | Cl | i-Pr | CH₃ | CF₃ | Cl | i-Pr | CH₃ | CF₃ | Cl |
| t-Bu | CH₃ | CF₃ | Cl | t-Bu | CH₃ | CF₃ | Cl | t-Bu | CH₃ | CF₃ | Cl |
| Me | CH₃ | CF₃ | Br | Me | CH₃ | CF₃ | Br | Me | CH₃ | CF₃ | Br |
| Et | CH₃ | CF₃ | Br | Et | CH₃ | CF₃ | Br | Et | CH₃ | CF₃ | Br |
| i-Pr | CH₃ | CF₃ | Br | i-Pr | CH₃ | CF₃ | Br | i-Pr | CH₃ | CF₃ | Br |
| t-Bu | CH₃ | CF₃ | Br | t-Bu | CH₃ | CF₃ | Br | t-Bu | CH₃ | CF₃ | Br |
| n-Pr | CH₃ | Cl | Cl | Me | Cl | F | Br | Me | Cl | H | Br |
| n-Bu | CH₃ | Cl | Cl | Et | Cl | F | Br | Et | Cl | H | Br |
| s-Bu | CH₃ | Cl | Cl | i-Pr | Cl | F | Br | i-Pr | Cl | H | Br |
| t-Bu | CH₃ | Cl | Cl | t-Bu | Cl | F | Br | t-Bu | Cl | H | Br |
| Me | Cl | F | Cl | Me | Cl | F | Cl | Me | Cl | H | Cl |
| Et | Cl | F | Cl | Et | Cl | F | Cl | Et | Cl | H | Cl |
| i-Pr | Cl | F | Cl | i-Pr | Cl | F | Cl | i-Pr | Cl | H | Cl |
| t-Bu | Cl | F | Cl | t-Bu | Cl | F | Cl | i-Pr | Cl | H | Cl |
| Me | Cl | F | Br | Me | Cl | Cl | Br | Me | Cl | I | Br |
| Et | Cl | F | Br | Et | Cl | Cl | Br | Et | Cl | I | Br |
| i-Pr | Cl | F | Br | i-Pr | Cl | Cl | Br | i-Pr | Cl | I | Br |
| t-Bu | Cl | F | Br | t-Bu | Cl | Cl | Br | t-Bu | Cl | I | Br |
| Me | Cl | Cl | Cl | Me | Cl | Cl | Cl | Me | Cl | I | Cl |
| Et | Cl | Cl | Cl | Et | Cl | Cl | Cl | Et | Cl | I | Cl |
| i-Pr | Cl | Cl | Cl | i-Pr | Cl | Cl | Cl | i-Pr | Cl | I | Cl |
| t-Bu | Cl | Cl | Cl | t-Bu | Cl | Cl | Cl | t-Bu | Cl | I | Cl |
| Me | Cl | H | Br | Me | Cl | H | Br | Me | Cl | F | Br |
| Et | Cl | H | Br | Et | Cl | H | Br | Et | Cl | F | Br |
| i-Pr | Cl | H | Br | i-Pr | Cl | H | Br | i-Pr | Cl | F | Br |
| t-Bu | Cl | H | Br | t-Bu | Cl | H | Br | t-Bu | Cl | F | Br |
| Me | Cl | H | Cl | Me | Cl | H | Cl | Me | Cl | F | Cl |
| Et | Cl | H | Cl | Et | Cl | H | Cl | Et | Cl | F | Cl |
| i-Pr | Cl | H | Cl | i-Pr | Cl | H | Cl | i-Pr | Cl | F | Cl |
| t-Bu | Cl | H | Cl | t-Bu | Cl | H | Cl | t-Bu | Cl | F | Cl |
| Me | Cl | Br | Br | Me | Cl | Br | Br | Me | Cl | CF₃ | Br |
| Et | Cl | Br | Br | Et | Cl | Br | Br | Et | Cl | CF₃ | Br |
| i-Pr | Cl | Br | Br | i-Pr | Cl | Br | Br | i-Pr | Cl | CF₃ | Br |
| t-Bu | Cl | Br | Br | t-Bu | Cl | Br | Br | t-Bu | Cl | CF₃ | Br |
| Me | Cl | Br | Cl | Me | Cl | I | Cl | Me | Cl | CF₃ | Cl |
| Et | Cl | Br | Cl | Et | Cl | I | Cl | Et | Cl | CF₃ | Cl |
| i-Pr | Cl | Br | Cl | i-Pr | Cl | I | Cl | i-Pr | Cl | CF₃ | Cl |
| t-Bu | Cl | Br | Cl | I-Bu | Cl | I | Cl | t-Bu | Cl | CF₃ | Cl |
| Me | Cl | I | Br | Me | Cl | I | Br | Me | Br | F | Cl |
| Et | Cl | I | Br | Et | Cl | I | Br | Et | Br | F | Cl |
| i-Pr | Cl | I | Br | i-Pr | Cl | I | Br | i-Pr | Br | F | Cl |
| t-Bu | Cl | I | Br | t-Bu | Cl | I | Br | t-Bu | Br | F | Cl |
| Me | Cl | I | Cl | Me | Cl | CF₃ | Cl | Me | Br | F | Br |
| Et | Cl | I | Cl | Et | Cl | CF₃ | Cl | Et | Br | F | Br |
| i-Pr | Cl | I | Cl | i-Pr | Cl | CF₃ | Cl | i-Pr | Br | F | Br |
| t-Bu | Cl | I | Cl | t-Bu | Cl | CF₃ | Cl | t-Bu | Br | F | Br |
| Me | Cl | CF₃ | Br | Me | Cl | CF₃ | Br | Me | Br | Cl | Cl |
| Et | Cl | CF₃ | Br | Et | Cl | CF₃ | Br | Et | Br | Cl | Cl |
| i-Pr | Cl | CF₃ | Br | i-Pr | Cl | CF₃ | Br | i-Pr | Br | Cl | Cl |
| t-Bu | Cl | CF₃ | Br | t-Bu | Cl | CF₃ | Br | t-Bu | Br | Cl | Cl |
| Me | Cl | CF₃ | Cl | n-Pr | Cl | Cl | Cl | Me | Br | Cl | Br |
| Et | Cl | CF₃ | Cl | n-Bu | Cl | Cl | Cl | Et | Br | Cl | Br |
| i-Pr | Cl | CF₃ | Cl | s-Bu | Cl | Cl | Cl | i-Pr | Br | Cl | Br |
| t-Bu | Cl | CF₃ | Cl | t-Bu | Cl | Cl | Cl | t-Bu | Br | Cl | Br |
| Me | Br | F | Cl | Me | Br | F | Cl | Me | Br | Br | Cl |
| Et | Br | F | Cl | Et | Br | F | Cl | Et | Br | Br | Cl |
| i-Pr | Br | F | Cl | i-Pr | Br | F | Cl | i-Pr | Br | Br | Cl |
| t-Bu | Br | F | Cl | t-Bu | Br | F | Cl | t-Bu | Br | Br | Cl |
| Me | Br | F | Br | Me | Br | F | Br | Me | Br | Br | Br |
| Et | Br | F | Br | Et | Br | F | Br | Et | Br | Br | Br |
| i-Pr | Br | F | Br | i-Pr | Br | F | Br | i-Pr | Br | Br | Br |
| t-Bu | Br | F | Br | t-Bu | Br | F | Br | t-Bu | Br | Br | Br |
| Me | Br | Cl | Cl | Me | Br | Cl | Cl | Me | Br | I | Cl |
| Et | Br | Cl | Cl | Et | Br | Cl | Cl | Et | Br | I | Cl |
| i-Pr | Br | Cl | Cl | i-Pr | Br | Cl | Cl | i-Pr | Br | I | Cl |
| t-Bu | Br | Cl | Cl | t-Bu | Br | Cl | Cl | t-Bu | Br | I | Cl |
| Me | Br | Cl | Br | Me | Br | Cl | Br | Me | Br | I | Br |
| Et | Br | Cl | Br | Et | Br | Cl | Br | Et | Br | I | Br |
| i-Pr | Br | Cl | Br | i-Pr | Br | Cl | Br | i-Pr | Br | I | Br |
| t-Bu | Br | Cl | Br | t-Bu | Br | Cl | Br | t-Bu | Br | I | Br |
| Me | Br | Br | Cl | Me | Br | Br | Cl | Me | Br | CF₃ | Cl |
| Et | Br | Br | Cl | Et | Br | Br | Cl | Et | Br | CF₃ | Cl |
| i-Pr | Br | Br | Cl | i-Pr | Br | Br | Cl | i-Pr | Br | CF₃ | Cl |
| t-Bu | Br | Br | Cl | t-Bu | Br | Br | Cl | t-Bu | Br | CF₃ | Cl |
| Me | Br | Br | Br | Me | Br | Br | Br | Me | Br | CF₃ | Br |
| Et | Br | Br | Br | Et | Br | Br | Br | Et | Br | CF₃ | Br |
| i-Pr | Br | Br | Br | i-Pr | Br | Br | Br | i-Pr | Br | CF₃ | Br |
| t-Bu | Br | Br | Br | t-Bu | Br | Br | Br | t-Bu | Br | CF₃ | Br |
| Me | Br | I | Cl | Me | Br | I | Cl | Me | Cl | Cl | Br |
| Et | Br | I | Cl | Et | Br | I | Cl | Et | Cl | Cl | Br |
| i-Pr | Br | I | Cl | i-Pr | Br | I | Cl | i-Pr | Cl | Cl | Br |
| t-Bu | Br | I | Cl | t-Bu | Br | I | Cl | t-Bu | Cl | Cl | Br |
| Me | Br | I | Br | Me | Br | I | Br | Me | Cl | Cl | Cl |
| Et | Br | I | Br | Et | Br | I | Br | Et | Cl | Cl | Cl |
| i-Pr | Br | I | Br | i-Pr | Br | I | Br | i-Pr | Cl | Cl | Cl |
| t-Bu | Br | I | Br | t-Bu | Br | I | Br | t-Bu | Cl | Cl | Cl |

TABLE 16

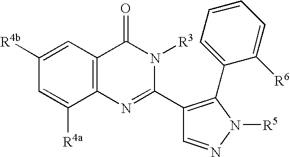

| R⁵ is CHF₂ | | | | R⁵ is CH₂CF₃ | | | | R⁵ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | H | Cl |
| Et | CH₃ | H | Cl | Et | CH₃ | H | Cl | Et | CH₃ | H | Cl |
| i-Pr | CH₃ | H | Cl | i-Pr | CH₃ | H | Cl | i-Pr | CH₃ | H | Cl |
| t-Bu | CH₃ | H | Cl | t-Bu | CH₃ | H | Cl | t-Bu | CH₃ | H | Cl |
| Me | CH₃ | H | Br | Me | CH₃ | H | Br | Me | CH₃ | H | Br |
| Et | CH₃ | H | Br | Et | CH₃ | H | Br | Et | CH₃ | H | Br |
| i-Pr | CH₃ | H | Br | i-Pr | CH₃ | H | Br | i-Pr | CH₃ | H | Br |
| t-Bu | CH₃ | H | Br | t-Bu | CH₃ | H | Br | t-Bu | CH₃ | H | Br |
| Me | CH₃ | F | Cl | Me | CH₃ | F | Cl | Me | CH₃ | F | Cl |
| Et | CH₃ | F | Cl | Et | CH₃ | F | Cl | Et | CH₃ | F | Cl |
| i-Pr | CH₃ | F | Cl | i-Pr | CH₃ | F | Cl | i-Pr | CH₃ | F | Cl |
| t-Bu | CH₃ | F | Cl | t-Bu | CH₃ | F | Cl | t-Bu | CH₃ | F | Cl |
| Me | CH₃ | F | Br | Me | CH₃ | F | Br | Me | CH₃ | F | Br |
| Et | CH₃ | F | Br | Et | CH₃ | F | Br | Et | CH₃ | F | Br |
| i-Pr | CH₃ | F | Br | i-Pr | CH₃ | F | Br | i-Pr | CH₃ | F | Br |
| t-Bu | CH₃ | F | Br | t-Bu | CH₃ | F | Br | t-Bu | CH₃ | F | Br |
| Me | CH₃ | Cl | Cl | Me | CH₃ | Cl | Cl | Me | CH₃ | Cl | Cl |
| Et | CH₃ | Cl | Cl | Et | CH₃ | Cl | Cl | Et | CH₃ | Cl | Cl |
| i-Pr | CH₃ | Cl | Cl | i-Pr | CH₃ | Cl | Cl | i-Pr | CH₃ | Cl | Cl |
| t-Bu | CH₃ | Cl | Cl | t-Bu | CH₃ | Cl | Cl | t-Bu | CH₃ | Cl | Cl |
| Me | CH₃ | Cl | Br | Me | CH₃ | Cl | Br | Me | CH₃ | Cl | Br |
| Et | CH₃ | Cl | Br | Et | CH₃ | Cl | Br | Et | CH₃ | Cl | Br |
| i-Pr | CH₃ | Cl | Br | i-Pr | CH₃ | Cl | Br | i-Pr | CH₃ | Cl | Br |
| t-Bu | CH₃ | Cl | Br | t-Bu | CH₃ | Cl | Br | t-Bu | CH₃ | Cl | Br |
| Me | CH₃ | Br | Cl | Me | CH₃ | Br | Cl | Me | CH₃ | Br | Cl |
| Et | CH₃ | Br | Cl | Et | CH₃ | Br | Cl | Et | CH₃ | Br | Cl |
| i-Pr | CH₃ | Br | Cl | i-Pr | CH₃ | Br | Cl | i-Pr | CH₃ | Br | Cl |
| t-Bu | CH₃ | Br | Cl | t-Bu | CH₃ | Br | Cl | t-Bu | CH₃ | Br | Cl |
| Me | CH₃ | Br | Br | Me | CH₃ | Br | Br | Me | CH₃ | Br | Br |
| Et | CH₃ | Br | Br | Et | CH₃ | Br | Br | Et | CH₃ | Br | Br |
| i-Pr | CH₃ | Br | Br | i-Pr | CH₃ | Br | Br | i-Pr | CH₃ | Br | Br |
| t-Bu | CH₃ | Br | Br | t-Bu | CH₃ | Br | Br | t-Bu | CH₃ | Br | Br |
| Me | CH₃ | I | Cl | Me | CH₃ | I | Cl | Me | CH₃ | I | Cl |
| Et | CH₃ | I | Cl | Et | CH₃ | I | Cl | Et | CH₃ | I | Cl |
| i-Pr | CH₃ | I | Cl | i-Pr | CH₃ | I | Cl | i-Pr | CH₃ | I | Cl |
| t-Bu | CH₃ | I | Cl | t-Bu | CH₃ | I | Cl | t-Bu | CH₃ | I | Cl |
| Me | CH₃ | I | Br | Me | CH₃ | I | Br | Me | CH₃ | I | Br |
| Et | CH₃ | I | Br | Et | CH₃ | I | Br | Et | CH₃ | I | Br |
| i-Pr | CH₃ | I | Br | i-Pr | CH₃ | I | Br | i-Pr | CH₃ | I | Br |
| t-Bu | CH₃ | I | Br | t-Bu | CH₃ | I | Br | t-Bu | CH₃ | I | Br |
| Me | CH₃ | CF₃ | Cl | Me | CH₃ | CF₃ | Cl | Me | CH₃ | CF₃ | Cl |
| Et | CH₃ | CF₃ | Cl | Et | CH₃ | CF₃ | Cl | Et | CH₃ | CF₃ | Cl |
| i-Pr | CH₃ | CF₃ | Cl | i-Pr | CH₃ | CF₃ | Cl | i-Pr | CH₃ | CF₃ | Cl |
| t-Bu | CH₃ | CF₃ | Cl | t-Bu | CH₃ | CF₃ | Cl | t-Bu | CH₃ | CF₃ | Cl |
| Me | CH₃ | CF₃ | Br | Me | CH₃ | CF₃ | Br | Me | CH₃ | CF₃ | Br |
| Et | CH₃ | CF₃ | Br | Et | CH₃ | CF₃ | Br | Et | CH₃ | CF₃ | Br |
| i-Pr | CH₃ | CF₃ | Br | i-Pr | CH₃ | CF₃ | Br | i-Pr | CH₃ | CF₃ | Br |
| t-Bu | CH₃ | CF₃ | Br | t-Bu | CH₃ | CF₃ | Br | t-Bu | CH₃ | CF₃ | Br |
| n-Pr | CH₃ | Cl | Cl | Me | Cl | F | Br | Me | Cl | H | Br |
| n-Bu | CH₃ | Cl | Cl | Et | Cl | F | Br | Et | Cl | H | Br |
| s-Bu | CH₃ | Cl | Cl | i-Pr | Cl | F | Br | i-Pr | Cl | H | Br |
| t-Bu | CH₃ | Cl | Cl | t-Bu | Cl | F | Br | t-Bu | Cl | H | Br |
| Me | Cl | F | Cl | Me | Cl | F | Cl | Me | Cl | H | Cl |
| Et | Cl | F | Cl | Et | Cl | F | Cl | Et | Cl | H | Cl |
| i-Pr | Cl | F | Cl | i-Pr | Cl | F | Cl | i-Pr | Cl | H | Cl |
| t-Bu | Cl | F | Cl | t-Bu | Cl | F | Cl | i-Pr | Cl | H | Cl |
| Me | Cl | F | Br | Me | Cl | Cl | Br | Me | Cl | I | Br |
| Et | Cl | F | Br | Et | Cl | Cl | Br | Et | Cl | I | Br |
| i-Pr | Cl | F | Br | i-Pr | Cl | Cl | Br | i-Pr | Cl | I | Br |
| t-Bu | Cl | F | Br | t-Bu | Cl | Cl | Br | t-Bu | Cl | I | Br |
| Me | Cl | Cl | Cl | Me | Cl | Cl | Cl | Me | Cl | I | Cl |
| Et | Cl | Cl | Cl | Et | Cl | Cl | Cl | Et | Cl | I | Cl |
| i-Pr | Cl | Cl | Cl | i-Pr | Cl | Cl | Cl | i-Pr | Cl | I | Cl |
| t-Bu | Cl | Cl | Cl | t-Bu | Cl | Cl | Cl | t-Bu | Cl | I | Cl |
| Me | Cl | H | Br | Me | Cl | H | Br | Me | Cl | F | Br |
| Et | Cl | H | Br | Et | Cl | H | Br | Et | Cl | F | Br |
| i-Pr | Cl | H | Br | i-Pr | Cl | H | Br | i-Pr | Cl | F | Br |
| t-Bu | Cl | H | Br | t-Bu | Cl | H | Br | t-Bu | Cl | F | Br |
| Me | Cl | H | Cl | Me | Cl | H | Cl | Me | Cl | F | Cl |
| Et | Cl | H | Cl | Et | Cl | H | Cl | Et | Cl | F | Cl |
| t-Pr | Cl | H | Cl | i-Pr | Cl | H | Cl | i-Pr | Cl | F | Cl |
| t-Bu | Cl | H | Cl | t-Bu | Cl | H | Cl | t-Bu | Cl | F | Cl |
| Me | Cl | Br | Br | Me | Cl | Br | Br | Me | Cl | CF₃ | Br |
| Et | Cl | Br | Br | Et | Cl | Br | Br | Et | Cl | CF₃ | Br |
| i-Pr | Cl | Br | Br | i-Pr | Cl | Br | Br | i-Pr | Cl | CF₃ | Br |
| t-Bu | Cl | Br | Br | t-Bu | Cl | Br | Br | t-Bu | Cl | CF₃ | Br |
| Me | Cl | Br | Cl | Me | Cl | I | Cl | Me | Cl | CF₃ | Cl |
| Et | Cl | Br | Cl | Et | Cl | I | Cl | Et | Cl | CF₃ | Cl |
| i-Pr | Cl | Br | Cl | i-Pr | Cl | I | Cl | i-Pr | Cl | CF₃ | Cl |
| t-Bu | Cl | Br | Cl | t-Bu | Cl | I | Cl | t-Bu | Cl | CF₃ | Cl |
| Me | Cl | I | Br | Me | Cl | I | Br | Me | Br | F | Cl |
| Et | Cl | I | Br | Et | Cl | I | Br | Et | Br | F | Cl |
| i-Pr | Cl | I | Br | i-Pr | Cl | I | Br | i-Pr | Br | F | Cl |
| t-Bu | Cl | I | Br | t-Bu | Cl | I | Br | t-Bu | Br | F | Cl |
| Me | Cl | I | Cl | Me | Cl | CF₃ | Cl | Me | Br | F | Br |
| Et | Cl | I | Cl | Et | Cl | CF₃ | Cl | Et | Br | F | Br |
| i-Pr | Cl | I | Cl | i-Pr | Cl | CF₃ | Cl | i-Pr | Br | F | Br |
| t-Bu | Cl | I | Cl | t-Bu | Cl | CF₃ | Cl | t-Bu | Br | F | Br |
| Me | Cl | CF₃ | Br | Me | Cl | CF₃ | Br | Me | Br | Cl | Cl |
| Et | Cl | CF₃ | Br | Et | Cl | CF₃ | Br | Et | Br | Cl | Cl |
| i-Pr | Cl | CF₃ | Br | i-Pr | Cl | CF₃ | Br | i-Pr | Br | Cl | Cl |
| t-Bu | Cl | CF₃ | Br | t-Bu | Cl | CF₃ | Br | t-Bu | Br | Cl | Cl |
| Me | Cl | CF₃ | Cl | n-Pr | Cl | Cl | Cl | Me | Br | Cl | Br |
| Et | Cl | CF₃ | Cl | n-Bu | Cl | Cl | Cl | Et | Br | Cl | Br |
| i-Pr | Cl | CF₃ | Cl | s-Bu | Cl | Cl | Cl | i-Pr | Br | Cl | Br |
| t-Bu | Cl | CF₃ | Cl | t-Bu | Cl | Cl | Cl | t-Bu | Br | Cl | Br |
| Me | Br | F | Cl | Me | Br | F | Cl | Me | Br | Br | Cl |
| Et | Br | F | Cl | Et | Br | F | Cl | Et | Br | Br | Cl |
| i-Pr | Br | F | Cl | i-Pr | Br | F | Cl | i-Pr | Br | Br | Cl |
| t-Bu | Br | F | Cl | t-Bu | Br | F | Cl | t-Bu | Br | Br | Cl |
| Me | Br | F | Br | Me | Br | F | Br | Me | Br | Br | Br |
| Et | Br | F | Br | Et | Br | F | Br | Et | Br | Br | Br |
| i-Pr | Br | F | Br | i-Pr | Br | F | Br | i-Pr | Br | Br | Br |
| t-Bu | Br | F | Br | t-Bu | Br | F | Br | t-Bu | Br | Br | Br |
| Me | Br | Cl | Cl | Me | Br | Cl | Cl | Me | Br | I | Cl |
| Et | Br | Cl | Cl | Et | Br | Cl | Cl | Et | Br | I | Cl |
| i-Pr | Br | Cl | Cl | i-Pr | Br | Cl | Cl | i-Pr | Br | I | Cl |
| t-Bu | Br | Cl | Cl | t-Bu | Br | Cl | Cl | t-Bu | Br | I | Cl |
| Me | Br | Cl | Br | Me | Br | Cl | Br | Me | Br | I | Br |
| Et | Br | Cl | Br | Et | Br | Cl | Br | Et | Br | I | Br |
| i-Pr | Br | Cl | Br | i-Pr | Br | Cl | Br | i-Pr | Br | I | Br |
| t-Bu | Br | Cl | Br | t-Bu | Br | Cl | Br | t-Bu | Br | I | Br |
| Me | Br | Br | Cl | Me | Br | Br | Cl | Me | Br | CF₃ | Cl |
| Et | Br | Br | Cl | Et | Br | Br | Cl | Et | Br | CF₃ | Cl |
| i-Pr | Br | Br | Cl | i-Pr | Br | Br | Cl | i-Pr | Br | CF₃ | Cl |
| t-Bu | Br | Br | Cl | t-Bu | Br | Br | Cl | t-Bu | Br | CF₃ | Cl |
| Me | Br | Br | Br | Me | Br | Br | Br | Me | Br | CF₃ | Br |
| Et | Br | Br | Br | Et | Br | Br | Br | Et | Br | CF₃ | Br |
| i-Pr | Br | Br | Br | i-Pr | Br | Br | Br | i-Pr | Br | CF₃ | Br |
| t-Bu | Br | Br | Br | t-Bu | Br | Br | Br | t-Bu | Br | CF₃ | Br |
| Me | Br | I | Cl | Me | Br | I | Cl | Me | Cl | Cl | Br |
| Et | Br | I | Cl | Et | Br | I | Cl | Et | Cl | Cl | Br |
| i-Pr | Br | I | Cl | i-Pr | Br | I | Cl | i-Pr | Cl | Cl | Br |
| t-Bu | Br | I | Cl | t-Bu | Br | I | Cl | t-Bu | Cl | Cl | Br |
| Me | Br | I | Br | Me | Br | I | Br | Me | Cl | Cl | Cl |
| Et | Br | I | Br | Et | Br | I | Br | Et | Cl | Cl | Cl |
| i-Pr | Br | I | Br | i-Pr | Br | I | Br | i-Pr | Cl | Cl | Cl |
| t-Bu | Br | I | Br | t-Bu | Br | I | Br | t-Bu | Cl | Cl | Cl |

TABLE 17

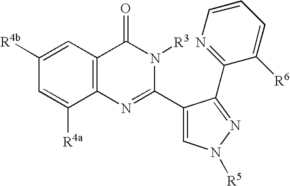

| R⁵ is CHF₂ | | | | R⁵ is CH₂F₃ | | | | R⁵ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | Br | Cl |
| Et | CH₃ | H | Cl | Et | CH₃ | H | Cl | Et | CH₃ | Br | Cl |
| i-Pr | CH₃ | H | Cl | i-Pr | CH₃ | H | Cl | i-Pr | CH₃ | Br | Cl |
| t-Bu | CH₃ | H | Cl | t-Bu | CH₃ | H | Cl | t-Bu | CH₃ | Br | Cl |
| Me | CH₃ | H | Br | Me | CH₃ | H | Br | Me | CH₃ | Br | Br |
| Et | CH₃ | H | Br | Et | CH₃ | H | Br | Et | CH₃ | Br | Br |
| i-Pr | CH₃ | H | Br | i-Pr | CH₃ | H | Br | i-Pr | CH₃ | Br | Br |
| t-Bu | CH₃ | H | Br | t-Bu | CH₃ | H | Br | t-Bu | CH₃ | Br | Br |
| Me | CH₃ | F | Cl | Me | CH₃ | Br | Cl | Me | CH₃ | I | Cl |
| Et | CH₃ | F | Cl | Et | CH₃ | Br | Cl | Et | CH₃ | I | Cl |
| i-Pr | CH₃ | F | Cl | i-Pr | CH₃ | Br | Cl | i-Pr | CH₃ | I | Cl |
| t-Bu | CH₃ | F | Cl | t-Bu | CH₃ | Br | Cl | t-Bu | CH₃ | I | Cl |
| Me | CH₃ | F | Br | Me | CH₃ | Br | Br | Me | CH₃ | I | Br |
| Et | CH₃ | F | Br | Et | CH₃ | Br | Br | Et | CH₃ | I | Br |
| i-Pr | CH₃ | F | Br | i-Pr | CH₃ | Br | Br | i-Pr | CH₃ | I | Br |
| t-Bu | CH₃ | F | Br | t-Bu | CH₃ | Br | Br | t-Bu | CH₃ | I | Br |
| Me | CH₃ | Cl | Cl | Me | CH₃ | F | Cl | Me | CH₃ | CF₃ | Cl |
| Et | CH₃ | Cl | Cl | Et | CH₃ | F | Cl | Et | CH₃ | CF₃ | Cl |
| i-Pr | CH₃ | Cl | Cl | i-Pr | CH₃ | F | Cl | i-Pr | CH₃ | CF₃ | Cl |
| t-Bu | CH₃ | Cl | Cl | t-Bu | CH₃ | F | Cl | t-Bu | CH₃ | CF₃ | Cl |
| Me | CH₃ | Cl | Br | Me | CH₃ | F | Br | Me | CH₃ | CF₃ | Br |
| Et | CH₃ | Cl | Br | Et | CH₃ | F | Br | Et | CH₃ | CF₃ | Br |
| i-Pr | CH₃ | Cl | Br | i-Pr | CH₃ | F | Br | i-Pr | CH₃ | CF₃ | Br |
| t-Bu | CH₃ | Cl | Br | t-Bu | CH₃ | F | Br | t-Bu | CH₃ | CF₃ | Br |
| Me | CH₃ | Br | Cl | Me | CH₃ | Cl | Cl | Me | CH₃ | Cl | Cl |
| Et | CH₃ | Br | Cl | Et | CH₃ | Cl | Cl | Et | CH₃ | Cl | Cl |
| i-Pr | CH₃ | Br | Cl | i-Pr | CH₃ | Cl | Cl | i-Pr | CH₃ | Cl | Cl |
| t-Bu | CH₃ | Br | Cl | t-Bu | CH₃ | Cl | Cl | t-Bu | CH₃ | Cl | Cl |
| Me | CH₃ | Br | Br | Me | CH₃ | Cl | Br | Me | CH₃ | Cl | Br |
| Et | CH₃ | Br | Br | Et | CH₃ | Cl | Br | Et | CH₃ | Cl | Br |
| i-Pr | CH₃ | Br | Br | i-Pr | CH₃ | Cl | Br | i-Pr | CH₃ | Cl | Br |
| t-Bu | CH₃ | Br | Br | t-Bu | CH₃ | Cl | Br | t-Bu | CH₃ | Cl | Br |
| Me | CH₃ | I | Cl | Me | CH₃ | I | Cl | Me | CH₃ | H | Cl |
| Et | CH₃ | I | Cl | Et | CH₃ | I | Cl | Et | CH₃ | H | Cl |
| i-Pr | CH₃ | I | Cl | i-Pr | CH₃ | I | Cl | i-Pr | CH₃ | H | Cl |
| t-Bu | CH₃ | I | Cl | t-Bu | CH₃ | I | Cl | t-Bu | CH₃ | H | Cl |
| Me | CH₃ | I | Br | Me | CH₃ | I | Br | Me | CH₃ | H | Br |
| Et | CH₃ | I | Br | Et | CH₃ | I | Br | Et | CH₃ | H | Br |
| i-Pr | CH₃ | I | Br | i-Pr | CH₃ | I | Br | i-Pr | CH₃ | H | Br |
| t-Bu | CH₃ | I | Br | t-Bu | CH₃ | I | Br | t-Bu | CH₃ | H | Br |
| Me | CH₃ | CF₃ | Cl | Me | CH₃ | CF₃ | Cl | Me | CH₃ | F | Cl |
| Et | CH₃ | CF₃ | Cl | Et | CH₃ | CF₃ | Cl | Et | CH₃ | F | Cl |
| i-Pr | CH₃ | CF₃ | Cl | i-Pr | CH₃ | CF₃ | Cl | i-Pr | CH₃ | F | Cl |
| t-Bu | CH₃ | CF₃ | Cl | t-Bu | CH₃ | CF₃ | Cl | t-Bu | CH₃ | F | Cl |
| Me | CH₃ | CF₃ | Br | Me | CH₃ | CF₃ | Br | Me | CH₃ | F | Br |
| Et | CH₃ | CF₃ | Br | Et | CH₃ | CF₃ | Br | Et | CH₃ | F | Br |
| i-Pr | CH₃ | CF₃ | Br | i-Pr | CH₃ | CF₃ | Br | i-Pr | CH₃ | F | Br |
| t-Bu | CH₃ | CF₃ | Br | t-Bu | CH₃ | CF₃ | Br | t-Bu | CH₃ | F | Br |
| n-Pr | CH₃ | Cl | Cl | Me | Cl | H | Br | Me | Cl | Cl | Br |
| n-Bu | CH₃ | Cl | Cl | Et | Cl | H | Br | Et | Cl | Cl | Br |
| s-Bu | CH₃ | Cl | Cl | i-Pr | Cl | H | Br | i-Pr | Cl | Cl | Br |
| t-Bu | CH₃ | Cl | Cl | t-Bu | Cl | H | Br | t-Bu | Cl | Cl | Br |
| Me | Cl | I | Br | Me | Cl | H | Cl | Me | Cl | Cl | Cl |
| Et | Cl | I | Br | Et | Cl | H | Cl | Et | Cl | Cl | Cl |
| i-Pr | Cl | I | Br | i-Pr | Cl | H | Cl | i-Pr | Cl | Cl | Cl |
| t-Bu | Cl | I | Br | t-Bu | Cl | H | Cl | t-Bu | Cl | Cl | Cl |
| Me | Cl | I | Cl | Me | Cl | Cl | Br | Me | Cl | I | Br |
| Et | Cl | I | Cl | Et | Cl | Cl | Br | Et | Cl | I | Br |
| i-Pr | Cl | I | Cl | i-Pr | Cl | Cl | Br | i-Pr | Cl | I | Br |
| t-Bu | Cl | I | Cl | t-Bu | Cl | Cl | Br | t-Bu | Cl | I | Br |
| Me | Cl | H | Br | Me | Cl | Cl | Cl | Me | Cl | I | Cl |
| Et | Cl | H | Br | Et | Cl | Cl | Cl | Et | Cl | I | Cl |
| i-Pr | Cl | H | Br | i-Pr | Cl | Cl | Cl | i-Pr | Cl | I | Cl |
| t-Bu | Cl | H | Br | t-Bu | Cl | Cl | Cl | t-Bu | Cl | I | Cl |
| Me | Cl | H | Cl | Me | Cl | F | Br | Me | Cl | F | Br |
| Et | Cl | H | Cl | Et | Cl | F | Br | Et | Cl | F | Br |
| i-Pr | Cl | H | Cl | i-Pr | Cl | F | Br | i-Pr | Cl | F | Br |
| t-Bu | Cl | H | Cl | t-Bu | Cl | F | Br | t-Bu | Cl | F | Br |
| Me | Cl | CF₃ | Br | Me | Cl | F | Cl | Me | Cl | F | Cl |
| Et | Cl | CF₃ | Br | Et | Cl | F | Cl | Et | Cl | F | Cl |
| i-Pr | Cl | CF₃ | Br | i-Pr | Cl | F | Cl | i-Pr | Cl | F | Cl |
| t-Bu | Cl | CF₃ | Br | t-Bu | Cl | F | Cl | t-Bu | Cl | F | Cl |
| Me | Cl | CF₃ | Cl | Me | Cl | Br | Br | Me | Cl | H | Br |
| Et | Cl | CF₃ | Cl | Et | Cl | Br | Br | Et | Cl | H | Br |
| i-Pr | Cl | CF₃ | Cl | i-Pr | Cl | Br | Br | i-Pr | Cl | H | Br |
| t-Bu | Cl | CF₃ | Cl | t-Bu | Cl | Br | Br | t-Bu | Cl | H | Br |
| Me | Cl | Br | Br | Me | Cl | I | Cl | Me | Cl | H | Cl |
| Et | Cl | Br | Br | Et | Cl | I | Cl | Et | Cl | H | Cl |
| i-Pr | Cl | Br | Br | i-Pr | Cl | I | Cl | i-Pr | Cl | H | Cl |
| t-Bu | Cl | Br | Br | t-Bu | Cl | I | Cl | i-Pr | Cl | H | Cl |
| Me | Cl | Br | Cl | Me | Cl | I | Br | Me | Cl | CF₃ | Br |
| Et | Cl | Br | Cl | Et | Cl | I | Br | Et | Cl | CF₃ | Br |
| i-Pr | Cl | Br | Cl | i-Pr | Cl | I | Br | i-Pr | Cl | CF₃ | Br |
| t-Bu | Cl | Br | Cl | t-Bu | Cl | I | Br | t-Bu | Cl | CF₃ | Br |
| Me | Cl | F | Br | Me | Cl | CF₃ | Cl | Me | Cl | CF₃ | Cl |
| Et | Cl | F | Br | Et | Cl | CF₃ | Cl | Et | Cl | CF₃ | Cl |
| i-Pr | Cl | F | Br | i-Pr | Cl | CF₃ | Cl | i-Pr | Cl | CF₃ | Cl |
| t-Bu | Cl | F | Br | t-Bu | Cl | CF₃ | Cl | t-Bu | Cl | CF₃ | Cl |
| Me | Cl | Cl | Cl | Me | Cl | CF₃ | Br | Me | Br | F | Cl |
| Et | Cl | Cl | Cl | Et | Cl | CF₃ | Br | Et | Br | F | Cl |
| i-Pr | Cl | Cl | Cl | i-Pr | Cl | CF₃ | Br | i-Pr | Br | F | Cl |
| t-Bu | Cl | Cl | Cl | t-Bu | Cl | CF₃ | Br | t-Bu | Br | F | Cl |
| Me | Cl | F | Cl | n-Pr | Cl | Cl | Cl | Me | Br | F | Br |
| Et | Cl | F | Cl | n-Bu | Cl | Cl | Cl | Et | Br | F | Br |
| i-Pr | Cl | F | Cl | s-Bu | Cl | Cl | Cl | i-Pr | Br | F | Br |
| t-Bu | Cl | F | Cl | t-Bu | Cl | Cl | Cl | t-Bu | Br | F | Br |
| Me | Br | Br | Cl | Me | Br | F | Cl | Me | Br | Cl | Cl |
| Et | Br | Br | Cl | Et | Br | F | Cl | Et | Br | Cl | Cl |
| i-Pr | Br | Br | Cl | i-Pr | Br | F | Cl | i-Pr | Br | Cl | Cl |
| t-Bu | Br | Br | Cl | t-Bu | Br | F | Cl | t-Bu | Br | Cl | Cl |
| Me | Br | Br | Br | Me | Br | F | Br | Me | Br | Cl | Br |
| Et | Br | Br | Br | Et | Br | F | Br | Et | Br | Cl | Br |
| i-Pr | Br | Br | Br | i-Pr | Br | F | Br | i-Pr | Br | Cl | Br |
| t-Bu | Br | Br | Br | t-Bu | Br | F | Br | t-Bu | Br | Cl | Br |
| Me | Br | I | Cl | Me | Br | Cl | Cl | Me | Br | Br | Cl |
| Et | Br | I | Cl | Et | Br | Cl | Cl | Et | Br | Br | Cl |
| i-Pr | Br | I | Cl | i-Pr | Br | Cl | Cl | i-Pr | Br | Br | Cl |
| t-Bu | Br | I | Cl | t-Bu | Br | Cl | Cl | t-Bu | Br | Br | Cl |
| Me | Br | I | Br | Me | Br | Cl | Br | Me | Br | Br | Br |
| Et | Br | I | Br | Et | Br | Cl | Br | Et | Br | Br | Br |
| i-Pr | Br | I | Br | i-Pr | Br | Cl | Br | i-Pr | Br | Br | Br |
| t-Bu | Br | I | Br | t-Bu | Br | Cl | Br | t-Bu | Br | Br | Br |
| Me | Br | F | Cl | Me | Br | I | Cl | Me | Br | CF₃ | Cl |
| Et | Br | F | Cl | Et | Br | I | Cl | Et | Br | CF₃ | Cl |
| i-Pr | Br | F | Cl | i-Pr | Br | I | Cl | i-Pr | Br | CF₃ | Cl |
| t-Bu | Br | F | Cl | t-Bu | Br | I | Cl | t-Bu | Br | CF₃ | Cl |
| Me | Br | F | Br | Me | Br | I | Br | Me | Br | CF₃ | Br |
| Et | Br | F | Br | Et | Br | I | Br | Et | Br | CF₃ | Br |
| i-Pr | Br | F | Br | i-Pr | Br | I | Br | i-Pr | Br | CF₃ | Br |
| t-Bu | Br | F | Br | t-Bu | Br | I | Br | t-Bu | Br | CF₃ | Br |
| Me | Br | Cl | Cl | Me | Br | Br | Cl | Me | Br | I | Cl |
| Et | Br | Cl | Cl | Et | Br | Br | Cl | Et | Br | I | Cl |
| i-Pr | Br | Cl | Cl | i-Pr | Br | Br | Cl | i-Pr | Br | I | Cl |
| t-Bu | Br | Cl | Cl | t-Bu | Br | Br | Cl | t-Bu | Br | I | Cl |
| Me | Br | Cl | Br | Me | Br | Br | Br | Me | Br | I | Br |
| Et | Br | Cl | Br | Et | Br | Br | Br | Et | Br | I | Br |
| i-Pr | Br | Cl | Br | i-Pr | Br | Br | Br | i-Pr | Br | I | Br |
| t-Bu | Br | Cl | Br | t-Bu | Br | Br | Br | t-Bu | Br | I | Br |

TABLE 18

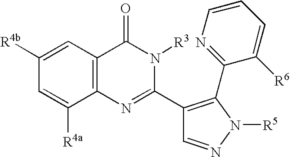

| R⁵ is CHF₂ | | | | R⁵ is CH₂F₃ | | | | R⁵ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | Br | Cl |
| Et | CH₃ | H | Cl | Et | CH₃ | H | Cl | Et | CH₃ | Br | Cl |
| i-Pr | CH₃ | H | Cl | i-Pr | CH₃ | H | Cl | i-Pr | CH₃ | Br | Cl |
| t-Bu | CH₃ | H | Cl | t-Bu | CH₃ | H | Cl | t-Bu | CH₃ | Br | Cl |
| Me | CH₃ | H | Br | Me | CH₃ | H | Br | Me | CH₃ | Br | Br |
| Et | CH₃ | H | Br | Et | CH₃ | H | Br | Et | CH₃ | Br | Br |
| i-Pr | CH₃ | H | Br | i-Pr | CH₃ | H | Br | i-Pr | CH₃ | Br | Br |
| t-Bu | CH₃ | H | Br | t-Bu | CH₃ | H | Br | t-Bu | CH₃ | Br | Br |
| Me | CH₃ | F | Cl | Me | CH₃ | Br | Cl | Me | CH₃ | I | Cl |
| Et | CH₃ | F | Cl | Et | CH₃ | Br | Cl | Et | CH₃ | I | Cl |
| i-Pr | CH₃ | F | Cl | i-Pr | CH₃ | Br | Cl | i-Pr | CH₃ | I | Cl |
| t-Bu | CH₃ | F | Cl | t-Bu | CH₃ | Br | Cl | t-Bu | CH₃ | I | Cl |
| Me | CH₃ | F | Br | Me | CH₃ | Br | Br | Me | CH₃ | I | Br |
| Et | CH₃ | F | Br | Et | CH₃ | Br | Br | Et | CH₃ | I | Br |
| i-Pr | CH₃ | F | Br | i-Pr | CH₃ | Br | Br | i-Pr | CH₃ | I | Br |
| t-Bu | CH₃ | F | Br | t-Bu | CH₃ | Br | Br | t-Bu | CH₃ | I | Br |
| Me | CH₃ | Cl | Cl | Me | CH₃ | F | Cl | Me | CH₃ | CF₃ | Cl |
| Et | CH₃ | Cl | Cl | Et | CH₃ | F | Cl | Et | CH₃ | CF₃ | Cl |
| i-Pr | CH₃ | Cl | Cl | i-Pr | CH₃ | F | Cl | i-Pr | CH₃ | CF₃ | Cl |
| t-Bu | CH₃ | Cl | Cl | t-Bu | CH₃ | F | Cl | t-Bu | CH₃ | CF₃ | Cl |
| Me | CH₃ | Cl | Br | Me | CH₃ | F | Br | Me | CH₃ | CF₃ | Br |
| Et | CH₃ | Cl | Br | Et | CH₃ | F | Br | Et | CH₃ | CF₃ | Br |
| i-Pr | CH₃ | Cl | Br | i-Pr | CH₃ | F | Br | i-Pr | CH₃ | CF₃ | Br |
| t-Bu | CH₃ | Cl | Br | t-Bu | CH₃ | F | Br | t-Bu | CH₃ | CF₃ | Br |
| Me | CH₃ | Br | Cl | Me | CH₃ | Cl | Cl | Me | CH₃ | Cl | Cl |
| Et | CH₃ | Br | Cl | Et | CH₃ | Cl | Cl | Et | CH₃ | Cl | Cl |
| i-Pr | CH₃ | Br | Cl | i-Pr | CH₃ | Cl | Cl | i-Pr | CH₃ | Cl | Cl |
| t-Bu | CH₃ | Br | Cl | t-Bu | CH₃ | Cl | Cl | t-Bu | CH₃ | Cl | Cl |
| Me | CH₃ | Br | Br | Me | CH₃ | Cl | Br | Me | CH₃ | Cl | Br |
| Et | CH₃ | Br | Br | Et | CH₃ | Cl | Br | Et | CH₃ | Cl | Br |
| i-Pr | CH₃ | Br | Br | i-Pr | CH₃ | Cl | Br | i-Pr | CH₃ | Cl | Br |
| t-Bu | CH₃ | Br | Br | t-Bu | CH₃ | Cl | Br | t-Bu | CH₃ | Cl | Br |
| Me | CH₃ | I | Cl | Me | CH₃ | I | Cl | Me | CH₃ | H | Cl |
| Et | CH₃ | I | Cl | Et | CH₃ | I | Cl | Et | CH₃ | H | Cl |
| i-Pr | CH₃ | I | Cl | i-Pr | CH₃ | I | Cl | i-Pr | CH₃ | H | Cl |
| t-Bu | CH₃ | I | Cl | t-Bu | CH₃ | I | Cl | t-Bu | CH₃ | H | Cl |
| Me | CH₃ | I | Br | Me | CH₃ | I | Br | Me | CH₃ | H | Br |
| Et | CH₃ | I | Br | Et | CH₃ | I | Br | Et | CH₃ | H | Br |
| i-Pr | CH₃ | I | Br | i-Pr | CH₃ | I | Br | i-Pr | CH₃ | H | Br |
| t-Bu | CH₃ | I | Br | t-Bu | CH₃ | I | Br | t-Bu | CH₃ | H | Br |
| Me | CH₃ | CF₃ | Cl | Me | CH₃ | CF₃ | Cl | Me | CH₃ | F | Cl |
| Et | CH₃ | CF₃ | Cl | Et | CH₃ | CF₃ | Cl | Et | CH₃ | F | Cl |
| i-Pr | CH₃ | CF₃ | Cl | i-Pr | CH₃ | CF₃ | Cl | i-Pr | CH₃ | F | Cl |
| t-Bu | CH₃ | CF₃ | Cl | t-Bu | CH₃ | CF₃ | Cl | t-Bu | CH₃ | F | Cl |
| Me | CH₃ | CF₃ | Br | Me | CH₃ | CF₃ | Br | Me | CH₃ | F | Br |
| Et | CH₃ | CF₃ | Br | Et | CH₃ | CF₃ | Br | Et | CH₃ | F | Br |
| i-Pr | CH₃ | CF₃ | Br | i-Pr | CH₃ | CF₃ | Br | i-Pr | CH₃ | F | Br |
| t-Bu | CH₃ | CF₃ | Br | t-Bu | CH₃ | CF₃ | Br | t-Bu | CH₃ | F | Br |
| n-Pr | CH₃ | Cl | Cl | Me | Cl | H | Br | Me | Cl | Cl | Br |
| n-Bu | CH₃ | Cl | Cl | Et | Cl | H | Br | Et | Cl | Cl | Br |
| s-Bu | CH₃ | Cl | Cl | i-Pr | Cl | H | Br | i-Pr | Cl | Cl | Br |
| t-Bu | CH₃ | Cl | Cl | t-Bu | Cl | H | Br | t-Bu | Cl | Cl | Br |
| Me | Cl | I | Br | Me | Cl | H | Cl | Me | Cl | Cl | Cl |
| Et | Cl | I | Br | Et | Cl | H | Cl | Et | Cl | Cl | Cl |
| i-Pr | Cl | I | Br | i-Pr | Cl | H | Cl | i-Pr | Cl | Cl | Cl |
| t-Bu | Cl | I | Br | t-Bu | Cl | H | Cl | t-Bu | Cl | Cl | Cl |
| Me | Cl | I | Cl | Me | Cl | Cl | Br | Me | Cl | I | Br |
| Et | Cl | I | Cl | Et | Cl | Cl | Br | Et | Cl | I | Br |
| i-Pr | Cl | I | Cl | i-Pr | Cl | Cl | Br | i-Pr | Cl | I | Br |
| t-Bu | Cl | I | Cl | t-Bu | Cl | Cl | Br | t-Bu | Cl | I | Br |
| Me | Cl | H | Br | Me | Cl | Cl | Cl | Me | Cl | I | Cl |
| Et | Cl | H | Br | Et | Cl | Cl | Cl | Et | Cl | I | Cl |
| i-Pr | Cl | H | Br | i-Pr | Cl | Cl | Cl | i-Pr | Cl | I | Cl |
| t-Bu | Cl | H | Br | t-Bu | Cl | Cl | Cl | t-Bu | Cl | I | Cl |
| Me | Cl | H | Cl | Me | Cl | F | Br | Me | Cl | F | Br |
| Et | Cl | H | Cl | Et | Cl | F | Br | Et | Cl | F | Br |
| i-Pr | Cl | H | Cl | i-Pr | Cl | F | Br | i-Pr | Cl | F | Br |
| t-Bu | Cl | H | Cl | t-Bu | Cl | F | Br | t-Bu | Cl | F | Br |
| Me | Cl | CF₃ | Br | Me | Cl | F | Cl | Me | Cl | F | Cl |
| Et | Cl | CF₃ | Br | Et | Cl | F | Cl | Et | Cl | F | Cl |
| i-Pr | Cl | CF₃ | Br | i-Pr | Cl | F | Cl | i-Pr | Cl | F | Cl |
| t-Bu | Cl | CF₃ | Br | t-Bu | Cl | F | Cl | t-Bu | Cl | F | Cl |
| Me | Cl | CF₃ | Cl | Me | Cl | Br | Br | Me | Cl | H | Br |
| Et | Cl | CF₃ | Cl | Et | Cl | Br | Br | Et | Cl | H | Br |
| i-Pr | Cl | CF₃ | Cl | i-Pr | Cl | Br | Br | i-Pr | Cl | H | Br |
| t-Bu | Cl | CF₃ | Cl | t-Bu | Cl | Br | Br | t-Bu | Cl | H | Br |
| Me | Cl | Br | Br | Me | Cl | I | Cl | Me | Cl | H | Cl |
| Et | Cl | Br | Br | Et | Cl | I | Cl | Et | Cl | H | Cl |
| i-Pr | Cl | Br | Br | i-Pr | Cl | I | Cl | i-Pr | Cl | H | Cl |
| t-Bu | Cl | Br | Br | t-Bu | Cl | I | Cl | i-Pr | Cl | H | Cl |
| Me | Cl | Br | Cl | Me | Cl | I | Br | Me | Cl | CF₃ | Br |
| Et | Cl | Br | Cl | Et | Cl | I | Br | Et | Cl | CF₃ | Br |
| i-Pr | Cl | Br | Cl | i-Pr | Cl | I | Br | i-Pr | Cl | CF₃ | Br |
| t-Bu | Cl | Br | Cl | t-Bu | Cl | I | Br | t-Bu | Cl | CF₃ | Br |
| Me | Cl | F | Br | Me | Cl | CF₃ | Cl | Me | Cl | CF₃ | Cl |
| Et | Cl | F | Br | Et | Cl | CF₃ | Cl | Et | Cl | CF₃ | Cl |
| i-Pr | Cl | F | Br | i-Pr | Cl | CF₃ | Cl | i-Pr | Cl | CF₃ | Cl |
| t-Bu | Cl | F | Br | t-Bu | Cl | CF₃ | Cl | t-Bu | Cl | CF₃ | Cl |
| Me | Cl | Cl | Cl | Me | Cl | CF₃ | Br | Me | Br | F | Cl |
| Et | Cl | Cl | Cl | Et | Cl | CF₃ | Br | Et | Br | F | Cl |
| i-Pr | Cl | Cl | Cl | i-Pr | Cl | CF₃ | Br | i-Pr | Br | F | Cl |
| t-Bu | Cl | Cl | Cl | t-Bu | Cl | CF₃ | Br | t-Bu | Br | F | Cl |
| Me | Cl | F | Cl | n-Pr | Cl | Cl | Cl | Me | Br | F | Br |
| Et | Cl | F | Cl | n-Bu | Cl | Cl | Cl | Et | Br | F | Br |
| i-Pr | Cl | F | Cl | s-Bu | Cl | Cl | Cl | i-Pr | Br | F | Br |
| t-Bu | Cl | F | Cl | t-Bu | Cl | Cl | Cl | t-Bu | Br | F | Br |
| Me | Br | Br | Cl | Me | Br | F | Cl | Me | Br | Cl | Cl |
| Et | Br | Br | Cl | Et | Br | F | Cl | Et | Br | Cl | Cl |
| i-Pr | Br | Br | Cl | i-Pr | Br | F | Cl | i-Pr | Br | Cl | Cl |
| t-Bu | Br | Br | Cl | t-Bu | Br | F | Cl | t-Bu | Br | Cl | Cl |
| Me | Br | Br | Br | Me | Br | F | Br | Me | Br | Cl | Br |
| Et | Br | Br | Br | Et | Br | F | Br | Et | Br | Cl | Br |
| i-Pr | Br | Br | Br | i-Pr | Br | F | Br | i-Pr | Br | Cl | Br |
| t-Bu | Br | Br | Br | t-Bu | Br | F | Br | t-Bu | Br | Cl | Br |
| Me | Br | I | Cl | Me | Br | Cl | Cl | Me | Br | Br | Cl |
| Et | Br | I | Cl | Et | Br | Cl | Cl | Et | Br | Br | Cl |
| i-Pr | Br | I | Cl | i-Pr | Br | Cl | Cl | i-Pr | Br | Br | Cl |
| t-Bu | Br | I | Cl | t-Bu | Br | Cl | Cl | t-Bu | Br | Br | Cl |
| Me | Br | I | Br | Me | Br | Cl | Br | Me | Br | Br | Br |
| Et | Br | I | Br | Et | Br | Cl | Br | Et | Br | Br | Br |
| i-Pr | Br | I | Br | i-Pr | Br | Cl | Br | i-Pr | Br | Br | Br |
| t-Bu | Br | I | Br | t-Bu | Br | Cl | Br | t-Bu | Br | Br | Br |
| Me | Br | F | Cl | Me | Br | I | Cl | Me | Br | CF₃ | Cl |
| Et | Br | F | Cl | Et | Br | I | Cl | Et | Br | CF₃ | Cl |
| i-Pr | Br | F | Cl | i-Pr | Br | I | Cl | i-Pr | Br | CF₃ | Cl |
| t-Bu | Br | F | Cl | t-Bu | Br | I | Cl | t-Bu | Br | CF₃ | Cl |
| Me | Br | F | Br | Me | Br | I | Br | Me | Br | CF₃ | Br |
| Et | Br | F | Br | Et | Br | I | Br | Et | Br | CF₃ | Br |
| i-Pr | Br | F | Br | i-Pr | Br | I | Br | i-Pr | Br | CF₃ | Br |
| t-Bu | Br | F | Br | t-Bu | Br | I | Br | t-Bu | Br | CF₃ | Br |
| Me | Br | Cl | Cl | Me | Br | Br | Cl | Me | Br | I | Cl |
| Et | Br | Cl | Cl | Et | Br | Br | Cl | Et | Br | I | Cl |
| i-Pr | Br | Cl | Cl | i-Pr | Br | Br | Cl | i-Pr | Br | I | Cl |
| t-Bu | Br | Cl | Cl | t-Bu | Br | Br | Cl | t-Bu | Br | I | Cl |
| Me | Br | Cl | Br | Me | Br | Br | Br | Me | Br | I | Br |
| Et | Br | Cl | Br | Et | Br | Br | Br | Et | Br | I | Br |
| i-Pr | Br | Cl | Br | i-Pr | Br | Br | Br | i-Pr | Br | I | Br |
| t-Bu | Br | Cl | Br | t-Bu | Br | Br | Br | t-Bu | Br | I | Br |

TABLE 19

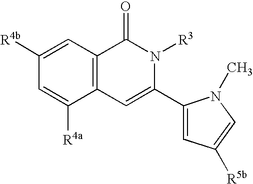

| R^{5b} is Cl | | | R^{5b} is CF₃ | | | R^{5b} is OCF₃ | | | R^{5b} is CF(CF₃)₂ | | |
|---|---|---|---|---|---|---|---|---|---|---|---|
| R³ | R^{4a} | R^{4b} | R³ | R^{4a} | R^{4b} | R³ | R^{4a} | R^{4b} | R³ | R^{4a} | R^{4b} |
| i-Pr | Me | H | i-Pr | Me | H | i-Pr | Me | H | i-Pr | Me | H |
| i-Pr | Cl | H | i-Pr | Cl | H | i-Pr | Cl | H | i-Pr | Cl | H |
| i-Pr | Me | Cl | i-Pr | Me | Cl | i-Pr | Me | Cl | i-Pr | Me | Cl |
| i-Pr | Cl | Cl | i-Pr | Cl | Cl | i-Pr | Cl | Cl | i-Pr | Cl | Cl |
| i-Pr | Me | Br | i-Pr | Me | Br | i-Pr | Me | Br | i-Pr | Me | Br |
| i-Pr | Cl | Br | i-Pr | Cl | Br | i-Pr | Cl | Br | i-Pr | Cl | Br |
| t-Bu | Me | H | t-Bu | Me | H | t-Bu | Me | H | t-Bu | Me | H |
| t-Bu | Cl | H | t-Bu | Cl | H | t-Bu | Cl | H | t-Bu | Cl | H |
| t-Bu | Me | Cl | t-Bu | Me | Cl | t-Bu | Me | Cl | t-Bu | Me | Cl |
| t-Bu | Cl | Cl | t-Bu | Cl | Cl | t-Bu | Cl | Cl | t-Bu | Cl | Cl |
| t-Bu | Me | Br | t-Bu | Me | Br | t-Bu | Me | Br | t-Bu | Me | Br |
| t-Bu | Cl | Br | t-Bu | Cl | Br | t-Bu | Cl | Br | t-Bu | Cl | Br |
| Et | Me | H | Et | Me | H | Et | Me | H | Et | Me | H |
| Et | Cl | H | Et | Cl | H | Et | Cl | H | Et | Cl | H |
| Et | Me | Cl | Et | Me | Cl | Et | Me | Cl | Et | Me | Cl |
| Et | Cl | Cl | Et | Cl | Cl | Et | Cl | Cl | Et | Cl | Cl |
| Et | Me | Br | Et | Me | Br | Et | Me | Br | Et | Me | Br |
| Et | Cl | Br | Et | Cl | Br | Et | Cl | Br | Et | Cl | Br |
| Me | Me | H | Me | Me | H | Me | Me | H | Me | Me | H |
| Me | Cl | H | Me | Cl | H | Me | Cl | H | Me | Cl | H |
| Me | Me | Cl | Me | Me | Cl | Me | Me | Cl | Me | Me | Cl |
| Me | Cl | Cl | Me | Cl | Cl | Me | Cl | Cl | Me | Cl | Cl |
| Me | Me | Br | Me | Me | Br | Me | Me | Br | Me | Me | Br |
| Me | Cl | Br | Me | Cl | Br | Me | Cl | Br | Me | Cl | Br |

TABLE 20

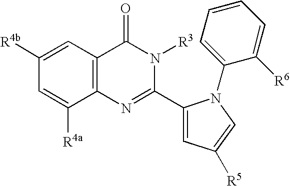

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | H | Cl | Br | Me | Cl | Br | Cl | Br |
| Et | CH₃ | H | CF₃ | Cl | Et | Cl | H | Cl | Br | Et | Cl | Br | Cl | Br |
| i-Pr | CH₃ | H | CF₃ | Cl | i-Pr | Cl | H | Cl | Br | i-Pr | Cl | Br | Cl | Br |
| t-Bu | CH₃ | H | CF₃ | Cl | t-Bu | Cl | H | Cl | Br | t-Bu | Cl | Br | Cl | Br |
| Me | CH₃ | H | CF₃ | Br | Me | Cl | H | Br | Cl | Me | Cl | Br | Br | Cl |
| Et | CH₃ | H | CF₃ | Br | Et | Cl | H | Br | Cl | Et | Cl | Br | Br | Cl |
| i-Pr | CH₃ | H | CF₃ | Br | i-Pr | Cl | H | Br | Cl | i-Pr | Cl | Br | Br | Cl |
| t-Bu | CH₃ | H | CF₃ | Br | t-Bu | Cl | H | Br | Cl | t-Bu | Cl | Br | Br | Cl |
| Me | CH₃ | H | Cl | Cl | Me | Cl | H | Br | Br | Me | Cl | Br | Br | Br |
| Et | CH₃ | H | Cl | Cl | Et | Cl | H | Br | Br | Et | Cl | Br | Br | Br |
| i-Pr | CH₃ | H | Cl | Cl | i-Pr | Cl | H | Br | Br | i-Pr | Cl | Br | Br | Br |
| t-Bu | CH₃ | H | Cl | Cl | t-Bu | Cl | H | Br | Br | t-Bu | Cl | Br | Br | Br |
| Me | CH₃ | H | Cl | Br | Me | Cl | H | CF₃ | Cl | Me | Cl | I | CF₃ | Cl |
| Et | CH₃ | H | Cl | Br | Et | Cl | H | CF₃ | Cl | Et | Cl | I | CF₃ | Cl |
| i-Pr | CH₃ | H | Cl | Br | i-Pr | Cl | H | CF₃ | Cl | i-Pr | Cl | I | CF₃ | Br |
| t-Bu | CH₃ | H | Cl | Br | t-Bu | Cl | H | CF₃ | Cl | t-Bu | Cl | I | CF₃ | Br |
| Me | CH₃ | H | Br | Cl | Me | Cl | H | CF₃ | Br | Me | Cl | I | CF₃ | Br |
| Et | CH₃ | H | Br | Cl | Et | Cl | H | CF₃ | Br | Et | Cl | I | CF₃ | Br |
| i-Pr | CH₃ | H | Br | Cl | i-Pr | Cl | H | CF₃ | Br | i-Pr | Cl | I | CF₃ | Br |
| t-Bu | CH₃ | H | Br | Cl | t-Bu | Cl | H | CF₃ | Br | t-Bu | Cl | I | CF₃ | Br |
| Me | CH₃ | H | Br | Br | Me | Cl | H | Cl | Cl | Me | Cl | I | Cl | Cl |
| Et | CH₃ | H | Br | Br | Et | Cl | H | Cl | Cl | Et | Cl | I | Cl | Cl |
| i-Pr | CH₃ | H | Br | Br | i-Pr | Cl | H | Cl | Cl | i-Pr | Cl | I | Cl | Cl |
| t-Bu | CH₃ | H | Br | Br | i-Pr | Cl | H | Cl | Cl | t-Bu | Cl | I | Cl | Br |
| Me | CH₃ | F | CF₃ | Cl | Me | CH₃ | Cl | CF₃ | Cl | Me | Cl | I | Cl | Br |
| Et | CH₃ | F | CF₃ | Cl | Et | CH₃ | Cl | CF₃ | Cl | Et | Cl | I | Cl | Br |
| i-Pr | CH₃ | F | CF₃ | Cl | i-Pr | CH₃ | Cl | CF₃ | Cl | i-Pr | Cl | I | Cl | Br |
| t-Bu | CH₃ | F | CF₃ | Cl | t-Bu | CH₃ | Cl | CF₃ | Br | t-Bu | Cl | I | Cl | Br |
| Me | CH₃ | F | CF₃ | Br | Me | CH₃ | Cl | CF₃ | Br | Me | Cl | I | Br | Cl |
| Et | CH₃ | F | CF₃ | Br | Et | CH₃ | Cl | CF₃ | Br | Et | Cl | I | Br | Cl |
| i-Pr | CH₃ | F | CF₃ | Br | i-Pr | CH₃ | Cl | CF₃ | Br | i-Pr | Cl | I | Br | Cl |
| t-Bu | CH₃ | F | CF₃ | Br | t-Bu | CH₃ | Cl | CF₃ | Br | t-Bu | Cl | I | Br | Cl |
| Me | CH₃ | F | Cl | Cl | Me | CH₃ | Cl | Cl | Cl | Me | Cl | I | Br | Br |
| Et | CH₃ | F | Cl | Cl | Et | CH₃ | Cl | Cl | Cl | Et | Cl | I | Br | Br |
| i-Pr | CH₃ | F | Cl | Cl | i-Pr | CH₃ | Cl | Cl | Cl | i-Pr | Cl | I | Br | Br |
| t-Bu | CH₃ | F | Cl | Cl | t-Bu | CH₃ | Cl | Cl | Cl | t-Bu | Cl | I | Br | Br |
| Me | CH₃ | F | Cl | Br | Me | CH₃ | Cl | Cl | Br | Me | Cl | CF₃ | CF₃ | Cl |
| Et | CH₃ | F | Cl | Br | Et | CH₃ | Cl | Cl | Br | Et | Cl | CF₃ | CF₃ | Cl |
| i-Pr | CH₃ | F | Cl | Br | i-Pr | CH₃ | Cl | Cl | Br | i-Pr | Cl | CF₃ | CF₃ | Cl |
| t-Bu | CH₃ | F | Cl | Br | t-Bu | CH₃ | Cl | Cl | Br | t-Bu | Cl | CF₃ | CF₃ | Cl |
| Me | CH₃ | F | Br | Cl | Me | CH₃ | Cl | Br | Cl | Me | Cl | CF₃ | CF₃ | Br |
| Et | CH₃ | F | Br | Cl | Et | CH₃ | Cl | Br | Cl | Et | Cl | CF₃ | CF₃ | Br |
| i-Pr | CH₃ | F | Br | Cl | i-Pr | CH₃ | Cl | Br | Cl | i-Pr | Cl | CF₃ | CF₃ | Br |
| t-Bu | CH₃ | F | Br | Cl | t-Bu | CH₃ | Cl | Br | Cl | t-Bu | Cl | CF₃ | CF₃ | Br |
| Me | CH₃ | F | Br | Br | Me | CH₃ | Cl | Br | Br | Me | Cl | CF₃ | Cl | Cl |
| Et | CH₃ | F | Br | Br | Et | CH₃ | Cl | Br | Br | Et | Cl | CF₃ | Cl | Cl |
| i-Pr | CH₃ | F | Br | Br | i-Pr | CH₃ | Cl | Br | Br | i-Pr | Cl | CF₃ | Cl | Cl |
| t-Bu | CH₃ | F | Br | Br | t-Bu | CH₃ | Cl | Br | Br | t-Bu | Cl | CF₃ | Cl | Cl |
| Me | CH₃ | Br | CF₃ | Cl | Me | Cl | F | CF₃ | Cl | Me | Cl | CF₃ | Cl | Br |
| Et | CH₃ | Br | CF₃ | Cl | Et | Cl | F | CF₃ | Cl | Et | Cl | CF₃ | Cl | Br |
| i-Pr | CH₃ | Br | CF₃ | Cl | i-Pr | Cl | F | CF₃ | Cl | i-Pr | Cl | CF₃ | Cl | Br |
| t-Bu | CH₃ | Br | CF₃ | Cl | t-Bu | Cl | F | CF₃ | Cl | t-Bu | Cl | CF₃ | Cl | Br |
| Me | CH₃ | Br | CF₃ | Br | Me | Cl | F | CF₃ | Br | Me | Cl | CF₃ | Br | Cl |
| Et | CH₃ | Br | CF₃ | Br | Et | Cl | F | CF₃ | Br | Et | Cl | CF₃ | Br | Cl |
| i-Pr | CH₃ | Br | CF₃ | Br | i-Pr | Cl | F | CF₃ | Br | i-Pr | Cl | CF₃ | Br | Cl |
| t-Bu | CH₃ | Br | CF₃ | Br | t-Bu | Cl | F | CF₃ | Br | t-Bu | Cl | CF₃ | Br | Cl |
| Me | CH₃ | Br | Cl | Cl | Me | Cl | F | Cl | Cl | Me | Cl | CF₃ | Br | Br |
| Et | CH₃ | Br | Cl | Cl | Et | Cl | F | Cl | Cl | Et | Cl | CF₃ | Br | Br |
| i-Pr | CH₃ | Br | Cl | Cl | i-Pr | Cl | F | Cl | Cl | i-Pr | Cl | CF₃ | Br | Br |
| t-Bu | CH₃ | Br | Cl | Cl | t-Bu | Cl | F | Cl | Cl | t-Bu | Cl | CF₃ | Br | Br |
| Me | CH₃ | Br | Cl | Br | Me | Cl | F | Cl | Br | n-Pr | Cl | Cl | Cl | Cl |
| Et | CH₃ | Br | Cl | Br | Et | Cl | F | Cl | Br | n-Bu | Cl | Cl | Cl | Cl |
| i-Pr | CH₃ | Br | Cl | Br | i-Pr | Cl | F | Cl | Br | s-Bu | Cl | Cl | Cl | Cl |
| t-Bu | CH₃ | Br | Cl | Br | t-Bu | Cl | F | Cl | Br | t-Bu | Cl | Cl | Cl | Cl |
| Me | CH₃ | Br | Br | Cl | Me | Cl | F | Br | Cl | Me | Br | F | CF₃ | Cl |
| Et | CH₃ | Br | Br | Cl | Et | Cl | F | Br | Cl | Et | Br | F | CF₃ | Cl |
| i-Pr | CH₃ | Br | Br | Cl | i-Pr | Cl | F | Br | Cl | i-Pr | Br | F | CF₃ | Cl |
| t-Bu | CH₃ | Br | Br | Cl | t-Bu | Cl | F | Br | Cl | t-Bu | Br | F | CF₃ | Cl |
| Me | CH₃ | Br | Br | Br | Me | Cl | F | Br | Br | Me | Br | F | CF₃ | Br |
| Et | CH₃ | Br | Br | Br | Et | Cl | F | Br | Br | Et | Br | F | CF₃ | Br |
| i-Pr | CH₃ | Br | Br | Br | i-Pr | Cl | F | Br | Br | i-Pr | Br | F | CF₃ | Br |
| t-Bu | CH₃ | Br | Br | Br | t-Bu | Cl | F | Br | Br | t-Bu | Br | F | CF₃ | Br |
| Me | CH₃ | I | CF₃ | Cl | Me | Cl | Cl | CF₃ | Cl | Me | Br | F | Cl | Cl |
| Et | CH₃ | I | CF₃ | Cl | Et | Cl | Cl | CF₃ | Cl | Et | Br | F | Cl | Cl |
| i-Pr | CH₃ | I | CF₃ | Cl | i-Pr | Cl | Cl | CF₃ | Cl | i-Pr | Br | F | Cl | Cl |
| t-Bu | CH₃ | I | CF₃ | Cl | t-Bu | Cl | Cl | CF₃ | Cl | t-Bu | Br | F | Cl | Cl |
| Me | CH₃ | I | CF₃ | Br | Me | Cl | Cl | CF₃ | Br | Me | Br | F | Cl | Br |
| Et | CH₃ | I | CF₃ | Br | Et | Cl | Cl | CF₃ | Br | Et | Br | F | Cl | Br |
| i-Pr | CH₃ | I | CF₃ | Br | i-Pr | Cl | Cl | CF₃ | Br | i-Pr | Br | F | Cl | Br |
| t-Bu | CH₃ | I | CF₃ | Br | t-Bu | Cl | Cl | CF₃ | Br | t-Bu | Br | F | Cl | Br |
| Me | CH₃ | I | Cl | Cl | Me | Cl | Cl | Cl | Cl | Me | Br | F | Br | Cl |
| Et | CH₃ | I | Cl | Cl | Et | Cl | Cl | Cl | Cl | Et | Br | F | Br | Cl |
| i-Pr | CH₃ | I | Cl | Cl | i-Pr | Cl | Cl | Cl | Cl | i-Pr | Br | F | Br | Cl |
| t-Bu | CH₃ | I | Cl | Cl | t-Bu | Cl | Cl | Cl | Cl | t-Bu | Br | F | Br | Cl |
| Me | CH₃ | I | Cl | Br | Me | Cl | Cl | Cl | Br | Me | Br | F | Br | Br |
| Et | CH₃ | I | Cl | Br | Et | Cl | Cl | Cl | Br | Et | Br | F | Br | Br |
| i-Pr | CH₃ | I | Cl | Br | i-Pr | Cl | Cl | Cl | Br | i-Pr | Br | F | Br | Br |
| t-Bu | CH₃ | I | Cl | Br | t-Bu | Cl | Cl | Cl | Br | t-Bu | Br | F | Br | Br |
| Me | CH₃ | I | Br | Cl | Me | Br | CF₃ | CF₃ | Cl | Me | Br | Cl | CF₃ | Cl |
| Et | CH₃ | I | Br | Cl | Et | Br | CF₃ | CF₃ | Cl | Et | Br | Cl | CF₃ | Cl |
| i-Pr | CH₃ | I | Br | Cl | i-Pr | Br | CF₃ | CF₃ | Cl | i-Pr | Br | Cl | CF₃ | Cl |
| t-Bu | CH₃ | I | Br | Cl | t-Bu | Br | CF₃ | CF₃ | Cl | t-Bu | Br | Cl | CF₃ | Cl |
| Me | CH₃ | I | Br | Br | Me | Br | CF₃ | CF₃ | Br | Me | Br | Cl | CF₃ | Br |
| Et | CH₃ | I | Br | Br | Et | Br | CF₃ | CF₃ | Br | Et | Br | Cl | CF₃ | Br |
| i-Pr | CH₃ | I | Br | Br | i-Pr | Br | CF₃ | CF₃ | Br | i-Pr | Br | Cl | CF₃ | Br |
| t-Bu | CH₃ | I | Br | Br | t-Bu | Br | CF₃ | CF₃ | Br | t-Bu | Br | Cl | CF₃ | Br |
| Me | CH₃ | CF₃ | CF₃ | Cl | Me | Br | CF₃ | Cl | Cl | Me | Br | Cl | Cl | Cl |
| Et | CH₃ | CF₃ | CF₃ | Cl | Et | Br | CF₃ | Cl | Cl | Et | Br | Cl | Cl | Cl |
| i-Pr | CH₃ | CF₃ | CF₃ | Cl | i-Pr | Br | CF₃ | Cl | Cl | i-Pr | Br | Cl | Cl | Cl |
| t-Bu | CH₃ | CF₃ | CF₃ | Cl | t-Bu | Br | CF₃ | Cl | Cl | t-Bu | Br | Cl | Cl | Cl |
| Me | CH₃ | CF₃ | CF₃ | Br | Me | Br | CF₃ | Cl | Br | Me | Br | Cl | Cl | Br |
| Et | CH₃ | CF₃ | CF₃ | Br | Et | Br | CF₃ | Cl | Br | Et | Br | Cl | Cl | Br |
| i-Pr | CH₃ | CF₃ | CF₃ | Br | i-Pr | Br | CF₃ | Cl | Br | i-Pr | Br | Cl | Cl | Br |
| t-Bu | CH₃ | CF₃ | CF₃ | Br | t-Bu | Br | CF₃ | Cl | Br | t-Bu | Br | Cl | Cl | Br |
| Me | CH₃ | CF₃ | Cl | Cl | Me | Br | CF₃ | Br | Cl | Me | Br | Cl | Br | Cl |
| Et | CH₃ | CF₃ | Cl | Cl | Et | Br | CF₃ | Br | Cl | Et | Br | Cl | Br | Cl |
| i-Pr | CH₃ | CF₃ | Cl | Cl | i-Pr | Br | CF₃ | Br | Cl | i-Pr | Br | Cl | Br | Cl |
| t-Bu | CH₃ | CF₃ | Cl | Cl | t-Bu | Br | CF₃ | Br | Cl | t-Bu | Br | Cl | Br | Cl |
| Me | CH₃ | CF₃ | Cl | Br | Me | Br | CF₃ | Br | Br | Me | Br | Cl | Br | Br |
| Et | CH₃ | CF₃ | Cl | Br | Et | Br | CF₃ | Br | Br | Et | Br | Cl | Br | Br |
| i-Pr | CH₃ | CF₃ | Cl | Br | i-Pr | Br | CF₃ | Br | Br | i-Pr | Br | Cl | Br | Br |
| t-Bu | CH₃ | CF₃ | Cl | Br | t-Bu | Br | CF₃ | Br | Br | t-Bu | Br | Cl | Br | Br |
| Me | CH₃ | CF₃ | Br | Cl | Me | Br | I | CF₃ | Cl | Me | Br | Br | CF₃ | Cl |
| Et | CH₃ | CF₃ | Br | Cl | Et | Br | I | CF₃ | Cl | Et | Br | Br | CF₃ | Cl |
| i-Pr | CH₃ | CF₃ | Br | Cl | i-Pr | Br | I | CF₃ | Cl | i-Pr | Br | Br | CF₃ | Cl |
| t-Bu | CH₃ | CF₃ | Br | Cl | t-Bu | Br | I | CF₃ | Cl | t-Bu | Br | Br | CF₃ | Cl |
| Me | CH₃ | CF₃ | Br | Br | Me | Br | I | CF₃ | Br | Me | Br | Br | CF₃ | Br |
| Et | CH₃ | CF₃ | Br | Br | Et | Br | I | CF₃ | Br | Et | Br | Br | CF₃ | Br |
| i-Pr | CH₃ | CF₃ | Br | Br | i-Pr | Br | I | CF₃ | Br | i-Pr | Br | Br | CF₃ | Br |
| t-Bu | CH₃ | CF₃ | Br | Br | t-Bu | Br | I | CF₃ | Br | t-Bu | Br | Br | CF₃ | Br |
| n-Pr | CH₃ | Cl | Cl | Cl | Me | Br | I | Cl | Cl | Me | Br | Br | Cl | Cl |
| n-Bu | CH₃ | Cl | Cl | Cl | Et | Br | I | Cl | Cl | Et | Br | Br | Cl | Cl |
| s-Bu | CH₃ | Cl | Cl | Cl | i-Pr | Br | I | Cl | Cl | i-Pr | Br | Br | Cl | Cl |
| i-Bu | CH₃ | Cl | Cl | Cl | t-Bu | Br | I | Cl | Cl | t-Bu | Br | Br | Cl | Cl |
| Me | Cl | Cl | Br | Cl | Me | Br | I | Cl | Br | Me | Br | Br | Cl | Br |
| Et | Cl | Cl | Br | Cl | Et | Br | I | Cl | Br | Et | Br | Br | Cl | Br |
| i-Pr | Cl | Cl | Br | Cl | i-Pr | Br | I | Cl | Br | i-Pr | Br | Br | Cl | Br |
| t-Bu | Cl | Cl | Br | Cl | t-Bu | Br | I | Cl | Br | t-Bu | Br | Br | Cl | Br |
| Me | Cl | Cl | Br | Br | Me | Br | I | Br | Cl | Me | Br | Br | Br | Cl |
| Et | Cl | Cl | Br | Br | Et | Br | I | Br | Cl | Et | Br | Br | Br | Cl |
| i-Pr | Cl | Cl | Br | Br | i-Pr | Br | I | Br | Cl | i-Pr | Br | Br | Br | Cl |
| t-Bu | Cl | Cl | Br | Br | t-Bu | Br | I | Br | Cl | t-Bu | Br | Br | Br | Cl |
| Me | Cl | Br | CF₃ | Cl | Me | Br | I | Br | Br | Me | Br | Br | Br | Br |
| Et | Cl | Br | CF₃ | Cl | Et | Br | I | Br | Br | Et | Br | Br | Br | Br |
| i-Pr | Cl | Br | CF₃ | Cl | i-Pr | Br | I | Br | Br | i-Pr | Br | Br | Br | Br |
| t-Bu | Cl | Br | CF₃ | Cl | t-Bu | Br | I | Br | Br | t-Bu | Br | Br | Br | Br |
| Me | Cl | Br | CF₃ | Br | Me | Cl | Br | Cl | Cl | t-Bu | Cl | Br | CF₃ | Br |
| Et | Cl | Br | CF₃ | Br | Et | Cl | Br | Cl | Cl | t-Bu | Cl | Br | Cl | Cl |
| i-Pr | Cl | Br | CF₃ | Br | i-Pr | Cl | Br | Cl | Cl | | | | | |

TABLE 21

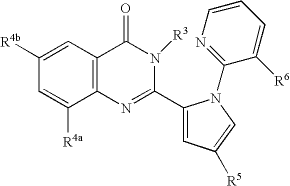

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | F | CF₃ | Cl | Me | Cl | H | Cl | Br |
| Et | CH₃ | H | CF₃ | Cl | Et | Cl | F | CF₃ | Cl | Et | Cl | H | Cl | Br |
| i-Pr | CH₃ | H | CF₃ | Cl | i-Pr | Cl | F | CF₃ | Cl | i-Pr | Cl | H | Cl | Br |
| t-Bu | CH₃ | H | CF₃ | Cl | t-Bu | Cl | F | CF₃ | Cl | t-Bu | Cl | H | Cl | Br |
| Me | CH₃ | H | CF₃ | Br | Me | Cl | F | CF₃ | Br | Me | Cl | H | Br | Cl |
| Et | CH₃ | H | CF₃ | Br | Et | Cl | F | CF₃ | Br | Et | Cl | H | Br | Cl |
| i-Pr | CH₃ | H | CF₃ | Br | i-Pr | Cl | F | CF₃ | Br | i-Pr | Cl | H | Br | Cl |
| t-Bu | CH₃ | H | CF₃ | Br | t-Bu | Cl | F | CF₃ | Br | t-Bu | Cl | H | Br | Cl |
| Me | CH₃ | H | Cl | Cl | Me | Cl | F | Cl | Cl | Me | Cl | H | Br | Br |
| Et | CH₃ | H | Cl | Cl | Et | Cl | F | Cl | Cl | Et | Cl | H | Br | Br |
| i-Pr | CH₃ | H | Cl | Cl | i-Pr | Cl | F | Cl | Cl | i-Pr | Cl | H | Br | Br |
| t-Bu | CH₃ | H | Cl | Cl | t-Bu | Cl | F | Cl | Cl | t-Bu | Cl | H | Br | Br |
| Me | CH₃ | H | Cl | Br | Me | Cl | F | Cl | Br | Me | Cl | H | CF₃ | Cl |
| Et | CH₃ | H | Cl | Br | Et | Cl | F | Cl | Br | Et | Cl | H | CF₃ | Cl |
| i-Pr | CH₃ | H | Cl | Br | i-Pr | Cl | F | Cl | Br | i-Pr | Cl | H | CF₃ | Cl |
| t-Bu | CH₃ | H | Cl | Br | t-Bu | Cl | F | Cl | Br | t-Bu | Cl | H | CF₃ | Cl |
| Me | CH₃ | H | Br | Cl | Me | Cl | F | Br | Cl | Me | Cl | H | CF₃ | Br |
| Et | CH₃ | H | Br | Cl | Et | Cl | F | Br | Cl | Et | Cl | H | CF₃ | Br |
| i-Pr | CH₃ | H | Br | Cl | i-Pr | Cl | F | Br | Cl | i-Pr | Cl | H | CF₃ | Br |
| t-Bu | CH₃ | H | Br | Cl | t-Bu | Cl | F | Br | Cl | t-Bu | Cl | H | CF₃ | Br |
| Me | CH₃ | H | Br | Br | Me | Cl | F | Br | Br | Me | Cl | H | Cl | Cl |
| Et | CH₃ | H | Br | Br | Et | Cl | F | Br | Br | Et | Cl | H | Cl | Cl |
| i-Pr | CH₃ | H | Br | Br | i-Pr | Cl | F | Br | Br | i-Pr | Cl | H | Cl | Cl |
| t-Bu | CH₃ | H | Br | Br | t-Bu | Cl | F | Br | Br | i-Pr | Cl | H | Cl | Cl |
| Me | CH₃ | F | CF₃ | Cl | Me | Cl | Cl | CF₃ | Cl | Me | Cl | Br | Cl | Br |
| Et | CH₃ | F | CF₃ | Cl | Et | Cl | Cl | CF₃ | Cl | Et | Cl | Br | Cl | Br |
| i-Pr | CH₃ | F | CF₃ | Cl | i-Pr | Cl | Cl | CF₃ | Cl | i-Pr | Cl | Br | Cl | Br |
| t-Bu | CH₃ | F | CF₃ | Cl | t-Bu | Cl | Cl | CF₃ | Cl | t-Bu | Cl | Br | Cl | Br |
| Me | CH₃ | F | CF₃ | Br | Me | Cl | Cl | CF₃ | Br | Me | Cl | Br | Br | Cl |
| Et | CH₃ | F | CF₃ | Br | Et | Cl | Cl | CF₃ | Br | Et | Cl | Br | Br | Cl |
| i-Pr | CH₃ | F | CF₃ | Br | i-Pr | Cl | Cl | CF₃ | Br | i-Pr | Cl | Br | Br | Cl |
| t-Bu | CH₃ | F | CF₃ | Br | t-Bu | Cl | Cl | CF₃ | Br | t-Bu | Cl | Br | Br | Cl |
| Me | CH₃ | F | Cl | Cl | Me | Cl | Cl | Cl | Cl | Me | Cl | Br | Br | Br |
| Et | CH₃ | F | Cl | Cl | Et | Cl | Cl | Cl | Cl | Et | Cl | Br | Br | Br |
| i-Pr | CH₃ | F | Cl | Cl | i-Pr | Cl | Cl | Cl | Cl | i-Pr | Cl | Br | Br | Br |
| t-Bu | CH₃ | F | Cl | Cl | t-Bu | Cl | Cl | Cl | Cl | t-Bu | Cl | Br | Br | Br |
| Me | CH₃ | F | Cl | Br | Me | Cl | Cl | Cl | Br | Me | Cl | I | CF₃ | Cl |
| Et | CH₃ | F | Cl | Br | Et | Cl | Cl | Cl | Br | Et | Cl | I | CF₃ | Cl |
| i-Pr | CH₃ | F | Cl | Br | i-Pr | Cl | Cl | Cl | Br | i-Pr | Cl | I | CF₃ | Cl |
| t-Bu | CH₃ | F | Cl | Br | t-Bu | Cl | Cl | Cl | Br | t-Bu | Cl | I | CF₃ | Cl |
| Me | CH₃ | F | Br | Cl | Me | Cl | Cl | Br | Cl | Me | Cl | I | CF₃ | Br |
| Et | CH₃ | F | Br | Cl | Et | Cl | Cl | Br | Cl | Et | Cl | I | CF₃ | Br |
| i-Pr | CH₃ | F | Br | Cl | i-Pr | Cl | Cl | Br | Cl | i-Pr | Cl | I | CF₃ | Br |
| t-Bu | CH₃ | F | Br | Cl | t-Bu | Cl | Cl | Br | Cl | t-Bu | Cl | I | CF₃ | Br |
| Me | CH₃ | F | Br | Br | Me | Cl | Cl | Br | Br | Me | Cl | I | Cl | Cl |
| Et | CH₃ | F | Br | Br | Et | Cl | Cl | Br | Br | Et | Cl | I | Cl | Cl |
| i-Pr | CH₃ | F | Br | Br | i-Pr | Cl | Cl | Br | Br | i-Pr | Cl | I | Cl | Cl |
| t-Bu | CH₃ | F | Br | Br | t-Bu | Cl | Cl | Br | Br | t-Bu | Cl | I | Cl | Cl |
| Me | CH₃ | Cl | CF₃ | Cl | Me | Cl | Br | CF₃ | Cl | Me | Cl | I | Cl | Br |
| Et | CH₃ | Cl | CF₃ | Cl | Et | Cl | Br | CF₃ | Cl | Et | Cl | I | Cl | Br |
| i-Pr | CH₃ | Cl | CF₃ | Cl | i-Pr | Cl | Br | CF₃ | Cl | i-Pr | Cl | I | Cl | Br |
| t-Bu | CH₃ | Cl | CF₃ | Cl | t-Bu | Cl | Br | CF₃ | Cl | t-Bu | Cl | I | Cl | Br |
| Me | CH₃ | Cl | CF₃ | Br | Me | Cl | Br | CF₃ | Br | Me | Cl | I | Br | Cl |
| Et | CH₃ | Cl | CF₃ | Br | Et | Cl | Br | CF₃ | Br | Et | Cl | I | Br | Cl |
| i-Pr | CH₃ | Cl | CF₃ | Br | i-Pr | Cl | Br | CF₃ | Br | i-Pr | Cl | I | Br | Cl |
| t-Bu | CH₃ | Cl | CF₃ | Br | t-Bu | Cl | Br | CF₃ | Br | t-Bu | Cl | I | Br | Cl |
| Me | CH₃ | Cl | Cl | Cl | Me | Cl | Br | Cl | Cl | Me | Cl | I | Br | Br |
| Et | CH₃ | Cl | Cl | Cl | Et | Cl | Br | Cl | Cl | Et | Cl | I | Br | Br |
| i-Pr | CH₃ | Cl | Cl | Cl | i-Pr | Cl | Br | Cl | Cl | i-Pr | Cl | I | Br | Br |
| t-Bu | CH₃ | Cl | Cl | Cl | t-Bu | Cl | Br | Cl | Cl | t-Bu | Cl | I | Br | Br |
| Me | CH₃ | Cl | Cl | Br | Me | Br | Br | Br | Cl | Me | Cl | CF₃ | CF₃ | Cl |
| Et | CH₃ | Cl | Cl | Br | Et | Br | Br | Br | Cl | Et | Cl | CF₃ | CF₃ | Cl |
| i-Pr | CH₃ | Cl | Cl | Br | i-Pr | Br | Br | Br | Cl | i-Pr | Cl | CF₃ | CF₃ | Cl |
| t-Bu | CH₃ | Cl | Cl | Br | t-Bu | Br | Br | Br | Cl | t-Bu | Cl | CF₃ | CF₃ | Cl |
| Me | CH₃ | Cl | Br | Cl | Me | Br | Br | Br | Br | Me | Cl | CF₃ | CF₃ | Br |
| Et | CH₃ | Cl | Br | Cl | Et | Br | Br | Br | Br | Et | Cl | CF₃ | CF₃ | Br |
| i-Pr | CH₃ | Cl | Br | Cl | i-Pr | Br | Br | Br | Br | i-Pr | Cl | CF₃ | CF₃ | Br |
| t-Bu | CH₃ | Cl | Br | Cl | t-Bu | Br | Br | Br | Br | t-Bu | Cl | CF₃ | CF₃ | Br |
| Me | CH₃ | Cl | Br | Br | Me | Br | I | CF₃ | Cl | Me | Cl | CF₃ | Cl | Cl |
| Et | CH₃ | Cl | Br | Br | Et | Br | I | CF₃ | Cl | Et | Cl | CF₃ | Cl | Cl |
| i-Pr | CH₃ | Cl | Br | Br | i-Pr | Br | I | CF₃ | Cl | i-Pr | Cl | CF₃ | Cl | Cl |
| t-Bu | CH₃ | Cl | Br | Br | t-Bu | Br | I | CF₃ | Cl | t-Bu | Cl | CF₃ | Cl | Cl |
| Me | CH₃ | Br | CF₃ | Cl | Me | Br | I | CF₃ | Br | Me | Cl | CF₃ | Cl | Br |
| Et | CH₃ | Br | CF₃ | Cl | Et | Br | I | CF₃ | Br | Et | Cl | CF₃ | Cl | Br |
| i-Pr | CH₃ | Br | CF₃ | Cl | i-Pr | Br | I | CF₃ | Br | i-Pr | Cl | CF₃ | Cl | Br |
| t-Bu | CH₃ | Br | CF₃ | Cl | t-Bu | Br | I | CF₃ | Br | t-Bu | Cl | CF₃ | Cl | Br |
| Me | CH₃ | Br | CF₃ | Br | Me | Br | I | Cl | Cl | Me | Cl | CF₃ | Br | Cl |
| Et | CH₃ | Br | CF₃ | Br | Et | Br | I | Cl | Cl | Et | Cl | CF₃ | Br | Cl |
| i-Pr | CH₃ | Br | CF₃ | Br | i-Pr | Br | I | Cl | Cl | i-Pr | Cl | CF₃ | Br | Cl |
| t-Bu | CH₃ | Br | CF₃ | Br | t-Bu | Br | I | Cl | Cl | t-Bu | Cl | CF₃ | Br | Cl |
| Me | CH₃ | Br | Cl | Cl | Me | Br | I | Cl | Br | Me | Cl | CF₃ | Br | Br |
| Et | CH₃ | Br | Cl | Cl | Et | Br | I | Cl | Br | Et | Cl | CF₃ | Br | Br |
| i-Pr | CH₃ | Br | Cl | Cl | i-Pr | Br | I | Cl | Br | i-Pr | Cl | CF₃ | Br | Br |
| t-Bu | CH₃ | Br | Cl | Cl | t-Bu | Br | I | Cl | Br | t-Bu | Cl | CF₃ | Br | Br |
| Me | CH₃ | Br | Cl | Br | Me | Br | I | Br | Cl | n-Pr | Cl | Cl | Cl | Cl |
| Et | CH₃ | Br | Cl | Br | Et | Br | I | Br | Cl | n-Bu | Cl | Cl | Cl | Cl |
| i-Pr | CH₃ | Br | Cl | Br | i-Pr | Br | I | Br | Cl | s-Bu | Cl | Cl | Cl | Cl |
| t-Bu | CH₃ | Br | Cl | Br | t-Bu | Br | I | Br | Cl | t-Bu | Cl | Cl | Cl | Cl |
| Me | CH₃ | Br | Br | Cl | Me | Br | I | Br | Br | Me | Br | F | CF₃ | Cl |
| Et | CH₃ | Br | Br | Cl | Et | Br | I | Br | Br | Et | Br | F | CF₃ | Cl |
| i-Pr | CH₃ | Br | Br | Cl | i-Pr | Br | I | Br | Br | i-Pr | Br | F | CF₃ | Cl |
| t-Bu | CH₃ | Br | Br | Cl | t-Bu | Br | I | Br | Br | t-Bu | Br | F | CF₃ | Cl |
| Me | CH₃ | Br | Br | Br | Me | Br | CF₃ | CF₃ | Cl | Me | Br | F | CF₃ | Br |
| Et | CH₃ | Br | Br | Br | Et | Br | CF₃ | CF₃ | Cl | Et | Br | F | CF₃ | Br |
| i-Pr | CH₃ | Br | Br | Br | i-Pr | Br | CF₃ | CF₃ | Cl | i-Pr | Br | F | CF₃ | Br |
| t-Bu | CH₃ | Br | Br | Br | t-Bu | Br | CF₃ | CF₃ | Cl | t-Bu | Br | F | CF₃ | Br |
| Me | CH₃ | I | CF₃ | Cl | Me | Br | CF₃ | CF₃ | Br | Me | Br | F | Cl | Cl |
| Et | CH₃ | I | CF₃ | Cl | Et | Br | CF₃ | CF₃ | Br | Et | Br | F | Cl | Cl |
| i-Pr | CH₃ | I | CF₃ | Cl | i-Pr | Br | CF₃ | CF₃ | Br | i-Pr | Br | F | Cl | Cl |
| t-Bu | CH₃ | I | CF₃ | Cl | t-Bu | Br | CF₃ | CF₃ | Br | t-Bu | Br | F | Cl | Cl |
| Me | CH₃ | I | CF₃ | Br | Me | Br | CF₃ | Cl | Cl | Me | Br | F | Cl | Br |
| Et | CH₃ | I | CF₃ | Br | Et | Br | CF₃ | Cl | Cl | Et | Br | F | Cl | Br |
| i-Pr | CH₃ | I | CF₃ | Br | i-Pr | Br | CF₃ | Cl | Cl | i-Pr | Br | F | Cl | Br |
| t-Bu | OH₃ | I | CF₃ | Br | t-Bu | Br | CF₃ | Cl | Cl | t-Bu | Br | F | Cl | Br |
| Me | CH₃ | I | Cl | Cl | Me | Br | CF₃ | Cl | Br | Me | Br | F | Br | Cl |
| Et | CH₃ | I | Cl | Cl | Et | Br | CF₃ | Cl | Br | Et | Br | F | Br | Cl |
| i-Pr | CH₃ | I | Cl | Cl | i-Pr | Br | CF₃ | Cl | Br | i-Pr | Br | F | Br | Cl |
| t-Bu | CH₃ | I | Cl | Cl | t-Bu | Br | CF₃ | Cl | Br | t-Bu | Br | F | Br | Cl |
| Me | CH₃ | I | Cl | Br | Me | Br | CF₃ | Br | Cl | Me | Br | F | Br | Br |
| Et | CH₃ | I | Cl | Br | Et | Br | CF₃ | Br | Cl | Et | Br | F | Br | Br |
| i-Pr | CH₃ | I | Cl | Br | i-Pr | Br | CF₃ | Br | Cl | i-Pr | Br | F | Br | Br |
| t-Bu | CH₃ | I | Cl | Br | t-Bu | Br | CF₃ | Br | Cl | t-Bu | Br | F | Br | Br |
| Me | CH₃ | I | Br | Cl | Me | Br | CF₃ | Br | Br | Me | Br | Cl | CF₃ | Cl |
| Et | CH₃ | I | Br | Cl | Et | Br | CF₃ | Br | Br | Et | Br | Cl | CF₃ | Cl |
| i-Pr | CH₃ | I | Br | Cl | i-Pr | Br | CF₃ | Br | Br | i-Pr | Br | Cl | CF₃ | Cl |
| t-Bu | CH₃ | I | Br | Cl | t-Bu | Br | CF₃ | Br | Br | t-Bu | Br | Cl | CF₃ | Cl |
| Me | CH₃ | I | Br | Br | Me | Br | Br | CF₃ | Cl | Me | Br | Cl | CF₃ | Br |
| Et | CH₃ | I | Br | Br | Et | Br | Br | CF₃ | Cl | Et | Br | Cl | CF₃ | Br |
| i-Pr | CH₃ | I | Br | Br | i-Pr | Br | Br | CF₃ | Cl | i-Pr | Br | Cl | CF₃ | Br |
| t-Bu | CH₃ | I | Br | Br | t-Bu | Br | Br | CF₃ | Cl | t-Bu | Br | Cl | CF₃ | Br |
| Me | CH₃ | CF₃ | CF₃ | Cl | Me | Br | Br | CF₃ | Br | Me | Br | Cl | Cl | Cl |
| Et | CH₃ | CF₃ | CF₃ | Cl | Et | Br | Br | CF₃ | Br | Et | Br | Cl | Cl | Cl |
| i-Pr | CH₃ | CF₃ | CF₃ | Cl | i-Pr | Br | Br | CF₃ | Br | i-Pr | Br | Cl | Cl | Cl |
| t-Bu | CH₃ | CF₃ | CF₃ | Cl | t-Bu | Br | Br | CF₃ | Br | t-Bu | Br | Cl | Cl | Cl |
| Me | CH₃ | CF₃ | CF₃ | Br | Me | Br | Br | Cl | Cl | Me | Br | Cl | Cl | Br |
| Et | CH₃ | CF₃ | CF₃ | Br | Et | Br | Br | Cl | Cl | Et | Br | Cl | Cl | Br |
| i-Pr | CH₃ | CF₃ | CF₃ | Br | i-Pr | Br | Br | Cl | Cl | i-Pr | Br | Cl | Cl | Br |
| t-Bu | CH₃ | CF₃ | CF₃ | Br | t-Bu | Br | Br | Cl | Cl | t-Bu | Br | Cl | Cl | Br |
| Me | CH₃ | CF₃ | Cl | Cl | Me | Br | Br | Cl | Br | Me | Br | Cl | Br | Cl |
| Et | CH₃ | CF₃ | Cl | Cl | Et | Br | Br | Cl | Br | Et | Br | Cl | Br | Cl |
| i-Pr | CH₃ | CF₃ | Cl | Cl | i-Pr | Br | Br | Cl | Br | i-Pr | Br | Cl | Br | Cl |
| t-Bu | CH₃ | CF₃ | Cl | Cl | t-Bu | Br | Br | Cl | Br | t-Bu | Br | Cl | Br | Cl |
| Me | CH₃ | CF₃ | Cl | Br | Me | CH₃ | CF₃ | Br | Cl | Me | Br | Cl | Br | Br |
| Et | CH₃ | CF₃ | Cl | Br | Et | CH₃ | CF₃ | Br | Cl | Et | Br | Cl | Br | Br |
| i-Pr | CH₃ | CF₃ | Cl | Br | i-Pr | CH₃ | CF₃ | Br | Cl | i-Pr | Br | Cl | Br | Br |
| t-Bu | CH₃ | CF₃ | Cl | Br | t-Bu | CH₃ | CF₃ | Br | Cl | t-Bu | Br | Cl | Br | Br |
| Me | CH₃ | CF₃ | Br | Br | n-Pr | CH₃ | Cl | Cl | Cl | t-Bu | CH₃ | CF₃ | Br | Br |
| Et | CH₃ | CF₃ | Br | Br | n-Bu | CH₃ | Cl | Cl | Cl | i-Bu | CH₃ | Cl | Cl | Cl |
| i-Pr | CH₃ | CF₃ | Br | Br | s-Bu | CH₃ | Cl | Cl | Cl | | | | | |

TABLE 22

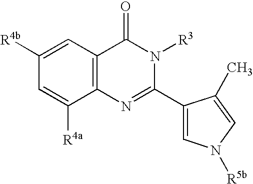

| R^{5b} is CHF₂ | | | R^{5b} is CF₃ | | | R^{5b} is CH₂CF₃ | | | R^{5b} is CF₂CHF₂ | | |
|---|---|---|---|---|---|---|---|---|---|---|---|
| R³ | R^{4a} | R^{4b} | R³ | R^{4a} | R^{4b} | R³ | R^{4a} | R^{4b} | R³ | R^{4a} | R^{4b} |
| i-Pr | Me | H | i-Pr | Me | H | i-Pr | Me | H | i-Pr | Me | H |
| i-Pr | Cl | H | i-Pr | Cl | H | i-Pr | Cl | H | i-Pr | Cl | H |
| i-Pr | Me | Cl | i-Pr | Me | Cl | i-Pr | Me | Cl | i-Pr | Me | Cl |
| i-Pr | Cl | Cl | i-Pr | Cl | Cl | i-Pr | Cl | Cl | i-Pr | Cl | Cl |
| i-Pr | Me | Br | i-Pr | Me | Br | i-Pr | Me | Br | i-Pr | Me | Br |
| i-Pr | Cl | Br | i-Pr | Cl | Br | i-Pr | Cl | Br | i-Pr | Cl | Br |
| t-Bu | Me | H | t-Bu | Me | H | t-Bu | Me | H | t-Bu | Me | H |
| t-Bu | Cl | H | t-Bu | Cl | H | t-Bu | Cl | H | t-Bu | Cl | H |
| t-Bu | Me | Cl | t-Bu | Me | Cl | t-Bu | Me | Cl | t-Bu | Me | Cl |
| t-Bu | Cl | Cl | t-Bu | Cl | Cl | t-Bu | Cl | Cl | t-Bu | Cl | Cl |
| t-Bu | Me | Br | t-Bu | Me | Br | t-Bu | Me | Br | t-Bu | Me | Br |
| t-Bu | Cl | Br | t-Bu | Cl | Br | t-Bu | Cl | Br | t-Bu | Cl | Br |
| Et | Me | H | Et | Me | H | Et | Me | H | Et | Me | H |
| Et | Cl | H | Et | Cl | H | Et | Cl | H | Et | Cl | H |
| Et | Me | Cl | Et | Me | Cl | Et | Me | Cl | Et | Me | Cl |
| Et | Cl | Cl | Et | Cl | Cl | Et | Cl | Cl | Et | Cl | Cl |
| Et | Me | Br | Et | Me | Br | Et | Me | Br | Et | Me | Br |
| Et | Cl | Br | Et | Cl | Br | Et | Cl | Br | Et | Cl | Br |
| Me | Me | H | Me | Me | H | Me | Me | H | Me | Me | H |
| Me | Cl | H | Me | Cl | H | Me | Cl | H | Me | Cl | H |
| Me | Me | Cl | Me | Me | Cl | Me | Me | Cl | Me | Me | Cl |
| Me | Cl | Cl | Me | Cl | Cl | Me | Cl | Cl | Me | Cl | Cl |
| Me | Me | Br | Me | Me | Br | Me | Me | Br | Me | Me | Br |
| Me | Cl | Br | Me | Cl | Br | Me | Cl | Br | Me | Cl | Br |

TABLE 23

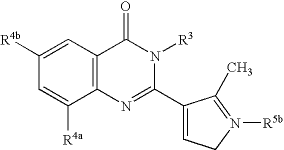

| R^{5b} is CHF₂ | | | R^{5b} is CF₃ | | | R^{5b} is CH₂CF₃ | | | R^{5b} is CF₂CHF₂ | | |
|---|---|---|---|---|---|---|---|---|---|---|---|
| R³ | R^{4a} | R^{4b} | R³ | R^{4a} | R^{4b} | R³ | R^{4a} | R^{4b} | R³ | R^{4a} | R^{4b} |
| i-Pr | Me | H | i-Pr | Me | H | i-Pr | Me | H | i-Pr | Me | H |
| i-Pr | Cl | H | i-Pr | Cl | H | i-Pr | Cl | H | i-Pr | Cl | H |
| i-Pr | Me | Cl | i-Pr | Me | Cl | i-Pr | Me | Cl | i-Pr | Me | Cl |
| i-Pr | Cl | Cl | i-Pr | Cl | Cl | i-Pr | Cl | Cl | i-Pr | Cl | Cl |
| i-Pr | Me | Br | i-Pr | Me | Br | i-Pr | Me | Br | i-Pr | Me | Br |
| i-Pr | Cl | Br | i-Pr | Cl | Br | i-Pr | Cl | Br | i-Pr | Cl | Br |
| t-Bu | Me | H | t-Bu | Me | H | t-Bu | Me | H | t-Bu | Me | H |
| t-Bu | Cl | H | t-Bu | Cl | H | t-Bu | Cl | H | t-Bu | Cl | H |
| t-Bu | Me | Cl | t-Bu | Me | Cl | t-Bu | Me | Cl | t-Bu | Me | Cl |
| t-Bu | Cl | Cl | t-Bu | Cl | Cl | t-Bu | Cl | Cl | t-Bu | Cl | Cl |
| t-Bu | Me | Br | t-Bu | Me | Br | t-Bu | Me | Br | t-Bu | Me | Br |
| t-Bu | Cl | Br | t-Bu | Cl | Br | t-Bu | Cl | Br | t-Bu | Cl | Br |
| Et | Me | H | Et | Me | H | Et | Me | H | Et | Me | H |
| Et | Cl | H | Et | Cl | H | Et | Cl | H | Et | Cl | H |
| Et | Me | Cl | Et | Me | Cl | Et | Me | Cl | Et | Me | Cl |
| Et | Cl | Cl | Et | Cl | Cl | Et | Cl | Cl | Et | Cl | Cl |
| Et | Me | Br | Et | Me | Br | Et | Me | Br | Et | Me | Br |
| Et | Cl | Br | Et | Cl | Br | Et | Cl | Br | Et | Cl | Br |
| Me | Me | H | Me | Me | H | Me | Me | H | Me | Me | H |
| Me | Cl | H | Me | Cl | H | Me | Cl | H | Me | Cl | H |
| Me | Me | Cl | Me | Me | Cl | Me | Me | Cl | Me | Me | Cl |
| Me | Cl | Cl | Me | Cl | Cl | Me | Cl | Cl | Me | Cl | Cl |
| Me | Me | Br | Me | Me | Br | Me | Me | Br | Me | Me | Br |
| Me | Cl | Br | Me | Cl | Br | Me | Cl | Br | Me | Cl | Br |

TABLE 24

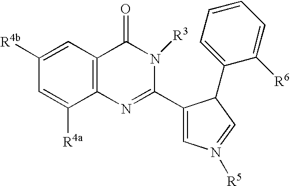

| R⁵ is CHF₂ | | | | R⁵ is CH₂CF₃ | | | | R⁵ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | H | Cl |
| Et | CH₃ | H | Cl | Et | CH₃ | H | Cl | Et | CH₃ | H | Cl |
| i-Pr | CH₃ | H | Cl | i-Pr | CH₃ | H | Cl | i-Pr | CH₃ | H | Cl |
| t-Bu | CH₃ | H | Cl | t-Bu | CH₃ | H | Cl | t-Bu | CH₃ | H | Cl |
| Me | CH₃ | H | Br | Me | CH₃ | H | Br | Me | CH₃ | H | Br |
| Et | CH₃ | H | Br | Et | CH₃ | H | Br | Et | CH₃ | H | Br |
| i-Pr | CH₃ | H | Br | i-Pr | CH₃ | H | Br | i-Pr | CH₃ | H | Br |
| t-Bu | CH₃ | H | Br | t-Bu | CH₃ | H | Br | t-Bu | CH₃ | H | Br |
| Me | CH₃ | F | Cl | Me | CH₃ | F | Cl | Me | CH₃ | F | Cl |
| Et | CH₃ | F | Cl | Et | CH₃ | F | Cl | Et | CH₃ | F | Cl |
| i-Pr | CH₃ | F | Cl | i-Pr | CH₃ | F | Cl | i-Pr | CH₃ | F | Cl |
| t-Bu | CH₃ | F | Cl | t-Bu | CH₃ | F | Cl | t-Bu | CH₃ | F | Cl |
| Me | CH₃ | F | Br | Me | CH₃ | F | Br | Me | CH₃ | F | Br |
| Et | CH₃ | F | Br | Et | CH₃ | F | Br | Et | CH₃ | F | Br |
| i-Pr | CH₃ | F | Br | i-Pr | CH₃ | F | Br | i-Pr | CH₃ | F | Br |
| t-Bu | CH₃ | F | Br | t-Bu | CH₃ | F | Br | t-Bu | CH₃ | F | Br |
| Me | CH₃ | Cl | Cl | Me | CH₃ | Cl | Cl | Me | CH₃ | Cl | Cl |
| Et | CH₃ | Cl | Cl | Et | CH₃ | Cl | Cl | Et | CH₃ | Cl | Cl |
| i-Pr | CH₃ | Cl | Cl | i-Pr | CH₃ | Cl | Cl | i-Pr | CH₃ | Cl | Cl |
| t-Bu | CH₃ | Cl | Cl | t-Bu | CH₃ | Cl | Cl | t-Bu | CH₃ | Cl | Cl |
| Me | CH₃ | Cl | Br | Me | CH₃ | Cl | Br | Me | CH₃ | Cl | Br |
| Et | CH₃ | Cl | Br | Et | CH₃ | Cl | Br | Et | CH₃ | Cl | Br |
| i-Pr | CH₃ | Cl | Br | i-Pr | CH₃ | Cl | Br | i-Pr | CH₃ | Cl | Br |
| t-Bu | CH₃ | Cl | Br | t-Bu | CH₃ | Cl | Br | t-Bu | CH₃ | Cl | Br |
| Me | CH₃ | Br | Cl | Me | CH₃ | Br | Cl | Me | CH₃ | Br | Cl |
| Et | CH₃ | Br | Cl | Et | CH₃ | Br | Cl | Et | CH₃ | Br | Cl |
| i-Pr | CH₃ | Br | Cl | i-Pr | CH₃ | Br | Cl | i-Pr | CH₃ | Br | Cl |
| t-Bu | CH₃ | Br | Cl | t-Bu | CH₃ | Br | Cl | t-Bu | CH₃ | Br | Cl |
| Me | CH₃ | Br | Br | Me | CH₃ | Br | Br | Me | CH₃ | Br | Br |
| Et | CH₃ | Br | Br | Et | CH₃ | Br | Br | Et | CH₃ | Br | Br |
| i-Pr | CH₃ | Br | Br | i-Pr | CH₃ | Br | Br | i-Pr | CH₃ | Br | Br |
| t-Bu | CH₃ | Br | Br | t-Bu | CH₃ | Br | Br | t-Bu | CH₃ | Br | Br |
| Me | CH₃ | I | Cl | Me | CH₃ | I | Cl | Me | CH₃ | I | Cl |
| Et | CH₃ | I | Cl | Et | CH₃ | I | Cl | Et | CH₃ | I | Cl |
| i-Pr | CH₃ | I | Cl | i-Pr | CH₃ | I | Cl | i-Pr | CH₃ | I | Cl |
| t-Bu | CH₃ | I | Cl | t-Bu | CH₃ | I | Cl | t-Bu | CH₃ | I | Cl |
| Me | CH₃ | I | Br | Me | CH₃ | I | Br | Me | CH₃ | I | Br |
| Et | CH₃ | I | Br | Et | CH₃ | I | Br | Et | CH₃ | I | Br |
| i-Pr | CH₃ | I | Br | i-Pr | CH₃ | I | Br | i-Pr | CH₃ | I | Br |
| t-Bu | CH₃ | I | Br | t-Bu | CH₃ | I | Br | t-Bu | CH₃ | I | Br |
| Me | CH₃ | CF₃ | Cl | Me | CH₃ | CF₃ | Cl | Me | CH₃ | CF₃ | Cl |
| Et | CH₃ | CF₃ | Cl | Et | CH₃ | CF₃ | Cl | Et | CH₃ | CF₃ | Cl |
| i-Pr | CH₃ | CF₃ | Cl | i-Pr | CH₃ | CF₃ | Cl | i-Pr | CH₃ | CF₃ | Cl |
| t-Bu | CH₃ | CF₃ | Cl | t-Bu | CH₃ | CF₃ | Cl | t-Bu | CH₃ | CF₃ | Cl |
| Me | CH₃ | CF₃ | Br | Me | CH₃ | CF₃ | Br | Me | CH₃ | CF₃ | Br |
| Et | CH₃ | CF₃ | Br | Et | CH₃ | CF₃ | Br | Et | CH₃ | CF₃ | Br |
| i-Pr | CH₃ | CF₃ | Br | i-Pr | CH₃ | CF₃ | Br | i-Pr | CH₃ | CF₃ | Br |
| t-Bu | CH₃ | CF₃ | Br | t-Bu | CH₃ | CF₃ | Br | t-Bu | CH₃ | CF₃ | Br |
| n-Pr | CH₃ | Cl | Cl | Me | Cl | F | Br | Me | Cl | H | Br |
| n-Bu | CH₃ | Cl | Cl | Et | Cl | F | Br | Et | Cl | H | Br |
| s-Bu | CH₃ | Cl | Cl | i-Pr | Cl | F | Br | i-Pr | Cl | H | Br |
| i-Bu | CH₃ | Cl | Cl | t-Bu | Cl | F | Br | t-Bu | Cl | H | Br |
| Me | Cl | F | Cl | Me | Cl | F | Cl | Me | Cl | H | Cl |
| Et | Cl | F | Cl | Et | Cl | F | Cl | Et | Cl | H | Cl |
| i-Pr | Cl | F | Cl | i-Pr | Cl | F | Cl | i-Pr | Cl | H | Cl |
| t-Bu | Cl | F | Cl | t-Bu | Cl | F | Cl | i-Pr | Cl | H | Cl |
| Me | Cl | F | Br | Me | Cl | Cl | Br | Me | Cl | I | Br |
| Et | Cl | F | Br | Et | Cl | Cl | Br | Et | Cl | I | Br |
| i-Pr | Cl | F | Br | i-Pr | Cl | Cl | Br | i-Pr | Cl | I | Br |
| t-Bu | Cl | F | Br | t-Bu | Cl | Cl | Br | t-Bu | Cl | I | Br |
| Me | Cl | Cl | Cl | Me | Cl | Cl | Cl | Me | Cl | I | Cl |
| Et | Cl | Cl | Cl | Et | Cl | Cl | Cl | Et | Cl | I | Cl |
| i-Pr | Cl | Cl | Cl | i-Pr | Cl | Cl | Cl | i-Pr | Cl | I | Cl |
| t-Bu | Cl | Cl | Cl | t-Bu | Cl | Cl | Cl | t-Bu | Cl | I | Cl |
| Me | Cl | H | Br | Me | Cl | H | Br | Me | Cl | F | Br |
| Et | Cl | H | Br | Et | Cl | H | Br | Et | Cl | F | Br |
| i-Pr | Cl | H | Br | i-Pr | Cl | H | Br | i-Pr | Cl | F | Br |
| t-Bu | Cl | H | Br | t-Bu | Cl | H | Br | t-Bu | Cl | F | Br |
| Me | Cl | H | Cl | Me | Cl | H | Cl | Me | Cl | F | Cl |
| Et | Cl | H | Cl | Et | Cl | H | Cl | Et | Cl | F | Cl |
| i-Pr | Cl | H | Cl | i-Pr | Cl | H | Cl | i-Pr | Cl | F | Cl |
| t-Bu | Cl | H | Cl | t-Bu | Cl | H | Cl | t-Bu | Cl | F | Cl |
| Me | Cl | Br | Br | Me | Cl | Br | Br | Me | Cl | CF₃ | Br |
| Et | Cl | Br | Br | Et | Cl | Br | Br | Et | Cl | CF₃ | Br |
| i-Pr | Cl | Br | Br | i-Pr | Cl | Br | Br | i-Pr | Cl | CF₃ | Br |
| t-Bu | Cl | Br | Br | t-Bu | Cl | Br | Br | t-Bu | Cl | CF₃ | Br |
| Me | Cl | Br | Cl | Me | Cl | I | Cl | Me | Cl | CF₃ | Cl |
| Et | Cl | Br | Cl | Et | Cl | I | Cl | Et | Cl | CF₃ | Cl |
| i-Pr | Cl | Br | Cl | i-Pr | Cl | I | Cl | i-Pr | Cl | CF₃ | Cl |
| t-Bu | Cl | Br | Cl | t-Bu | Cl | I | Cl | t-Bu | Cl | CF₃ | Cl |
| Me | Cl | I | Br | Me | Cl | I | Br | Me | Br | F | Cl |
| Et | Cl | I | Br | Et | Cl | I | Br | Et | Br | F | Cl |
| i-Pr | Cl | I | Br | i-Pr | Cl | I | Br | i-Pr | Br | F | Cl |
| t-Bu | Cl | I | Br | t-Bu | Cl | I | Br | t-Bu | Br | F | Cl |
| Me | Cl | I | Cl | Me | Cl | CF₃ | Cl | Me | Br | F | Br |
| Et | Cl | I | Cl | Et | Cl | CF₃ | Cl | Et | Br | F | Br |
| i-Pr | Cl | I | Cl | i-Pr | Cl | CF₃ | Cl | i-Pr | Br | F | Br |
| t-Bu | Cl | I | Cl | t-Bu | Cl | CF₃ | Cl | t-Bu | Br | F | Br |
| Me | Cl | CF₃ | Br | Me | Cl | CF₃ | Br | Me | Br | Cl | Cl |
| Et | Cl | CF₃ | Br | Et | Cl | CF₃ | Br | Et | Br | Cl | Cl |
| i-Pr | Cl | CF₃ | Br | i-Pr | Cl | CF₃ | Br | i-Pr | Br | Cl | Cl |
| t-Bu | Cl | CF₃ | Br | t-Bu | Cl | CF₃ | Br | t-Bu | Br | Cl | Cl |
| Me | Cl | CF₃ | Cl | n-Pr | Cl | Cl | Cl | Me | Br | Cl | Br |
| Et | Cl | CF₃ | Cl | n-Bu | Cl | Cl | Cl | Et | Br | Cl | Br |
| i-Pr | Cl | CF₃ | Cl | s-Bu | Cl | Cl | Cl | i-Pr | Br | Cl | Br |
| t-Bu | Cl | CF₃ | Cl | t-Bu | Cl | Cl | Cl | t-Bu | Br | Cl | Br |
| Me | Br | F | Cl | Me | Br | F | Cl | Me | Br | Br | Cl |
| Et | Br | F | Cl | Et | Br | F | Cl | Et | Br | Br | Cl |
| i-Pr | Br | F | Cl | i-Pr | Br | F | Cl | i-Pr | Br | Br | Cl |
| t-Bu | Br | F | Cl | t-Bu | Br | F | Cl | t-Bu | Br | Br | Cl |
| Me | Br | F | Br | Me | Br | F | Br | Me | Br | Br | Br |
| Et | Br | F | Br | Et | Br | F | Br | Et | Br | Br | Br |
| i-Pr | Br | F | Br | i-Pr | Br | F | Br | i-Pr | Br | Br | Br |
| t-Bu | Br | F | Br | t-Bu | Br | F | Br | t-Bu | Br | Br | Br |
| Me | Br | Cl | Cl | Me | Br | Cl | Cl | Me | Br | I | Cl |
| Et | Br | Cl | Cl | Et | Br | Cl | Cl | Et | Br | I | Cl |
| i-Pr | Br | Cl | Cl | i-Pr | Br | Cl | Cl | i-Pr | Br | I | Cl |
| t-Bu | Br | Cl | Cl | t-Bu | Br | Cl | Cl | t-Bu | Br | I | Cl |
| Me | Br | Cl | Br | Me | Br | Cl | Br | Me | Br | I | Br |
| Et | Br | Cl | Br | Et | Br | Cl | Br | Et | Br | I | Br |
| i-Pr | Br | Cl | Br | i-Pr | Br | Cl | Br | i-Pr | Br | I | Br |
| t-Bu | Br | Cl | Br | t-Bu | Br | Cl | Br | t-Bu | Br | I | Br |
| Me | Br | Br | Cl | Me | Br | Br | Cl | Me | Br | CF₃ | Cl |
| Et | Br | Br | Cl | Et | Br | Br | Cl | Et | Br | CF₃ | Cl |
| i-Pr | Br | Br | Cl | i-Pr | Br | Br | Cl | i-Pr | Br | CF₃ | Cl |
| t-Bu | Br | Br | Cl | t-Bu | Br | Br | Cl | t-Bu | Br | CF₃ | Cl |
| Me | Br | Br | Br | Me | Br | Br | Br | Me | Br | CF₃ | Br |
| Et | Br | Br | Br | Et | Br | Br | Br | Et | Br | CF₃ | Br |
| i-Pr | Br | Br | Br | i-Pr | Br | Br | Br | i-Pr | Br | CF₃ | Br |
| t-Bu | Br | Br | Br | t-Bu | Br | Br | Br | t-Bu | Br | CF₃ | Br |
| Me | Br | I | Cl | Me | Br | I | Cl | Me | Cl | Cl | Br |
| Et | Br | I | Cl | Et | Br | I | Cl | Et | Cl | Cl | Br |
| i-Pr | Br | I | Cl | i-Pr | Br | I | Cl | i-Pr | Cl | Cl | Br |
| t-Bu | Br | I | Cl | t-Bu | Br | I | Cl | t-Bu | Cl | Cl | Br |
| Me | Br | I | Br | Me | Br | I | Br | Me | Cl | Cl | Cl |
| Et | Br | I | Br | Et | Br | I | Br | Et | Cl | Cl | Cl |
| i-Pr | Br | I | Br | i-Pr | Br | I | Br | i-Pr | Cl | Cl | Cl |
| t-Bu | Br | I | Br | t-Bu | Br | I | Br | t-Bu | Cl | Cl | Cl |

TABLE 25

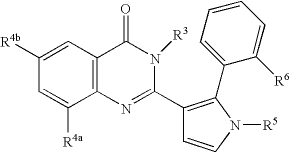

| R⁵ is CHF₂ | | | | R⁵ is CH₂CF₃ | | | | R⁵ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R³ | R^{4a} | R^{4b} | R⁶ |
| Me | CH₃ | H | Cl | Me | CH₃ | H | Cl | Me | CH₃ | H | Cl |
| Et | CH₃ | H | Cl | Et | CH₃ | H | Cl | Et | CH₃ | H | Cl |
| i-Pr | CH₃ | H | Cl | i-Pr | CH₃ | H | Cl | i-Pr | CH₃ | H | Cl |
| t-Bu | CH₃ | H | Cl | t-Bu | CH₃ | H | Cl | t-Bu | CH₃ | H | Cl |
| Me | CH₃ | H | Br | Me | CH₃ | H | Br | Me | CH₃ | H | Br |
| Et | CH₃ | H | Br | Et | CH₃ | H | Br | Et | CH₃ | H | Br |
| i-Pr | CH₃ | H | Br | i-Pr | CH₃ | H | Br | i-Pr | CH₃ | H | Br |
| t-Bu | CH₃ | H | Br | t-Bu | CH₃ | H | Br | t-Bu | CH₃ | H | Br |
| Me | CH₃ | F | Cl | Me | CH₃ | F | Cl | Me | CH₃ | F | Cl |
| Et | CH₃ | F | Cl | Et | CH₃ | F | Cl | Et | CH₃ | F | Cl |
| i-Pr | CH₃ | F | Cl | i-Pr | CH₃ | F | Cl | i-Pr | CH₃ | F | Cl |
| t-Bu | CH₃ | F | Cl | t-Bu | CH₃ | F | Cl | t-Bu | CH₃ | F | Cl |
| Me | CH₃ | F | Br | Me | CH₃ | F | Br | Me | CH₃ | F | Br |
| Et | CH₃ | F | Br | Et | CH₃ | F | Br | Et | CH₃ | F | Br |
| i-Pr | CH₃ | F | Br | i-Pr | CH₃ | F | Br | i-Pr | CH₃ | F | Br |
| t-Bu | CH₃ | F | Br | t-Bu | CH₃ | F | Br | t-Bu | CH₃ | F | Br |
| Me | CH₃ | Cl | Cl | Me | CH₃ | Cl | Cl | Me | CH₃ | Cl | Cl |
| Et | CH₃ | Cl | Cl | Et | CH₃ | Cl | Cl | Et | CH₃ | Cl | Cl |
| i-Pr | CH₃ | Cl | Cl | i-Pr | CH₃ | Cl | Cl | i-Pr | CH₃ | Cl | Cl |
| t-Bu | CH₃ | Cl | Cl | t-Bu | CH₃ | Cl | Cl | t-Bu | CH₃ | Cl | Cl |
| Me | CH₃ | Cl | Br | Me | CH₃ | Cl | Br | Me | CH₃ | Cl | Br |
| Et | CH₃ | Cl | Br | Et | CH₃ | Cl | Br | Et | CH₃ | Cl | Br |
| i-Pr | CH₃ | Cl | Br | i-Pr | CH₃ | Cl | Br | i-Pr | CH₃ | Cl | Br |
| t-Bu | CH₃ | Cl | Br | t-Bu | CH₃ | Cl | Br | t-Bu | CH₃ | Cl | Br |
| Me | CH₃ | Br | Cl | Me | CH₃ | Br | Cl | Me | CH₃ | Br | Cl |
| Et | CH₃ | Br | Cl | Et | CH₃ | Br | Cl | Et | CH₃ | Br | Cl |
| i-Pr | CH₃ | Br | Cl | i-Pr | CH₃ | Br | Cl | i-Pr | CH₃ | Br | Cl |
| t-Bu | CH₃ | Br | Cl | t-Bu | CH₃ | Br | Cl | t-Bu | CH₃ | Br | Cl |
| Me | CH₃ | Br | Br | Me | CH₃ | Br | Br | Me | CH₃ | Br | Br |
| Et | CH₃ | Br | Br | Et | CH₃ | Br | Br | Et | CH₃ | Br | Br |
| i-Pr | CH₃ | Br | Br | i-Pr | CH₃ | Br | Br | i-Pr | CH₃ | Br | Br |
| t-Bu | CH₃ | Br | Br | t-Bu | CH₃ | Br | Br | t-Bu | CH₃ | Br | Br |
| Me | CH₃ | I | Cl | Me | CH₃ | I | Cl | Me | CH₃ | I | Cl |
| Et | CH₃ | I | Cl | Et | CH₃ | I | Cl | Et | CH₃ | I | Cl |
| i-Pr | CH₃ | I | Cl | i-Pr | CH₃ | I | Cl | i-Pr | CH₃ | I | Cl |
| t-Bu | CH₃ | I | Cl | t-Bu | CH₃ | I | Cl | t-Bu | CH₃ | I | Cl |
| Me | CH₃ | I | Br | Me | CH₃ | I | Br | Me | CH₃ | I | Br |
| Et | CH₃ | I | Br | Et | CH₃ | I | Br | Et | CH₃ | I | Br |
| i-Pr | CH₃ | I | Br | i-Pr | CH₃ | I | i-Pr | CH₃ | I | Br | |
| t-Bu | CH₃ | I | Br | t-Bu | CH₃ | I | Br | t-Bu | CH₃ | I | Br |
| Me | CH₃ | CF₃ | Cl | Me | CH₃ | CF₃ | Cl | Me | CH₃ | CF₃ | Cl |
| Et | CH₃ | CF₃ | Cl | Et | CH₃ | CF₃ | Cl | Et | CH₃ | CF₃ | Cl |
| i-Pr | CH₃ | CF₃ | Cl | i-Pr | CH₃ | CF₃ | Cl | i-Pr | CH₃ | CF₃ | Cl |
| t-Bu | CH₃ | CF₃ | Cl | t-Bu | CH₃ | CF₃ | Cl | t-Bu | CH₃ | CF₃ | Cl |
| Me | CH₃ | CF₃ | Br | Me | CH₃ | CF₃ | Br | Me | CH₃ | CF₃ | Br |
| Et | CH₃ | CF₃ | Br | Et | CH₃ | CF₃ | Br | Et | CH₃ | CF₃ | Br |
| i-Pr | CH₃ | CF₃ | Br | i-Pr | CH₃ | CF₃ | Br | i-Pr | CH₃ | CF₃ | Br |
| t-Bu | CH₃ | CF₃ | Br | t-Bu | CH₃ | CF₃ | Br | t-Bu | CH₃ | CF₃ | Br |
| n-Pr | CH₃ | Cl | Cl | Me | Cl | F | Br | Me | Cl | H | Br |
| n-Bu | CH₃ | Cl | Cl | Et | Cl | F | Br | Et | Cl | H | Br |
| s-Bu | CH₃ | Cl | Cl | i-Pr | Cl | F | Br | i-Pr | Cl | H | Br |
| i-Bu | CH₃ | Cl | Cl | t-Bu | Cl | F | Br | t-Bu | Cl | H | Br |
| Me | Cl | F | Cl | Me | Cl | F | Cl | Me | Cl | H | Cl |
| Et | Cl | F | Cl | Et | Cl | F | Cl | Et | Cl | H | Cl |
| i-Pr | Cl | F | Cl | i-Pr | Cl | F | Cl | i-Pr | Cl | H | Cl |
| t-Bu | Cl | F | Cl | t-Bu | Cl | F | Cl | i-Pr | Cl | H | Cl |
| Me | Cl | F | Br | Me | Cl | Cl | Br | Me | Cl | I | Br |
| Et | Cl | F | Br | Et | Cl | Cl | Br | Et | Cl | I | Br |
| i-Pr | Cl | F | Br | i-Pr | Cl | Cl | Br | i-Pr | Cl | I | Br |
| t-Bu | Cl | F | Br | t-Bu | Cl | Cl | Br | t-Bu | Cl | I | Br |
| Me | Cl | Cl | Cl | Me | Cl | Cl | Cl | Me | Cl | I | Cl |
| Et | Cl | Cl | Cl | Et | Cl | Cl | Cl | Et | Cl | I | Cl |
| i-Pr | Cl | Cl | Cl | i-Pr | Cl | Cl | Cl | i-Pr | Cl | I | Cl |
| t-Bu | Cl | Cl | Cl | t-Bu | Cl | Cl | Cl | t-Bu | Cl | I | Cl |
| Me | Cl | H | Br | Me | Cl | H | Br | Me | Cl | F | Br |
| Et | Cl | H | Br | Et | Cl | H | Br | Et | Cl | F | Br |
| i-Pr | Cl | H | Br | i-Pr | Cl | H | Br | i-Pr | Cl | F | Br |
| t-Bu | Cl | H | Br | t-Bu | Cl | H | Br | t-Bu | Cl | F | Br |
| Me | Cl | H | Cl | Me | Cl | H | Cl | Me | Cl | F | Cl |
| Et | Cl | H | Cl | Et | Cl | H | Cl | Et | Cl | F | Cl |
| i-Pr | Cl | H | Cl | i-Pr | Cl | H | Cl | i-Pr | Cl | F | Cl |
| t-Bu | Cl | H | Cl | t-Bu | Cl | H | Cl | t-Bu | Cl | F | Cl |
| Me | Cl | Br | Br | Me | Cl | Br | Br | Me | Cl | CF₃ | Br |
| Et | Cl | Br | Br | Et | Cl | Br | Br | Et | Cl | CF₃ | Br |
| i-Pr | Cl | Br | Br | i-Pr | Cl | Br | Br | i-Pr | Cl | CF₃ | Br |
| t-Bu | Cl | Br | Br | t-Bu | Cl | Br | Br | t-Bu | Cl | CF₃ | Br |
| Me | Cl | Br | Cl | Me | Cl | I | Cl | Me | Cl | CF₃ | Cl |
| Et | Cl | Br | Cl | Et | Cl | I | Cl | Et | Cl | CF₃ | Cl |
| i-Pr | Cl | Br | Cl | i-Pr | Cl | I | Cl | i-Pr | Cl | CF₃ | Cl |
| t-Bu | Cl | Br | Cl | t-Bu | Cl | I | Cl | t-Bu | Cl | CF₃ | Cl |
| Me | Cl | I | Br | Me | Cl | I | Br | Me | Br | F | Cl |
| Et | Cl | I | Br | Et | Cl | I | Br | Et | Br | F | Cl |
| i-Pr | Cl | I | Br | i-Pr | Cl | I | Br | i-Pr | Br | F | Cl |
| t-Bu | Cl | I | Br | t-Bu | Cl | I | Br | t-Bu | Br | F | Cl |
| Me | Cl | I | Cl | Me | Cl | CF₃ | Cl | Me | Br | F | Br |
| Et | Cl | I | Cl | Et | Cl | CF₃ | Cl | Et | Br | F | Br |
| i-Pr | Cl | I | Cl | i-Pr | Cl | CF₃ | Cl | i-Pr | Br | F | Br |
| t-Bu | Cl | I | Cl | t-Bu | Cl | CF₃ | Cl | t-Bu | Br | F | Br |
| Me | Cl | CF₃ | Br | Me | Cl | CF₃ | Br | Me | Br | Cl | Cl |
| Et | Cl | CF₃ | Br | Et | Cl | CF₃ | Br | Et | Br | Cl | Cl |
| i-Pr | Cl | CF₃ | Br | i-Pr | Cl | CF₃ | Br | i-Pr | Br | Cl | Cl |
| t-Bu | Cl | CF₃ | Br | t-Bu | Cl | CF₃ | Br | t-Bu | Br | Cl | Cl |
| Me | Cl | CF₃ | Cl | n-Pr | Cl | Cl | Cl | Me | Br | Cl | Br |
| Et | Cl | CF₃ | Cl | n-Bu | Cl | Cl | Cl | Et | Br | Cl | Br |
| i-Pr | Cl | CF₃ | Cl | s-Bu | Cl | Cl | Cl | i-Pr | Br | Cl | Br |
| t-Bu | Cl | CF₃ | Cl | i-Bu | Cl | Cl | Cl | t-Bu | Br | Cl | Br |
| Me | Br | F | Cl | Me | Br | F | Cl | Me | Br | Br | Cl |
| Et | Br | F | Cl | Et | Br | F | Cl | Et | Br | Br | Cl |
| i-Pr | Br | F | Cl | i-Pr | Br | F | Cl | i-Pr | Br | Br | Cl |
| t-Bu | Br | F | Cl | t-Bu | Br | F | Cl | t-Bu | Br | Br | Cl |
| Me | Br | F | Br | Me | Br | F | Br | Me | Br | Br | Br |
| Et | Br | F | Br | Et | Br | F | Br | Et | Br | Br | Br |
| i-Pr | Br | F | Br | i-Pr | Br | F | Br | i-Pr | Br | Br | Br |
| t-Bu | Br | F | Br | t-Bu | Br | F | Br | t-Bu | Br | Br | Br |
| Me | Br | Cl | Cl | Me | Br | Cl | Cl | Me | Br | I | Cl |
| Et | Br | Cl | Cl | Et | Br | Cl | Cl | Et | Br | I | Cl |
| i-Pr | Br | Cl | Cl | i-Pr | Br | Cl | Cl | i-Pr | Br | I | Cl |
| t-Bu | Br | Cl | Cl | t-Bu | Br | Cl | Cl | t-Bu | Br | I | Cl |
| Me | Br | Cl | Br | Me | Br | Cl | Br | Me | Br | I | Br |
| Et | Br | Cl | Br | Et | Br | Cl | Br | Et | Br | I | Br |
| i-Pr | Br | Cl | Br | i-Pr | Br | Cl | Br | i-Pr | Br | I | Br |
| t-Bu | Br | Cl | Br | t-Bu | Br | Cl | Br | t-Bu | Br | I | Br |
| Me | Br | Br | Cl | Me | Br | Br | Cl | Me | Br | CF₃ | Cl |
| Et | Br | Br | Cl | Et | Br | Br | Cl | Et | Br | CF₃ | Cl |
| i-Pr | Br | Br | Cl | i-Pr | Br | Br | Cl | i-Pr | Br | CF₃ | Cl |
| t-Bu | Br | Br | Cl | t-Bu | Br | Br | Cl | t-Bu | Br | CF₃ | Cl |
| Me | Br | Br | Br | Me | Br | Br | Br | Me | Br | CF₃ | Br |
| Et | Br | Br | Br | Et | Br | Br | Br | Et | Br | CF₃ | Br |
| i-Pr | Br | Br | Br | i-Pr | Br | Br | Br | i-Pr | Br | CF₃ | Br |
| t-Bu | Br | Br | Br | t-Bu | Br | Br | Br | t-Bu | Br | CF₃ | Br |
| Me | Br | I | Cl | Me | Br | I | Cl | Me | Cl | Cl | Br |
| Et | Br | I | Cl | Et | Br | I | Cl | Et | Cl | Cl | Br |
| i-Pr | Br | I | Cl | i-Pr | Br | I | Cl | i-Pr | Cl | Cl | Br |
| t-Bu | Br | I | Cl | t-Bu | Br | I | Cl | t-Bu | Cl | Cl | Br |
| Me | Br | I | Br | Me | Br | I | Br | Me | Cl | Cl | Cl |
| Et | Br | I | Br | Et | Br | I | Br | Et | Cl | Cl | Cl |
| i-Pr | Br | I | Br | i-Pr | Br | I | Br | i-Pr | Cl | Cl | Cl |
| t-Bu | Br | I | Br | t-Bu | Br | I | Br | t-Bu | Cl | Cl | Cl |

TABLE 26

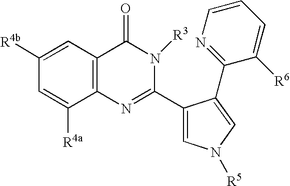

| | | |
|---|---|---|
| R⁵ is CHF₂ | R⁵ is CH₂F₃ | R⁵ is CF₂CHF₂ |

| R³ | R^{4a} | R^{4b} | R⁶ | R³ | R^{4a} | R^{4b} | R⁶ | R³ | R^{4a} | R^{4b} | R⁶ |
|---|---|---|---|---|---|---|---|---|---|---|---|
| Me | CH₃ | H | Cl | Me | CH₃ | H | Cl | Me | CH₃ | Br | Cl |
| Et | CH₃ | H | Cl | Et | CH₃ | H | Cl | Et | CH₃ | Br | Cl |
| i-Pr | CH₃ | H | Cl | i-Pr | CH₃ | H | Cl | i-Pr | CH₃ | Br | Cl |
| t-Bu | CH₃ | H | Cl | t-Bu | CH₃ | H | Cl | t-Bu | CH₃ | Br | Cl |
| Me | CH₃ | H | Br | Me | CH₃ | H | Br | Me | CH₃ | Br | Br |
| Et | CH₃ | H | Br | Et | CH₃ | H | Br | Et | CH₃ | Br | Br |
| i-Pr | CH₃ | H | Br | i-Pr | CH₃ | H | Br | i-Pr | CH₃ | Br | Br |
| t-Bu | CH₃ | H | Br | i-Bu | CH₃ | H | Br | t-Bu | CH₃ | Br | Br |
| Me | CH₃ | F | Cl | Me | CH₃ | Br | Cl | Me | CH₃ | I | Cl |
| Et | CH₃ | F | Cl | Et | CH₃ | Br | Cl | Et | CH₃ | I | Cl |
| i-Pr | CH₃ | F | Cl | i-Pr | CH₃ | Br | Cl | i-Pr | CH₃ | I | Cl |
| t-Bu | CH₃ | F | Cl | t-Bu | CH₃ | Br | Cl | t-Bu | CH₃ | I | Cl |
| Me | CH₃ | F | Br | Me | CH₃ | Br | Br | Me | CH₃ | I | Br |
| Et | CH₃ | F | Br | Et | CH₃ | Br | Br | Et | CH₃ | I | Br |
| i-Pr | CH₃ | F | Br | i-Pr | CH₃ | Br | Br | i-Pr | CH₃ | I | Br |
| t-Bu | CH₃ | F | Br | t-Bu | CH₃ | Br | Br | t-Bu | CH₃ | I | Br |
| Me | CH₃ | Cl | Cl | Me | CH₃ | F | Cl | Me | CH₃ | CF₃ | Cl |
| Et | CH₃ | Cl | Cl | Et | CH₃ | F | Cl | Et | CH₃ | CF₃ | Cl |
| i-Pr | CH₃ | Cl | Cl | i-Pr | CH₃ | F | Cl | i-Pr | CH₃ | CF₃ | Cl |
| t-Bu | CH₃ | Cl | Cl | t-Bu | CH₃ | F | Cl | t-Bu | CH₃ | CF₃ | Cl |
| Me | CH₃ | Cl | Br | Me | CH₃ | F | Br | Me | CH₃ | CF₃ | Br |
| Et | CH₃ | Cl | Br | Et | CH₃ | F | Br | Et | CH₃ | CF₃ | Br |
| i-Pr | CH₃ | Cl | Br | i-Pr | CH₃ | F | Br | i-Pr | CH₃ | CF₃ | Br |
| t-Bu | CH₃ | Cl | Br | t-Bu | CH₃ | F | Br | t-Bu | CH₃ | CF₃ | Br |
| Me | CH₃ | Br | Cl | Me | CH₃ | Cl | Cl | Me | CH₃ | Cl | Cl |
| Et | CH₃ | Br | Cl | Et | CH₃ | Cl | Cl | Et | CH₃ | Cl | Cl |
| i-Pr | CH₃ | Br | Cl | i-Pr | CH₃ | Cl | Cl | i-Pr | CH₃ | Cl | Cl |
| t-Bu | CH₃ | Br | Cl | t-Bu | CH₃ | Cl | Cl | t-Bu | CH₃ | Cl | Cl |
| Me | CH₃ | Br | Br | Me | CH₃ | Cl | Br | Me | CH₃ | Cl | Br |
| Et | CH₃ | Br | Br | Et | CH₃ | Cl | Br | Et | CH₃ | Cl | Br |
| i-Pr | CH₃ | Br | Br | i-Pr | CH₃ | Cl | Br | i-Pr | CH₃ | Cl | Br |
| t-Bu | CH₃ | Br | Br | t-Bu | CH₃ | Cl | Br | t-Bu | CH₃ | Cl | Br |
| Me | CH₃ | I | Cl | Me | CH₃ | I | Cl | Me | CH₃ | H | Cl |
| Et | CH₃ | I | Cl | Et | CH₃ | I | Cl | Et | CH₃ | H | Cl |
| i-Pr | CH₃ | I | Cl | i-Pr | CH₃ | I | Cl | i-Pr | CH₃ | H | Cl |
| t-Bu | CH₃ | I | Cl | t-Bu | CH₃ | I | Cl | t-Bu | CH₃ | H | Cl |
| Me | CH₃ | I | Br | Me | CH₃ | I | Br | Me | CH₃ | H | Br |
| Et | CH₃ | I | Br | Et | CH₃ | I | Br | Et | CH₃ | H | Br |
| i-Pr | CH₃ | I | Br | i-Pr | CH₃ | I | Br | i-Pr | CH₃ | H | Br |
| t-Bu | CH₃ | I | Br | t-Bu | CH₃ | I | Br | t-Bu | CH₃ | H | Br |
| Me | CH₃ | CF₃ | Cl | Me | CH₃ | CF₃ | Cl | Me | CH₃ | F | Cl |
| Et | CH₃ | CF₃ | Cl | Et | CH₃ | CF₃ | Cl | Et | CH₃ | F | Cl |
| i-Pr | CH₃ | CF₃ | Cl | i-Pr | CH₃ | CF₃ | Cl | i-Pr | CH₃ | F | Cl |
| t-Bu | CH₃ | CF₃ | Cl | t-Bu | CH₃ | CF₃ | Cl | t-Bu | CH₃ | F | Cl |
| Me | CH₃ | CF₃ | Br | Me | CH₃ | CF₃ | Br | Me | CH₃ | F | Br |
| Et | CH₃ | CF₃ | Br | Et | CH₃ | CF₃ | Br | Et | CH₃ | F | Br |
| i-Pr | CH₃ | CF₃ | Br | i-Pr | CH₃ | CF₃ | Br | i-Pr | CH₃ | F | Br |
| t-Bu | CH₃ | CF₃ | Br | t-Bu | CH₃ | CF₃ | Br | t-Bu | CH₃ | F | Br |
| n-Pr | CH₃ | Cl | Cl | Me | Cl | H | Br | Me | Cl | Cl | Br |
| n-Bu | CH₃ | Cl | Cl | Et | Cl | H | Br | Et | Cl | Cl | Br |
| s-Bu | CH₃ | Cl | Cl | i-Pr | Cl | H | Br | i-Pr | Cl | Cl | Br |
| i-Bu | CH₃ | Cl | Cl | t-Bu | Cl | H | Br | t-Bu | Cl | Cl | Br |
| Me | Cl | I | Br | Me | Cl | H | Cl | Me | Cl | Cl | Cl |
| Et | Cl | I | Br | Et | Cl | H | Cl | Et | Cl | Cl | Cl |
| i-Pr | Cl | I | Br | i-Pr | Cl | H | Cl | i-Pr | Cl | Cl | Cl |
| t-Bu | Cl | I | Br | t-Bu | Cl | H | Cl | t-Bu | Cl | Cl | Cl |
| Me | Cl | I | Cl | Me | Cl | Cl | Br | Me | Cl | I | Br |
| Et | Cl | I | Cl | Et | Cl | Cl | Br | Et | Cl | I | Br |
| i-Pr | Cl | I | Cl | i-Pr | Cl | Cl | Br | i-Pr | Cl | I | Br |
| t-Bu | Cl | I | Cl | t-Bu | Cl | Cl | Br | t-Bu | Cl | I | Br |
| Me | Cl | H | Br | Me | Cl | Cl | Cl | Me | Cl | I | Cl |
| Et | Cl | H | Br | Et | Cl | Cl | Cl | Et | Cl | I | Cl |
| i-Pr | Cl | H | Br | i-Pr | Cl | Cl | Cl | i-Pr | Cl | I | Cl |
| t-Bu | Cl | H | Br | t-Bu | Cl | Cl | Cl | t-Bu | Cl | I | Cl |
| Me | Cl | H | Cl | Me | Cl | F | Br | Me | Cl | F | Br |
| Et | Cl | H | Cl | Et | Cl | F | Br | Et | Cl | F | Br |
| i-Pr | Cl | H | Cl | i-Pr | Cl | F | Br | i-Pr | Cl | F | Br |
| t-Bu | Cl | H | Cl | t-Bu | Cl | F | Br | t-Bu | Cl | F | Br |
| Me | Cl | CF₃ | Br | Me | Cl | F | Cl | Me | Cl | F | Cl |
| Et | Cl | CF₃ | Br | Et | Cl | F | Cl | Et | Cl | F | Cl |
| i-Pr | Cl | CF₃ | Br | i-Pr | Cl | F | Cl | i-Pr | Cl | F | Cl |
| t-Bu | Cl | CF₃ | Br | t-Bu | Cl | F | Cl | t-Bu | Cl | F | Cl |
| Me | Cl | CF₃ | Cl | Me | Cl | Br | Br | Me | Cl | H | Br |
| Et | Cl | CF₃ | Cl | Et | Cl | Br | Br | Et | Cl | H | Br |
| i-Pr | Cl | CF₃ | Cl | i-Pr | Cl | Br | Br | i-Pr | Cl | H | Br |
| t-Bu | Cl | CF₃ | Cl | t-Bu | Cl | Br | Br | t-Bu | Cl | H | Brf |
| Me | Cl | Br | Br | Me | Cl | I | Cl | Me | Cl | H | Cl |
| Et | Cl | Br | Br | Et | Cl | I | Cl | Et | Cl | H | Cl |
| i-Pr | Cl | Br | Br | i-Pr | Cl | I | Cl | i-Pr | Cl | H | Cl |
| t-Bu | Cl | Br | Br | t-Bu | Cl | I | Cl | i-Pr | Cl | H | Cl |
| Me | Cl | Br | Cl | Me | Cl | I | Br | Me | Cl | CF₃ | Br |
| Et | Cl | Br | Cl | Et | Cl | I | Br | Et | Cl | CF₃ | Br |
| i-Pr | Cl | Br | Cl | i-Pr | Cl | I | Br | i-Pr | Cl | CF₃ | Br |
| t-Bu | Cl | Br | Cl | t-Bu | Cl | I | Br | t-Bu | Cl | CF₃ | Br |
| Me | Cl | F | Br | Me | Cl | CF₃ | Cl | Me | Cl | CF₃ | Cl |
| Et | Cl | F | Br | Et | Cl | CF₃ | Cl | Et | Cl | CF₃ | Cl |
| i-Pr | Cl | F | Br | i-Pr | Cl | CF₃ | Cl | i-Pr | Cl | CF₃ | Cl |
| t-Bu | Cl | F | Br | t-Bu | Cl | CF₃ | Cl | t-Bu | Cl | CF₃ | Cl |
| Me | Cl | Cl | Cl | Me | Cl | CF₃ | Br | Me | Br | F | Cl |
| Et | Cl | Cl | Cl | Et | Cl | CF₃ | Br | Et | Br | F | Cl |
| i-Pr | Cl | Cl | Cl | i-Pr | Cl | CF₃ | Br | i-Pr | Br | F | Cl |
| t-Bu | Cl | Cl | Cl | t-Bu | Cl | CF₃ | Br | t-Bu | Br | F | Cl |
| Me | Cl | F | Cl | n-Pr | Cl | Cl | CL | Me | Br | F | Br |
| Et | Cl | F | Cl | n-Bu | Cl | Cl | Cl | Et | Br | F | Br |
| i-Pr | Cl | F | Cl | s-Bu | Cl | Cl | Cl | i-Pr | Br | F | Br |
| t-Bu | Cl | F | Cl | t-Bu | Cl | Cl | Cl | t-Bu | Br | F | Br |
| Me | Br | Br | Cl | Me | Br | F | Cl | Me | Br | Cl | Cl |
| Et | Br | Br | Cl | Et | Br | F | Cl | Et | Br | Cl | Cl |
| i-Pr | Br | Br | Cl | i-Pr | Br | F | Cl | i-Pr | Br | Cl | Cl |
| t-Bu | Br | Br | Cl | t-Bu | Br | F | Cl | t-Bu | Br | Cl | Cl |
| Me | Br | Br | Br | Me | Br | F | Br | Me | Br | Cl | Br |
| Et | Br | Br | Br | Et | Br | F | Br | Et | Br | Cl | Br |
| i-Pr | Br | Br | Br | i-Pr | Br | F | Br | i-Pr | Br | Cl | Br |
| t-Bu | Br | Br | Br | t-Bu | Br | F | Br | t-Bu | Br | Cl | Br |
| Me | Br | I | Cl | Me | Br | Cl | Cl | Me | Br | Br | Cl |
| Et | Br | I | Cl | Et | Br | Cl | Cl | Et | Br | Br | Cl |
| i-Pr | Br | I | Cl | i-Pr | Br | Cl | Cl | i-Pr | Br | Br | Cl |
| t-Bu | Br | I | Cl | t-Bu | Br | Cl | Cl | t-Bu | Br | Br | Cl |
| Me | Br | I | Br | Me | Br | Cl | Br | Me | Br | Br | Br |
| Et | Br | I | Br | Et | Br | Cl | Br | Et | Br | Br | Br |
| i-Pr | Br | I | Br | i-Pr | Br | Cl | Br | i-Pr | Br | Br | Br |
| t-Bu | Br | I | Br | t-Bu | Br | Cl | Br | t-Bu | Br | Br | Br |
| Me | Br | F | Cl | Me | Br | I | Cl | Me | Br | CF₃ | Cl |
| Et | Br | F | Cl | Et | Br | I | Cl | Et | Br | CF₃ | Cl |
| i-Pr | Br | F | Cl | i-Pr | Br | I | Cl | i-Pr | Br | CF₃ | Cl |
| t-Bu | Br | F | Cl | t-Bu | Br | I | Cl | t-Bu | Br | CF₃ | Cl |
| Me | Br | F | Br | Me | Br | I | Br | Me | Br | CF₃ | Br |
| Et | Br | F | Br | Et | Br | I | Br | Et | Br | CF₃ | Br |
| i-Pr | Br | F | Br | i-Pr | Br | I | Br | i-Pr | Br | CF₃ | Br |
| t-Bu | Br | F | Br | t-Bu | Br | I | Br | t-Bu | Br | CF₃ | Br |
| Me | Br | Cl | Cl | Me | Br | Br | Cl | Me | Br | I | Cl |
| Et | Br | Cl | Cl | Et | Br | Br | Cl | Et | Br | I | Cl |
| i-Pr | Br | Cl | Cl | i-Pr | Br | Br | Cl | i-Pr | Br | I | Cl |
| t-Bu | Br | Cl | Cl | t-Bu | Br | Br | Cl | t-Bu | Br | I | Cl |
| Me | Br | Cl | Br | Me | Br | Br | Br | Me | Br | I | Br |
| Et | Br | Cl | Br | Et | Br | Br | Br | Et | Br | I | Br |
| i-Pr | Br | Cl | Br | i-Pr | Br | Br | Br | i-Pr | Br | I | Br |
| t-Bu | Br | Cl | Br | t-Bu | Br | Br | Br | t-Bu | Br | I | Br |

TABLE 27

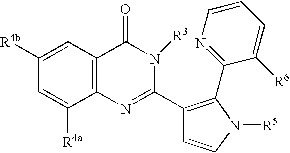

| R⁵ is CHF₂ | | | | R⁵ is CH₂F₃ | | | | R⁵ is CF₂CHF₂ | | | |
|---|---|---|---|---|---|---|---|---|---|---|---|
| R³ | R^{4a} | R^{4b} | R⁶ | R³ | R^{4a} | R^{4b} | R⁶ | R⁴ | R^{4a} | R^{4b} | R⁶ |
| Me | CH₃ | H | Cl | Me | CH₃ | H | Cl | Me | CH₃ | Br | Cl |
| Et | CH₃ | H | Cl | Me | CH₃ | H | Cl | Me | CH₃ | Br | Cl |
| i-Pr | CH₃ | H | Cl | i-Pr | CH₃ | H | Cl | i-Pr | CH₃ | Br | Cl |
| t-Bu | CH₃ | H | Cl | t-Bu | CH₃ | H | Cl | t-Bu | CH₃ | Br | Cl |
| Me | CH₃ | H | Br | Me | CH₃ | H | Br | Me | CH₃ | Br | Br |
| Et | CH₃ | H | Br | Et | CH₃ | H | Br | Et | CH₃ | Br | Br |
| i-Pr | CH₃ | H | Br | i-Pr | CH₃ | H | Br | i-Pr | CH₃ | Br | Br |
| t-Bu | CH₃ | H | Br | t-Bu | CH₃ | H | Br | t-Bu | CH₃ | Br | Br |
| Me | CH₃ | F | Cl | Me | CH₃ | Br | Cl | Me | CH₃ | I | Cl |
| Et | CH₃ | F | Cl | Et | CH₃ | Br | Cl | Et | CH₃ | I | Cl |
| i-Pr | CH₃ | F | Cl | i-Pr | CH₃ | Br | Cl | i-Pr | CH₃ | I | Cl |
| t-Bu | CH₃ | F | Cl | t-Bu | CH₃ | Br | Cl | t-Bu | CH₃ | I | Cl |
| Me | CH₃ | F | Br | Me | CH₃ | Br | Br | Me | CH₃ | I | Br |
| Et | CH₃ | F | Br | Et | CH₃ | Br | Br | Et | CH₃ | I | Br |
| i-Pr | CH₃ | F | Br | i-Pr | CH₃ | Br | Br | i-Pr | CH₃ | I | Br |
| t-Bu | CH₃ | F | Br | t-Bu | CH₃ | Br | Br | t-Bu | CH₃ | I | Br |
| Me | CH₃ | Cl | Cl | Me | CH₃ | F | Cl | Me | CH₃ | CF₃ | Cl |
| Et | CH₃ | Cl | Cl | Et | CH₃ | F | Cl | Et | CH₃ | CF₃ | Cl |
| i-Pr | CH₃ | Cl | Cl | i-Pr | CH₃ | F | Cl | i-Pr | CH₃ | CF₃ | Cl |
| t-Bu | CH₃ | Cl | Cl | t-Bu | CH₃ | F | Cl | t-Bu | CH₃ | CF₃ | Cl |
| Me | CH₃ | Cl | Br | Me | CH₃ | F | Br | Me | CH₃ | CF₃ | Br |
| Et | CH₃ | Cl | Br | Et | CH₃ | F | Br | Et | CH₃ | CF₃ | Br |
| i-Pr | CH₃ | Cl | Br | i-Pr | CH₃ | F | Br | i-Pr | CH₃ | CF₃ | Br |
| t-Bu | CH₃ | Cl | Br | t-Bu | CH₃ | F | Br | t-Bu | CH₃ | CF₃ | Br |
| Me | CH₃ | Br | Cl | Me | CH₃ | Cl | Cl | Me | CH₃ | Cl | Cl |
| Et | CH₃ | Br | Cl | Et | CH₃ | Cl | Cl | Et | CH₃ | Cl | Cl |
| i-Pr | CH₃ | Br | Cl | i-Pr | CH₃ | Cl | Cl | i-Pr | CH₃ | Cl | Cl |
| t-Bu | CH₃ | Br | Cl | t-Bu | CH₃ | Cl | Cl | t-Bu | CH₃ | Cl | Cl |
| Me | CH₃ | Br | Br | Me | CH₃ | Cl | Br | Me | CH₃ | Cl | Br |
| Et | CH₃ | Br | Br | Et | CH₃ | Cl | Br | Et | CH₃ | Cl | Br |
| i-Pr | CH₃ | Br | Br | i-Pr | CH₃ | Cl | Br | i-Pr | CH₃ | Cl | Br |
| t-Bu | CH₃ | Br | Br | t-Bu | CH₃ | Cl | Br | t-Bu | CH₃ | Cl | Br |
| Me | CH₃ | I | Cl | Me | CH₃ | I | Cl | Me | CH₃ | H | Cl |
| Et | CH₃ | I | Cl | Et | CH₃ | I | Cl | Et | CH₃ | H | Cl |
| i-Pr | CH₃ | I | Cl | i-Pr | CH₃ | I | Cl | i-Pr | CH₃ | H | Cl |
| t-Bu | CH₃ | I | Cl | t-Bu | CH₃ | I | Cl | t-Bu | CH₃ | H | Cl |
| Me | CH₃ | I | Br | Me | CH₃ | I | Br | Me | CH₃ | H | Br |
| Et | CH₃ | I | Br | Et | CH₃ | I | Br | Et | CH₃ | H | Br |
| i-Pr | CH₃ | I | Br | i-Pr | CH₃ | I | Br | i-Pr | CH₃ | H | Br |
| t-Bu | CH₃ | I | Br | t-Bu | CH₃ | I | Br | t-Bu | CH₃ | H | Br |
| Me | CH₃ | CF₃ | Cl | Me | CH₃ | CF₃ | Cl | Me | CH₃ | F | Cl |
| Et | CH₃ | CF₃ | Cl | Et | CH₃ | CF₃ | Cl | Et | CH₃ | F | Cl |
| i-Pr | CH₃ | CF₃ | Cl | i-Pr | CH₃ | CF₃ | Cl | i-Pr | CH₃ | F | Cl |
| t-Bu | CH₃ | CF₃ | Cl | t-Bu | CH₃ | CF₃ | Cl | t-Bu | CH₃ | F | Cl |
| Me | CH₃ | CF₃ | Br | Me | CH₃ | CF₃ | Br | Me | CH₃ | I | Br |
| Et | CH₃ | CF₃ | Br | Et | CH₃ | CF₃ | Br | Et | CH₃ | F | Br |
| i-Pr | CH₃ | CF₃ | Br | i-Pr | CH₃ | CF₃ | Br | i-Pr | CH₃ | F | Br |
| t-Bu | CH₃ | CF₃ | Br | t-Bu | CH₃ | CF₃ | Br | t-Bu | CH₃ | F | Br |
| n-Pr | CH₃ | Cl | Cl | Me | Cl | H | Br | Me | Cl | Cl | Br |
| n-Bu | CH₃ | Cl | Cl | Et | Cl | H | Br | Et | Cl | Cl | Br |
| s-Bu | CH₃ | Cl | Cl | i-Pr | Cl | H | Br | i-Pr | Cl | Cl | Br |
| i-Bu | CH₃ | Cl | Cl | t-Bu | Cl | H | Cl | t-Bu | Cl | Cl | Br |
| Me | Cl | I | Br | Me | Cl | H | Cl | Me | Cl | Cl | Cl |
| Et | Cl | I | Br | Et | Cl | H | Cl | Et | Cl | Cl | Cl |
| i-Pr | Cl | I | Br | i-Pr | Cl | H | Cl | i-Pr | Cl | Cl | Cl |
| t-Bu | Cl | I | Br | t-Bu | Cl | H | Cl | t-Bu | Cl | Cl | Cl |
| Me | CL | I | Cl | Me | Cl | Cl | Br | Me | Cl | I | Br |
| Et | Cl | I | Cl | Et | Cl | Cl | Br | Et | Cl | I | Br |
| i-Pr | Cl | I | Cl | i-Pr | Cl | Cl | Br | i-Pr | Cl | I | Br |
| t-Bu | Cl | I | Cl | t-Bu | Cl | Cl | Br | t-Bu | Cl | I | Br |
| Me | Cl | H | Br | Me | Cl | Cl | Cl | Me | Cl | I | Cl |
| Et | Cl | H | Br | Et | Cl | Cl | Cl | Et | Cl | I | Cl |
| i-Pr | Cl | H | Br | i-Pr | Cl | Cl | Cl | i-Pr | Cl | I | Cl |
| t-Bu | Cl | H | Br | t-Bu | Cl | Cl | Cl | t-Bu | Cl | I | Cl |
| Me | Cl | H | Cl | Me | Cl | F | Br | Me | Cl | F | Br |
| Et | Cl | H | Cl | Et | Cl | F | Br | Et | Cl | F | Br |
| i-Pr | Cl | H | Cl | i-Pr | Cl | F | Br | i-Pr | Cl | F | Br |
| t-Bu | Cl | H | Cl | t-Bu | Cl | F | Br | t-Bu | Cl | F | Br |
| Me | Cl | CF₃ | Br | Me | Cl | F | Cl | Me | Cl | F | Cl |
| Et | Cl | CF₃ | Br | Et | Cl | F | Cl | Et | Cl | F | Cl |
| i-Pr | Cl | CF₃ | Br | i-Pr | Cl | F | Cl | i-Pr | Cl | F | Cl |
| t-Bu | Cl | CF₃ | Br | t-Bu | Cl | F | Cl | t-Bu | Cl | F | Cl |
| Me | Cl | CF₃ | Cl | Me | Cl | Br | Br | Me | Cl | H | Br |
| Et | Cl | CF₃ | Cl | Et | Cl | Br | Br | Et | Cl | H | Br |
| i-Pr | Cl | CF₃ | Cl | i-Pr | Cl | Br | Br | i-Pr | Cl | H | Br |
| t-Bu | Cl | CF₃ | Cl | t-Bu | Cl | Br | Br | t-Bu | Cl | H | Br |
| Me | Cl | Br | Br | Me | Cl | I | Cl | Me | Cl | H | Cl |
| Et | Cl | Br | Br | Et | Cl | I | Cl | Et | Cl | H | Cl |
| i-Pr | Cl | Br | Br | i-Pr | Cl | I | Cl | i-Pr | Cl | H | Cl |
| t-Bu | Cl | Br | Br | t-Bu | Cl | I | Cl | i-Pr | Cl | H | Cl |
| Me | Cl | Br | Cl | Me | Cl | I | Br | Me | Cl | CF₃ | Br |
| Et | Cl | Br | Cl | Et | Cl | I | Br | Et | Cl | CF₃ | Br |
| i-Pr | Cl | Br | Cl | i-Pr | Cl | I | Br | i-Pr | Cl | CF₃ | Br |
| t-Bu | Cl | Br | Cl | t-Bu | Cl | I | Br | t-Bu | Cl | CF₃ | Br |
| Me | Cl | F | Bu | Me | Cl | CF₃ | Cl | Me | Cl | CF₃ | Cl |
| Et | Cl | F | Br | Et | Cl | CF₃ | Cl | Et | Cl | CF₃ | Cl |
| i-Pr | Cl | F | Br | i-Pr | Cl | CF₃ | Cl | i-Pr | Cl | CF₃ | Cl |
| t-Bu | Cl | F | Br | t-Bu | Cl | CF₃ | Cl | t-Bu | Cl | CF₃ | Cl |
| Me | Cl | Cl | Cl | Me | Cl | CF₃ | Br | Me | Br | F | Cl |
| Et | Cl | Cl | Cl | Et | Cl | CF₃ | Br | Et | Br | F | Cl |
| i-Pr | Cl | Cl | Cl | i-Pr | Cl | CF₃ | Br | i-Pr | Br | F | Cl |
| t-Bu | Cl | Cl | Cl | t-Bu | Cl | CF₃ | Br | t-Bu | Br | F | Cl |
| Me | Cl | F | Cl | n-Pr | Cl | Cl | Cl | Me | Br | F | Br |
| Et | Cl | F | Cl | n-Bu | Cl | Cl | Cl | Et | Br | F | Br |
| i-Pr | Cl | F | Cl | s-Bu | Cl | Cl | Cl | i-Pr | Br | F | Br |
| t-Bu | Cl | F | Cl | i-Bu | Cl | Cl | Cl | t-Bu | Br | F | Br |
| Me | Br | Br | Cl | Me | Br | F | Cl | Me | Br | Cl | Cl |
| Et | Br | Br | Cl | Et | Br | F | Cl | Et | Br | Cl | Cl |
| i-Pr | Br | Br | Cl | i-Pr | Br | F | Cl | i-Pr | Br | Cl | Cl |
| t-Bu | Br | Br | Cl | t-Bu | Br | F | Cl | t-Bu | Br | Cl | Cl |
| Me | Br | Br | Br | Me | Br | F | Br | Me | Br | Cl | Br |
| Et | Br | Br | Br | Et | Br | F | Br | Et | Br | Cl | Br |
| i-Pr | Br | Br | Br | i-Pr | Br | F | Br | i-Pr | Br | Cl | Br |
| t-Bu | Br | Br | Br | t-Bu | Br | F | Br | t-Bu | Br | Cl | Br |
| Me | Br | I | Cl | Me | Br | Cl | Cl | Me | Br | Br | Cl |
| Et | Br | I | Cl | Et | Br | Cl | Cl | Et | Br | Br | Cl |
| i-Pr | Br | I | Cl | i-Pr | Br | Cl | Cl | i-Pr | Br | Br | Cl |
| t-Bu | Br | I | Cl | t-Bu | Br | Cl | Cl | t-Bu | Br | Br | Cl |
| Me | Br | I | Br | Me | Br | Cl | Br | Me | Br | Br | Br |
| Et | Br | I | Br | Et | Br | Cl | Br | i-Pr | Br | Br | Br |
| t-Bu | Br | I | Br | t-Bu | Br | Cl | Br | t-Bu | Br | Br | Br |
| Me | Br | F | Cl | Me | Br | I | Cl | Me | Br | CF₃ | Cl |
| Et | Br | F | Cl | Et | Br | I | Cl | Et | Br | CF₃ | Cl |
| i-Pr | Br | F | Cl | i-Pr | Br | I | Cl | i-Pr | Br | CF₃ | Cl |
| t-Bu | Br | F | Cl | t-Bu | Br | I | Cl | t-Bu | Br | CF₃ | Cl |
| Me | Br | F | Br | Me | Br | I | Br | Me | Br | CF₃ | Br |
| Et | Br | F | Br | Et | Br | I | Br | Et | Br | CF₃ | Br |
| i-Pr | Br | F | Br | i-Pr | Br | I | Br | i-Pr | Br | CF₃ | Br |
| t-Bu | Br | F | Br | t-Bu | Br | I | Br | t-Bu | Br | CF₃ | Br |
| Me | Br | Cl | Cl | Me | Br | Br | Cl | Me | Br | I | Cl |
| Et | Br | Cl | Cl | Et | Br | Br | Cl | Et | Br | I | Cl |
| i-Pr | Br | Cl | Cl | i-Pr | Br | Br | Cl | i-Pr | Br | I | Cl |
| t-Bu | Br | Cl | Cl | t-Bu | Br | Br | C l | t-Bu | Br | I | Cl |
| Me | Br | Cl | Br | Me | Br | Br | Br | Me | Br | I | Br |
| Et | Br | Cl | Br | Et | Br | Br | Br | Et | Br | I | Br |
| i-Pr | Br | Cl | Br | i-Pr | Br | Br | Br | i-Pr | Br | I | Br |
| t-Bu | Br | Cl | Br | t-Bu | Br | Br | Br | t-Bu | Br | I | Br |

TABLE 28

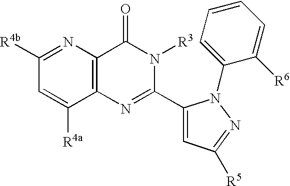

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | H | Cl | Br | Me | Cl | Br | Cl | Br |
| Et | CH₃ | H | CF₃ | Cl | Et | Cl | H | Cl | Br | Et | Cl | Br | Cl | Br |
| i-Pr | CH₃ | H | CF₃ | Cl | i-Pr | Cl | H | Cl | Br | i-Pr | Cl | Br | Cl | Br |
| t-Bu | CH₃ | H | CF₃ | Cl | t-Bu | Cl | H | Cl | Br | t-Bu | Cl | Br | Cl | Br |
| Me | CH₃ | H | CF₃ | Br | Me | Cl | H | Br | Cl | Me | Cl | Br | Br | Cl |
| Et | CH₃ | H | CF₃ | Br | Et | Cl | H | Br | Cl | Et | Cl | Br | Br | Cl |
| i-Pr | CH₃ | H | CF₃ | Br | i-Pr | CI | H | Br | Cl | i-Pr | Cl | Br | Br | Cl |
| t-Bu | CH₃ | H | CF₃ | Br | t-Bu | Cl | H | Br | Cl | t-Bu | Cl | Br | Br | Cl |
| Me | CH₃ | H | Cl | Cl | Me | Cl | H | Br | Br | Me | Cl | Br | Br | Br |
| Et | CH₃ | H | Cl | Cl | Et | Cl | H | Br | Br | Et | Cl | Br | Br | Br |
| i-Pr | CH₃ | H | Cl | Cl | i-Pr | Cl | H | Br | Br | i-Pr | Cl | Br | Br | Br |
| t-Bu | CH₃ | H | Cl | Cl | t-Bu | Cl | H | Br | Br | t-Bu | Cl | Br | Br | Br |
| Me | CH₃ | H | Cl | Br | Me | Cl | H | CF₃ | Cl | Me | Cl | I | CF₃ | Cl |
| Et | CH₃ | H | Cl | Br | Et | Cl | H | CF₃ | Cl | Et | Cl | I | CF₃ | Cl |
| i-Pr | CH₃ | H | Cl | Br | i-Pr | Cl | H | CF₃ | Cl | i-Pr | Cl | I | CF₃ | Cl |
| t-Bu | CH₃ | H | Cl | Br | t-Bu | Cl | H | CF₃ | Cl | t-Bu | Cl | I | CF₃ | Cl |
| Me | CH₃ | H | Br | Cl | Me | Cl | H | CF₃ | Br | Me | Cl | I | CF₃ | Br |
| Et | CH₃ | H | Br | Cl | Et | Cl | H | CF₃ | Br | Et | Cl | I | CF₃ | Br |
| i-Pr | CH₃ | H | Br | Cl | i-Pr | Cl | H | CF₃ | Br | i-Pr | Cl | I | CF₃ | Br |
| t-Bu | CH₃ | H | Br | Cl | t-Bu | Cl | H | CF₃ | Br | t-Bu | Cl | I | CF₃ | Br |
| Me | CH₃ | H | Br | Br | Me | Cl | H | Cl | Cl | Me | Cl | I | Cl | Cl |
| Et | CH₃ | H | Br | Br | Et | Cl | H | Cl | Cl | Et | Cl | I | Cl | Cl |
| i-Pr | CH₃ | H | Br | Br | i-Pr | Cl | H | Cl | Cl | i-Pr | Cl | I | Cl | Cl |
| t-Bu | CH₃ | H | Br | Br | i-Pr | Cl | H | Cl | Cl | t-Bu | Cl | I | Cl | Cl |
| Me | CH₃ | F | CF₃ | Cl | Me | CH₃ | Cl | CF₃ | Cl | Me | Cl | I | Cl | Br |
| Et | CH₃ | F | CF₃ | Cl | Et | CH₃ | Cl | CF₃ | Cl | Et | Cl | I | Cl | Br |
| i-Pr | CH₃ | F | CF₃ | Cl | i-Pr | CH₃ | Cl | CF₃ | Cl | i-Pr | Cl | I | Cl | Br |
| t-Bu | CH₃ | F | CF₃ | Cl | t-Bu | CH₃ | Cl | CF₃ | Cl | t-Bu | Cl | I | Cl | Br |
| Me | CH₃ | F | CF₃ | Br | Me | CH₃ | Cl | CF₃ | Br | Me | Cl | I | Br | Cl |
| Et | CH₃ | F | CF₃ | Br | Et | CH₃ | Cl | CF₃ | Br | Et | Cl | I | Br | Cl |
| i-Pr | CH₃ | F | CF₃ | Br | i-Pr | CH₃ | Cl | CF₃ | Br | i-Pr | Cl | I | Br | Cl |
| t-Bu | CH₃ | F | CF₃ | Br | t-Bu | CH₃ | Cl | CF₃ | Br | t-Bu | Cl | I | Br | Cl |
| Me | CH₃ | F | Cl | Cl | Me | CH₃ | Cl | Cl | Cl | Me | Cl | I | Br | Br |
| Et | CH₃ | F | Cl | Cl | Et | CH₃ | Cl | Cl | Cl | Et | Cl | I | Br | Br |
| i-Pr | CH₃ | F | Cl | Cl | i-Pr | CH₃ | Cl | Cl | Cl | i-Pr | Cl | I | Br | Br |
| t-Bu | CH₃ | F | Cl | Cl | t-Bu | OH₃ | Cl | Cl | Cl | t-Bu | Cl | I | Br | Br |
| Me | CH₃ | F | Cl | Br | Me | CH₃ | Cl | Cl | Br | Me | Cl | CF₃ | CF₃ | Cl |
| Et | CH₃ | F | Cl | Br | Et | CH₃ | Cl | Cl | Br | Et | Cl | CF₃ | CF₃ | Cl |
| i-Pr | CH₃ | F | Cl | Br | i-Pr | CH₃ | Cl | Cl | Br | i-Pr | Cl | CF₃ | CF₃ | Cl |
| t-Bu | CH₃ | F | Cl | Br | t-Bu | CH₃ | Cl | Cl | Br | t-Bu | Cl | CF₃ | CF₃ | Cl |
| Me | CH₃ | F | Br | Cl | Me | CH₃ | Cl | Br | Cl | Me | Cl | CF₃ | CF₃ | Br |
| Et | CH₃ | F | Br | Cl | Et | CH₃ | Cl | Br | Cl | Et | Cl | CF₃ | CF₃ | Br |
| i-Pr | CH₃ | F | Br | Cl | i-Pr | CH₃ | Cl | Br | Cl | i-Pr | Cl | CF₃ | CF₃ | Br |
| t-Bu | CH₃ | F | Br | Cl | t-Bu | CH₃ | Cl | Br | Cl | t-Bu | Cl | CF₃ | CF₃ | Br |
| Me | CH₃ | F | Br | Br | Me | CH₃ | Cl | Br | Br | Me | Cl | CF₃ | Cl | Cl |
| Et | CH₃ | F | Br | Br | Et | CH₃ | Cl | Br | Br | Et | Cl | CF₃ | Cl | Cl |
| i-Pr | CH₃ | F | Br | Br | i-Pr | CH₃ | Cl | Br | Br | i-Pr | Cl | CF₃ | Cl | Cl |
| t-Bu | CH₃ | F | Br | Br | t-Bu | CH₃ | Cl | Br | Br | t-Bu | Cl | CF₃ | Cl | Cl |
| Me | CH₃ | Br | CF₃ | Cl | Me | Cl | F | CF₃ | Cl | Me | Cl | CF₃ | Cl | Br |
| Et | CH₃ | Br | CF₃ | Cl | Et | Cl | F | CF₃ | Cl | Et | Cl | CF₃ | Cl | Br |
| i-Pr | CH₃ | Br | CF₃ | Cl | i-Pr | Cl | F | CF₃ | Cl | i-Pr | Cl | CF₃ | Cl | Br |
| t-Bu | CH₃ | Br | CF₃ | Cl | t-Bu | Cl | F | CF₃ | Cl | t-Bu | Cl | CF₃ | Cl | Br |
| Me | CH₃ | Br | CF₃ | Br | Me | Cl | F | CF₃ | Br | Me | Cl | CF₃ | Br | Cl |
| Et | CH₃ | Br | CF₃ | Br | Et | Cl | F | CF₃ | Br | Et | Cl | CF₃ | Br | Cl |
| i-Pr | CH₃ | Br | CF₃ | Br | i-Pr | Cl | F | CF₃ | Br | i-Pr | Cl | CF₃ | Br | Cl |
| t-Bu | CH₃ | Br | CF₃ | Br | t-Bu | Cl | F | CF₃ | Br | t-Bu | Cl | CF₃ | Br | Cl |
| Me | CH₃ | Br | Cl | Cl | Me | Cl | F | Cl | Cl | Me | Cl | CF₃ | Br | Br |
| Et | CH₃ | Br | Cl | Cl | Et | Cl | F | Cl | Cl | Et | Cl | CF₃ | Br | Br |
| i-Pr | CH₃ | Br | Cl | Cl | i-Pr | Cl | F | Cl | Cl | i-Pr | Cl | CF₃ | Br | Br |
| t-Bu | CH₃ | Br | Cl | Cl | t-Bu | Cl | F | Cl | Cl | t-Bu | Cl | CF₃ | Br | Br |
| Me | CH₃ | Br | Cl | Br | Me | Cl | F | Cl | Br | n-Pr | Cl | Cl | Cl | Cl |
| Et | CH₃ | Br | Cl | Br | Et | Cl | F | Cl | Br | n-Bu | Cl | Cl | Cl | Cl |
| i-Pr | CH₃ | Br | Cl | Br | i-Pr | Cl | F | Cl | Br | s-Bu | Cl | Cl | Cl | Cl |
| t-Bu | CH₃ | Br | Cl | Br | t-Bu | Cl | F | Cl | Br | i-Bu | Cl | Cl | Cl | Cl |
| Me | CH₃ | Br | Br | Cl | Me | Cl | F | Br | Cl | Me | Br | F | CF3 | Cl |
| Et | CH₃ | Br | Br | Cl | Et | Cl | F | Br | Cl | Et | Br | F | CF3 | Cl |
| i-Pr | CH₃ | Br | Br | Cl | i-Pr | Cl | F | Br | Cl | i-Pr | Br | F | CF₃ | Cl |
| t-Bu | CH₃ | Br | Br | Cl | t-Bu | Cl | F | Br | Cl | t-Bu | Br | F | CF₃ | Cl |
| Me | CH₃ | Br | Br | Br | Me | Cl | F | Br | Br | Me | Br | F | CF₃ | Br |
| Et | CH₃ | Br | Br | Br | Et | Cl | F | Br | Br | Et | Br | F | CF₃ | Br |
| i-Pr | CH₃ | Br | Br | Br | i-Pr | Cl | F | Br | Br | i-Pr | Br | F | CF₃ | Br |
| t-Bu | CH₃ | Br | Br | Br | t-Bu | Cl | F | Br | Br | t-Bu | Br | F | CF₃ | Br |
| Me | CH₃ | I | CF₃ | Cl | Me | Cl | Cl | CF₃ | Cl | Me | Br | F | Cl | Cl |
| Et | CH₃ | I | CF₃ | Cl | Et | Cl | Cl | CF₃ | Cl | Et | Br | F | Cl | Cl |
| i-Pr | CH₃ | I | CF₃ | Cl | i-Pr | Cl | Cl | CF₃ | CI | i-Pr | Br | F | Cl | Cl |
| t-Bu | CH₃ | I | CF₃ | Cl | t-Bu | Cl | Cl | CF₃ | Cl | t-Bu | Br | F | Cl | Cl |
| Me | CH₃ | I | CF₃ | Br | Me | Cl | Cl | CF₃ | Br | Me | Br | F | Cl | Br |
| Et | CH₃ | I | CF₃ | Br | Et | Cl | Cl | CF₃ | Br | Et | Br | F | Cl | Br |
| i-Pr | CH₃ | I | CF₃ | Br | i-Pr | Cl | Cl | CF₃ | Br | i-Pr | Br | F | Cl | Br |
| t-Bu | CH₃ | I | CF₃ | Br | t-Bu | Cl | Cl | CF₃ | Br | t-Bu | Br | F | Cl | Br |
| Me | CH₃ | I | Cl | Cl | Me | Cl | Cl | Cl | Cl | Me | Br | F | Br | Cl |
| Et | CH₃ | I | Cl | Cl | Et | Cl | Cl | Cl | Cl | Et | Br | F | Br | Cl |
| i-Pr | CH₃ | I | Cl | Cl | i-Pr | Cl | Cl | Cl | Cl | i-Pr | Br | F | Br | Cl |
| t-Bu | CH₃ | I | Cl | Cl | t-Bu | Cl | Cl | Cl | Cl | t-Bu | Br | F | Br | Cl |
| Me | CH₃ | I | Cl | Br | Me | Cl | Cl | Cl | Br | Me | Br | F | Br | Br |
| Et | CH₃ | I | Cl | Br | Et | Cl | Cl | Cl | Br | Et | Br | F | Br | Br |
| z-Pr | CH₃ | I | Cl | Br | i-Pr | Cl | Cl | Cl | Br | i-Pr | Br | F | Br | Br |
| t-Bu | CH₃ | I | Cl | Br | t-Bu | Cl | Cl | Cl | Br | t-Bu | Br | F | Br | Br |
| Me | CH₃ | I | Br | Cl | Me | Br | CF₃ | CF₃ | Cl | Me | Br | Cl | CF₃ | Cl |
| Et | CH₃ | I | Br | Cl | Et | Br | CF₃ | CF₃ | Cl | Et | Br | Cl | CF₃ | Cl |
| i-Pr | CH₃ | I | Br | Cl | i-Pr | Br | CF₃ | CF₃ | Cl | i-Pr | Br | Cl | CF₃ | Cl |
| t-Bu | CH₃ | I | Br | Cl | t-Bu | Br | CF₃ | CF₃ | Cl | t-Bu | Br | Cl | CF₃ | Cl |
| Me | CH₃ | I | Br | Br | Me | Br | CF₃ | CF₃ | Br | Me | Br | Cl | CF₃ | Br |
| Et | CH₃ | I | Br | Br | Et | Br | CF₃ | CF₃ | Br | Et | Br | Cl | CF₃ | Br |
| i-Pr | CH₃ | I | Br | Br | i-Pr | Br | CF₃ | CF₃ | Br | i-Pr | Br | Cl | CF₃ | Br |
| t-Bu | CH₃ | I | Br | Br | t-Bu | Br | CF₃ | CF₃ | Br | t-Bu | Br | Cl | CF₃ | Br |
| Me | CH₃ | CF₃ | CF₃ | Cl | Me | Br | CF₃ | Cl | Cl | Me | Br | Cl | Cl | Cl |
| Et | CH₃ | CF₃ | CF₃ | Cl | Et | Br | CF₃ | Cl | Cl | Et | Br | Cl | Cl | Cl |
| i-Pr | CH₃ | CF₃ | CF₃ | Cl | i-Pr | Br | CF₃ | Cl | Cl | i-Pr | Br | Cl | Cl | Cl |
| t-Bu | CH₃ | CF₃ | CF₃ | Cl | t-Bu | Br | CF₃ | Cl | Cl | t-Bu | Br | Cl | Cl | Cl |
| Me | CH₃ | CF₃ | CF₃ | Br | Me | Br | CF₃ | Cl | Br | Me | Br | Cl | Cl | Br |
| Et | CH₃ | CF₃ | CF₃ | Br | Et | Br | CF₃ | Cl | Br | Et | Br | Cl | Cl | Br |
| i-Pr | CH₃ | CF₃ | CF₃ | Br | i-Pr | Br | CF₃ | Cl | Br | i-Pr | Br | Cl | Cl | Br |
| t-Bu | CH₃ | CF₃ | CF₃ | Br | t-Bu | Br | CF₃ | Cl | Br | t-Bu | Br | Cl | Cl | Br |
| Me | CH₃ | CF₃ | Cl | Cl | Me | Br | CF₃ | Br | Cl | Me | Br | Cl | Br | Cl |
| Et | CH₃ | CF₃ | Cl | Cl | Et | Br | CF₃ | Br | Cl | Et | Br | Cl | Br | Cl |
| i-Pr | CH₃ | CF₃ | Cl | Cl | i-Pr | Br | CF₃ | Br | Cl | i-Pr | Br | Cl | Br | Cl |
| t-Bu | CH₃ | CF₃ | Cl | Cl | t-Bu | Br | CF₃ | Br | Cl | t-Bu | Br | Cl | Br | Cl |
| Me | CH₃ | CF₃ | Cl | Br | Me | Br | CF₃ | Br | Br | Me | Br | Cl | Br | Br |
| Et | CH₃ | CF₃ | Cl | Br | Et | Br | CF₃ | Br | Br | Et | Br | Cl | Br | Br |
| i-Pr | CH₃ | CF₃ | Cl | Br | i-Pr | Br | CF₃ | Br | Br | i-Pr | Br | Cl | Br | Br |
| t-Bu | CH₃ | CF₃ | Cl | Br | t-Bu | Br | CF₃ | Br | Br | t-Bu | Br | Cl | Br | Br |
| Me | CH₃ | CF₃ | Br | Cl | Me | Br | I | CF₃ | Cl | Me | Br | Br | CF₃ | Cl |
| Et | CH₃ | CF₃ | Br | Cl | Et | Br | I | CF₃ | Cl | Et | Br | Br | CF₃ | Cl |
| i-Pr | CH₃ | CF₃ | Br | Cl | i-Pr | Br | I | CF₃ | Cl | i-Pr | Br | Br | CF₃ | Cl |
| t-Bu | CH₃ | CF₃ | Br | Cl | t-Bu | Br | I | CF₃ | Cl | t-Bu | Br | Br | CF₃ | Cl |
| Me | CH₃ | CF₃ | Br | Br | Me | Br | I | CF₃ | Br | Me | Br | Br | CF₃ | Br |
| Et | CH₃ | CF₃ | Br | Br | Et | Br | I | CF₃ | Br | Et | Br | Br | CF₃ | Br |
| i-Pr | CH₃ | CF₃ | Br | Br | i-Pr | Br | I | CF₃ | Br | i-Pr | Br | Br | CF₃ | Br |
| t-Bu | CH₃ | CF₃ | Br | Br | t-Bu | Br | I | CF₃ | Br | t-Bu | Br | Br | CF₃ | Br |
| n-Pr | CH₃ | Cl | Cl | Cl | Me | Br | I | Cl | Cl | Me | Br | Br | Cl | Cl |
| n-Bu | CH₃ | Cl | Cl | Cl | Et | Br | I | Cl | Cl | Et | Br | Br | Cl | Cl |
| s-Bu | CH₃ | Cl | Cl | Cl | i-Pr | Br | I | Cl | Cl | i-Pr | Br | Br | Cl | Cl |
| t-Bu | CH₃ | Cl | Cl | Cl | t-Bu | Br | I | Cl | Cl | t-Bu | Br | Br | Cl | Cl |
| Me | Cl | Cl | Br | Cl | Me | Br | I | Cl | Br | Me | Br | Br | Cl | Br |
| Et | Cl | Cl | Br | Cl | Et | Br | I | Cl | Br | Et | Br | Br | Cl | Br |
| i-Pr | Cl | Cl | Br | Cl | i-Pr | Br | I | Cl | Br | i-Pr | Br | Br | Cl | Br |
| t-Bu | Cl | Cl | Br | Cl | t-Bu | Br | I | Cl | Br | t-Bu | Br | Br | Cl | Br |
| Me | Cl | Cl | Br | Br | Me | Br | I | Br | Cl | Me | Br | Br | Br | Cl |
| Et | Cl | Cl | Br | Br | Et | Br | I | Br | Cl | Et | Br | Br | Br | Cl |
| i-Pr | Cl | Cl | Br | Br | i-Pr | Br | I | Br | Cl | i-Pr | Br | Br | Br | Cl |
| t-Bu | Cl | Cl | Br | Br | t-Bu | Br | I | Br | Cl | t-Bu | Br | Br | Br | Cl |
| Me | Cl | Br | CF₃ | Cl | Me | Br | I | Br | Br | Me | Br | Br | Br | Br |
| Et | Cl | Br | CF₃ | Cl | Et | Br | I | Br | Br | Et | Br | Br | Br | Br |
| i-Pr | Cl | Br | CF₃ | Cl | i-Pr | Br | I | Br | Br | i-Pr | Br | Br | Br | Br |
| t-Bu | Cl | Br | CF₃ | Cl | t-Bu | Br | I | Br | Br | t-Bu | Br | Br | Br | Br |
| Me | Cl | Br | CF₃ | Br | Me | Cl | Br | Cl | Cl | t-Bu | Cl | Br | CF₃ | Br |
| Et | Cl | Br | CF₃ | Br | Et | Cl | Br | Cl | Cl | t-Bu | Cl | Br | Cl | Cl |
| i-Pr | Cl | Br | CF₃ | Br | i-Pr | Cl | Br | Cl | Cl | | | | | |

TABLE 29

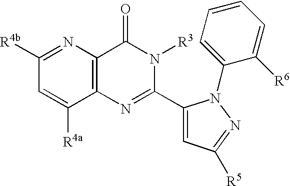

| R³ | R^{4a} | R^{4b} | R⁵ | R⁶ | R³ | R^{4a} | R^{4b} | R⁵ | R⁶ | R³ | R^{4a} | R^{4b} | R⁵ | R⁶ |
|---|---|---|---|---|---|---|---|---|---|---|---|---|---|---|
| Me | CH₃ | H | CF₃ | Cl | Me | Cl | F | CF₃ | Cl | Me | Cl | H | Cl | Br |
| Et | CH₃ | H | CF₃ | Cl | Et | Cl | F | CF₃ | Cl | Et | Cl | H | Cl | Br |
| i-Pr | CH₃ | H | CF₃ | Cl | i-Pr | Cl | F | CF₃ | Cl | i-Pr | Cl | H | Cl | Br |
| t-Bu | CH₃ | H | CF₃ | Cl | t-Bu | Cl | F | CF₃ | Cl | t-Bu | Cl | H | Cl | Br |
| Me | CH₃ | H | CF₃ | Br | Me | Cl | F | CF₃ | Br | Me | Cl | H | Br | Cl |
| Et | CH₃ | H | CF₃ | Br | Et | Cl | F | CF₃ | Br | Et | Cl | H | Br | Cl |
| i-Pr | CH₃ | H | CF₃ | Br | i-Pr | Cl | F | CF₃ | Br | i-Pr | Cl | H | Br | Cl |
| t-Bu | CH₃ | H | CF₃ | Br | t-Bu | Cl | F | CF₃ | Br | t-Bu | Cl | H | Br | Cl |
| Me | CH₃ | H | Cl | Cl | Me | Cl | F | Cl | Cl | Me | Cl | H | Br | Br |
| Et | CH₃ | H | Cl | Cl | Et | Cl | F | Cl | Cl | Et | Cl | H | Br | Br |
| i-Pr | CH₃ | H | Cl | Cl | i-Pr | Cl | F | Cl | Cl | i-Pr | Cl | H | Br | Br |
| t-Bu | CH₃ | H | Cl | Cl | t-Bu | Cl | F | Cl | Cl | t-Bu | Cl | H | Br | Br |
| Me | CH₃ | H | Cl | Br | Me | Cl | F | Cl | Br | Me | Cl | H | CF₃ | Cl |
| Et | CH₃ | H | Cl | Br | Et | Cl | F | Cl | Br | Et | Cl | H | CF₃ | Cl |
| i-Pr | CH₃ | H | Cl | Br | i-Pr | Cl | F | Cl | Br | i-Pr | Cl | H | CF₃ | Cl |
| t-Bu | CH₃ | H | Cl | Br | t-Bu | Cl | F | Cl | Br | t-Bu | Cl | H | CF₃ | Cl |
| Me | CH₃ | H | Br | Cl | Me | Cl | F | Br | Cl | Me | Cl | H | CF₃ | Br |
| Et | CH₃ | H | Br | Cl | Et | Cl | F | Br | Cl | Et | Cl | H | CF₃ | Br |
| i-Pr | CH₃ | H | Br | Cl | i-Pr | Cl | F | Br | Cl | i-Pr | Cl | H | CF₃ | Br |
| t-Bu | CH₃ | H | Br | Cl | t-Bu | Cl | F | Br | Cl | t-Bu | Cl | H | CF₃ | Br |
| Me | CH₃ | H | Br | Br | Me | Cl | F | Br | Br | Me | Cl | H | Cl | Cl |
| Et | CH₃ | H | Br | Br | Et | Cl | F | Br | Br | Et | Cl | H | Cl | Cl |
| i-Pr | CH₃ | H | Br | Br | i-Pr | Cl | F | Br | Br | i-Pr | Cl | H | Cl | Cl |
| t-Bu | CH₃ | H | Br | Br | t-Bu | Cl | F | Br | Br | i-Pr | Cl | H | Cl | Cl |
| Me | CH₃ | F | CF₃ | Cl | Me | Cl | Cl | CF₃ | Cl | Me | Cl | Br | Cl | Br |
| Et | CH₃ | F | CF₃ | Cl | Et | Cl | Cl | CF₃ | Cl | Et | Cl | Br | Cl | Br |
| i-Pr | CH₃ | F | CF₃ | Cl | i-Pr | Cl | Cl | CF₃ | Cl | i-Pr | Cl | Br | Cl | Br |
| t-Bu | CH₃ | F | CF₃ | Cl | t-Bu | Cl | Cl | CF₃ | Cl | t-Bu | Cl | Br | Cl | Br |
| Me | CH₃ | F | CF₃ | Br | Me | Cl | Cl | CF₃ | Br | Me | Cl | Br | Br | Cl |
| Et | CH₃ | F | CF₃ | Br | Et | Cl | Cl | CF₃ | Br | Et | Cl | Br | Br | Cl |
| i-Pr | CH₃ | F | CF₃ | Br | i-Pr | Cl | Cl | CF₃ | Br | i-Pr | Cl | Br | Br | Cl |
| t-Bu | CH₃ | F | CF₃ | Br | t-Bu | Cl | Cl | CF₃ | Br | t-Bu | Cl | Br | Br | Cl |
| Me | CH₃ | F | Cl | Cl | Me | Cl | Cl | Cl | Cl | Me | Cl | Br | Br | Br |
| Et | CH₃ | F | Cl | Cl | Et | Cl | Cl | Cl | Cl | Et | Cl | Br | Br | Br |
| i-Pr | CH₃ | F | Cl | Cl | i-Pr | Cl | Cl | Cl | Cl | i-Pr | Cl | Br | Br | Br |
| t-Bu | CH₃ | F | Cl | Cl | t-Bu | Cl | Cl | Cl | Cl | t-Bu | Cl | Br | Br | Br |
| Me | CH₃ | F | Cl | Br | Me | Cl | Cl | Cl | Br | Me | Cl | I | CF₃ | Cl |
| Et | CH₃ | F | Cl | Br | Et | Cl | Cl | Cl | Br | Et | Cl | I | CF₃ | Cl |
| i-Pr | CH₃ | F | Cl | Br | i-Pr | Cl | Cl | Cl | Br | i-Pr | Cl | I | CF₃ | Cl |
| t-Bu | CH₃ | F | Cl | Br | t-Bu | Cl | Cl | Cl | Br | t-Bu | Cl | I | CF₃ | Cl |
| Me | CH₃ | F | Br | Cl | Me | Cl | Cl | Br | Cl | Me | Cl | I | CF₃ | Br |
| Et | CH₃ | F | Br | Cl | Et | Cl | Cl | Br | Cl | Et | Cl | I | CF₃ | Br |
| i-Pr | CH₃ | F | Br | Cl | i-Pr | Cl | Cl | Br | Cl | i-Pr | Cl | I | CF₃ | Br |
| t-Bu | CH₃ | F | Br | Cl | t-Bu | Cl | Cl | Br | Cl | t-Bu | Cl | I | CF₃ | Br |
| Me | CH₃ | F | Br | Br | Me | Cl | Cl | Br | Br | Me | Cl | I | Cl | Cl |
| Et | CH₃ | F | Br | Br | Et | Cl | Cl | Br | Br | Et | Cl | I | Cl | Cl |
| i-Pr | CH₃ | F | Br | Br | i-Pr | Cl | Cl | Br | Br | i-Pr | Cl | I | Cl | Cl |
| t-Bu | CH₃ | F | Br | Br | t-Bu | Cl | Cl | Br | Br | t-Bu | Cl | I | Cl | Cl |
| Me | CH₃ | Cl | CF₃ | Cl | Me | Cl | Br | CF₃ | Cl | Me | Cl | I | Cl | Br |
| Et | CH₃ | Cl | CF₃ | Cl | Et | Cl | Br | CF₃ | Cl | Et | Cl | I | Cl | Br |
| i-Pr | CH₃ | Cl | CF₃ | Cl | i-Pr | Cl | Br | CF₃ | Cl | i-Pr | Cl | I | Cl | Br |
| t-Bu | CH₃ | Cl | CF₃ | Cl | t-Bu | Cl | Br | CF₃ | Cl | t-Bu | Cl | I | Cl | Br |
| Me | CH₃ | Cl | CF₃ | Br | Me | Cl | Br | CF₃ | Br | Me | Cl | I | Br | Cl |
| Et | CH₃ | CI | CF₃ | Br | Et | Cl | Br | CF₃ | Br | Et | Cl | I | Br | Cl |
| i-Pr | CH₃ | Cl | CF₃ | Br | i-Pr | Cl | Br | CF₃ | Br | i-Pr | Cl | I | Br | Cl |
| t-Bu | CH₃ | Cl | CF₃ | Br | t-Bu | Cl | Br | CF₃ | Br | t-Bu | Cl | I | Br | Cl |
| Me | CH₃ | Cl | Cl | Cl | Me | Cl | Br | Cl | Cl | Me | Cl | I | Br | Br |
| Et | CH₃ | Cl | Cl | Cl | Et | Cl | Br | Cl | Cl | Et | Cl | I | Br | Br |
| i-Pr | CH₃ | Cl | Cl | Cl | i-Pr | Cl | Br | Cl | Cl | i-Pr | Cl | I | Br | Br |
| t-Bu | CH₃ | Cl | Cl | Cl | t-Bu | Cl | Br | Cl | Cl | t-Bu | Cl | I | Br | Br |
| Me | CH₃ | Cl | Cl | Br | Me | Br | Br | Br | Cl | Me | Cl | CF₃ | CF₃ | Cl |
| Et | CH₃ | CI | Cl | Br | Et | Br | Br | Br | Cl | Et | Cl | CF₃ | CF₃ | Cl |
| i-Pr | CH₃ | Cl | Cl | Br | i-Pr | Br | Br | Br | Cl | i-Pr | Cl | CF₃ | CF₃ | Cl |
| t-Bu | CH₃ | Cl | Cl | Br | t-Bu | Br | Br | Br | Cl | t-Bu | Cl | CF₃ | CF₃ | Cl |
| Me | CH₃ | Cl | Br | Cl | Me | Br | Br | Br | Br | Me | Cl | CF₃ | CF₃ | Br |
| Et | CH₃ | Cl | Br | Cl | Et | Br | Br | Br | Br | Et | Cl | CF₃ | CF₃ | Br |
| i-Pr | CH₃ | Cl | Br | Cl | i-Pr | Br | Br | Br | Br | i-Pr | Cl | CF₃ | CF₃ | Br |
| t-Bu | CH₃ | Cl | Br | Cl | t-Bu | Br | Br | Br | Br | t-Bu | Cl | CF₃ | CF₃ | Br |
| Me | CH₃ | Cl | Br | Br | Me | Br | I | CF₃ | Cl | Me | Cl | CF₃ | Cl | Cl |
| Et | CH₃ | Cl | Br | Br | Et | Br | I | CF₃ | Cl | Et | Cl | CF₃ | Cl | Cl |
| i-Pr | CH₃ | Cl | Br | Br | i-Pr | Br | I | CF₃ | Cl | i-Pr | Cl | CF₃ | Cl | Cl |
| t-Bu | CH₃ | Cl | Br | Br | t-Bu | Br | I | CF₃ | Cl | t-Bu | Cl | CF₃ | Cl | Cl |
| Me | CH₃ | Br | CF₃ | Cl | Me | Br | I | CF₃ | Br | Me | Cl | CF₃ | Cl | Br |
| Et | CH₃ | Br | CF₃ | Cl | Et | Br | I | CF₃ | Br | Et | Cl | CF₃ | Cl | Br |
| i-Pr | CH₃ | Br | CF₃ | Cl | i-Pr | Br | I | CF₃ | Br | i-Pr | Cl | CF₃ | Cl | Br |
| t-Bu | CH₃ | Br | CF₃ | Cl | t-Bu | Br | I | CF₃ | Br | t-Bu | Cl | CF₃ | Cl | Br |
| Me | CH₃ | Br | CF₃ | Br | Me | Br | I | Cl | Cl | Me | Cl | CF₃ | Br | Cl |
| Et | CH₃ | Br | CF₃ | Br | Et | Br | I | Cl | Cl | Et | Cl | CF₃ | Br | Cl |
| i-Pr | CH₃ | Br | CF₃ | Br | i-Pr | Br | I | Cl | Cl | i-Pr | Cl | CF₃ | Br | Cl |
| t-Bu | CH₃ | Br | CF₃ | Br | t-Bu | Br | I | Cl | Cl | t-Bu | Cl | CF₃ | Br | Cl |
| Me | CH₃ | Br | Cl | Cl | Me | Br | I | Cl | Br | Me | Cl | CF₃ | Br | Br |
| Et | CH₃ | Br | Cl | Cl | Et | Br | I | Cl | Br | Et | Cl | CF₃ | Br | Br |
| i-Pr | CH₃ | Br | Cl | Cl | i-Pr | Br | I | Cl | Br | i-Pr | Cl | CF₃ | Br | Br |
| t-Bu | CH₃ | Br | Cl | Cl | t-Bu | Br | I | Cl | Br | t-Bu | Cl | CF₃ | Br | Br |
| Me | CH₃ | Br | Cl | Br | Me | Br | I | Br | Cl | n-Pr | Cl | Cl | Cl | Cl |
| Et | CH₃ | Br | Cl | Br | Et | Br | I | Br | Cl | n-Bu | Cl | Cl | Cl | Cl |
| i-Pr | CH₃ | Br | Cl | Br | i-Pr | Br | I | Br | Cl | s-Bu | Cl | Cl | Cl | Cl |
| t-Bu | CH₃ | Br | Cl | Br | t-Bu | Br | I | Br | Cl | i-Bu | Cl | Cl | Cl | Cl |
| Me | CH₃ | Br | Br | Cl | Me | Br | I | Br | Br | Me | Br | F | CF₃ | Cl |
| Et | CH₃ | Br | Br | Cl | Et | Br | I | Br | Br | Et | Br | F | CF₃ | Cl |
| i-Pr | CH₃ | Br | Br | Cl | i-Pr | Br | I | Br | Br | i-Pr | Br | F | CF₃ | Cl |
| t-Bu | CH₃ | Br | Br | Cl | t-Bu | Br | I | Br | Br | t-Bu | Br | F | CF₃ | Cl |
| Me | CH₃ | Br | Br | Br | Me | Br | CF₃ | CF₃ | Cl | Me | Br | F | CF₃ | Br |
| Et | CH₃ | Br | Br | Br | Et | Br | CF₃ | CF₃ | Cl | Et | Br | F | CF₃ | Br |
| i-Pr | CH₃ | Br | Br | Br | i-Pr | Br | CF₃ | CF₃ | Cl | i-Pr | Br | F | CF₃ | Br |
| t-Bu | CH₃ | Br | Br | Br | t-Bu | Br | CF₃ | CF₃ | Cl | t-Bu | Br | F | CF₃ | Br |
| Me | CH₃ | I | CF₃ | Cl | Me | Br | CF₃ | CF₃ | Br | Me | Br | F | Cl | Cl |
| Et | CH₃ | I | CF₃ | Cl | Et | Br | CF₃ | CF₃ | Br | Et | Br | F | Cl | Cl |
| i-Pr | CH₃ | I | CF₃ | Cl | i-Pr | Br | CF₃ | CF₃ | Br | i-Pr | Br | F | Cl | Cl |
| t-Bu | CH₃ | I | CF₃ | Cl | t-Bu | Br | CF₃ | CF₃ | Br | t-Bu | Br | F | Cl | Cl |
| Me | CH₃ | I | CF₃ | Br | Me | Br | CF₃ | Cl | Cl | Me | Br | F | Cl | Br |
| Et | CH₃ | I | CF₃ | Br | Et | Br | CF₃ | Cl | Cl | Et | Br | F | Cl | Br |
| i-Pr | CH₃ | I | CF₃ | Br | i-Pr | Br | CF₃ | Cl | Cl | i-Pr | Br | F | Cl | Br |
| t-Bu | CH₃ | I | CF₃ | Br | t-Bu | Br | CF₃ | Cl | Cl | t-Bu | Br | F | Cl | Br |
| Me | CH₃ | I | Cl | Cl | Me | Br | CF₃ | Cl | Br | Me | Br | F | Br | Cl |
| Et | CH₃ | I | Cl | Cl | Et | Br | CF₃ | Cl | Br | Et | Br | F | Br | Cl |
| i-Pr | CH₃ | I | Cl | Cl | i-Pr | Br | CF₃ | Cl | Br | i-Pr | Br | F | Br | Cl |
| t-Bu | CH₃ | I | Cl | Cl | t-Bu | Br | CF₃ | Cl | Br | t-Bu | Br | F | Br | Cl |
| Me | CH₃ | I | Cl | Br | Me | Br | CF₃ | Br | Cl | Me | Br | F | Br | Br |
| Et | CH₃ | I | Cl | Br | Et | Br | CF₃ | Br | Cl | Et | Br | F | Br | Br |
| i-Pr | CH₃ | I | Cl | Br | i-Pr | Br | CF₃ | Br | Cl | i-Pr | Br | F | Br | Br |
| t-Bu | CH₃ | I | Cl | Br | t-Bu | Br | CF₃ | Br | Cl | t-Bu | Br | F | Br | Br |
| Me | CH₃ | I | Br | Cl | Me | Br | CF₃ | Br | Br | Me | Br | Cl | CF₃ | Cl |
| Et | CH₃ | I | Br | Cl | Et | Br | CF₃ | Br | Br | Et | Br | Cl | CF₃ | Cl |
| i-Pr | CH₃ | I | Br | Cl | i-Pr | Br | CF₃ | Br | Br | i-Pr | Br | Cl | CF₃ | Cl |
| t-Bu | CH₃ | I | Br | Cl | t-Bu | Br | CF₃ | Br | Br | t-Bu | Br | Cl | CF₃ | Cl |
| Me | CH₃ | I | Br | Br | Me | Br | Br | CF₃ | Cl | Me | Br | Cl | CF₃ | Br |
| Et | CH₃ | I | Br | Br | Et | Br | Br | CF₃ | Cl | Et | Br | Cl | CF₃ | Br |
| i-Pr | CH₃ | I | Br | Br | i-Pr | Br | Br | CF₃ | Cl | i-Pr | Br | Cl | CF₃ | Br |
| t-Bu | CH₃ | I | Br | Br | t-Bu | Br | Br | CF₃ | Cl | t-Bu | Br | Cl | CF₃ | Br |
| Me | CH₃ | CF₃ | CF₃ | Cl | Me | Br | Br | CF₃ | Br | Me | Br | Cl | Cl | Cl |
| Et | CH₃ | CF₃ | CF₃ | Cl | Et | Br | Br | CF₃ | Br | Et | Br | Cl | Cl | Cl |
| i-Pr | CH₃ | CF₃ | CF₃ | Cl | i-Pr | Br | Br | CF₃ | Br | i-Pr | Br | Cl | Cl | Cl |
| t-Bu | CH₃ | CF₃ | CF₃ | Cl | t-Bu | Br | Br | CF₃ | Br | t-Bu | Br | Cl | Cl | Cl |
| Me | CH₃ | CF₃ | CF₃ | Br | Me | Br | Br | Cl | Cl | Me | Br | Cl | Cl | Br |
| Et | CH₃ | CF₃ | CF₃ | Br | Et | Br | Br | Cl | Cl | Et | Br | Cl | Cl | Br |
| i-Pr | CH₃ | CF₃ | CF₃ | Br | i-Pr | Br | Br | Cl | Cl | i-Pr | Br | Cl | Cl | Br |
| t-Bu | CH₃ | CF₃ | CF₃ | Br | t-Bu | Br | Br | Cl | Cl | t-Bu | Br | Cl | Cl | Br |
| Me | CH₃ | CF₃ | Cl | Cl | Me | Br | Br | Cl | Br | Me | Br | Cl | Br | Cl |
| Et | CH₃ | CF₃ | Cl | Cl | Et | Br | Br | Cl | Br | Et | Br | Cl | Br | Cl |
| i-Pr | CH₃ | CF₃ | Cl | Cl | i-Pr | Br | Br | Cl | Br | i-Pr | Br | Cl | Br | Cl |
| t-Bu | CH₃ | CF₃ | Cl | Cl | t-Bu | Br | Br | Cl | Br | t-Bu | Br | Cl | Br | Cl |
| Me | CH₃ | CF₃ | Cl | Br | Me | CH₃ | CF₃ | Br | Cl | Me | Br | Cl | Br | Br |
| Et | CH₃ | CF₃ | Cl | Br | Et | CH₃ | CF₃ | Br | Cl | Et | Br | Cl | Br | Br |
| i-Pr | CH₃ | CF₃ | Cl | Br | i-Pr | CH₃ | CF₃ | Br | Cl | i-Pr | Br | Cl | Br | Br |
| t-Bu | CH₃ | CF₃ | Cl | Br | t-Bu | CH₃ | CF₃ | Br | Cl | t-Bu | Br | Cl | Br | Br |
| Me | CH₃ | CF₃ | Br | Br | n-Pr | CH₃ | Cl | Cl | Cl | t-Bu | CH₃ | CF₃ | Br | Br |
| Et | CH₃ | CF₃ | Br | Br | n-Bu | CH₃ | Cl | Cl | Cl | i-Bu | CH₃ | Cl | Cl | Cl |
| i-Pr | CH₃ | CF₃ | Br | Br | s-Bu | CH₃ | Cl | Cl | Cl | | | | | |

TABLE 30

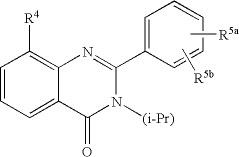

| R⁴ | R^{5a} and/or R^{5b} | R⁴ | R^{5a} and/or R^{5b} | R⁴ | R^{5a} and/or R^{5b} |
|---|---|---|---|---|---|
| Me | 2-CF₃ | Me | 3-CF₃ | Me | 4-CF₃ |
| Me | 2-OCF₃ | Me | 3-CF₃ | Me | 4-OCF₃ |
| Me | 2-OCF₂H | Me | 3-OCF₃ | Me | 4-OCF₂H |
| Me | 2-OCF₂CF₂H | Me | 3-OCF₂H | Me | 4-OCF₂CF₂H |
| Me | 2-OCH₂CF₃ | Me | 3-OCF₂CF₂H | Me | 4-OCH₂CF₃ |
| Me | 2-SCF₃ | Me | 3-OCH₂CF₃ | Me | 4-SCF₃ |
| Me | 2-SOCF₃ | Me | 3-SCF₃ | Me | 4-SOCF₃ |
| Me | 2-SO₂CF₃ | Me | 3-SOCF₃ | Me | 4-SO₂CF₃ |
| Me | 2-SCF₂H | Me | 3-SO₂CF₃ | Me | 4-SCF₂H |
| Me | 2-SOCF₂H | Me | 3-SCF₂H | Me | 4-SOCF₂H |
| Me | 2-SO₂CF₂H | Me | 3-SOCF₂H | Me | 4-SO₂CF₂H |
| Cl | 2-CF₃ | Cl | 3-CF₃ | Cl | 4-CF₃ |
| Cl | 2-OCF₃ | Cl | 3-OCF₃ | Cl | 4-OCF₃ |
| Cl | 2-OCF₂H | Cl | 3-OCF₂H | Cl | 4-OCF₂H |
| Cl | 2-OCF₂CF₂H | Cl | 3-OCF₂CF₂H | Cl | 4-OCF₂CF₂H |
| Cl | 2-OCH₂CF₃ | Cl | 3-OCH₂CF₃ | Cl | 4-OCH₂CF₃ |
| Cl | 2-SCF₃ | Cl | 3-SCF₃ | Cl | 4-SCF₃ |
| Cl | 2-SOCF₃ | Cl | 3-SOCF₃ | Cl | 4-SOCF₃ |
| Cl | 2-SO₂CF₃ | Cl | 3-SO₂CF₃ | Cl | 4-SO₂CF₃ |
| Cl | 2-SCF₂H | Cl | 3-SCF₂H | Cl | 4-SCF₂H |
| Cl | 2-SOCF₂H | Cl | 3-SOCF₂H | Cl | 4-SOCF₂H |
| Cl | 2-SO₂CF₂H | Cl | 3-SO₂CF₂H | Cl | 4-SO₂CF₂H |
| F | 2-CF₃ | F | 3-CF₃ | F | 4-CF₃ |
| F | 2-OCF₃ | F | 3-OCF₃ | F | 4-OCF₃ |
| F | 2-OCF₂H | F | 3-OCF₂H | F | 4-OCF₂H |
| F | 2-OCF₂CF₂H | F | 3-OCF₂CF₂H | F | 4-OCF₂CF₂H |
| F | 2-OCH₂CF₃ | F | 3-OCH₂CF₃ | F | 4-OCH₂CF₃ |
| F | 2-SCF₃ | F | 3-SCF₃ | F | 4-SCF₃ |
| F | 2-SOCF₃ | F | 3-SOCF₃ | F | 4-SOCF₃ |
| F | 2-SO₂CF₃ | F | 3-SO₂CF₃ | F | 4-SO₂CF₃ |
| F | 2-SCF₂H | F | 3-SCF₂H | F | 4-SCF₂H |
| F | 2-SOCF₂H | F | 3-SOCF₂H | F | 4-SOCF₂H |
| F | 2-SO₂CF₂H | F | 3-SO₂CF₂H | F | 4-SO₂CF₂H |
| Br | 2-CF₃ | Br | 3-CF₃ | Br | 4-CF₃ |
| Br | 2-OCF₃ | Br | 3-OCF₃ | Br | 4-OCF₃ |
| Br | 2-OCF₂H | Br | 3-OCF₂H | Br | 4-OCF₂H |
| Br | 2-OCF₂CF₂H | Br | 3-OCF₂CF₂H | Br | 4-OCF₂CF₂H |
| Br | 2-OCH₂CF₃ | Br | 3-OCH₂CF₃ | Br | 4-OCH₂CF₃ |
| Br | 2-SCF₃ | Br | 3-SCF₃ | Br | 4-SCF₃ |
| Br | 2-SOCF₃ | Br | 3-SOCF₃ | Br | 4-SOCF₃ |
| Br | 2-SO₂CF₃ | Br | 3-SO₂CF₃ | Br | 4-SO₂CF₃ |
| Br | 2-SCF₂H | Br | 3-SCF₂H | Br | 4-SCF₂H |
| Br | 2-SOCF₂H | Br | 3-SOCF₂H | Br | 4-SOCF₂H |
| Br | 2-SO₂CF₂H | Br | 3-SO₂CF₂H | Br | 4-SO₂CF₂H |
| I | 2-CF₃ | I | 3-CF₃ | I | 4-CF₃ |
| I | 2-OCF₃ | I | 3-OCF₃ | I | 4-OCF₃ |
| I | 2-OCF₂H | I | 3-OCF₂H | I | 4-OCF₂H |
| I | 2-OCF₂CF₂H | I | 3-OCF₂CF₂H | I | 4-OCF₂CF₂H |
| I | 2-OCH₂CF₃ | I | 3-OCH₂CF₃ | I | 4-OCH₂CF₃ |
| I | 2-SCF₃ | I | 3-SCF₃ | I | 4-SCF₃ |
| I | 2-SOCF₃ | I | 3-SOCF₃ | I | 4-SOCF₃ |
| I | 2-SO₂CF₃ | I | 3-SO₂CF₃ | I | 4-SO₂CF₃ |
| I | 2-SCF₂H | I | 3-SCF₂H | I | 4-SCF₂H |
| I | 2-SOCF₂H | I | 3-SOCF₂H | I | 4-SOCF₂H |
| I | 2-SO₂CF₂H | I | 3-SO₂CF₂H | I | 4-SO₂CF₂H |
| OMe | 2-CF₃ | OMe | 3-CF₃ | OMe | 4-CF₃ |
| OMe | 2-OCF₃ | OMe | 3-OCF₃ | OMe | 4-OCF₃ |
| OMe | 2-OCF₂H | OMe | 3-OCF₂H | OMe | 4-OCF₂H |
| OMe | 2-OCF₂CF₂H | OMe | 3-OCF₂CF₂H | OMe | 4-OCF₂CF₂H |
| OMe | 2-OCH₂CF₃ | OMe | 3-OCH₂CF₃ | OMe | 4-OCH₂CF₃ |
| OMe | 2-SCF₃ | OMe | 3-SCF₃ | OMe | 4-SCF₃ |
| OMe | 2-SOCF₃ | OMe | 3-SOCF₃ | OMe | 4-SOCF₃ |
| OMe | 2-SO₂CF₃ | OMe | 3-SO₂CF₃ | OMe | 4-SO₂CF₃ |
| OMe | 2-SCF₂H | OMe | 3-SCF₂H | OMe | 4-SCF₂H |
| OMe | 2-SOCF₂H | OMe | 3-SOCF₂H | OMe | 4-SOCF₂H |
| OMe | 2-SO₂CF₂H | OMe | 3-SO₂CF₂H | OMe | 4-SO₂CF₂H |
| CF₃ | 2-CF₃ | CF₃ | 3-CF₃ | CF₃ | 4-CF₃ |
| CF₃ | 2-OCF₃ | CF₃ | 3-OCF₃ | CF₃ | 4-OCF₃ |
| CF₃ | 2-OCF₂H | CF₃ | 3-OCF₂H | CF₃ | 4-OCF₂H |
| CF₃ | 2-OCF₂CF₂H | CF₃ | 3-OCF₂CF₂H | CF₃ | 4-OCF₂CF₂H |
| CF₃ | 2-OCH₂CF₃ | CF₃ | 3-OCH₂CF₃ | CF₃ | 4-OCH₂CF₃ |
| CF₃ | 2-SCF₃ | CF₃ | 3-SCF₃ | CF₃ | 4-SCF₃ |
| CF₃ | 2-SOCF₃ | CF₃ | 3-SOCF₃ | CF₃ | 4-SOCF₃ |
| CF₃ | 2-SO₂CF₃ | CF₃ | 3-SO₂CF₃ | CF₃ | 4-SO₂CF₃ |
| CF₃ | 2-SCF₂H | CF₃ | 3-SCF₂H | CF₃ | 4-SCF₂H |
| CF₃ | 2-SOCF₂H | CF₃ | 3-SOCF₂H | CF₃ | 4-SOCF₂H |
| CF₃ | 2-SO₂CF₂H | CF₃ | 3-SO₂CF₂H | CF₃ | 4-SO₂CF₂H |
| OCF₂H | 2-CF₃ | OCF₂H | 3-CF₃ | OCF₂H | 4-CF₃ |
| OCF₂H | 2-OCF₃ | OCF₂H | 3-OCF₃ | OCF₂H | 4-OCF₃ |
| OCF₂H | 2-OCF₂H | OCF₂H | 3-OCF₂H | OCF₂H | 4-OCF₂H |
| OCF₂H | 2-OCF₂CF₂H | OCF₂H | 3-OCF₂CF₂H | OCF₂H | 4-OCF₂CF₂H |
| OCF₂H | 2-OCH₂CF₃ | OCF₂H | 3-OCH₂CF₃ | OCF₂H | 4-OCH₂CF₃ |
| OCF₂H | 2-SCF₃ | OCF₂H | 3-SCF₃ | OCF₂H | 4-SCF₃ |
| OCF₂H | 2-SOCF₃ | OCF₂H | 3-SOCF₃ | OCF₂H | 4-SOCF₃ |
| OCF₂H | 2-SO₂CF₃ | OCF₂H | 3-SO₂CF₃ | OCF₂H | 4-SO₂CF₃ |
| OCF₂H | 2-SCF₂H | OCF₂H | 3-SCF₂H | OCF₂H | 4-SCF₂H |
| OCF₂H | 2-SOCF₂H | OCF₂H | 3-SOCF₂H | OCF₂H | 4-SOCF₂H |
| OCF₂H | 2-SO₂CF₂H | OCF₂H | 3-SO₂CF₂H | OCF₂H | 4-SO₂CF₂H |
| Me | 2-Me-4-CF₃ | F | 2-Me-4-CF₃ | Cl | 2-Me-4-CF₃ |
| Me | 2-Me-4-OCF₃ | F | 2-Me-4-OCF₃ | Cl | 2-Me-4-OCF₃ |
| Me | 2-Me-4-OCF₂H | F | 2-Me-4-OCF₂H | Cl | 2-Me-4-OCF₂H |
| Me | 2-Me-4-OCH₂CF₃ | F | 2-Me-4-OCH₂CF₃ | Cl | 2-Me-4-OCH₂CF₃ |
| Me | 2-Me-4-SCF₃ | F | 2-Me-4-SCF₃ | Cl | 2-Me-4-SCF₃ |
| Me | 2-Me-4-SOCF₃ | F | 2-Me-4-SOCF₃ | Cl | 2-Me-4-SOCF₃ |
| Me | 2-Me-4-SO₂CF₃ | F | 2-Me-4-SO₂CF₃ | Cl | 2-Me-4-SO₂CF₃ |
| Me | 2-Me-4-SCF₂H | F | 2-Me-4-SCF₂H | Cl | 2-Me-4-SCF₂H |
| Me | 2-Me-4-SOCF₂H | F | 2-Me-4-SOCF₂H | Cl | 2-Me-4-SOCF₂H |
| Me | 2-Me-4-SO₂CF₂H | F | 2-Me-4-SO₂CF₂H | Cl | 2-Me-4-SO₂CF₂H |
| Br | 2-Me-4-CF₃ | I | 2-Me-4-CF₃ | OMe | 2-Me-4-CF₃ |
| Br | 2-Me-4-OCF₃ | I | 2-Me-4-OCF₃ | OMe | 2-Me-4-OCF₃ |
| Br | 2-Me-4-OCF₂H | I | 2-Me-4-OCF₂H | OMe | 2-Me-4-OCF₂H |
| Br | 2-Me-4-OCH₂CF₃ | I | 2-Me-4-OCH₂CF₃ | OMe | 2-Me-4-OCH₂CF₃ |
| Br | 2-Me-4-SCF₃ | I | 2-Me-4-SCF₃ | OMe | 2-Me-4-SCF₃ |
| Br | 2-Me-4-SOCF₃ | I | 2-Me-4-SOCF₃ | OMe | 2-Me-4-SOCF₃ |
| Br | 2-Me-4-SO₂CF₃ | I | 2-Me-4-SO₂CF₃ | OMe | 2-Me-4-SO₂CF₃ |
| Br | 2-Me-4-SCF₂H | I | 2-Me-4-SCF₂H | OMe | 2-Me-4-SCF₂H |
| Br | 2-Me-4-SOCF₂H | I | 2-Me-4-SOCF₂H | OMe | 2-Me-4-SOCF₂H |
| Br | 2-Me-4-SO₂CF₂H | I | 2-Me-4-SO₂CF₂H | OMe | 2-Me-4-SO₂CF₂H |
| CF₃ | 2-Me-4-CF₃ | NO₂ | 2-Me-4-CF₃ | SMe | 2-Me-4-CF₃ |
| CF₃ | 2-Me-4-OCF₃ | NO₂ | 2-Me-4-OCF₃ | SMe | 2-Me-4-OCF₃ |
| CF₃ | 2-Me-4-OCF₂H | NO₂ | 2-Me-4-OCF₂H | SMe | 2-Me-4-OCF₂H |
| CF₃ | 2-Me-4-OCH₂CF₃ | NO₂ | 2-Me-4-OCH₂CF₃ | SMe | 2-Me-4-OCH₂CF₃ |
| CF₃ | 2-Me-4-SCF₃ | NO₂ | 2-Me-4-SCF₃ | SMe | 2-Me-4-SCF₃ |
| CF₃ | 2-Me-4-SOCF₃ | NO₂ | 2-Me-4-SOCF₃ | SMe | 2-Me-4-SOCF₃ |
| CF₃ | 2-Me-4-SO₂CF₃ | NO₂ | 2-Me-4-SO₂CF₃ | SMe | 2-Me-4-SO₂CF₃ |
| CF₃ | 2-Me-4-SCF₂H | NO₂ | 2-Me-4-SCF₂H | SMe | 2-Me-4-SCF₂H |
| CF₃ | 2-Me-4-SOCF₂H | NO₂ | 2-Me-4-SOCF₂H | SMe | 2-Me-4-SOCF₂H |
| CF₃ | 2-Me-4-SO₂CF₂H | NO₂ | 2-Me-4-SO₂CF₂H | SMe | 2-Me-4-SO₂CF₂H |

TABLE 31

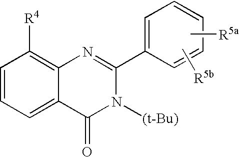

| R⁴ | R^{5a} and/or R^{5b} | R⁴ | R^{5a} and/or R^{5b} | R⁴ | R^{5a} and/or R^{5b} |
|---|---|---|---|---|---|
| Me | 2-CF₃ | Me | 3-CF₃ | Me | 4-CF₃ |
| Me | 2-OCF₃ | Me | 3-OCF₃ | Me | 4-OCF₃ |
| Me | 2-OCF₂H | Me | 3-OCF₂H | Me | 4-OCF₂H |
| Me | 2-OCF₂CF₂H | Me | 3-OCF₂CF₂H | Me | 4-OCF₂CF₂H |
| Me | 2-OCH₂CF₃ | Me | 3-OCH₂CF₃ | Me | 4-OCH₂CF₃ |
| Me | 2-SCF₃ | Me | 3-SCF₃ | Me | 4-SCF₃ |
| Me | 2-SOCF₃ | Me | 3-SOCF₃ | Me | 4-SOCF₃ |
| Me | 2-SO₂CF₃ | Me | 3-SO₂CF₃ | Me | 4-SO₂CF₃ |
| Me | 2-SCF₂H | Me | 3-SCF₂H | Me | 4-SCF₂H |
| Me | 2-SOCF₂H | Me | 3-SOCF₂H | Me | 4-SOCF₂H |
| Me | 2-SO₂CF₂H | Me | 3-SO₂CF₂H | Me | 4-SO₂CF₂H |
| Cl | 2-CF₃ | Cl | 3-CF₃ | Cl | 4-CF₃ |
| Cl | 2-OCF₃ | Cl | 3-OCF₃ | Cl | 4-OCF₃ |
| Cl | 2-OCF₂H | Cl | 3-OCF₂H | Cl | 4-OCF₂H |
| Cl | 2-OCF₂CF₂H | Cl | 3-OCF₂CF₂H | Cl | 4-OCF₂CF₂H |
| Cl | 2-OCH₂CF₃ | Cl | 3-OCH₂CF₃ | Cl | 4-OCH₂CF₃ |
| Cl | 2-SCF₃ | Cl | 3-SCF₃ | Cl | 4-SCF₃ |
| Cl | 2-SOCF₃ | Cl | 3-SOCF₃ | Cl | 4-SOCF₃ |
| Cl | 2-SO₂CF₃ | Cl | 3-SO₂CF₃ | Cl | 4-SO₂CF₃ |
| Cl | 2-SCF₂H | Cl | 3-SCF₂H | Cl | 4-SCF₂H |
| Cl | 2-SOCF₂H | Cl | 3-SOCF₂H | Cl | 4-SOCF₂H |
| Cl | 2-SO₂CF₂H | Cl | 3-SO₂CF₂H | Cl | 4-SO₂CF₂H |
| F | 2-CF₃ | F | 3-CF₃ | F | 4-CF₃ |
| F | 2-OCF₃ | F | 3-OCF₃ | F | 4-OCF₃ |
| F | 2-OCF₂H | F | 3-OCF₂H | F | 4-OCF₂H |
| F | 2-OCF₂CF₂H | F | 3-OCF₂CF₂H | F | 4-OCF₂CF₂H |
| F | 2-OCH₂CF₃ | F | 3-OCH₂CF₃ | F | 4-OCH₂CF₃ |
| F | 2-SCF₃ | F | 3-SCF₃ | F | 4-SCF₃ |
| F | 2-SOCF₃ | F | 3-SOCF₃ | F | 4-SOCF₃ |
| F | 2-SO₂CF₃ | F | 3-SO₂CF₃ | F | 4-SO₂CF₃ |
| F | 2-SCF₂H | F | 3-SCF₂H | F | 4-SCF₂H |
| F | 2-SOCF₂H | F | 3-SOCF₂H | F | 4-SOCF₂H |
| F | 2-SO₂CF₂H | F | 3-SO₂CF₂H | F | 4-SO₂CF₂H |
| Br | 2-CF₃ | Br | 3-CF₃ | Br | 4-CF₃ |
| Br | 2-OCF₃ | Br | 3-OCF₃ | Br | 4-OCF₃ |
| Br | 2-OCF₂H | Br | 3-OCF₂H | Br | 4-OCF₂H |
| Br | 2-OCF₂CF₂H | Br | 3-OCF₂CF₂H | Br | 4-OCF₂CF₂H |
| Br | 2-OCH₂CF₃ | Br | 3-OCH₂CF₃ | Br | 4-OCH₂CF₃ |
| Br | 2-SCF₃ | Br | 3-SCF₃ | Br | 4-SCF₃ |
| Br | 2-SOCF₃ | Br | 3-SOCF₃ | Br | 4-SOCF₃ |
| Br | 2-SO₂CF₃ | Br | 3-SO₂CF₃ | Br | 4-SO₂CF₃ |
| Br | 2-SCF₂H | Br | 3-SCF₂H | Br | 4-SCF₂H |
| Br | 2-SOCF₂H | Br | 3-SOCF₂H | Br | 4-SOCF₂H |
| Br | 2-SO₂CF₂H | Br | 3-SO₂CF₂H | Br | 4-SO₂CF₂H |
| I | 2-CF₃ | I | 3-CF₃ | I | 4-CF₃ |
| I | 2-OCF₃ | I | 3-OCF₃ | I | 4-OCF₃ |
| I | 2-OCF₂H | I | 3-OCF₂H | I | 4-OCF₂H |
| I | 2-OCF₂CF₂H | I | 3-OCF₂CF₂H | I | 4-OCF₂CF₂H |
| I | 2-OCH₂CF₃ | I | 3-OCH₂CF₃ | I | 4-OCH₂CF₃ |
| I | 2-SCF₃ | I | 3-SCF₃ | I | 4-SCF₃ |
| I | 2-SOCF₃ | I | 3-SOCF₃ | I | 4-SOCF₃ |
| I | 2-SO₂CF₃ | I | 3-SO₂CF₃ | I | 4-SO₂CF₃ |
| I | 2-SCF₂H | I | 3-SCF₂H | I | 4-SCF₂H |
| I | 2-SOCF₂H | I | 3-SOCF₂H | I | 4-SOCF₂H |
| I | 2-SO₂CF₂H | I | 3-SO₂CF₂H | I | 4-SO₂CF₂H |
| OMe | 2-CF₃ | OMe | 3-CF₃ | OMe | 4-CF₃ |
| OMe | 2-OCF₃ | OMe | 3-OCF₃ | OMe | 4-OCF₃ |
| OMe | 2-OCF₂H | OMe | 3-OCF₂H | OMe | 4-OCF₂H |
| OMe | 2-OCF₂CF₂H | OMe | 3-OCF₂CF₂H | OMe | 4-OCF₂CF₂H |
| OMe | 2-OCH₂CF₃ | OMe | 3-OCH₂CF₃ | OMe | 4-OCH₂CF₃ |
| OMe | 2-SCF₃ | OMe | 3-SCF₃ | OMe | 4-SCF₃ |
| OMe | 2-SOCF₃ | OMe | 3-SOCF₃ | OMe | 4-SOCF₃ |
| OMe | 2-SO₂CF₃ | OMe | 3-SO₂CF₃ | OMe | 4-SO₂CF₃ |
| OMe | 2-SCF₂H | OMe | 3-SCF₂H | OMe | 4-SCF₂H |
| OMe | 2-SOCF₂H | OMe | 3-SOCF₂H | OMe | 4-SOCF₂H |
| OMe | 2-SO₂CF₂H | OMe | 3-SO₂CF₂H | OMe | 4-SO₂CF₂H |
| CF₃ | 2-CF₃ | CF₃ | 2-CF₃ | CF₃ | 4-CF₃ |
| CF₃ | 2-OCF₃ | CF₃ | 2-OCF₃ | CF₃ | 4-OCF₃ |
| CF₃ | 2-OCF₂H | CF₃ | 2-OCF₂H | CF₃ | 4-OCF₂H |
| CF₃ | 2-OCF₂CF₂H | CF₃ | 2-OCF₂CF₂H | CF₃ | 4-OCF₂CF₂H |
| CF₃ | 2-OCH₂CF₃ | CF₃ | 2-OCH₂CF₃ | CF₃ | 4-OCH₂CF₃ |
| CF₃ | 2-SCF₃ | CF₃ | 2-SCF₃ | CF₃ | 4-SCF₃ |
| CF₃ | 2-SOCF₃ | CF₃ | 2-SOCF₃ | CF₃ | 4-SOCF₃ |
| CF₃ | 2-SO₂CF₃ | CF₃ | 2-SO₂CF₃ | CF₃ | 4-SO₂CF₃ |
| CF₃ | 2-SCF₂H | CF₃ | 2-SCF₂H | CF₃ | 4-SCF₂H |
| CF₃ | 2-SOCF₂H | CF₃ | 2-SOCF₂H | CF₃ | 4-SOCF₂H |
| CF₃ | 2-SO₂CF₂H | CF₃ | 2-SO₂CF₂H | CF₃ | 4-SO₂CF₂H |
| OCF₂H | 2-CF₃ | OCF₂H | 3-CF₃ | OCF₂H | 4-CF₃ |
| OCF₂H | 2-OCF₃ | OCF₂H | 3-OCF₃ | OCF₂H | 4-OCF₃ |
| OCF₂H | 2-OCF₂H | OCF₂H | 3-OCF₂H | OCF₂H | 4-OCF₂H |
| OCF₂H | 2-OCF₂CF₂H | OCF₂H | 3-OCF₂CF₂H | OCF₂H | 4-OCF₂CF₂H |
| OCF₂H | 2-OCH₂CF₃ | OCF₂H | 3-OCH₂CF₃ | OCF₂H | 4-OCH₂CF₃ |
| OCF₂H | 2-SCF₃ | OCF₂H | 3-SCF₃ | OCF₂H | 4-SCF₃ |
| OCF₂H | 2-SOCF₃ | OCF₂H | 3-SOCF₃ | OCF₂H | 4-SOCF₃ |
| OCF₂H | 2-SO₂CF₃ | OCF₂H | 3-SO₂CF₃ | OCF₂H | 4-SO₂CF₃ |
| OCF₂H | 2-SCF₂H | OCF₂H | 3-SCF₂H | OCF₂H | 4-SCF₂H |
| OCF₂H | 2-SOCF₂H | OCF₂H | 3-SOCF₂H | OCF₂H | 4-SOCF₂H |
| OCF₂H | 2-SO₂CF₂H | OCF₂H | 3-SO₂CF₂H | OCF₂H | 4-SO₂CF₂H |
| Me | 2-Me-4-CF₃ | F | 2-Me-4-CF₃ | Cl | 2-Me-4-CF₃ |
| Me | 2-Me-4-OCF₃ | F | 2-Me-4-OCF₃ | Cl | 2-Me-4-OCF₃ |
| Me | 2-Me-4-OCF₂H | F | 2-Me-4-OCF₂H | Cl | 2-Me-4-OCF₂H |
| Me | 2-Me-4-OCH₂CF₃ | F | 2-Me-4-OCH₂CF₃ | Cl | 2-Me-4-OCH₂CF₃ |
| Me | 2-Me-4-SCF₃ | F | 2-Me-4-SCF₃ | Cl | 2-Me-4-SCF₃ |
| Me | 2-Me-4-SOCF₃ | F | 2-Me-4-SOCF₃ | Cl | 2-Me-4-SOCF₃ |
| Me | 2-Me-4-SO₂CF₃ | F | 2-Me-4-SO₂CF₃ | Cl | 2-Me-4-SO₂CF₃ |
| Me | 2-Me-4-SCF₂H | F | 2-Me-4-SCF₂H | Cl | 2-Me-4-SCF₂H |
| Me | 2-Me-4-SOCF₂H | F | 2-Me-4-SOCF₂H | Cl | 2-Me-4-SOCF₂H |
| Me | 2-Me-4-SO₂CF₂H | F | 2-Me-4-SO₂CF₂H | Cl | 2-Me-4-SO₂CF₂H |
| Br | 2-Me-4-CF₃ | I | 2-Me-4-CF₃ | OMe | 2-Me-4-CF₃ |
| Br | 2-Me-4-OCF₃ | I | 2-Me-4-OCF₃ | OMe | 2-Me-4-OCF₃ |
| Br | 2-Me-4-OCF₂H | I | 2-Me-4-OCF₂H | OMe | 2-Me-4-OCF₂H |
| Br | 2-Me-4-OCH₂CF₃ | I | 2-Me-4-OCH₂CF₃ | OMe | 2-Me-4-OCH₂CF₃ |
| Br | 2-Me-4-SCF₃ | I | 2-Me-4-SCF₃ | OMe | 2-Me-4-SCF₃ |
| Br | 2-Me-4-SOCF₃ | I | 2-Me-4-SOCF₃ | OMe | 2-Me-4-SOCF₃ |
| Br | 2-Me-4-SO₂CF₃ | I | 2-Me-4-SO₂CF₃ | OMe | 2-Me-4-SO₂CF₃ |
| Br | 2-Me-4-SCF₂H | I | 2-Me-4-SCF₂H | OMe | 2-Me-4-SCF₂H |
| Br | 2-Me-4-SOCF₂H | I | 2-Me-4-SOCF₂H | OMe | 2-Me-4-SOCF₂H |
| Br | 2-Me-4-SO₂CF₂H | I | 2-Me-4-SO₂CF₂H | OMe | 2-Me-4-SO₂CF₂H |
| CF₃ | 2-Me-4-CF₃ | NO₂ | 2-Me-4-CF₃ | SMe | 2-Me-4-CF₃ |
| CF₃ | 2-Me-4-OCF₃ | NO₂ | 2-Me-4-OCF₃ | SMe | 2-Me-4-OCF₃ |
| CF₃ | 2-Me-4-OCF₂H | NO₂ | 2-Me-4-OCF₂H | SMe | 2-Me-4-OCF₂H |
| CF₃ | 2-Me-4-OCH₂CF₃ | NO₂ | 2-Me-4-OCH₂CF₃ | SMe | 2-Me-4-OCH₂CF₃ |
| CF₃ | 2-Me-4-SCF₃ | NO₂ | 2-Me-4-SCF₃ | SMe | 2-Me-4-SCF₃ |
| CF₃ | 2-Me-4-SOCF₃ | NO₂ | 2-Me-4-SOCF₃ | SMe | 2-Me-4-SOCF₃ |
| CF₃ | 2-Me-4-SO₂CF₃ | NO₂ | 2-Me-4-SO₂CF₃ | SMe | 2-Me-4-SO₂CF₃ |
| CF₃ | 2-Me-4-SCF₂H | NO₂ | 2-Me-4-SCF₂H | SMe | 2-Me-4-SCF₂H |
| CF₃ | 2-Me-4-SOCF₂H | NO₂ | 2-Me-4-SOCF₂H | SMe | 2-Me-4-SOCF₂H |
| CF₃ | 2-Me-4-SO₂CF₂H | NO₂ | 2-Me-4-SO₂CF₂H | SMe | 2-Me-4-SO₂CF₂H |

TABLE 32

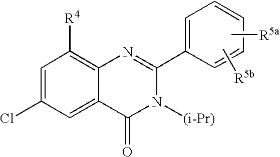

| R⁴ | R^{5a} and/or 5^{5b} | R⁴ | R^{5a} and/or 5^{5b} | R⁴ | R^{5a} and/or 5^{5b} |
|---|---|---|---|---|---|
| Me | 2-CF₃ | Me | 3-CF₃ | Me | 4-CF₃ |
| Me | 2-OCF₃ | Me | 3-OCF₃ | Me | 4-OCF₃ |
| Me | 2-OCF₂H | Me | 3-OCF₂H | Me | 4-OCF₂H |
| Me | 2-OCF₂CF₂H | Me | 3-OCF₂CF₂H | Me | 4-OCF₂CF₂H |
| Me | 2-OCH₂CF₃ | Me | 3-OCH₂CF₃ | Me | 4-OCH₂CF₃ |
| Me | 2-SCF₃ | Me | 3-SCF₃ | Me | 4-SCF₃ |
| Me | 2-SOCF₃ | Me | 3-SOCF₃ | Me | 4-SOCF₃ |
| Me | 2-SO₂CF₃ | Me | 3-SO₂CF₃ | Me | 4-SO₂CF₃ |
| Me | 2-SCF₂H | Me | 3-SCF₂H | Me | 4-SCF₂H |
| Me | 2-SOCF₂H | Me | 3-SOCF₂H | Me | 4-SOCF₂H |
| Me | 2-SO₂CF₂H | Me | 3-SO₂CF₂H | Me | 4-SO₂CF₂H |
| Cl | 2-CF₃ | Cl | 3-CF₃ | Cl | 4-CF₃ |
| Cl | 2-OCF₃ | Cl | 3-OCF₃ | Cl | 4-OCF₃ |
| Cl | 2-OCF₂H | Cl | 3-OCF₂H | Cl | 4-OCF₂H |
| Cl | 2-OCF₂CF₂H | Cl | 3-OCF₂CF₂H | Cl | 4-OCF₂CF₂H |
| Cl | 2-OCH₂CF₃ | Cl | 3-OCH₂CF₃ | Cl | 4-OCH₂CF₃ |
| Cl | 2-SCF₃ | Cl | 3-SCF₃ | Cl | 4-SCF₃ |
| Cl | 2-SOCF₃ | Cl | 3-SOCF₃ | Cl | 4-SOCF₃ |
| Cl | 2-SO₂CF₃ | Cl | 3-SO₂CF₃ | Cl | 4-SO₂CF₃ |
| Cl | 2-SCF₂H | Cl | 3-SCF₂H | Cl | 4-SCF₂H |
| Cl | 2-SOCF₂H | Cl | 3-SOCF₂H | Cl | 4-SOCF₂H |
| Cl | 2-SO₂CF₂H | Cl | 3-SO₂CF₂H | Cl | 4-SO₂CF₂H |
| F | 2-CF₃ | F | 3-CF₃ | F | 4-CF₃ |
| F | 2-OCF₃ | F | 3-OCF₃ | F | 4-OCF₃ |
| F | 2-OCF₂H | F | 3-OCF₂H | F | 4-OCF₂H |
| F | 2-OCF₂CF₂H | F | 3-OCF₂CF₂H | F | 4-OCF₂CF₂H |
| F | 2-OCH₂CF₃ | F | 3-OCH₂CF₃ | F | 4-OCH₂CF₃ |
| F | 2-SCF₃ | F | 3-SCF₃ | F | 4-SCF₃ |
| F | 2-SOCF₃ | F | 3-SOCF₃ | F | 4-SOCF₃ |
| F | 2-SO₂CF₃ | F | 3-SO₂CF₃ | F | 4-SO₂CF₃ |
| F | 2-SCF₂H | F | 3-SCF₂H | F | 4-SCF₂H |
| F | 2-SOCF₂H | F | 3-SOCF₂H | F | 4-SOCF₂H |
| F | 2-SO₂CF₂H | F | 3-SO₂CF₂H | F | 4-SO₂CF₂H |
| Br | 2-CF₃ | Br | 3-CF₃ | Br | 4-CF₃ |
| Br | 2-OCF₃ | Br | 3-OCF₃ | Br | 4-OCF₃ |
| Br | 2-OCF₂H | Br | 3-OCF₂H | Br | 4-OCF₂H |
| Br | 2-OCF₂CF₂H | Br | 3-OCF₂CF₂H | Br | 4-OCF₂CF₂H |
| Br | 2-OCH₂CF₃ | Br | 3-OCH₂CF₃ | Br | 4-OCH₂CF₃ |
| Br | 2-SCF₃ | Br | 3-SCF₃ | Br | 4-SCF₃ |
| Br | 2-SOCF₃ | Br | 3-SOCF₃ | Br | 4-SOCF₃ |
| Br | 2-SO₂CF₃ | Br | 3-SO₂CF₃ | Br | 4-SO₂CF₃ |
| Br | 2-SCF₂H | Br | 3-SCF₂H | Br | 4-SCF₂H |
| Br | 2-SOCF₂H | Br | 3-SOCF₂H | Br | 4-SOCF₂H |
| Br | 2-SO₂CF₂H | Br | 3-SO₂CF₂H | Br | 4-SO₂CF₂H |
| I | 2-CF₃ | I | 3-CF₃ | I | 4-CF₃ |
| I | 2-OCF₃ | I | 3-OCF₃ | I | 4-OCF₃ |
| I | 2-OCF₂H | I | 3-OCF₂H | I | 4-OCF₂H |
| I | 2-OCF₂CF₂H | I | 3-OCF₂CF₂H | I | 4-OCF₂CF₂H |
| I | 2-OCH₂CF₃ | I | 3-OCH₂CF₃ | I | 4-OCH₂CF₃ |
| I | 2-SCF₃ | I | 3-SCF₃ | I | 4-SCF₃ |
| I | 2-SOCF₃ | I | 3-SOCF₃ | I | 4-SOCF₃ |
| I | 2-SO₂CF₃ | I | 3-SO₂CF₃ | I | 4-SO₂CF₃ |
| I | 2-SCF₂H | I | 3-SCF₂H | I | 4-SCF₂H |
| I | 2-SOCF₂H | I | 3-SOCF₂H | I | 4-SOCF₂H |
| I | 2-SO₂CF₂H | I | 3-SO₂CF₂H | I | 4-SO₂CF₂H |
| OMe | 2-CF₃ | OMe | 3-CF₃ | OMe | 4-CF₃ |
| OMe | 2-OCF₃ | OMe | 3-OCF₃ | OMe | 4-OCF₃ |
| OMe | 2-OCF₂H | OMe | 3-OCF₂H | OMe | 4-OCF₂H |
| OMe | 2-OCF₂CF₂H | OMe | 3-OCF₂CF₂H | OMe | 4-OCF₂CF₂H |
| OMe | 2-OCH₂CF₃ | OMe | 3-OCH₂CF₃ | OMe | 4-OCH₂CF₃ |
| OMe | 2-SCF₃ | OMe | 3-SCF₃ | OMe | 4-SCF₃ |
| OMe | 2-SOCF₃ | OMe | 3-SOCF₃ | OMe | 4-SOCF₃ |
| OMe | 2-SO₂CF₃ | OMe | 3-SO₂CF₃ | OMe | 4-SO₂CF₃ |
| OMe | 2-SCF₂H | OMe | 3-SCF₂H | OMe | 4-SCF₂H |
| OMe | 2-SOCF₂H | OMe | 3-SOCF₂H | OMe | 4-SOCF₂H |
| OMe | 2-SO₂CF₂H | OMe | 3-SO₂CF₂H | OMe | 4-SO₂CF₂H |
| CF₃ | 2-CF₃ | CF₃ | 3-CF₃ | CF₃ | 4-CF₃ |
| CF₃ | 2-OCF₃ | CF₃ | 3-OCF₃ | CF₃ | 4-OCF₃ |
| CF₃ | 2-OCF₂H | CF₃ | 3-OCF₂H | CF₃ | 4-OCF₂H |
| CF₃ | 2-OCF₂CF₂H | CF₃ | 3-OCF₂CF₂H | CF₃ | 4-OCF₂CF₂H |
| CF₃ | 2-OCH₂CF₃ | CF₃ | 3-OCH₂CF₃ | CF₃ | 4-OCH₂CF₃ |
| CF₃ | 2-SCF₃ | CF₃ | 3-SCF₃ | CF₃ | 4-SCF₃ |
| CF₃ | 2-SOCF₃ | CF₃ | 3-SOCF₃ | CF₃ | 4-SOCF₃ |
| CF₃ | 2-SO₂CF₃ | CF₃ | 3-SO₂CF₃ | CF₃ | 4-SO₂CF₃ |
| CF₃ | 2-SCF₂H | CF₃ | 3-SCF₂H | CF₃ | 4-SCF₂H |
| CF₃ | 2-SOCF₂H | CF₃ | 3-SOCF₂H | CF₃ | 4-SOCF₂H |
| CF₃ | 2-SO₂CF₂H | CF₃ | 3-SO₂CF₂H | CF₃ | 4-SO₂CF₂H |
| OCF₂H | 2-CF₃ | OCF₂H | 3-CF₃ | OCF₂H | 4-CF₃ |
| OCF₂H | 2-OCF₃ | OCF₂H | 3-OCF₃ | OCF₂H | 4-OCF₃ |
| OCF₂H | 2-OCF₂H | OCF₂H | 3-OCF₂H | OCF₂H | 4-OCF₂H |
| OCF₂H | 2-OCF₂CF₂H | OCF₂H | 3-OCF₂CF₂H | OCF₂H | 4-OCF₂CF₂H |
| OCF₂H | 2-OCH₂CF₃ | OCF₂H | 3-OCH₂CF₃ | QCF₂H | 4-OCH₂CF₃ |
| OCF₂H | 2-SCF₃ | OCF₂H | 3-SCF₃ | OCF₂H | 4-SCF₃ |
| OCF₂H | 2-SOCF₃ | OCF₂H | 3-SOCF₃ | OCF₂H | 4-SOCF₃ |
| OCF₂H | 2-SO₂CF₃ | OCF₂H | 3-SO₂CF₃ | OCF₂H | 4-SO₂CF₃ |
| OCF₂H | 2-SCF₂H | OCF₂H | 3-SCF₂H | OCF₂H | 4-SCF₂H |
| OCF₂H | 2-SOCF₂H | OCF₂H | 3-SOCF₂H | OCF₂H | 4-SOCF₂H |
| OCF₂H | 2-SO₂CF₂H | OCF₂H | 3-SO₂CF₂H | OCF₂H | 4-SO₂CF₂H |
| Me | 2-Me-4-CF₃ | F | 2-Me-4-CF₃ | Cl | 2-Me-4-CF₃ |
| Me | 2-Me-4-OCF₃ | F | 2-Me-4-OCF₃ | Cl | 2-Me-4-OCF₃ |
| Me | 2-Me-4-OCF₂H | F | 2-Me-4-OCF₂H | Cl | 2-Me-4-OCF₂H |
| Me | 2-Me-4-OCH₂CF₃ | F | 2-Me-4-OCH₂CF₃ | Cl | 2-Me-4-OCH₂CF₃ |
| Me | 2-Me-4-SCF₃ | F | 2-Me-4-SCF₃ | Cl | 2-Me-4-SCF₃ |
| Me | 2-Me-4-SOCF₃ | F | 2-Me-4-SOCF₃ | Cl | 2-Me-4-SOCF₃ |
| Me | 2-Me-4-SO₂CF₃ | F | 2-Me-4-SO₂CF₃ | Cl | 2-Me-4-SO₂CF₃ |
| Me | 2-Me-4-SCF₂H | F | 2-Me-4-SCF₂H | Cl | 2-Me-4-SCF₂H |
| Me | 2-Me-4-SOCF₂H | F | 2-Me-4-SOCF₂H | Cl | 2-Me-4-SOCF₂H |
| Me | 2-Me-4-SO₂CF₂H | F | 2-Me-4-SO₂CF₂H | Cl | 2-Me-4-SO₂CF₂H |
| Br | 2-Me-4-CF₃ | I | 2-Me-4-CF₃ | OMe | 2-Me-4-CF₃ |
| Br | 2-Me-4-OCF₃ | I | 2-Me-4-OCF₃ | OMe | 2-Me-4-OCF₃ |
| Br | 2-Me-4-OCF₂H | I | 2-Me-4-OCF₂H | OMe | 2-Me-4-OCF₂H |
| Br | 2-Me-4-OCH₂CF₃ | I | 2-Me-4-OCH₂CF₃ | OMe | 2-Me-4-OCH₂CF₃ |
| Br | 2-Me-4-SCF₃ | I | 2-Me-4-SCF₃ | OMe | 2-Me-4-SCF₃ |
| Br | 2-Me-4-SOCF₃ | I | 2-Me-4-SOCF₃ | OMe | 2-Me-4-SOCF₃ |
| Br | 2-Me-4-SO₂CF₃ | I | 2-Me-4-SO₂CF₃ | OMe | 2-Me-4-SO₂CF₃ |
| Br | 2-Me-4-SCF₂H | I | 2-Me-4-SCF₂H | OMe | 2-Me-4-SCF₂H |
| Br | 2-Me-4-SOCF₂H | I | 2-Me-4-SOCF₂H | OMe | 2-Me-4-SOCF₂H |
| Br | 2-Me-4-SO₂CF₂H | I | 2-Me-4-SO₂CF₂H | OMe | 2-Me-4-SO₂CF₂H |
| CF₃ | 2-Me-4-CF₃ | NO₂ | 2-Me-4-CF₃ | SMe | 2-Me-4-CF₃ |
| CF₃ | 2-Me-4-OCF₃ | NO₂ | 2-Me-4-OCF₃ | SMe | 2-Me-4-OCF₃ |
| CF₃ | 2-Me-4-OCF₂H | NO₂ | 2-Me-4-OCF₂H | SMe | 2-Me-4-OCF₂H |
| CF₃ | 2-Me-4-OCH₂CF₃ | NO₂ | 2-Me-4-OCH₂CF₃ | SMe | 2-Me-4-OCH₂CF₃ |
| CF₃ | 2-Me-4-SCF₃ | NO₂ | 2-Me-4-SCF₃ | SMe | 2-Me-4-SCF₃ |
| CF₃ | 2-Me-4-SOCF₃ | NO₂ | 2-Me-4-SOCF₃ | SMe | 2-Me-4-SOCF₃ |
| CF₃ | 2-Me-4-SO₂CF₃ | NO₂ | 2-Me-4-SO₂CF₃ | SMe | 2-Me-4-SO₂CF₃ |
| CF₃ | 2-Me-4-SCF₂H | NO₂ | 2-Me-4-SCF₂H | SMe | 2-Me-4-SCF₂H |
| CF₃ | 2-Me-4-SOCF₂H | NO₂ | 2-Me-4-SOCF₂H | SMe | 2-Me-4-SOCF₂H |
| CF₃ | 2-Me-4-SO₂CF₂H | NO₂ | 2-Me-4-SO₂CF₂H | SMe | 2-Me-4-SO₂CF₂H |

TABLE 33

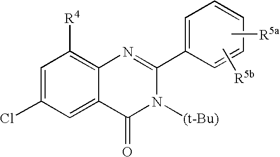

| R⁴ | R^{5a} and/or R^{5b} | R⁴ | R^{5a} and/or R^{5b} | R⁴ | R^{5a} and/or R^{5b} |
|---|---|---|---|---|---|
| Me | 2-CF₃ | Me | 3-CF₃ | Me | 4-CF₃ |
| Me | 2-OCF₃ | Me | 3-OCF₃ | Me | 4-OCF₃ |
| Me | 2-OCF₂H | Me | 3-OCF₂H | Me | 4-OCF₂H |
| Me | 2-OCF₂CF₂H | Me | 3-OCF₂CF₂H | Me | 4-OCF₂CF₂H |
| Me | 2-OCH₂CF₃ | Me | 3-OCH₂CF₃ | Me | 4-OCH₂CF₃ |
| Me | 2-SCF₃ | Me | 3-SCF₃ | Me | 4-SCF₃ |
| Me | 2-SOCF₃ | Me | 3-SOCF₃ | Me | 4-SOCF₃ |
| Me | 2-SO₂CF₃ | Me | 3-SO₂CF₃ | Me | 4-SO₂CF₃ |
| Me | 2-SCF₂H | Me | 3-SCF₂H | Me | 4-SCF₂H |
| Me | 2-SOCF₂H | Me | 3-SOCF₂H | Me | 4-SOCF₂H |
| Me | 2-SO₂CF₂H | Me | 3-SO₂CF₂H | Me | 4-SO₂CF₂H |
| Cl | 2-CF₃ | Cl | 3-CF₃ | Cl | 4-CF₃ |
| Cl | 2-OCF₃ | Cl | 3-OCF₃ | Cl | 4-OCF₃ |
| Cl | 2-OCF₂H | Cl | 3-OCF₂H | Cl | 4-OCF₂H |
| Cl | 2-OCF₂CF₂H | Cl | 3-OCF₂CF₂H | Cl | 4-OCF₂CF₂H |
| Cl | 2-OCH₂CF₃ | Cl | 3-OCH₂CF₃ | Cl | 4-OCH₂CF₃ |
| Cl | 2-SCF₃ | Cl | 3-SCF₃ | Cl | 4-SCF₃ |
| Cl | 2-SOCF₃ | Cl | 3-SOCF₃ | Cl | 4-SOCF₃ |
| Cl | 2-SO₂CF₃ | Cl | 3-SO₂CF₃ | Cl | 4-SO₂CF₃ |
| Cl | 2-SCF₂H | Cl | 3-SCF₂H | Cl | 4-SCF₂H |
| Cl | 2-SOCF₂H | Cl | 3-SOCF₂H | Cl | 4-SOCF₂H |
| Cl | 2-SO₂CF₂H | Cl | 3-SO₂CF₂H | Cl | 4-SO₂CF₂H |
| F | 2-CF₃ | F | 3-CF₃ | F | 4-CF₃ |
| F | 2-OCF₃ | F | 3-OCF₃ | F | 4-OCF₃ |
| F | 2-OCF₂H | F | 3-OCF₂H | F | 4-OCF₂H |
| F | 2-OCF₂CF₂H | F | 3-OCF₂CF₂H | F | 4-OCF₂CF₂H |
| F | 2-OCH₂CF₃ | F | 3-OCH₂CF₃ | F | 4-OCH₂CF₃ |
| F | 2-SCF₃ | F | 3-SCF₃ | F | 4-SCF₃ |
| F | 2-SOCF₃ | F | 3-SOCF₃ | F | 4-SOCF₃ |
| F | 2-SO₂CF₃ | F | 3-SO₂CF₃ | F | 4-SO₂CF₃ |
| F | 2-SCF₂H | F | 3-SCF₂H | F | 4-SCF₂H |
| F | 2-SOCF₂H | F | 3-SOCF₂H | F | 4-SOCF₂H |
| F | 2-SO₂CF₂H | F | 3-SO₂CF₂H | F | 4-SO₂CF₂H |
| Br | 2-CF₃ | Br | 3-CF₃ | Br | 4-CF₃ |
| Br | 2-OCF₃ | Br | 3-OCF₃ | Br | 4-OCF₃ |
| Br | 2-OCF₂H | Br | 3-OCF₂H | Br | 4-OCF₂H |
| Br | 2-OCF₂CF₂H | Br | 3-OCF₂CF₂H | Br | 4-OCF₂CF₂H |
| Br | 2-OCH₂CF₃ | Br | 3-OCH₂CF₃ | Br | 4-OCH₂CF₃ |
| Br | 2-SCF₃ | Br | 3-SCF₃ | Br | 4-SCF₃ |
| Br | 2-SOCF₃ | Br | 3-SOCF₃ | Br | 4-SOCF₃ |
| Br | 2-SO₂CF₃ | Br | 3-SO₂CF₃ | Br | 4-SO₂CF₃ |
| Br | 2-SCF₂H | Br | 3-SCF₂H | Br | 4-SCF₂H |
| Br | 2-SOCF₂H | Br | 3-SOCF₂H | Br | 4-SOCF₂H |
| Br | 2-SO₂CF₂H | Br | 3-SO₂CF₂H | Br | 4-SO₂CF₂H |
| I | 2-CF₃ | I | 3-CF₃ | I | 4-CF₃ |
| I | 2-OCF₃ | I | 3-OCF₃ | I | 4-OCF₃ |
| I | 2-OCF₂H | I | 3-OCF₂H | I | 4-OCF₂H |
| I | 2-OCF₂CF₂H | I | 3-OCF₂CF₂H | I | 4-OCF₂CF₂H |
| I | 2-OCH₂CF₃ | I | 3-OCH₂CF₃ | I | 4-OCH₂CF₃ |
| I | 2-SCF₃ | I | 3-SCF₃ | I | 4-SCF₃ |
| I | 2-SOCF₃ | I | 3-SOCF₃ | I | 4-SOCF₃ |
| I | 2-SO₂CF₃ | I | 3-SO₂CF₃ | I | 4-SO₂CF₃ |
| I | 2-SCF₂H | I | 3-SCF₂H | I | 4-SCF₂H |
| I | 2-SOCF₂H | I | 3-SOCF₂H | I | 4-SOCF₂H |
| I | 2-SO₂CF₂H | I | 3-SO₂CF₂H | I | 4-SO₂CF₂H |
| OMe | 2-CF₃ | OMe | 3-CF₃ | OMe | 4-CF₃ |
| OMe | 2-OCF₃ | OMe | 3-OCF₃ | OMe | 4-OCF₃ |
| OMe | 2-OCF₂H | OMe | 3-OCF₂H | OMe | 4-OCF₂H |
| OMe | 2-OCF₂CF₂H | OMe | 3-OCF₂CF₂H | OMe | 4-OCF₂CF₂H |
| OMe | 2-OCH₂CF₃ | OMe | 3-OCH₂CF₃ | OMe | 4-OCH₂CF₃ |
| OMe | 2-SCF₃ | OMe | 3-SCF₃ | OMe | 4-SCF₃ |
| OMe | 2-SOCF₃ | OMe | 3-SOCF₃ | OMe | 4-SOCF₃ |
| OMe | 2-SO₂CF₃ | OMe | 3-SO₂CF₃ | OMe | 4-SO₂CF₃ |
| OMe | 2-SCF₂H | OMe | 3-SCF₂H | OMe | 4-SCF₂H |
| OMe | 2-SOCF₂H | OMe | 3-SOCF₂H | OMe | 4-SOCF₂H |
| OMe | 2-SO₂CF₂H | OMe | 3-SO₂CF₂H | OMe | 4-SO₂CF₂H |
| CF₃ | 2-CF₃ | CF₃ | 3-CF₃ | CF₃ | 4-CF₃ |
| CF₃ | 2-OCF₃ | CF₃ | 3-OCF₃ | CF₃ | 4-OCF₃ |
| CF₃ | 2-OCF₂H | CF₃ | 3-OCF₂H | CF₃ | 4-OCF₂H |
| CF₃ | 2-OCF₂CF₂H | CF₃ | 3-OCF₂CF₂H | CF₃ | 4-OCF₂CF₂H |
| CF₃ | 2-OCH₂CF₃ | CF₃ | 3-OCH₂CF₃ | CF₃ | 4-OCH₂CF₃ |
| CF₃ | 2-SCF₃ | CF₃ | 3-SCF₃ | CF₃ | 4-SCF₃ |
| CF₃ | 2-SOCF₃ | CF₃ | 3-SOCF₃ | CF₃ | 4-SOCF₃ |
| CF₃ | 2-SO₂CF₃ | CF₃ | 3-SO₂CF₃ | CF₃ | 4-SO₂CF₃ |
| CF₃ | 2-SCF₂H | CF₃ | 3-SCF₂H | CF₃ | 4-SCF₂H |
| CF₃ | 2-SOCF₂H | CF₃ | 3-SOCF₂H | CF₃ | 4-SOCF₂H |
| CF₃ | 2-SO₂CF₂H | CF₃ | 3-SO₂CF₂H | CF₃ | 4-SO₂CF₂H |
| OCF₂H | 2-CF₃ | OCF₂H | 3-CF₃ | OCF₂H | 4-CF₃ |
| OCF₂H | 2-OCF₃ | OCF₂H | 3-OCF₃ | OCF₂H | 4-OCF₃ |
| OCF₂H | 2-OCF₂H | OCF₂H | 3-OCF₂H | OCF₂H | 4-OCF₂H |
| QCF₂H | 2-OCF₂CF₂H | OCF₂H | 3-OCF₂CF₂H | OCF₂H | 4-OCF₂CF₂H |
| OCF₂H | 2-OCH₂CF₃ | OCF₂H | 3-OCH₂CF₃ | OCF₂H | 4-OCH₂CF₃ |
| OCF₂H | 2-SCF₃ | OCF₂H | 3-SCF₃ | OCF₂H | 4-SCF₃ |
| OCF₂H | 2-SOCF₃ | OCF₂H | 3-SOCF₃ | OCF₂H | 4-SOCF₃ |
| OCF₂H | 2-SO₂CF₃ | OCF₂H | 3-SO₂CF₃ | OCF₂H | 4-SO₂CF₃ |
| OCF₂H | 2-SCF₂H | OCF₂H | 3-SCF₂H | OCF₂H | 4-SCF₂H |
| OCF₂H | 2-SOCF₂H | OCF₂H | 3-SOCF₂H | OCF₂H | 4-SOCF₂H |
| OCF₂H | 2-SO₂CF₂H | OCF₂H | 3-SO₂CF₂H | OCF₂H | 4-SO₂CF₂H |
| Me | 2-Me-4-CF₃ | F | 2-Me-4-CF₃ | Cl | 2-Me-4-CF₃ |
| Me | 2-Me-4-OCF₃ | F | 2-Me-4-OCF₃ | Cl | 2-Me-4-OCF₃ |
| Me | 2-Me-4-OCF₂H | F | 2-Me-4-OCF₂H | Cl | 2-Me-4-OCF₂H |
| Me | 2-Me-4-OCH₂CF₃ | F | 2-Me-4-OCH₂CF₃ | Cl | 2-Me-4-OCH₂CF₃ |
| Me | 2-Me-4-SCF₃ | F | 2-Me-4-SCF₃ | Cl | 2-Me-4-SCF₃ |
| Me | 2-Me-4-SOCF₃ | F | 2-Me-4-SOCF₃ | Cl | 2-Me-4-SOCF₃ |
| Me | 2-Me-4-SO₂CF₃ | F | 2-Me-4-SO₂CF₃ | Cl | 2-Me-4-SO₂CF₃ |
| Me | 2-Me-4-SCF₂H | F | 2-Me-4-SCF₂H | Cl | 2-Me-4-SCF₂H |
| Me | 2-Me-4-SOCF₂H | F | 2-Me-4-SOCF₂H | Cl | 2-Me-4-SOCF₂H |
| Me | 2-Me-4-SO₂CF₂H | F | 2-Me-4-SO₂CF₂H | Cl | 2-Me-4-SO₂CF₂H |
| Br | 2-Me-4-CF₃ | I | 2-Me-4-CF₃ | OMe | 2-Me-4-CF₃ |
| Br | 2-Me-4-OCF₃ | I | 2-Me-4-OCF₃ | OMe | 2-Me-4-OCF₃ |
| Br | 2-Me-4-OCF₂H | I | 2-Me-4-OCF₂H | OMe | 2-Me-4-OCF₂H |
| Br | 2-Me-4-OCH₂CF₃ | I | 2-Me-4-OCH₂CF₃ | OMe | 2-Me-4-OCH₂CF₃ |
| Br | 2-Me-4-SCF₃ | I | 2-Me-4-SCF₃ | OMe | 2-Me-4-SCF₃ |
| Br | 2-Me-4-SOCF₃ | I | 2-Me-4-SOCF₃ | OMe | 2-Me-4-SOCF₃ |
| Br | 2-Me-4-SO₂CF₃ | I | 2-Me-4-SO₂CF₃ | OMe | 2-Me-4-SO₂CF₃ |
| Br | 2-Me-4-SCF₂H | I | 2-Me-4-SCF₂H | OMe | 2-Me-4-SCF₂H |
| Br | 2-Me-4-SOCF₂H | I | 2-Me-4-SOCF₂H | OMe | 2-Me-4-SOCF₂H |
| Br | 2-Me-4-SO₂CF₂H | I | 2-Me-4-SO₂CF₂H | OMe | 2-Me-4-SO₂CF₂H |
| CF₃ | 2-Me-4-CF₃ | NO₂ | 2-Me-4-CF₃ | SMe | 2-Me-4-CF₃ |
| CF₃ | 2-Me-4-OCF₃ | NO₂ | 2-Me-4-OCF₃ | SMe | 2-Me-4-OCF₃ |
| CF₃ | 2-Me-4-OCF₂H | NO₂ | 2-Me-4-OCF₂H | SMe | 2-Me-4-OCF₂H |
| CF₃ | 2-Me-4-OCH₂CF₃ | NO₂ | 2-Me-4-OCH₂CF₃ | SMe | 2-Me-4-OCH₂CF₃ |
| CF₃ | 2-Me-4-SCF₃ | NO₂ | 2-Me-4-SCF₃ | SMe | 2-Me-4-SCF₃ |
| CF₃ | 2-Me-4-SOCF₃ | NO₂ | 2-Me-4-SOCF₃ | SMe | 2-Me-4-SOCF₃ |
| CF₃ | 2-Me-4-SO₂CF₃ | NO₂ | 2-Me-4-SO₂CF₃ | SMe | 2-Me-4-SO₂CF₃ |
| CF₃ | 2-Me-4-SCF₂H | NO₂ | 2-Me-4-SCF₂H | SMe | 2-Me-4-SCF₂H |
| CF₃ | 2-Me-4-SOCF₂H | NO₂ | 2-Me-4-SOCF₂H | SMe | 2-Me-4-SOCF₂H |
| CF₃ | 2-Me-4-SO₂CF₂H | NO₂ | 2-Me-4-SO₂CF₂H | SMe | 2-Me-4-SO₂CF₂H |

Formulation/Utility

Compounds of this invention will generally be used as a formulation or composition with an agriculturally suitable carrier comprising at least one of a liquid diluent, a solid diluent or a surfactant. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. Active ingredient can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically contain effective amounts of active ingredient, diluent and surfactant within the following approximate ranges that add up to 100 percent by weight.

| | Weight Percent | | |
|---|---|---|---|
| | Active | | Sur- |
| | Ingredient | Diluent | factant |
| Water-Dispersible and Water-soluble | 5-90 | 0-94 | 1-15 |
| Granules, Tablets and Powders. | | | |
| Suspensions, Emulsions, Solutions | 5-50 | 40-95 | 0-15 |
| (including Emulsifiable | | | |
| Concentrates) | | | |
| Dusts | 1-25 | 70-99 | 0-5 |
| Granules and Pellets | 0.01-99 | 5-99.99 | 0-15 |
| High Strength Compositions | 90-99 | 0-10 | 0-2 |

Typical solid diluents are described in Watkins, et al., Handbook of Insecticide Dust Diluents and Carriers, 2nd Ed., Dorland Books, Caldwell, N.J. Typical liquid diluents are described in Marsden, Solvents Glide, 2nd Ed., Interscience, New York, 1950. McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, and polyoxyethylene/polyoxypropylene block copolymers. Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol and tetrahydrofurfuryl alcohol.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and PCT Publication WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modem Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7i line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th Ed., Blackwell Scientific Publications, Oxford, 1989.

In the following Examples, all percentages are by weight and all formulations are prepared in conventional ways. Compound numbers refer to compounds in Index Tables A-D.

### Example A

Wettable Powder

| | |
|---|---|
| Compound 7 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0%. |

### Example B

Granule

| | |
|---|---|
| Compound 7 | 10.0% |
| attapulgite granules (low volatile matter, | 90.0%. |
| 0.71/0.30 mm; U.S.S. No. 25-50 sieves) | |

### Example C

Extruded Pellet

| | |
|---|---|
| Compound 7 | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

Example D

Emulsifiable Concentrate

| | |
|---|---|
| Compound 7 | 20.0% |
| blend of oil soluble sulfonates | 10.0% |
| and polyoxyethylene ethers | |
| isophorone | 70.0%. |

### Example E

Granule

| | |
|---|---|
| Compound 7 | 0.5% |
| cellulose | 2.5% |
| lactose | 4.0% |
| cornmeal | 93.0%. |

Compounds of this invention are characterized by favorable metabolic and/or soil residual patterns and exhibit activity controlling a spectrum of agronomic and non-agronomic invertebrate pests. (In the context of this disclosure “invertebrate pest control” means inhibition of invertebrate pest development (including mortality) that causes significant reduction in feeding or other injury or damage caused by the pest; related expressions are defined analogously.) As referred to in this disclosure, the term “invertebrate pest” includes arthropods, gastropods and nematodes of economic importance as pests. The term “arthropod” includes insects, mites, spiders, scorpions, centipedes, millipedes, pill bugs and symphylans. The term “gastropod” includes snails, slugs and other Stylommatophora. The term “nematode” includes all of the helminths, such as: roundworms, heartworms, and phytophagous nematodes (Nematoda), flukes (Tematoda), Acanthocephala, and tapeworms (Cestoda). Those skilled in the art will recognize that not all compounds are equally effective against all pests. Compounds of this invention display activity against economically important agronomic, forest, greenhouse, nursery, ornamentals, food and fiber, public and animal health, domestic and commercial structure, household, and stored product pests. These include larvae of the order Lepidoptera, such as armyworms, cutworms, loopers, and heliothines in the family Noctuidae (e.g., fall armyworm (Spodoptera fugiperda J. E. Smith), beet armyworm (Spodoptera exigua Hübner), black cutworm (Agrotis ipsilon Hufnagel), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Crambus caliginosellus Clemens), sod webworm (Herpetogramma licarsisalis Walker)); leafrollers, budworms, seed worms, and fruit worms in the family Tortricidae (e.g., codling moth (Cydia pomonella Linnaeus), grape berry moth (Endopiza viteana Clemens), oriental fruit moth (Grapholita molesta Busck)); and many other economically important lepidoptera (e.g., diamondback moth (Plutella xylostella Linnaeus), pink bollworm (Pectinophora gossypiella Saunders), gypsy moth (Lymantria dispar Linnaeus)); nymphs and adults of the order Blattodea including cockroaches from the families Blattellidae and Blattidae (e.g., oriental cockroach (Blatta orietalis Linnaeus), Asian cockroach (Blatella asahinai Mizukubo), German cockroach (Blattella germanica Linnaeus), brownbanded cockroach (Supella longipalpa Fabricius), American cockroach (Periplaneta americana Linnaeus), brown cockroach (Periplaneta brunnea Burmeister), Madeira cockroach (Leucophaea maderae Fabricius)); foliar feeding larvae and adults of the order Coleoptera including weevils from the families Anthribidae, Bruchidae, and Curculionidae (e.g., boll weevil (Autonomous grandis Boheman), rice water weevil (Lissorhoptrus oryzophilus Kuschel), granary weevil (Sitophilus granarius Linnaeus), rice weevil (Sitophilus oryzae Linnaeus)); flea beetles, cucumber beetles, rootworms, leaf beetles, potato beetles, and leafminers in the family Chrysomelidae (e.g., Colorado potato beetle (Leptinotarsa decemlinieata Say), western corn rootworm (Diabrotica virgifera vigifera LeConte)); chafers and other beetles from the family Scaribaeidae (e.g., Japanese beetle (Popillia japonica Newman) and European chafer (Rhizotrogus majalis Razoumowsky)); carpet beetles from the family Dermestidae; wireworms from the family Elateridae; bark beetles from the family Scolytidae and flour beetles from the family Tenebrionidae. In addition it includes: adults and larvae of the order Dermaptera including earwigs from the family Forficulidae (e.g., European earwig (Forficula auricularia Linnaeus), black earwig (Chelisoches morio Fabricius)); adults and nymphs of the orders Hemiptera and Homoptera such as, plant bugs from the family Miridae, cicadas from the family Cicadidae, leafhoppers (e.g. Empoasca spp.) from the family Cicadellidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, cinch bugs (e.g., Blissus spp.) and other seed bugs from the family Lygaeidae, spittlebugs from the family Cercopidae squash bugs from the family Coccidae, and red bugs and cotton stainers from the family Pyrrhocoridae. Also included are adults and larvae of the order Acari (mites) such as spider mites and red mites in the family Tetranychidae (e.g., European red mite (Panonychus ulmi Koch), two spotted spider mite (Tetranychus urticae Koch), McDaniel mite (Tetranychus mcdanieli McGregor)), flat mites in the family Tenuipalpidae (e.g., citrus flat mite (Brevipalpus lewisi McGregor)), rust and bud mites in the family Eriophyidae and other foliar feeding mites and mites important in human and animal health, i.e. dust mites in the family Epidermoptidae, follicle mites in the family Demodicidae, grain mites in the family Glycyphagidae, ticks in the order Ixodidae (e.g., deer tick (Ixodes scapularis Say), Australian paralysis tick (Ixodes holocyclus Neumann), American dog tick (Dermacentor variabilis Say), lone star tick (Amblyomma americanum Linnaeus) and scab and itch mites in the families Psoroptidae, Pyemotidae, and Sarcoptidae; adults and immatures of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forskal), migratory locust (Locusta migratoria Linnaeus), house cricket (Acheta domiesticus Linnaeus), mole crickets (Gryllotalpa spp.)); adults and immatures of the order Diptera including leafminers, midges, fruit flies (Tephritidae), frit flies (e.g., Oscinella frit Linnaeus), soil maggots, house flies (e.g., Musca domestica Linnaeus), lesser house flies (e.g., Fannia canicularis Linnaeus, F. femoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera, mosquitoes (e.g., Aedes spp., Anophleles spp., Culex spp.), black flies (e.g., Prosimulium spp., Simulium spp.), biting midges, sand flies, sciarids, and other Nematocera; adults and immatures of the order Thysanoptera including onion thrips (Thrips tabaci Lindeman) and other foliar feeding thrips; insect pests of the order Hymenoptera including ants (e.g., red carpenter ant (Camponotus ferrigineus Fabricius), black carpenter ant (Camponotus pensylvanicus De Geer), Pharaoh ant (Monomororium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Förster), odorous house ant (Tapinoma sessile Say)), bees (including carpenter bees), hornets, yellow jackets and wasps; insect pests of the order Isoptera including the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder) and other termites of economic importance; insect pests of the order Thysanura such as silverfish (Lepisima saccharina Linnaeus) and firebrat (Thermobia domestica Packard); insect pests of the order Mallophaga and including the head louse (Pediculus humanus capitis De Geer), body louse (Pediculus humanus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch), long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Cteizocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Additional arthropod pests covered include: spiders in the order Araneae such as the brown recluse spider (Loxosceles reclusa Gertsch & Mulaik) and the black widow spider (Latrodectuts mactans Fabricius), and centipedes in the order Scutigeromorpha such as the house centipede (Scutigera coleoptrata Linnaeus). Activity also includes members of the Classes Nematoda, Cestoda, Trematoda, and Acanthocephala including economically important members of the orders Strongylida, Ascaridida, Oxyurida, Rhabditida, Spirurida, and Enoplida such as but not limited to economically important agricultural pests (i.e. root knot nematodes in the genus Meloidogyne, lesion nematodes in the genus Pratylenchus, stubby root nematodes in the genus Trichodorus, etc.) and animal and human health pests (i.e. all economically important flukes, tapeworms, and roundworms, such as Strongylus vulgaris in horses, Toxocara canis in dogs, Haemonchus contortus in sheep, Dirofilaria immitis Leidy in dogs, Anoplocephala perfoliata in horses, Fasciola hepatica Linnaeus in ruminants, etc.).

Compounds of the invention show particularly high activity against pests in the order Lepidoptera (e.g., Alabama argillacea Hübner (cotton leaf worm), Archips argyrospila Walker (fruit tree leaf roller), A. rosana Linnaeus (European leaf roller) and other Archips species, Chilo suppressalis Walker (rice stem borer), Cnaphalocrosis medinalis Guenee (rice leaf roller), Crambus caliginosellus Clemens (corn root webworm), Crambus teterrellus Zincken (bluegrass webworm), Cydia pomonella Linnaeus (codling moth), Earias insulana Boisduval (spiny bollworm), Earias vittella Fabricius (spotted bollworm), Helicoverpa armigera Hübner (American bollworm), Helicoverpa zea Boddie (corn earworm), Heliothis virescens Fabricius (tobacco budworm), Herpetogramma licarsisalis Walker (sod webworm), Lobesia botrana Denis & Schiffermüller (grape berry moth), Pectinophora gossvpiella Saunders (pink bollworm), Phyllocnistis citrella Stainton (citrus leafminer), Pieris brassicae Linnaeus (large white butterfly), Pieris rapae Linnaeus (small white butterfly), Plutella xylostella Linnaeus (diamondback moth), Spodoptera exigua Hübner (beet armyworm), Spodoptera litura Fabricius (tobacco cutworm, cluster caterpillar), Spodoptera frugiperda J. E. Smith (fall armyworm), Trichoplusia in Hübner (cabbage looper) and Tuta absoluta Meyrick (tomato leafminer)). Compounds of the invention also have commercially significant activity on members from the order Homoptera including: Acyrthisiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoina lanzigerum Hausmann (woolly apple aphid), Hyalopterus prunii Geoffroy (mealy plum aphid), Lipaphis erysimi Kaltenbach (turnip aphid), Metopolophium dirrhodum Walker (cereal aphid), Macrosipum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminun Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argenitifolii Bellows & Perring (silverleaf whitefly), Dialeurodes citri Ashmead (citrus whitefly) and Trialeurodes vaporariorum Westwood (greenhouse whitefly); Empoasca fabaeHarris (potato leafhopper), Laodelphax striatellus Fallen (smaller brown planthopper), Macrolestes quadrilineatus Forbes (aster leafhopper), Nephotettix cinticeps Uhler (green leaf1Hopper), Nephotettix nigropictus Stål (rice leafhopper), Nilaparvata lugens Stål (brown planthopper), Peregrinus maidis Ashmead (corn planthopper), Sogatella furciferaHorvath (white-backed planthopper), Sogatodes orizicola Muir (rice delphacid), Typhlocyba pomaria McAtee white apple leafhopper, Erythroneoura spp. (grape leafhoppers); Magicidada septendecim Linnaeus (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla). These compounds also have activity on members from the order Hemiptera including: Acrosternum hilare Say (green stink bug), Anasa tristis De Geer (squash bug), Blissus leucopterus leucopterus Say (chinch bug), Corythuca gossypii Fabricius (cotton lace bug), Cyrtopeltis modesta Distant (tomato bug), Dysdercus suturellusHerrich-Schäffer (cotton stainer), Euchistus sevius Say (brown stink bug), Euchistus variolarius Palisot de Beauvois (one-spotted stink bug), Graptosthetus spp. (complex of seed bugs), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the invention include Thysanoptera (e.g., Frankliniella occidenitalis Pergande (western flower thrip), Scirthothrips citri Moulton (citrus thrip), Sericothrips variabilis Beach (soybean thrip), and Thrips tabaci Lindeman (onion thrip); and the order Coleoptera (e.g., Leptinotarsa decemlineata Say (Colorado potato beetle), Epilachna varivestis Mulsant (Mexican bean beetle) and wireworms of the genera Agriotes, Athtous or Limonius).

Compounds of Formula I can also be mixed with one or more other biologically active compounds or agents including insecticides, fungicides, nematocides, bactericides, acaricides, growth regulators such as rooting stimulants, chemosterilants, semiochemicals, repellents, attractants, pheromones, feeding stimulants, other biologically active compounds or entomopathogenic bacteria, virus or fungi to form a multi-component pesticide giving an even broader spectrum of agricultural utility. Thus the present invention also relates to a method wherein the invertebrate pest or its environment is contacted with a biologically effective amount of a compound of Formula I or a composition comprising a compound of Formula I and a biologically effective amount of at least one additional compound or agent for controlling invertebrate pests. Likewise compositions of the present invention comprising a compound of Formula Ia can further comprise a biologically effective amount of at least one additional biologically active compound or agent. Examples of such biologically active compounds or agents with which compounds of this invention can be formulated are: insecticides such as abamectin, acephate, acetamiprid, avermectin, azadirachtin, azinphos-methyl, bifenthrin, binfenazate, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenproximate, fenvalerate, fipronil, flonicamid, flucythrinate, tau-fluvalinate, flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, oxamyl, parathion, parathion-methyl, permethrin, phorate, phosalone, phosmet, phosphamidon, pirimicarb, profenofos, pymetrozine, pyridalyl. pyriproxyfen, rotenone, spinosad, sulprofos, tebufenozide, teflubenzuron, tefluthrin, terbufos, tetrachlorvinphos, thiacloprid, thiamethoxam, thiodicarb, thiosultap-sodium, tralomethrin, trichlorfon and triflumuron; fungicides such as acibenzolar, azoxystrobin, benomyl, blasticidin-S, Bordeaux mixture (tribasic copper sulfate), bromuconazole, carpropamid, captafol, captan, carbendazim, chloroneb, chlorothalonil, copper oxychloride, copper salts, cyflufenamid, cymoxanil, cyproconazole, cyprodinil, (S)-3,5-dichloro-N-(3-chloro-1-ethyl-1-methyl-2-oxopropyl)-4-methylbenzamide (RH 7281), diclocymet (S-2900), diclomezine, dicloran, difenoconazole, (S)-3,5-dihydro-5-methyl-2-(methylthio)-5-phenyl-3-(phenylamino)-4H-imidazol-4-one (RP 407213), dimethomorph, dimoxystrobin, diniconazole, diniconazole-M, dodine, edifenphos, epoxiconazole, famoxadone, fenamidone, fenarimol, fenbuconazole, fencaramid (SZX0722), fenpiclonil, fenpropidin, fenpropimorph, fentin acetate, fentin hydroxide, fluazinam, fludioxonil, flumetover (RPA 403397), fluquinconazole, flusilazole, flutolanil, flutriafol, folpet, fosetyl-aluminum, furalaxyl, furametapyr (S-82658), hexaconazole, ipconazole, iprobenfos, iprodione, isoprothiolane, kasugamycin, kresoxim-methyl, mancozeb, maneb, mefenoxam, mepronil, metalaxyl, metconazole, metominostrobin/fenominostrobin (SSF-126), myclobutanil, neo-asozin (ferric methanearsonate), oxadixyl, penconazole, pencycuron, probenazole, prochloraz, propamocarb, propiconazole, pyrifenox, pyraclostrobin, pyrimethanil, pyroquilon, quinoxyfen, spiroxamine, sulfur, tebuconazole, tetraconazole, thiabendazole, thifluzamide, thiophanate-methyl, thiram, tiadinil, triadimefon, triadimenol, tricyclazole, trifloxystrobin, triticonazole, validamycin and vinclozolin; nematocides such as aldicarb, oxamyl and fenamiphos; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; and biological agents such as Bacillus thuringiensis including ssp. aizawai and kurstaki, Bacillus thurigiensis delta endotoxin, baculovirus, and entomopathogenic bacteria, virus and fungi.

A general reference for these agricultural protectants is The Pesticide Manual, 12th Edition, C. D. S. Tomlin, Ed., British Crop Protection Council, Farnham, Surrey, U.K., 2000.

Preferred insecticides and acaricides for mixing with compounds of Formula I or Ia include pyrethroids such as cypermethrin, cyhalothrin, cyfluthrin, beta-cyfluthrin, esfenvalerate, fenvalerate and tralomethrin; carbamates such as fenothicarb, methomyl, oxamyl and thiodicarb; neonicotinoids such as clothianidin, imidacloprid and thiacloprid; neuronal sodium channel blockers such as indoxacarb; insecticidal macrocyclic lactones such as spinosad, abamectin, avermectin and emamectin; γ-aminobutyric acid (GABA) antagonists such as endosulfan, ethiprole and fipronil; insecticidal ureas such as flufenoxuron and triflumuron; juvenile hormone mimics such as diofenolan and pyriproxyfen; pymetrozine; and amitraz. Preferred biological agents for mixing with compounds of Formula I or Ia include Bacillus thuringiensis and Bacillus thurigiensis delta endotoxin as well as naturally occurring and genetically modified viral insecticides including members of the family Baculoviridae as well as entomophagous fungi.

Most preferred mixtures include a mixture of a compound of Formula I or Ia with cyhalothrin; a mixture of a compound of Formula I or Ia with beta-cyfluthrin; a mixture of a compound of Formula I or Ia with esfenvalerate; a mixture of a compound of Formula I or Ia with methomyl; a mixture of a compound of Formula I or Ia with imidacloprid; a mixture of a compound of Formula I or Ia with thiacloprid; a mixture of a compound of Formula I or Ia with indoxacarb; a mixture of a compound of Formula I or Ia with abamectin; a mixture of a compound of Formula I or Ia with endosulfan; a mixture of a compound of Formula I or Ia with ethiprole; a mixture of a compound of Formula I or Ia with fipronil; a mixture of a compound of Formula I or Ia with flufenoxuron; a mixture of a compound of Formula I or Ia with pyriproxyfen; a mixture of a compound of Formula I or Ia with pymetrozine; a mixture of a compound of Formula I or Ia with amitraz; a mixture of a compound of Formula I or Ia with Bacillus thuringiensis and a mixture of a compound of Formula I or Ia with Bacillus thuringiensis delta endotoxin.

In certain instances, combinations with other invertebrate pest control compounds or agents having a similar spectrum of control but a different mode of action will be particularly advantageous for resistance management. Thus, compositions of the present invention comprising a compound of Formula Ia can further comprise a biologically effective amount of at least one additional invertebrate pest control compound or agent having a similar spectrum of control but a different mode of action, and the methods of the present invention can utilize compositions compromising a compound of Formula I and a biologically effective amount of at least one additional invertebrate pest control compound or agent having a similar spectrum of control but a different mode of action. Contacting a plant genetically modified to express a plant protection compound (e.g., protein) or the locus of the plant with a biologically effective amount of a compound of Formula I or Ia can also provide a broader spectrum of plant protection and be advantageous for resistance management.

Invertebrate pests are controlled and protection of agronomic, horticultural and specialty crops, animal and human health is achieved by applying one or more of the compounds of Formula I or Ia, in an effective amount, to the environment of the pests including the agronomic and/or nonagronomic locus of infestation, to the area to be protected, or directly on the pests to be controlled. Thus, the present invention comprises a method for the control of foliar- and soil-inhabiting invertebrates and protection of agronomic and/or nonagronomic crops, comprising contacting the invertebrates or their environment with a biologically effective amount of one or more of the compounds of Formula I, or with a composition comprising at least one such compound or a composition comprising at least one such compound and an effective amount of at least one additional biologically active compound or agent. A preferred method of contact is by spraying. Alternatively, a granular composition comprising a compound of Formula I or Ia can be applied to the plant foliage or the soil. Compounds of Formula I or Ia are effective in delivery through plant uptake by contacting the plant with a composition comprising a compound of Formula I or Ia applied as a soil drench of a liquid formulation, a granular formulation to the soil, a nursery box treatment or a dip of transplants. Other methods of contact include application of a compound of Formula I or Ia or a composition comprising of Formula I or Ia of the invention by direct and residual sprays, aerial sprays, seed coats, microencapsulations, systemic uptake, baits, eartags, boluses, foggers, fumigants, aerosols, dusts and many others.

The compounds of Formula I or Ia can be incorporated into baits that are consumed by the invertebrates or within devices such as traps and the like. Granules or baits comprising between 0.01-5% active ingredient, 0.05-10% moisture retaining agent(s) and 40-99% vegetable flour are effective in controlling soil insects at very low application rates, particularly at doses of active ingredient that are lethal by ingestion rather than by direct contact.

The compounds of Formula I or Ia can be applied in their pure state, but most often application will be of a formulation comprising one or more compounds with suitable carriers, diluents, and surfactants and possibly in combination with a food depending on the contemplated end use. A preferred method of application involves spraying a water dispersion or refined oil solution of the compounds. Combinations with spray oils, spray oil concentrations, spreader stickers, adjuvants, other solvents, and synergists such as piperonyl butoxide often enhance compound efficacy.

The rate of application required for effective control (i.e. “biologically effective amount”) will depend on such factors as the species of invertebrate to be controlled, the pest's life cycle, life stage, its size, location, time of year, host crop or animal, feeding behavior, mating behavior, ambient moisture, temperature, and the like. Under normal circumstances, application rates of about 0.01 to 2 kg of active ingredient per hectare are sufficient to control pests in agronomic ecosystems, but as little as 0.0001 kg/hectare may be sufficient or as much as 8 kg/hectare may be required. For nonagronomic applications, effective use rates will range from about 1.0 to 50 mg/square meter but as little as 0.1 mg/square meter may be sufficient or as much as 150 mg/square meter may be required. One skilled in the art can easily determine the biologically effective amount necessary for the desired level of invertebrate pest control.

The following Tests in the Biological Examples of the Invention demonstrate the efficacy of methods of the invention for protecting plants from specific arthropod pests. “Control efficacy” represents inhibition of arthropod development (including mortality) that causes significantly reduced feeding. The pest control protection afforded by the compounds is not limited, however, to these species. See Index Tables A-D for compound descriptions.

The following abbreviations are used in the Index Tables which follows: t is tertiary, n is normal, i is iso, s is secondary, C is cyclo, Me is methyl, Et is ethyl, Pr is propyl and Bu is butyl; accordingly i-Pr is isopropyl, s-Bu is secondary butyl, etc. The abbreviation “Ex.” stands for “Example” and is followed by a number indicating in which example the compound is prepared.

Index Table A

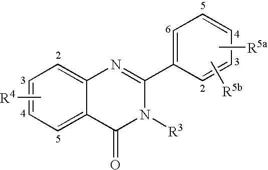

| Compound | R³ | R⁴ | R^{5a} | R^{5b} | mp ° C. |
|---|---|---|---|---|---|
| 1 | i-Pr | 2-Me | H | 4-OCF₃ | oil |
| 2 | i-Pr | 2-Me | H | 4-CF₃ | oil |
| 3 (Ex. 1) | i-Pr | 2-Me | 2-Me | 4-CF₃ | 100-103 |

Index Table B

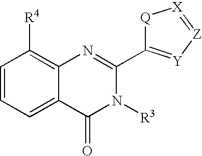

| Compound | R³ | R⁴ | Q | X | Y | Z | mp ° C. |
|---|---|---|---|---|---|---|---|
| 4 | i-Pr | Cl | NPh | N | CH | CCF₃ | 155-159 |

Index Table C

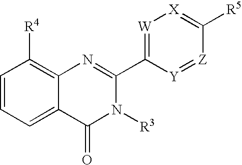

| Compound | R³ | R⁴ | W | X | Y | Z | R⁵ | m.p. ° C. |
|---|---|---|---|---|---|---|---|---|
| 5 | i-Pr | Me | C-Me | N | CH | CH | CF₃ | 132-135 |
| 6 | i-Pr | Me | C-Et | N | CH | CH | Cl | 127-131 |

Index Table D

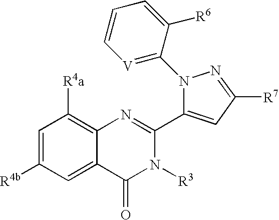

| Compound | R³ | R^{4b} | R^{4b} | R⁶ | R⁷ | V | mp ° C. |
|---|---|---|---|---|---|---|---|
| 7 (Ex. 3) | Me | Cl | H | Cl | CF₃ | N | 155-159 |
| 8 | i-Pr | Me | H | H | CF₃ | CH | |
| 9 | CH₂CHClCH₃ | Me | H | Cl | CF₃ | CH | 178-180 |
| 10 (Ex. 2) | Me | Me | Cl | Cl | CF₃ | N | solid |
| 11 | i-Pr | Me | Cl | Cl | Br | N | 190-193 |

INDEX TABLE E

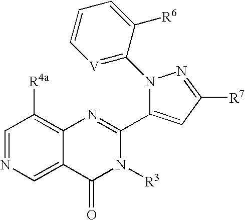

| Compound | R³ | R^{4a} | R⁶ | R⁷ | V | mp ° C. |
|---|---|---|---|---|---|---|
| 12 | CH₂C≡CH | Me | Cl | Br | CH | |
| 13 | CH₂C≡CH | Me | Cl | CF₃ | CH | |

### BIOLOGICAL EXAMPLES OF THE INVENTION

### Test

For evaluating control of diamondback moth (Plutella xylostella) the test unit consisted of a small open container with a 12-14-day-old radish plant inside. This was pre-infested with 10-15 neonate larvae on a piece of insect diet by use of a core sampler to remove a plug from a sheet of hardened insect diet having many larvae growing on it and transfer the plug containing larvae and diet to the test unit. The larvae moved onto the test plant as the diet plug dried out.

Test compounds were formulated using a solution containing 10% acetone, 90% water and 300 ppm X-77® Spreader Lo-Foam Formula non-ionic surfactant containing alkylarylpolyoxyethylene, free fatty acids, glycols and isopropanol (Loveland Industries, Inc.), unless otherwise indicated. The formulated compounds were applied in 1 mL of liquid through a SUJ2 atomizer nozzle with ⅛ JJ custom body (Spraying Systems Co.) positioned 1.27 cm (0.5 inches) above the top of each test unit. All experimental compounds in this screen were sprayed at 250 ppm and replicated three times. After spraying of the formulated test compound, each test unit was allowed to dry for 1 hour and then a black, screened cap was placed on top. The test units were held for 6 days in a growth chamber at 25° C. and 70% relative humidity. Plant feeding damage was then visually assessed.

Of the compounds tested, the following provided very good levels of plant protection (20% or less feeding damage): 3, 4, 5, 6, 8 and 10.

What is claimed is:

1. A method for controlling an invertebrate pest comprising contacting the invertebrate pest or its environment with a biologically effective amount of a compound of Formula I, its N-oxide or an agriculturally suitable salt of the compound 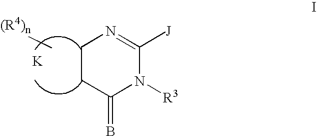
wherein
B is O or S;
J is a phenyl ring substituted with 1 to 4 R⁵, or a naphthyl ring system, a 5- or 6-membered heteroaromatic ring or an aromatic 8-, 9- or 10-membered fused heterobicyclic ring system wherein each ring or ring system is optionally substituted with 1 to 4 R⁵;
K is, together with the two contiguous linking carbon atoms, a fused phenyl or a fused pyridinyl ring selected from the group consisting of K-1, K-2, K-3, K-4 and K-5, each optionally substituted with 1 to 4R⁴ 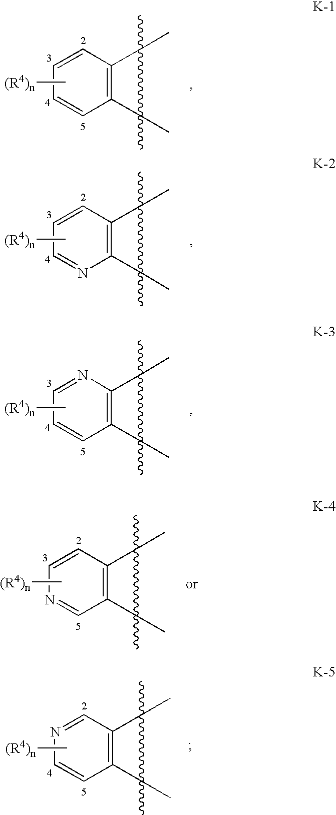
R³ is G; C₁-C₆ alkyl, C₂-C₆ alkenyl, C₂-C₆ alkynyl, C₃-C₆ cycloalkyl, each optionally substituted with one or more substituents selected from the group consisting of halogen, G, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₂-C₆ alkoxycarbonyl, C₂-C₆ alkylcarbonyl, C₃-C₆ trialkylsilyl, or a phenoxy ring optionally substituted with one to three substituents independently selected from R⁶; hydroxy; C₁-C₄ alkoxy; C₁-C₄ alkylamino; C₂-C₈ dialkylamino; C₃-C₆ cycloalkylamino; C₂-C₆ alkoxycarbonyl or C₂-C₆ alkylcarbonyl;
G is a phenyl ring or 5- or 6-membered heteroaromatic ring, each ring optionally substituted with one to three substituents independently selected from R⁶; a 5- or 6-membered nonaromatic carbocyclic or heterocyclic ring, optionally including one or two ring members selected from the group consisting of C(═O), SO or S(O)₂ and optionally substituted with 1 to 4 substituents selected from R¹²;
each R⁴ is independently H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkenyl, C₃-C₆ halocycloalkyl, halogen, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₁-C₄ alkoxyalkyl, C₁-C₄ hydroxyalkyl, C(O)R¹⁰,CO₂R¹⁰, C(O)NR¹⁰R¹¹, NR¹⁰R¹¹, N(R¹¹)COR¹⁰, N(R¹¹)CO₂R¹⁰ or C₃-C₆ trialkylsilyl; or
each R⁴ is independently a phenyl, benzyl, phenoxy or a 5- or 6-membered heteroaromatic ring, each ring optionally substituted with one to three substituents independently selected from R⁶;
each R⁵ is independently H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl, C₃-C₆ trialkylsilyl; or
each R⁵ is independently a phenyl, benzyl, benzoyl, phenoxy, 5- or 6-membered heteroaromatic ring or an aromatic 8-, 9- or 10-membered fused heterobicyclic ring system, each ring optionally substituted with one to three substituents independently selected from R⁶; or
(R⁵)₂ when attached to adjacent carbon atoms can be taken together as —OCF₂O—, —CF₂CF₂O—, or —OCF₂CF₂O—;
each R⁶ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl;
R¹⁰ is H or C₁-C₄ alkyl or C₁-C₄ haloalkyl;
R¹¹ is H or C₁-C₄ alkyl;
each R¹² is independently C₁-C₂ alkyl, halogen, CN, NO₂ and C₁-C₂ alkoxy; and
n is 1 to 4.

2. The method of claim 1 wherein B is O and R³ is C₁-C₆ alkyl, C₂-C₆ alkenyl, C₂-C₆ alkynyl or C₃-C₆ cycloalkyl each optionally substituted with one or more substituents selected from the group consisting of halogen, CN, C₁-C₂ alkoxy, C₁-C₂ alkylthio, C₁-C₂ alkylsulfinyl and C₁-C₂ alkylsulfonyl.

3. The method of claim 2 wherein J is a phenyl group substituted with 1 to 4 R⁵.

4. The method of claim 3 wherein
n is 1 to 2;
one R⁴ group is attached to the K-ring at the 2-position or 5-position, and said R⁴ is C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl or C₁-C₄ haloalkylsulfonyl; and
each R⁵ is independently H, halogen, C₁-C₄ alkyl, C₁-C₂ alkoxy, C₁-C₄ haloalkyl, CN, NO₂, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl or C₂-C₄ alkoxycarbonyl; or
each R⁵ is independently a phenyl or a 5- or 6-membered heteroaromatic ring, each ring optionally substituted with R⁶; or
(R⁵)₂ when attached to adjacent carbon atoms can be taken together as —OCF₂O—, —CF₂CF₂O— or —OCF₂CF₂O—.

5. The method of claim 4 wherein
R³ is C₁-C₄ alkyl optionally substituted with halogen, CN, OCH₃ or S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
each R⁵ is independently H, halogen, methyl, CF₃, OCF₃, OCHF₂, S(O)ₚCF₃, S(O)ₚCHF₂, OCH₂CF₃, OCF₂CHF₂, S(O)ₚCH₂CF₃ or S(O)ₚCF₂CHF₂; or a phenyl, pyrazole, imidazole, triazole, pyridine or pyrimidine ring, each ring optionally substituted with C₁-C₄ alkyl, C₁-C₄ haloalkyl, halogen or CN; and
p is 0, 1 or 2.

6. The method of claim 5 wherein R³ is i-propyl or t-butyl.

7. The method of claim 2 wherein J is a 5- or 6-membered heteroaromatic ring optionally substituted with 1 to 4 R⁵.

8. The method of claim 7 wherein
J is a 5- or 6-membered heteroaromatic ring selected from the group consisting of J-1, J-2, J-3, J-4 and J-5, each J optionally substituted with 1 to 3 R⁵ 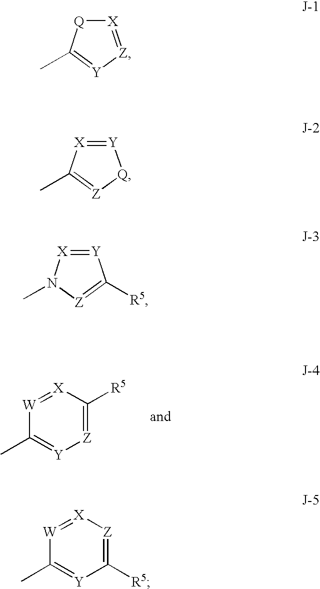
Q is O, S or NR⁵; and
W, X, Y and Z are independently N or CR⁵, provided that in J-4 and J-5 at least one of W, X, Y or Z is N.

9. The method of claim 8 wherein
n is 1 to 2;
one R⁴ group is attached to the K-ring at the 2-position or 5-position, and said R⁴ is C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, or C₁-C₄ haloalkylsulfonyl; and
each R⁵ is independently H, C₁-C₄ alkyl, C₁-C₄ haloalkyl, halogen, CN, NO₂, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl or C₂-C₄ alkoxycarbonyl; or a phenyl or a 5- or 6-membered heteroaromatic ring, each ring optionally substituted with R⁶.

10. The method of claim 9 wherein
J substituted with 1 to 3 R⁵ is selected from the group consisting of J-6, J-7, J-8, J-9, J-10, J-11, J-12 and J-13 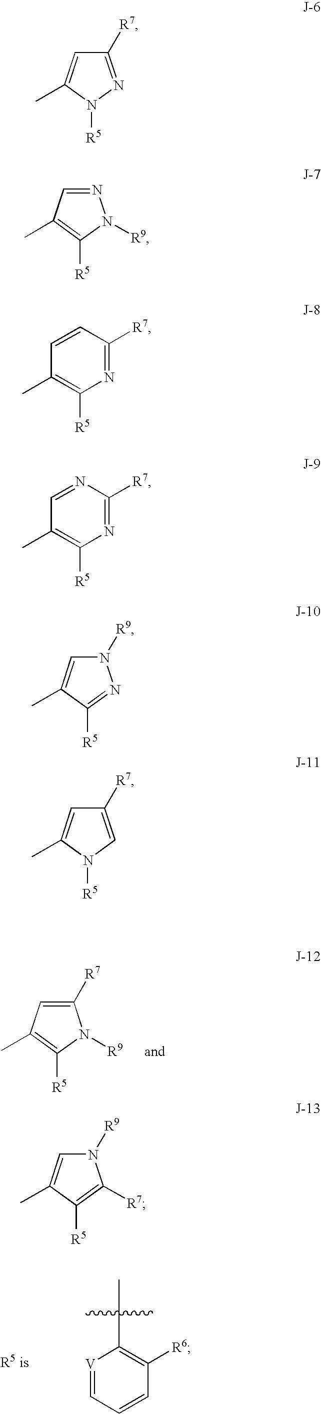
V is N, CH, CF, CCl, CBr or CI;
each R⁷ is independently H, C₁-C₆ alkyl, C₁-C₆ haloalkyl, halogen, CN, C₁-C₄ alkoxy, C₁-C₄ haloalkoxy or C₁-C₄ haloalkylthio;
R⁹ is H, C₂-C₆ alkyl, C₁-C₆ haloalkyl, C₃-C₆ alkenyl, C₃-C₆ haloalkenyl, C₃-C₆ alkynyl or C₃-C₆ haloalkynyl, provided that R⁷ and R⁹ are not both H; and
n is 0, 1 or 2.

11. The method of claim 10 wherein
J substituted with 1 to 3 R⁵ is J-6;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁷ is CH₃, CF₃, OCHF₂ or halogen; and
p is 0, 1 or 2.

12. The method of claim 11 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁷ is halogen or CF₃.

13. The method of claim 10 wherein
J substituted with 1 to 3 R⁵ is J-7;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁹ is C₂-C₆ alkyl or C₁-C₆ haloalkyl; and
p is 0, 1 or 2.

14. The method of claim 13 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁹ is CF₃, CHF₂, CBrF₂, CClF₂, CH₂CF₃, or CF₂CHF₂.

15. The method of claim 10 wherein
J substituted with 1 to 3 R⁵ is J-8;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or, CF₃;
R⁶ is C₁-C₄ alkyl, C₁-C₄ haloalkyl, halogen or CN R⁶ is CH₃, CF₃ or halogen;
R⁷ is CH₃, CF₃ or halogen; and
p is 0, 1 or 2.

16. The method of claim 15 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁷ is halogen or CF₃.

17. The method of claim 10 wherein
J substituted with 1 to 3 R⁵ is J-9;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁷ is CH₃, CF₃ or halogen; and
p is 0, 1 or 2.

18. The method of claim 17 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁷ is CF₃.

19. The method of claim 10 wherein
J substituted with 1 to 3 R⁵ is J-10;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁹ is C₂-C₆ alkyl or C₁-C₆ haloalkyl; and
p is 0, 1 or 2.

20. The method of claim 19 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁹ is CF₃, CHF₂, CBrF₂, CClF₂, CH₂CF₃, or CF₂CHF₂.

21. The method of claim 10 wherein
J substituted with 1 to 3 R⁵ is J-11;
R³ is C₁-C₄ alkyl optionally substituted with halogen, CN, OCH₃, S(O)ₚCH₃;
one R⁴ group is attached to the K-ring at the 2-position and said
R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁷ is CH₃, CF₃, OCHF₂ or halogen; and
p is 0, 1 or 2.

22. The method of claim 21 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁷ is halogen or CF₃.

23. The method of claim 10 wherein
J substituted with 1 to 3 R⁵ is J-12;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁹ is C₂-C₆ alkyl or C₁-C₆ haloalkyl; and
p is 0, 1 or 2.

24. The method of claim 23 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁹ is CF₃, CHF₂, CBrF₂, CClF₂, CH₂CF₃, or CF₂CHF₂.

25. The method of claim 10 wherein
J substituted with 1 to 3 R⁵ is J-13;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁹ is C₂-C₆ alkyl or C₁-C₆ haloalkyl; and
p is 0, 1 or 2.

26. The method of claim 25 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁹ is CF₃, CHF₂, CBrF₂, CClF₂, CH₂CF₃, or CF₂, CHF₂.

27. The method of claim 1 wherein the compound of Formula I is selected from the group consisting of:
8-methyl-3-(1-methylethyl)-2-[2-methyl-6-(trifluoromethyl)-3-pyridinyl]-4(3H)-quinazolinone,
2-[3-bromo-1-(3-chloro-2-pyridinyl)-1H-pyrazol-5-yl]-6-chloro-3,8-dimethyl4(3H)-quinazoline,
2-[3-bromo-1-(3-chloro-2-pyridinyl)-1H-pyrazol-5-yl]-6-chloro-3-ethyl-8-methyl-4(3H)-quinazoline,
2-[3-bromo-1-(3-chloro-2-pyridinyl)-1H-pyrazol-5-yl]-6-chloro-8-methyl-3-(1-methylethyl)-4(3H)-quinazoline,
2-[3-bromo-1-(3-chloro-2-pyridinyl)-1H-pyrazol-5-yl]-6-chloro-3-(1,1-dimethylethyl)-8-methyl-4(3H)-quinazoline,
6-chloro-2-[3-chloro-1-(3-chloro-2-pyridinyl)-1H-pyrazol-5-yl]-3,8-dimethyl-4(3H)-quinazoline,
6-chloro-2-[3-chloro-1-(3-chloro-2-pyridinyl)-1H-pyrazol-5-yl]-3-ethyl-8-methyl-4(3H)-quinazoline,
6-chloro-2-[3-chloro-1-(3-chloro-2-pyridinyl)-1H-pyrazol-5-yl]-8-methyl-3-(1-methylethyl)-4(3H)-quinazoline,
6-chloro-2-[3-chloro-1-(3-chloro-2-pyridinyl)-1H-pyrazol-5-yl]-3-(1,1-dimethylethyl)-8-methyl-4(3H)-quinazoline,
6-chloro-2-[1-(3-chloro-2-pyridinyl)-3-(trifluoromethyl)-1H-pyrazol-5-yl]-3,8-dimethyl-4(3H)-quinazoline,
6-chloro-2-[1-(3-chloro-2-pyridinyl)-3-(trifluoromethyl)-1H-pyrazol-5-yl]-3-ethyl-8-methyl-4(3H)-quinazoline,
6-chloro-2-[1-(3-chloro-2-pyridinyl)-3-(trifluoromethyl)-1H-pyrazol-5-yl]-8-methyl-3-(1-methylethyl)-4(3H)-quinazoline,
6-chloro-2-[1-(3-chloro-2-pyridinyl)-3-(trifluoromethyl)-1H-pyrazol-5-yl]-3-(1,1-dimethylethyl)-8-methyl-4(3H)-quinazoline,
2-[3-bromo-1-(3-chloro-2-pyridinyl)-1H-pyrazol-5-yl]-8-methyl-3-(1-methylethyl)-4(3H)-quinazoline,
2-[3-bromo-1-(3-chloro-2-pyridinyl)-1H-pyrazol-5-yl]-3-(1,1-dimethylethyl)-8-methyl-4(3H)-quinazoline,
2-[1-(3-chloro-2-pyridinyl)-3-(trifluoromethyl)-1H-pyrazol-5-yl]-8-methyl-3-(1-methylethyl)-4(3H)-quinazoline,
2-[1-(3-chloro-2-pyridinyl)-3-(trifluoromethyl)-1H-pyrazol-5-yl]-3(1,1-dimethylethyl)-8-methyl-4(3H)-quinazoline,
6,8-dichloro-2-[1-(3-chloro-2-pyridinyl)-3-(trifluoromethyl)-1H-pyrazol-5-yl]-3-methyl -4(3H)-quinazoline,
6,8-dichloro-2-[1-(3-chloro-2-pyridinyl)-3-(trifluoromethyl)-1H-pyrazol-5-yl]-3ethyl-4(3H)-quinazoline,
6,8-dichloro-2-[1-(3-chloro-2-pyridinyl)-3-(trifluoromethyl)-1H-pyrazol-5-yl]-3-(1-methylethyl)-4(3H)-quinazoline,
2-[3-bromo-1-(3-chloro-2-pyridinyl)-1H-pyrazol-5-yl]-6,8-dichloro-3-methyl-4(3H)-quinazoline,
2-[3-bromo-1-(3-chloro-2-pyridinyl)-1H-pyrazol-5-yl]-6,8-dichloro-3-ethyl-4(3H)-quinazoline,
2-[3-bromo-1-(3-chloro-2-pyridinyl)-1H-pyrazol-5-yl]-6,8-dichloro-3-(1-methylethyl)-4(3H)-quinazoline,
6,8-dichloro-2-[3-chloro-1-(3-chloro-2-pyridinyl)-1H-pyrazol-5-yl]-3-methyl-4(3H)-quinazoline,
6,8-dichloro-2-[3-chloro-1-(3-chloro-2-pyridinyl)-1H-pyrazol-5-yl]-3-ethyl-4(3H)quinazoline, and
6,8-dichloro-2-[3-chloro-1-(3-chloro-2-pyridinyl)-1H-pyrazol-5-yl]-3-(1-methylethyl)-4(3H)-quinazoline.

28. The method of claim 1 wherein the compound of Formula I is comprised in a composition, said composition optionally further comprising an effective amount of at least one additional biologically active compound or agent.

29. The method of claim 28 wherein at least one additional biologically active compound or agent is selected from arthropodicides of the group consisting of pyrethroids, carbamates, neonicotinoids, neuronal sodium channel blockers, insecticidal macrocyclic lactones, γ-aminobutyric acid (GABA) antagonists, insecticidal ureas and juvenile hormone mimics.

30. The method of claim 28 wherein at least one additional biologically active compound or agent is selected from insecticide, nematocide, acaricide or biological agents in the group consisting of abamectin, acephate, acetamiprid, avermectin, azadirachtin, azinphos-methyl, bifenthrin, binfenazate buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenproximate, fenvalerate, fipronil, flonicamid, flucythrinate, tau-fluvalinate, flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, oxamyl, parathion, parathion-methyl, permethrin, phorate, phosalone, phosmet, phosphamidon, pirimicarb, profenofos, pymetrozine, pyridalyl, pyriproxyfen, rotenone, spinosad, sulprofos, tebufenozide, teflubenzuron, tefluthrin, terbufos, tetrachlorvilnplios, thiacloprid, thiamethoxam, thiodicarb, thiosultap-sodium, tralomethrin, trichlorfon and triflumuron, aldicarb, oxamyl, fenamiphos, amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben, tebufenpyrad, Bacillus thuringiensis, Bacillus thuringiensis delta endotoxin, baculovirus, and entomopathogenic bacteria, virus and fungi.

31. The method of claim 30 wherein at least one additional biologically active compound or agent is selected from insecticide, nematocide, acaricide or biological agents in the group consisting of cypermethrin, cyhalothrin, cyfluthrin and beta-cyfluthrin, esfenvalerate, fenvalerate, tralomethrin, fenothicarb, methomyl, oxamyl, thiodicarb, clothianidin, imidacloprid, thiacloprid, indoxacarb, spinosad, abamectin, avermectin, emamectin, endosulfan, ethiprole, fipronil, flufenoxuron, triflumuron, diofenolan, pyriproxyfen, pymetrozine, amitraz, Bacillus thuringiensis, Bacillus thuringiensis delta endotoxin and entomophagous fungi.

32. The method of claim 1 wherein at least one insect pest controlled is selected from the group consisting of Alabama argillacea Hübner (cotton leaf worm), Archips argyrospila Walker (fruit tree leaf roller), A. rosana Linnaeus (European leaf roller) and other Archips species, Chilo suppressalis Walker (rice stem borer), Cnaphalocirosis medinalis Guenee (rice leaf roller), Crambus caliginosellus Clemens (corn root webworm), Crambus teterrellus Zincken (bluegrass webworm), Cydia pomonella Linnaeus (codling moth), Earias insulana Boisduval (spiny bollworm), Earias vittella Fabricius (spotted bollworm), Helicoverpa armigera Hübner (American bollworm), Helicoverpa zea Boddie (corn earworm), Heliothis virescens Fabricius (tobacco budworm), Herpetogramma licarsisalis Walker (sod webworm), Lobesia botrana Denis & Schiffermüller (grape berry moth), Pectinophora gossypiella Saunders (pink bollworm), Phyllocnistis citrella Stainton (citrus leafminer), Pieris brassicae Linnaeus (large white butterfly), Pieris rapae Linnaeus (small white butterfly), Plutella xylostella Linnaeus (diamondback moth), Spodoptera exigua Hübner (beet armyworm), Spodoptera litura Fabricius (tobacco cutworm, cluster caterpillar), Spodoptera frugiperda J. E. Smith (fall armyworm), Trichoplusia ni Hübner (cabbage looper) and Tuta absoluta Meyrick (tomato leafminer), Acyrthisiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffroy (mealy plum aphid), Lipaphis erysimi Kaltenbach (turnip aphid), Metopolophium dirrhodum Walker (cereal aphid), Macrosipum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argentifolii Bellows & Perring (silverleaf whitefly), Dialeurodes citri Ashmead (citrus whitefly) and Trialeurodes vaporarium Westwood (greenhouse whitefly); Empoasca fabae Harris (potato leafhopper), Laodelphax striatellus Fallen (smaller brown planthopper), Macrolestes quadrilineatus Forbes (aster leafhopper), Nephotettix cincticeps Uhler (green leafhopper), Nephotettix nigropictus Stål (rice leafhopper), Nilaparvata lugens Stål (brown planthopper), Peregrinus maidis Ashmead (corn planthopper), Sogatella furcifera Horvath (white-backed planthopper), Sogatodes orizicola Muir (rice delphacid), Typhlocyba pomaria McAtee white apple leafhopper, Erythroneoura spp. (grape leafhoppers); Magicidada septendecim Linnaeus (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla), Acrosternum hilare Say (green stink bug), Anasa tristis De Geer (squash bug), Blissus leucopterus leucopterus Say (chinch bug), Corythuca gossypii Fabricius (cotton lace bug), Cyrtopeltis modesta Distant (tomato bug), Dysdercus suturellus Herrich-Schäffer (cotton stainer), Euchistus servus Say (brown stink bug), Euchistus variolarius Palisot de Beauvois (one-spotted stink bug), Graptosthetus spp. (complex of seed bugs), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper), Frankliniella occidentalis Pergande (western flower thrip), Scirthothrips citri Moulton (citrus thrip), Sericothrips variabilis Beach (soybean thrip), and Thrips tabaci Lindeman (onion thrip), Leptinotarsa decemlineata Say (Colorado potato beetle), Epilachna varivestis Mulsant (Mexican bean beetle) and wireworms of the genera Agriotes, Athous or Limonius).

33. A compound of Formula Ia, its N-oxide or an agriculturally suitable salt of the compound 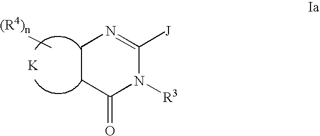
wherein
K is, together with the two contiguous linking carbon atoms, a fused phenyl or a fused pyridinyl ring selected from the group consisting of K-1, K-2, K-3, K-4 and K-5, each optionally substituted with 1 to 4 R⁴ 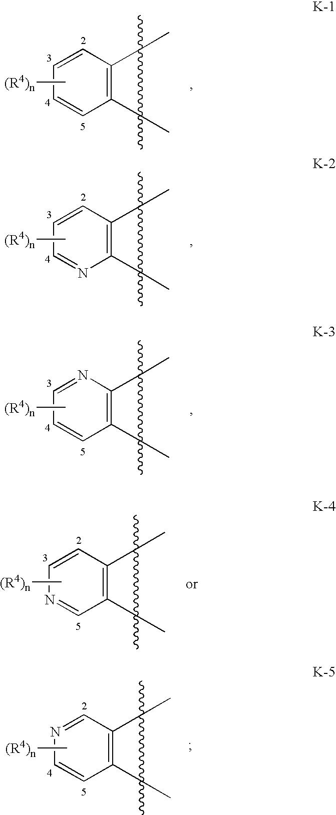
J substituted with 1 to 3 R⁵ is selected from the group consisting of J-6, J-7, J-8, J-9, J-10, J-11, J-12 and J-13 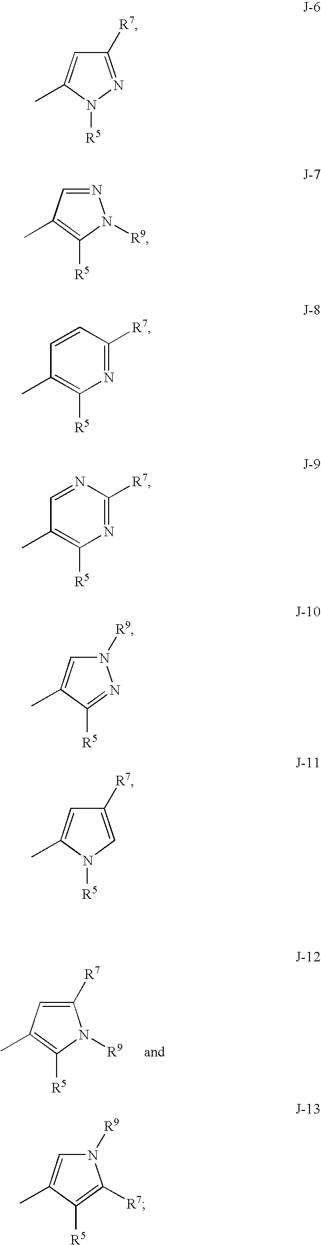
R³is C₁-C₆ alkyl, C₂-C₆ alkenyl, C₂-C₆ alkynyl or C₃-C₆ cycloalkyl each optionally substituted with one or more substituents selected from the group consisting of halogen, CN, C₁-C₂ alkoxy, C₁-C₂ alkylthio, C₁-C₂ alkylsulfinyl and C₁-C₂ alkylsulfonyl;
one R⁴ group is attached to the K-ring at the 2-position or 5-position, and said R⁴ is C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, or C₁-C₄ haloalkylsulfonyl; and
an optional second R⁴ is H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₁-C₄ alkoxyalkyl, C₁-C₄ hydroxyalkyl, C(O)R¹⁰, CO₂R¹⁰, C(O)NR¹⁰R¹¹, NR¹⁰R¹¹, N(R¹¹)COR¹⁰,N(R¹¹)CO₂R¹⁰ or C₃-C₆ trialkylsilyl;
R⁵ is 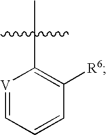
V is N, CH, CF, CCl, CBr or CI;
each R⁶ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl;
each R⁷ is independently H, C₁-C₆ alkyl, C₁-C₆ haloalkyl, halogen, CN, C₁-C₄ alkoxy, C₁-C₄ haloalkoxy or C₁-C₄ haloalkylthio;
R⁹ is H, C₂-C₆ alkyl, C₁-C₆ haloalkyl, C₃-C₆ alkenyl, C₃-C₆ haloalkenyl, C₃-C₆ alkynyl or C₃-C₆ haloalkynyl, provided that R⁷ and R⁹ are not both H;
R¹⁰ is H or C₁-C₄ alkyl or C₁-C₄ haloalkyl;
R¹¹ is H or C₁-C₄ alkyl; and
n is 0, 1 or 2.

34. The compound of claim 33 wherein
J substituted with 1 to 3 R⁵ is J-6;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁷ is CH₃, CF₃, OCHF₂ or halogen; and
p is 0, 1 or 2.

35. The compound of claim 34 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁷ is halogen or CF₃.

36. The compound of claim 33 wherein
J substituted with 1 to 3 R⁵ is J-7;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁹ is C₂-C₆ alkyl or C₁-C₆ haloalkyl; and
p is 0, 1 or 2.

37. The compound of claim 36 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁹ is CF₃, CHF₂, CBrF₂, CClF₂, CH₂CF₃, or CF₂CHF₂.

38. The compound of claim 33 wherein
J substituted with 1 to 3 R⁵ is J-8;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN R⁶ is CH₃, CF₃ or halogen;
R⁷ is CH₃, CF₃ or halogen; and
p is 0, 1 or 2.

39. The compound of claim 38 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁷ is halogen or CF₃.

40. The compound of claim 33 wherein
J substituted with 1 to 3 R⁵ is J-9;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁷ is CH₃, CF₃ or halogen; and
p is 0, 1 or 2.

41. The compound of claim 40 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁷ is CF₃.

42. The compound of claim 33 wherein
J substituted with 1 to 3 R⁵ is J-10;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁹ is C₂-C₆ alkyl or C₁-C₆ haloalkyl; and
p is 0, 1 or 2.

43. The compound of claim 42 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁹ is CF₃, CHF₂, CBrF₂, CClF₂, CH₂CF₃, or CF₂CHF₂.

44. The compound of claim 33 wherein
J substituted with 1 to 3 R⁵ is J-11;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁷ is CH₃, CF₃, OCHF₂ or halogen; and
p is 0, 1 or 2.

45. The compound of claim 44 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁷ is halogen or CF₃.

46. The compound of claim 33 wherein
J substituted with 1 to 3 R⁵ is J-12;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁹ is C₂-C₆ alkyl or C₁-C₆ haloalkyl; and
p is 0, 1 or 2.

47. The compound of claim 46 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁹ is CF₃, CHF₂, CBrF₂, CClF₂, CH₂CF₃, or CF₂CHF₂.

48. The compound of claim 33 wherein
J substituted with 1 to 3 R⁵ is J-13;
R³ is C₁-C₄ alkyl optionally substituted with halogen, CN, OCH₃, S(O)ₚCH₃;
one R⁴ group is attached to the K-ring at the 2-position and said R⁴ is CH₃, CF₃, OCF₃, OCHF₂, S(O)ₚCF₃, S(O)ₚCHF₂, CN or halogen;
a second R⁴ is H, F, Cl, Br, I or CF₃;
R⁶ is C₁-C₄ alkyl, C₁-C₄ haloalkyl, halogen or CN;
R⁹ is C₂-C₆ alkyl or C₁-C₆ haloalkyl; and
p is 0,1 or 2.

49. The compound of claim 48 wherein
R³ is C₁-C₄ alkyl;
one R⁴ group is attached to the K-ring at the 2-position and said R⁴ is CH₃, Cl or Br;
a second R⁴ is H, F, Cl, Br, I or CF₃;
R⁶ is Cl or Br; and
R⁹ is CF₃, CHF₂, CBrF₂, CClF₂, CH₂CF₃, or CF₂CHF₂.

50. The compound of claim 33 selected from the group consisting of:
8-methyl-3-(1-methylethyl)-2-[2-methyl-6-(trifluoromethyl)-3-pyridinyl]-4(3H)-quinazolinone,
2-[3-bromo-1-(3-chloro-2-pyridinyl)-1H-pyrazol-5-yl]-6-chloro-3,8-dimethyl-4(3H)-quinazoline,
2-[3-bromo-1-(3-chloro-2-pyridinyl)-1H-pyrazol-5-yl]-6-chloro-3-ethyl-8-methyl-4(3H)-quinazoline,
2-[3-bromo-1-(3-chloro-2-pyridinyl)-1H-pyrazol-5-yl]-6-chloro-8-methyl-3-(1-methylethyl)-4(3H)-quinazoline,
2-[3-bromo-1-(3-chloro-2-pyridinyl)-1H-pyrazol-5-yl]-6-chloro-3(1,1-dimethylethyl)-8-methyl-4(3H)-quinazoline,
6-chloro-2-[3-chloro-1-(3-chloro-2-pyridinyl)-1H-pyrazol-5-yl]-3,8-dimethyl-4(3H)-quinazoline,
6-chloro-2-[3-chloro-1-(3-chloro-2-pyridinyl)-1H-pyrazol-5-yl]-3-ethyl-8-methyl-4(3H)-quinazoline,
6-chloro-2-[3-chloro-1-(3-chloro-
2-pyridinyl)-1H-pyrazol-5-yl]-8-methyl-3-(1-methylethyl)-4(3H)-quinazoline,
6-chloro-2-[3-chloro-1-(3-chloro-2-pyridinyl)-1H-pyrazol-5-yl]-3-(1,1-dimethylethyl)-8-methyl-4(3H)-quinazoline,
6-chloro-2-[1-(3-chloro-2-pyridinyl)-3-(trifluoromethyl)-1H-pyrazol-5-yl]-3,8-dimethyl-4(3H)-quinazoline,
6-chloro-2-[1-(3-chloro-2-pyridinyl)-3-(trifluoromethyl)-1H-pyrazol-5-yl]-3-ethyl-8-methyl-4(3H)-quinazoline,
6-chloro-2-[1-(3-chloro-2-pyridinyl)-3-(trifluoromethyl)-1H-pyrazol-5-yl]-8-methyl-3-(1-methylethyl)-4(3H)-quinazoline,
6-chloro-2-[1-(3-chloro-2-pyridinyl)-3-(trifluoromethyl)-1H-pyrazol-5-yl]-3-(1,1-dimethylethyl)-8-methyl-4(3H)-quinazoline,
2-[3-bromo-1-(3-chloro-2-pyridinyl)-1H-pyrazol-5-yl]-8-methyl-3-(1-methylethyl)-4(3H)-quinazoline,
2-[3-bromo-1-(3-chloro-2-pyridinyl)-1H-pyrazol-5-yl]-3-(1,1-dimethylethyl)-8-methyl-4(3H)-quinazoline,
2-[1-(3-chloro-2-pyridinyl)-3-(trifluoromethyl)-1H-pyrazol-5-yl]-8-methyl-3(1-methylethyl)-4(3H)-quinazoline,
2-[1-(3-chloro-2-pyridinyl)-3-(trifluoromethyl)-1H-pyrazol-5-yl]-3-(1,1-dimethylethyl)-8-methyl-4(3H)-quinazoline,
6,8-dichloro-2-[1-(3-chloro-2-pyridinyl)-3-(trifluoromethyl)-1H-pyrazol-5-yl]-3-methyl-4(3H)-quinazoline,
6,8-dichloro-2-[1-(3-chloro-2-pyridinyl)-3-(trifluoromethyl)-1H-pyrazol-5-yl]-3-ethyl-4(3H)-quinazoline,
6,8-dichloro-2-[1-(3-chloro-2-pyridinyl)-3-(trifluoromethyl)-1H-pyrazol-5-yl]-3-(1-methylethyl)-4(3H)-quinazoline,
2-[3-bromo-1-(3-chloro-2-pyridinyl)-1H-pyrazol-5-yl]-6,8-dichloro-3-methyl-4(3H)-quinazoline,
2-[3-bromo-1-(3-chloro-2-pyridinyl)-1H-pyrazol-5-yl]-6,8-dichloro-3-ethyl-4(3H)-quinazoline,
2-[3-bromo-1-(3-chloro-2-pyridinyl)-1H-pyrazol-5-yl]-6,8-dichloro-3-(1-methylethyl)-4(3H)-quinazoline,
6,8-dichloro-2-[3-chloro-1-(3-chloro-2-pyridinyl)-1H-pyrazol-5-yl]-3-methyl-4(3H)-quinazoline,
6,8-dichloro-2-[3-chloro-1-(3-chloro-2-pyridinyl)-1H-pyrazol-5-yl]-3-et1Hyl-4(3H)-quinazoline, and
6,8-dichloro-2-[3-chloro-1-(3-chloro-2-pyridinyl)-1H-pyrazol-5-yl]-3-(1-methylethyl)-4(3H)-quinazoline.

51. A composition for controlling an invertebrate pest comprising a biologically effective amount of a compound of Formula Ia of claim 33 and at least one additional component selected from the group consisting of surfactants, solid diluents and liquid diluents.

52. A composition for controlling an invertebrate pest comprising a biologically effective amount of a compound of Formula Ia of claim 33 and an effective amount of at least one additional biologically active compound or agent.
